(19) United States
(12) Patent Application Publication
(10) Pub. No.: US 2025/0245153 A1
(43) Pub. Date: Jul. 31, 2025

(54) Application Programming Interface to Deallocate a Data Structure

(71) Applicant: NVIDIA Corporation, Santa Clara, CA (US)

(72) Inventors: Kyrylo PERELYGIN, Broomfield, CO (US); Shelton DSOUZA, San Jose, CA (US); Alicia Xiao HU, Santa Clara, CA (US); Ze LONG, San Jose, CA (US)

(21) Appl. No.: 18/593,588

(22) Filed: Mar. 1, 2024

Related U.S. Application Data
(60) Provisional application No. 63/625,278, filed on Jan. 25, 2024.

(51) Int. Cl. G06F 12/0806; G06F 9/54

(52) U.S. Cl. CPC G06F 12/0806; G06F 9/54

(57) ABSTRACT

Apparatuses, systems, and techniques to perform computing operations. In at least one embodiment, a processor performs an application programming interface to deallocate one or more data structures to indicate which of one or more streaming multiprocessors of one or more processors are to be used to perform one or more software threads.

### CROSS-REFERENCE TO RELATED APPLICATIONS

This application claims the benefit of U.S. Provisional Application No. 63/625,278 (Attorney Docket No. 0112912-A27PR0) titled “APPLICATION PROGRAMMING INTERFACE TO MANAGE RESOURCES,” filed Jan. 25, 2024, the entire contents of which is incorporated herein by reference. This application also incorporates for all purposes the full disclosure of co-pending U.S. patent application Ser. No. ______, filed concurrently herewith, entitled “APPLICATION PROGRAMMING INTERFACE TO ALLOCATE A DATA STRUCTURE” (Attorney Docket No. 0112912-A27US0), co-pending U.S. patent application Ser. No. ______, filed concurrently herewith, entitled “APPLICATION PROGRAMMING INTERFACE TO STORE AN IDENTIFIER OF A DATA STRUCTURE” (Attorney Docket No. 0112912-C04US0), co-pending U.S. patent application Ser. No. ______, filed concurrently herewith, entitled “APPLICATION PROGRAMMING INTERFACE TO INDICATE MULTIPROCESSOR AVAILABILITY” (Attorney Docket No. 0112912-C05US0), co-pending U.S. patent application Ser. No. ______, filed concurrently herewith, entitled “APPLICATION PROGRAMMING INTERFACE TO STORE IDENTIFIERS OF MULTIPROCESSOR GROUPS” (Attorney Docket No. 0112912-C06US0), co-pending U.S. patent application Ser. No. ______, filed concurrently herewith, entitled “APPLICATION PROGRAMMING INTERFACE TO INDICATE MULTIPROCESSOR GROUPS” (Attorney Docket No. 0112912-C07US0), co-pending U.S. patent application Ser. No. ______, filed concurrently herewith, entitled “APPLICATION PROGRAMMING INTERFACE TO READ FROM A DATA STRUCTURE” (Attorney Docket No. 0112912-C08US0), co-pending U.S. patent application Ser. No. ______, filed concurrently herewith, entitled “APPLICATION PROGRAMMING INTERFACE TO COMMUNICATE CONTEXT” (Attorney Docket No. 0112912-C09US0), and co-pending U.S. patent application Ser. No. ______, filed concurrently herewith, entitled “APPLICATION PROGRAMMING INTERFACE TO WAIT FOR CONTEXT” (Attorney Docket No. 0112912-C10US0).

### FIELD

At least one embodiment pertains to processing resources used to execute one or more software programs on a graphics processing unit (“GPU”). For example, at least one embodiment pertains to performing application programming interfaces to manage resources of software programs.

### BACKGROUND

Performing computer programs can use significant memory, time, or resources. An amount of memory, time, and/or resources used to perform computer programs can be improved. Despite advances that accelerate or otherwise assist in performance of various components of a computer program, there are still challenges in performing computer programs with improved use of memory, time, and/or resources.

### BRIEF DESCRIPTION OF THE DRAWINGS

FIG. 1 is a block diagram illustrating a computer system to perform computing resource operation application programming interfaces (APIs), in accordance with at least one embodiment;

FIG. 2 is a block diagram illustrating contexts and sub-contexts, in accordance with at least one embodiment;

FIG. 3 is a block diagram illustrating a software program to be performed by one or more processors, in accordance with at least one embodiment;

FIG. 4 is a block diagram illustrating a process to perform one or more application programming interfaces (APIs), in accordance with at least one embodiment;

FIG. 5 is a block diagram illustrating an application programming interface (API) to create a sub-context, in accordance with at least one embodiment;

FIG. 6 is a block diagram illustrating a process to perform an application programming interface (API) to create a sub-context, in accordance with at least one embodiment;

FIG. 7 is a block diagram illustrating an application programming interface (API) to destroy a sub-context, in accordance with at least one embodiment;

FIG. 8 is a block diagram illustrating a process to perform an application programming interface (API) to destroy a subcontext, in accordance with at least one embodiment;

FIG. 9 is a block diagram illustrating an application programming interface (API) to get a sub-context from a stream, in accordance with at least one embodiment;

FIG. 10 is a block diagram illustrating a process to perform an application programming interface (API) to get a sub-context from a stream, in accordance with at least one embodiment;

FIG. 11 is a block diagram illustrating an application programming interface (API) to get resources associated with a context, in accordance with at least one embodiment;

FIG. 12 is a block diagram illustrating a process to perform an application programming interface (API) to get resources associated with a context, in accordance with at least one embodiment;

FIG. 13 is a block diagram illustrating an application programming interface (API) to subdivide context resources, in accordance with at least one embodiment;

FIG. 14 is a block diagram illustrating a process to perform an application programming interface (API) to subdivide context resources, in accordance with at least one embodiment;

FIG. 15 is a block diagram illustrating an application programming interface (API) to generate a resource descriptor, in accordance with at least one embodiment;

FIG. 16 is a block diagram illustrating a process to perform an application programming interface (API) to generate a resource descriptor, in accordance with at least one embodiment;

FIG. 17 is a block diagram illustrating an application programming interface (API) to get device resources of a context, in accordance with at least one embodiment;

FIG. 18 is a block diagram illustrating a process to perform an application programming interface (API) to get device resources of a context, in accordance with at least one embodiment;

FIG. 19 is a block diagram illustrating an application programming interface (API) to record a context event, in accordance with at least one embodiment;

FIG. 20 is a block diagram illustrating a process to perform an application programming interface (API) to record a context event, in accordance with at least one embodiment;

FIG. 21 is a block diagram illustrating an application programming interface (API) to wait on a context event, in accordance with at least one embodiment;

FIG. 22 is a block diagram illustrating a process to perform an application programming interface (API) to wait on a context event, in accordance with at least one embodiment;

FIG. 23 is a block diagram illustrating an example software stack where application programming interfaces (API) are processed, in accordance with at least one embodiment;

FIG. 24 is a block diagram illustrating a processor and modules, according to at least one embodiment;

FIG. 25 is a block diagram illustrating a driver and/or runtime comprising one or more libraries to provide one or more application programming interfaces (APIs), according to at least one embodiment;

FIG. 26 illustrates an exemplary data center, in accordance with at least one embodiment;

FIG. 27 illustrates a processing system, in accordance with at least one embodiment;

FIG. 28 illustrates a computer system, in accordance with at least one embodiment;

FIG. 29 illustrates a system, in accordance with at least one embodiment;

FIG. 30 illustrates an exemplary integrated circuit, in accordance with at least one embodiment;

FIG. 31 illustrates a computing system, according to at least one embodiment;

FIG. 32 illustrates an APU, in accordance with at least one embodiment;

FIG. 33 illustrates a CPU, in accordance with at least one embodiment;

FIG. 34 illustrates an exemplary accelerator integration slice, in accordance with at least one embodiment;

FIGS. 35A and 35B illustrate exemplary graphics processors, in accordance with at least one embodiment;

FIG. 36A illustrates a graphics core, in accordance with at least one embodiment;

FIG. 36B illustrates a GPGPU, in accordance with at least one embodiment;

FIG. 37A illustrates a parallel processor, in accordance with at least one embodiment;

FIG. 37B illustrates a processing cluster, in accordance with at least one embodiment;

FIG. 37C illustrates a graphics multiprocessor, in accordance with at least one embodiment;

FIG. 38 illustrates a graphics processor, in accordance with at least one embodiment;

FIG. 39 illustrates a processor, in accordance with at least one embodiment;

FIG. 40 illustrates a processor, in accordance with at least one embodiment;

FIG. 41 illustrates a graphics processor core, in accordance with at least one embodiment;

FIG. 42 illustrates a PPU, in accordance with at least one embodiment;

FIG. 43 illustrates a GPC, in accordance with at least one embodiment;

FIG. 44 illustrates a streaming multiprocessor, in accordance with at least one embodiment;

FIG. 45 illustrates a software stack of a programming platform, in accordance with at least one embodiment;

FIG. 46 illustrates a CUDA implementation of a software stack of FIG. 45, in accordance with at least one embodiment;

FIG. 47 illustrates a ROCm implementation of a software stack of FIG. 45, in accordance with at least one embodiment;

FIG. 48 illustrates an OpenCL implementation of a software stack of FIG. 45, in accordance with at least one embodiment;

FIG. 49 illustrates software that is supported by a programming platform, in accordance with at least one embodiment;

FIG. 50 illustrates compiling code to execute on programming platforms of FIGS. 45-48, in accordance with at least one embodiment;

FIG. 51 illustrates in greater detail compiling code to execute on programming platforms of FIGS. 45-48, in accordance with at least one embodiment;

FIG. 52 illustrates translating source code prior to compiling source code, in accordance with at least one embodiment;

FIG. 53A illustrates a system configured to compile and execute CUDA source code using different types of processing units, in accordance with at least one embodiment;

FIG. 53B illustrates a system configured to compile and execute CUDA source code of FIG. 53A using a CPU and a CUDA-enabled GPU, in accordance with at least one embodiment;

FIG. 53C illustrates a system configured to compile and execute CUDA source code of FIG. 53A using a CPU and a non-CUDA-enabled GPU, in accordance with at least one embodiment;

FIG. 54 illustrates an exemplary kernel translated by CUDA-to-HIP translation tool of FIG. 53C, in accordance with at least one embodiment;

FIG. 55 illustrates non-CUDA-enabled GPU of FIG. 53C in greater detail, in accordance with at least one embodiment;

FIG. 56 illustrates how threads of an exemplary CUDA grid are mapped to different compute units of FIG. 55, in accordance with at least one embodiment;

FIG. 57 illustrates how to migrate existing CUDA code to Data Parallel C++ code, in accordance with at least one embodiment; and

FIG. 58 illustrates components of a system to access a large language model, according to at least one embodiment.

### DETAILED DESCRIPTION

In at least one embodiment, software (e.g., a computer program) performed by one or more processors causes software performed by other processors (e.g., in a data center) to perform operations to manage resources associated with said software performed by other processors. In at least one embodiment, software performed by one or more processors performs one or more application programming interfaces (APIs) to create a sub-context that manages a sub-set of resources usable to perform software programs. In at least one embodiment, software performed by one or more processors performs one or more APIs to create a sub-context that manages a sub-set of resources usable to perform software programs, thereby causing software performed by other processors to perform operations to manage resources associated with said software performed by other processors.

In at least one embodiment, software performed by one or more processors performs one or more APIs to destroy a sub-context. In at least one embodiment, software performed by one or more processors performs one or more APIs to destroy a sub-context, thereby causing software performed by other processors to perform operations to manage resources associated with said software performed by other processors. In at least one embodiment, sub-context destroyed by an application programming interface (API) to destroy a sub-context is a sub-context created by an API to create a sub-context, described above, is performed.

In at least one embodiment, software performed by one or more processors performs one or more APIs to create a sub-context from a stream (e.g., a series of operations to be performed, in a specified order, by one or more other processors). In at least one embodiment, software performed by one or more processors performs one or more APIs to create a sub-context from a stream, thereby causing software performed by other processors to perform operations to manage resources associated with said software performed by other processors. In at least one embodiment, sub-context created by an API to create a sub-context to a stream functions as a sub-context created by an API to create a sub-context, described above and is a sub-context that can be destroyed using an API to destroy a sub-context, also described above.

In at least one embodiment, software performed by one or more processors performs one or more APIs to obtain resources associated with a context or sub-context. In at least one embodiment, software performed by one or more processors performs one or more APIs to obtain resources associated with a context or sub-context, thereby causing software performed by other processors to perform operations to manage resources associated with said software performed by other processors. In at least one embodiment, resources obtained when an API to obtain resources associated with a context or sub-context is performed are resources associated with a context or sub-context that is created as described above (e.g., using an API to create a sub-context or an API to create a sub-context from a stream).

In at least one embodiment, software performed by one or more processors performs one or more APIs to subdivide context resources according to one or more criteria. In at least one embodiment, software performed by one or more processors performs one or more APIs to subdivide context resources, thereby causing software performed by other processors to perform operations to manage resources associated with said software performed by other processors. In at least one embodiment, the context resources subdivided by an API to subdivide context resources are resources associated with a context or sub-context is performed are resources associated with a context or sub-context that is created as described above (e.g., using an API to create a sub-context or an API to create a sub-context from a stream). In at least one embodiment, resource subdivisions (e.g., obtained by an API to subdivide context resources) are used to generate sub-contexts, as described herein.

In at least one embodiment, software performed by one or more processors performs one or more APIs to generate a resource descriptor from a list of resources. In at least one embodiment, software performed by one or more processors performs one or more APIs to generate a resource descriptor, thereby causing software performed by other processors to perform operations to manage resources associated with said software performed by other processors. In at least one embodiment, resource descriptor list generated by an API to generate a resource descriptor is used to create and/or manage sub-context, as described above.

In at least one embodiment, software performed by one or more processors performs one or more APIs to obtain device resources associated with a context or subcontext. In at least one embodiment, software performed by one or more processors performs one or more APIs to get device resources, thereby causing software performed by other processors to perform operations to manage resources associated with said software performed by other processors. In at least one embodiment, device resources obtained by performing an obtain device resources API are usable to create a sub-context and/or to further subdivide resources, as described above.

In at least one embodiment, software performed by one or more processors performs one or more APIs to record a context event (e.g., to issue an event that is associated with another context so that synchronization between contexts can be performed). In at least one embodiment, software performed by one or more processors performs one or more APIs to record a context event, thereby causing software performed by other processors to perform operations to manage resources associated with said software performed by other processors. In at least one embodiment, a context event recorded by an API to record a context event is used by a context associated with an API to wait on a context event, described below.

In at least one embodiment, software performed by one or more processors performs one or more APIs to wait on a context event (e.g., to wait on an event that is associated with another context so that synchronization between contexts can be performed). In at least one embodiment, software performed by one or more processors performs one or more APIs to wait on a context event, thereby causing software performed by other processors to perform operations to manage resources associated with said software performed by other processors. In at least one embodiment, a context event of an API to wait on a context event is used by a context associated with an API to record a context event, described above.

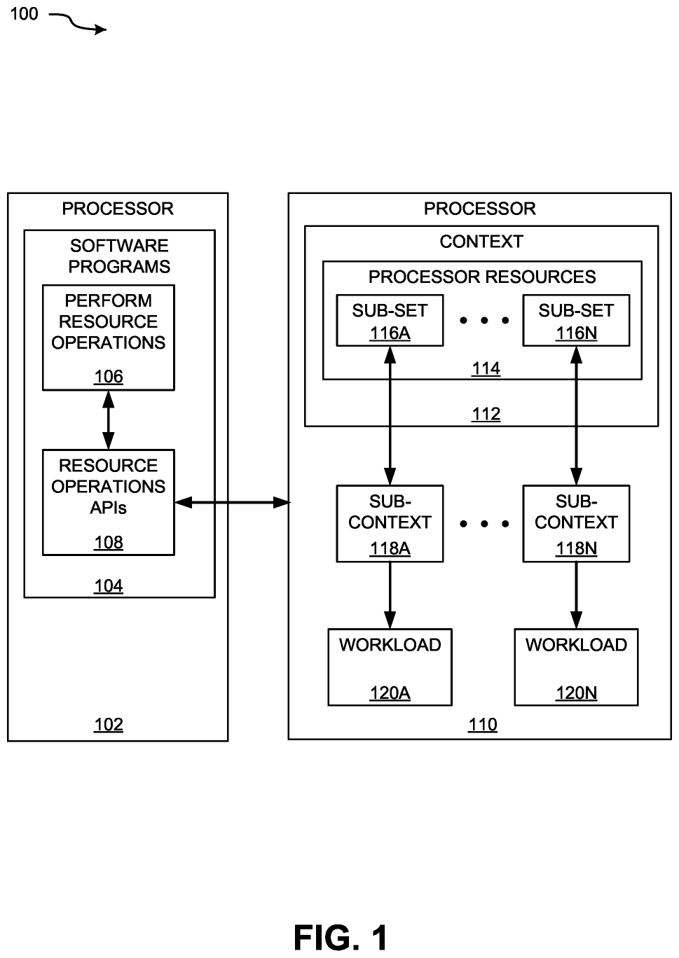

FIG. 1 is a block diagram 100 illustrating a computer system to perform computing resource operation application programming interfaces (APIs), in accordance with at least one embodiment. In at least one embodiment, a processor 102 performs one or more software programs 104. In at least one embodiment, processor 102 is a processor such as those described below. In at least one embodiment, processor 102 is a central processing unit (CPU), a graphics processing unit (GPU), a parallel processing unit (PPU), a general-purpose graphics processing unit (GPGPU), a compute cluster, and/or a combination of these and/or other such processors. In at least one embodiment, processor 102 is part of a computer system such as those described herein. In at least one embodiment, not shown in FIG. 1, processor 102 is a processor of a client computing system. In at least one embodiment, a client computing system comprises one or more client devices such as those described herein. In at least one embodiment, a client computing system comprises one or more devices that are clients of a cloud computing environment such as those described herein.

In at least one embodiment, software programs 104 comprise one or more computing operations such as computing operations to train a neural network, perform a neural network, perform a compute uniform device architecture (CUDA) program, perform a large-language model, perform a rendering operation, perform data analysis, and/or perform other operations including, but not limited to, those described herein. In at least one embodiment, software programs 104 comprise software such as that described herein.

In at least one embodiment, software programs 104 perform resource operations 106 using resource operations APIs 108. In at least one embodiment, resource operations 106 are operations to manage resources associated with processor 110. In at least one embodiment, processor 110 is a processor such as those described below. In at least one embodiment, processor 110 is a central processing unit (CPU), a graphics processing unit (GPU), a parallel processing unit (PPU), a general-purpose graphics processing unit (GPGPU), a compute cluster, and/or a combination of these and/or other such processors. In at least one embodiment, processor 110 is part of a computer system such as those described herein.

In at least one embodiment, not shown in FIG. 1, processor 110 is one of a plurality of processors of a high-performance computing system. In at least one embodiment, a high-performance computing system is a computing system comprising a plurality of processors to perform computing operations such as those described herein. In at least one embodiment, a high-performance computing system is a distributed computing system. In at least one embodiment, a high-performance computing system is a deep-learning computing system. In at least one embodiment, operations to perform computing operations are performed by a high-performance computing system, using systems, methods, operations, and/or techniques described herein. In at least one embodiment, a high-performance computing system comprises a cloud computing environment such as those described herein. In at least one embodiment, a high-performance computing system comprises one or more processors such as processor 110. In at least one embodiment, a high-performance computing system comprises one or more graphics processors such as those described herein. In at least one embodiment, processors of a high-performance computing system include one or more central processing units (CPUs), graphics processing units (GPUs), parallel processing units (PPUs), general-purpose graphics processing units (GPGPUs), compute clusters, and/or a combination of these and/or other such processors, as described herein.

In at least one embodiment, a high-performance computing system comprises a plurality of processors such as processor 110, that have an associated set of resources usable by a processor such as processor 102 to perform computing operations including one or more resource operations 106 using one or more resource operations APIs 108. In at least one embodiment, resource operations 106 are computing operations to manage resources of processes being performed by one or more processors, using systems, methods, and/or operations such as those described herein.

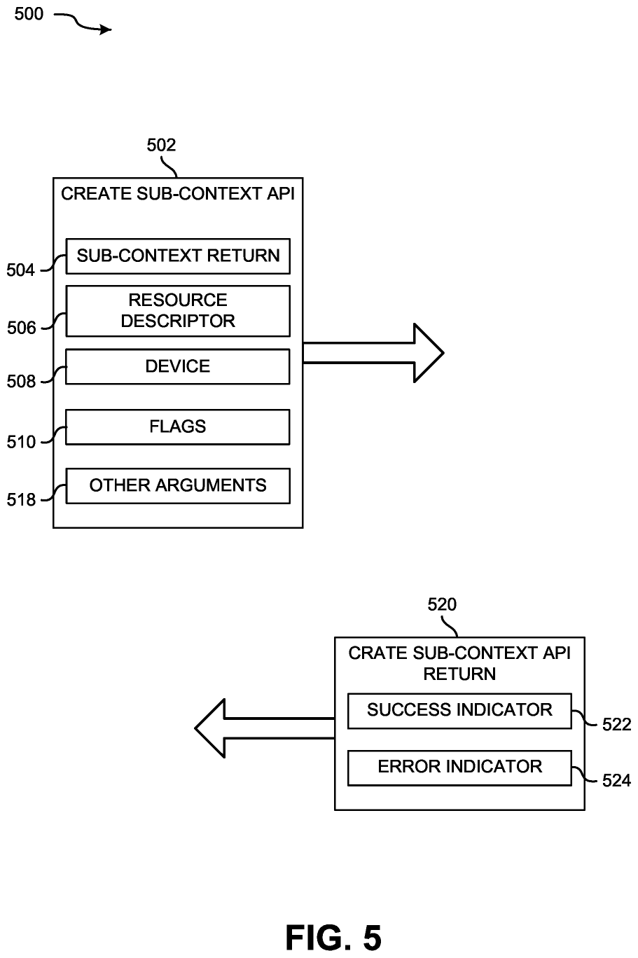

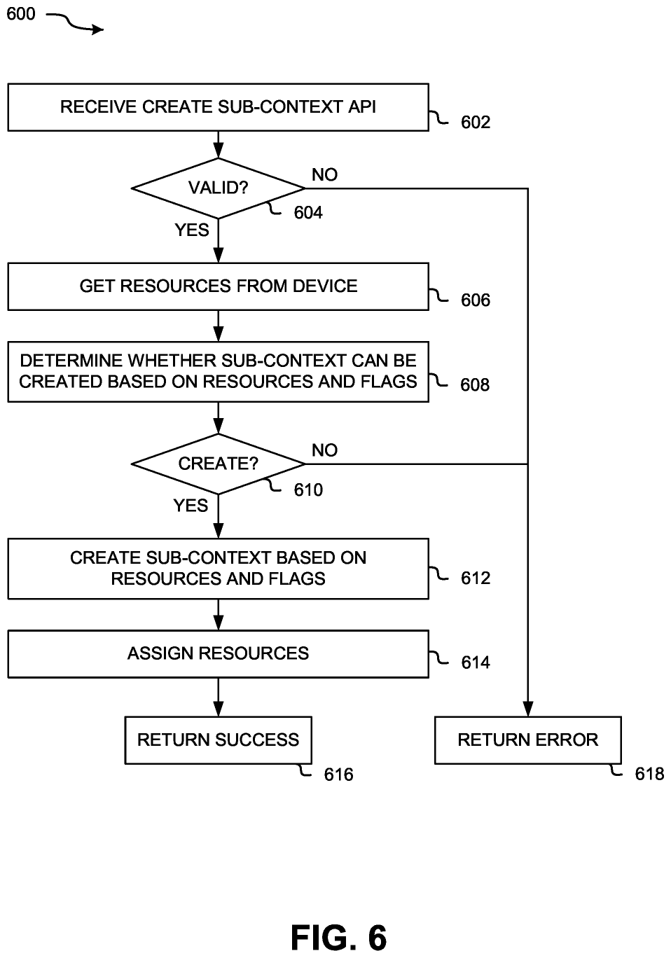

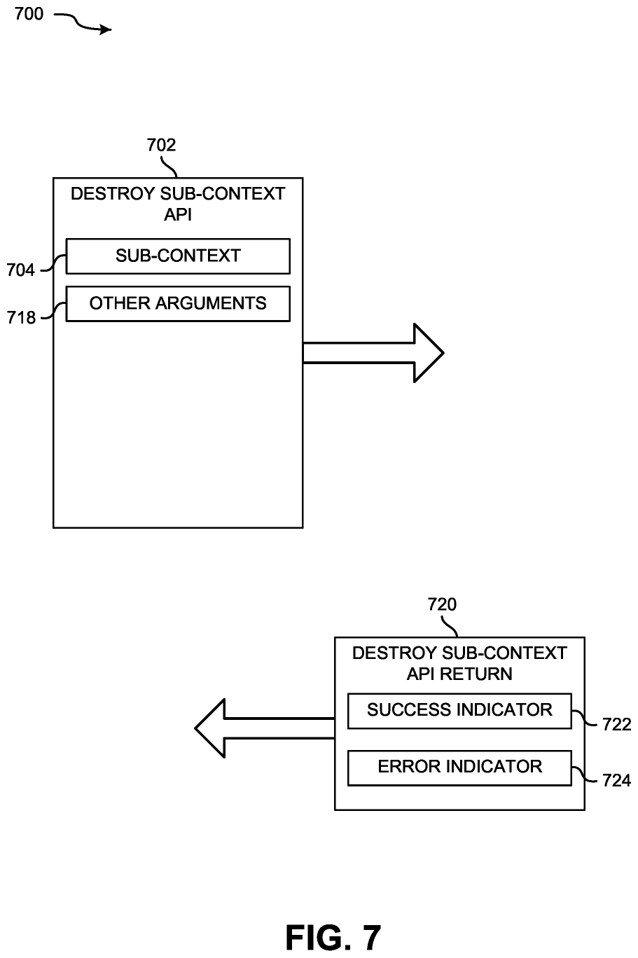

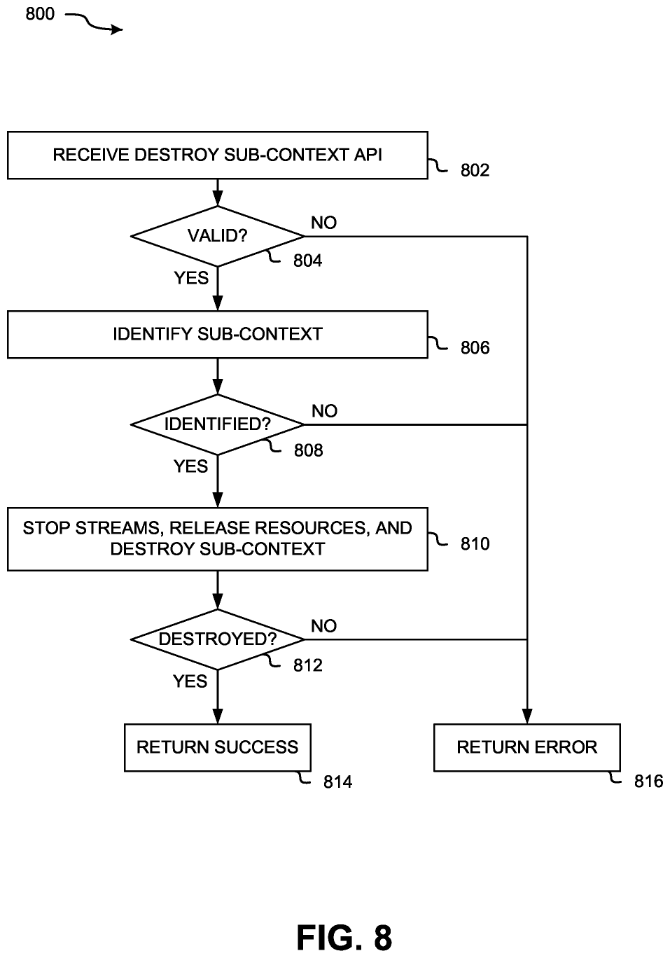

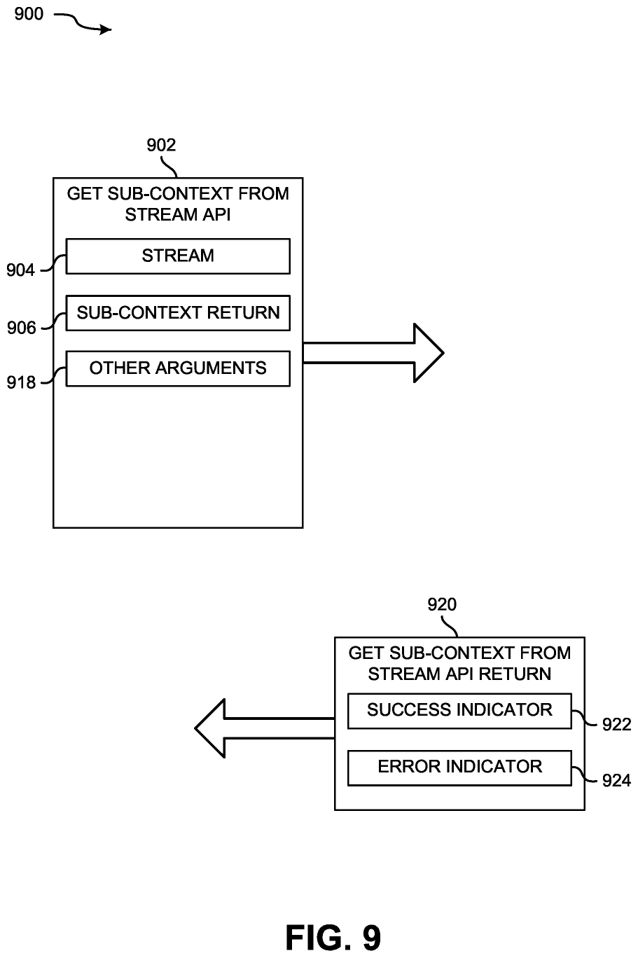

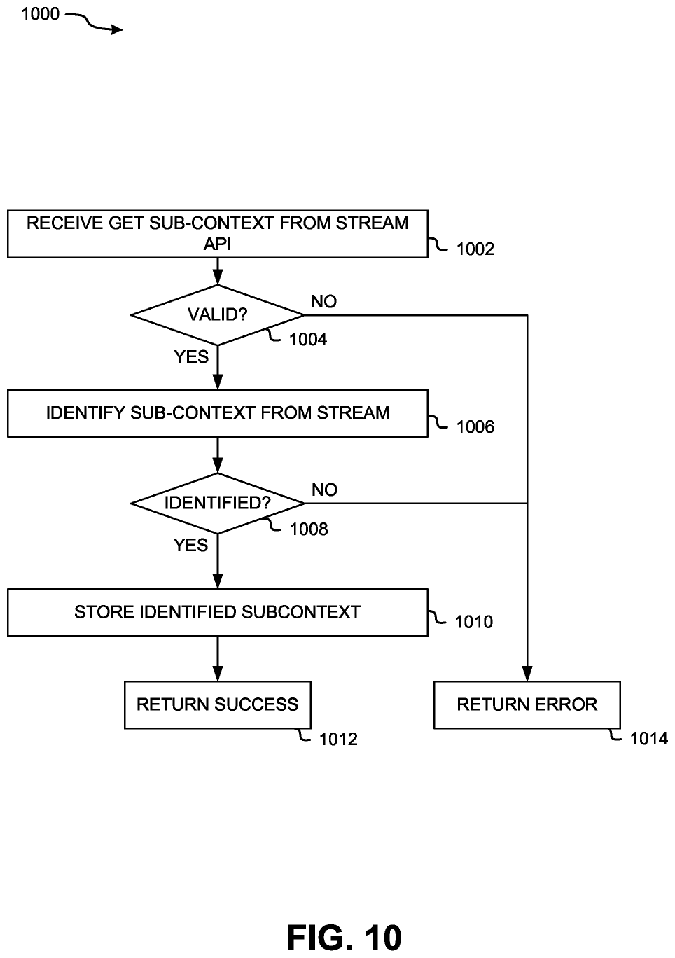

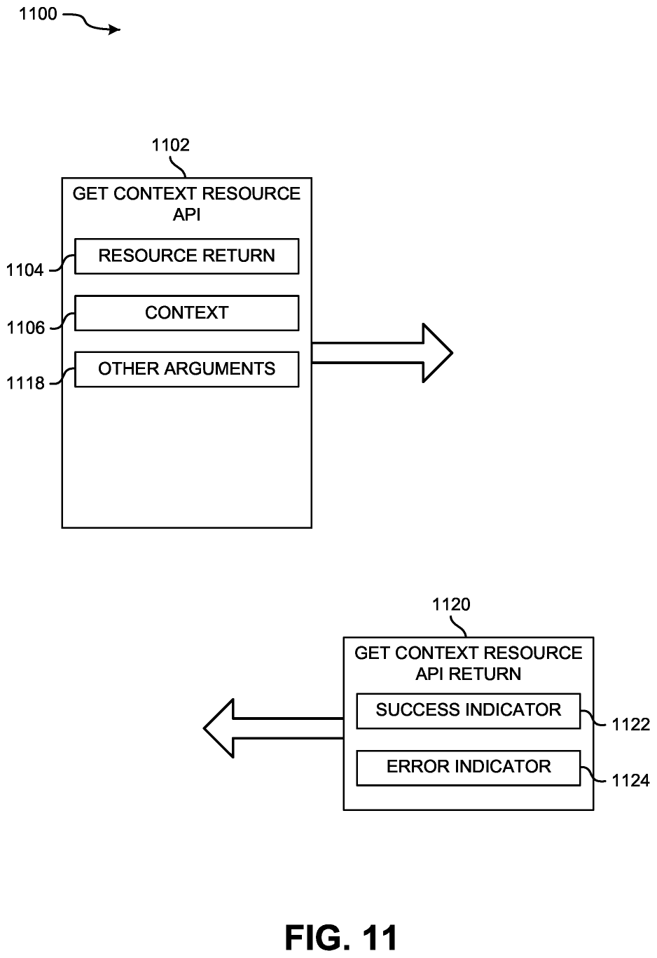

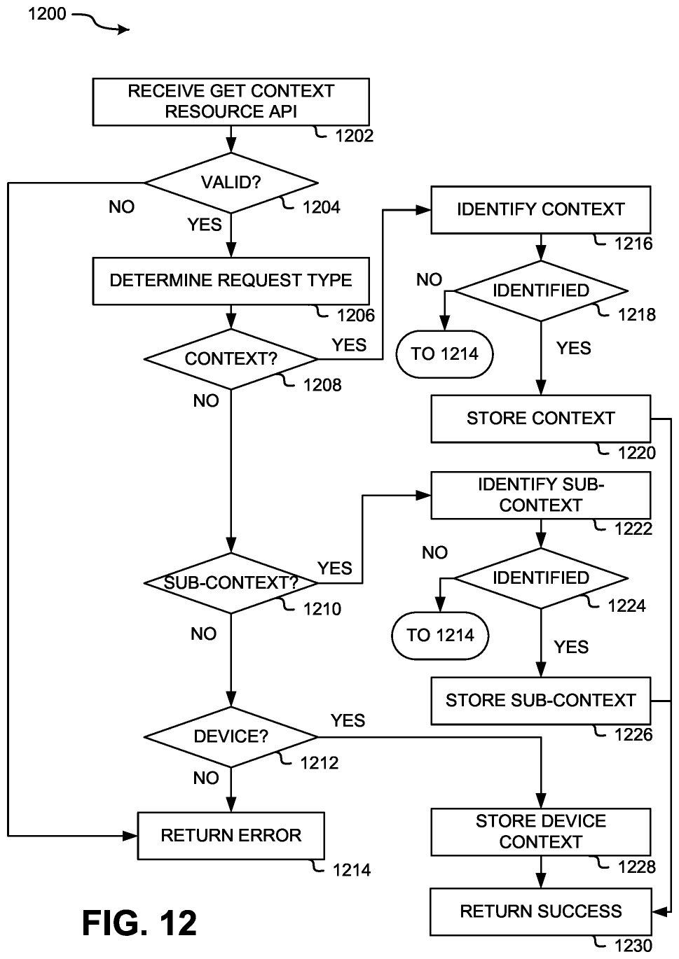

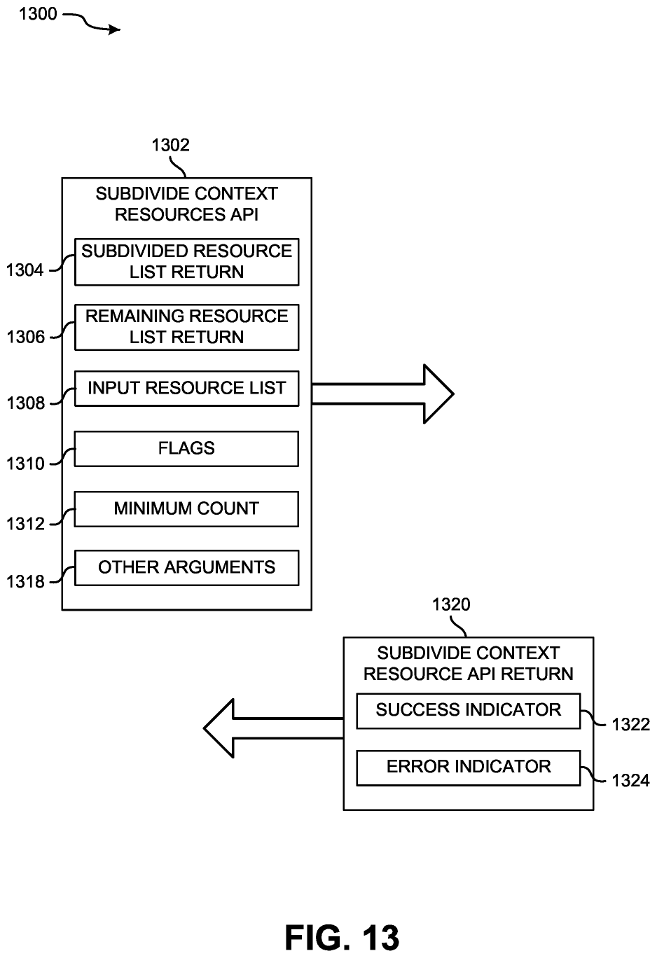

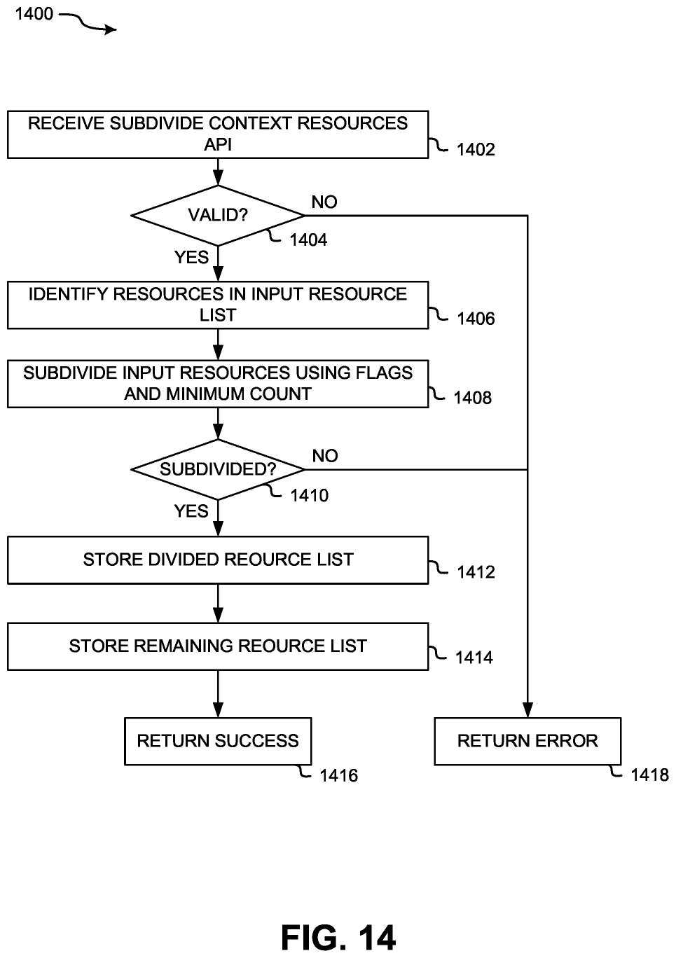

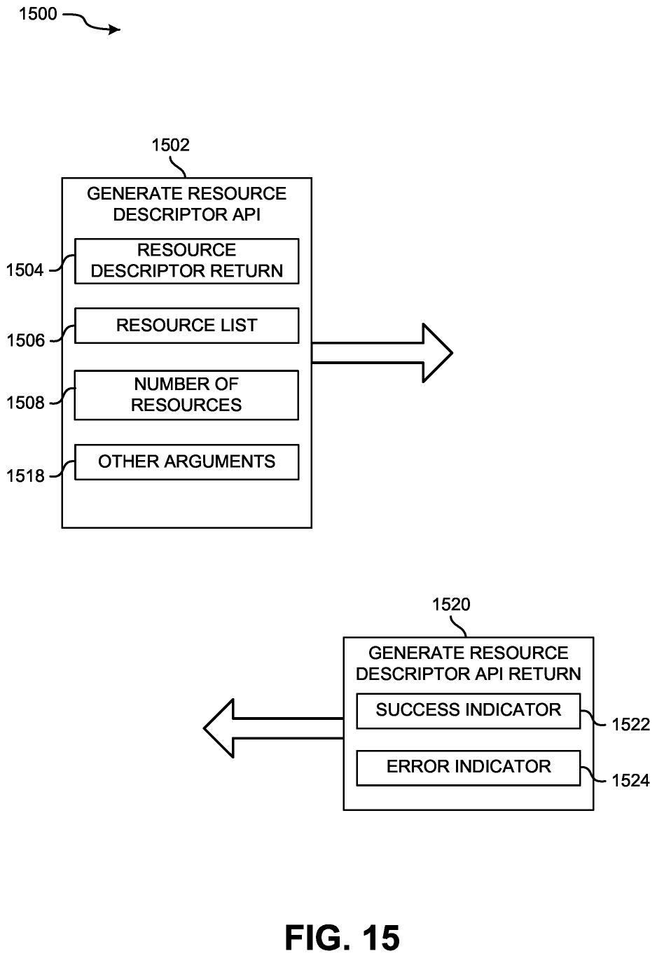

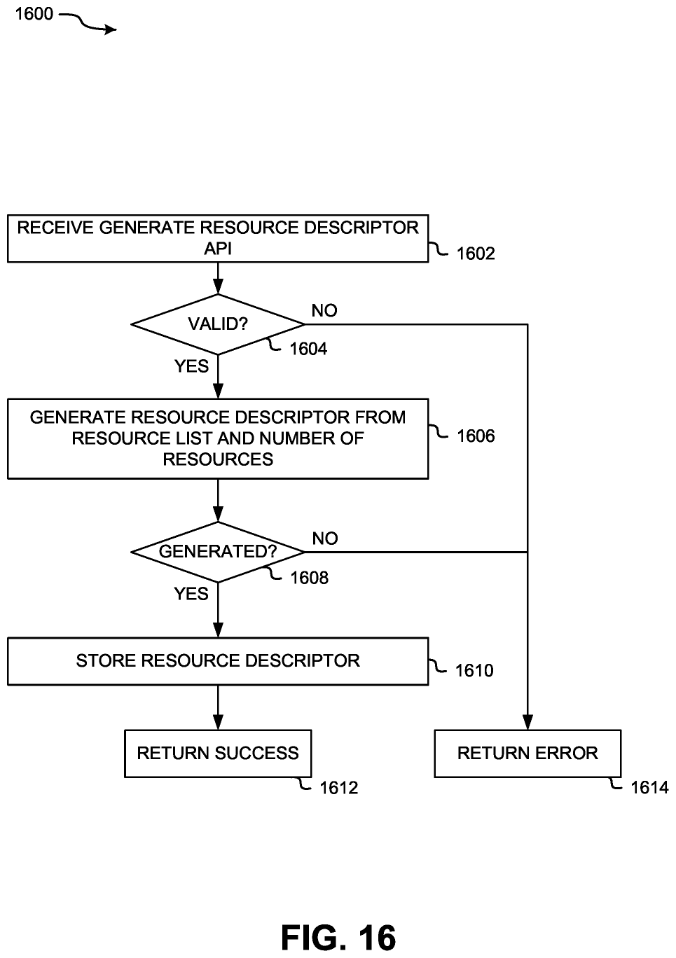

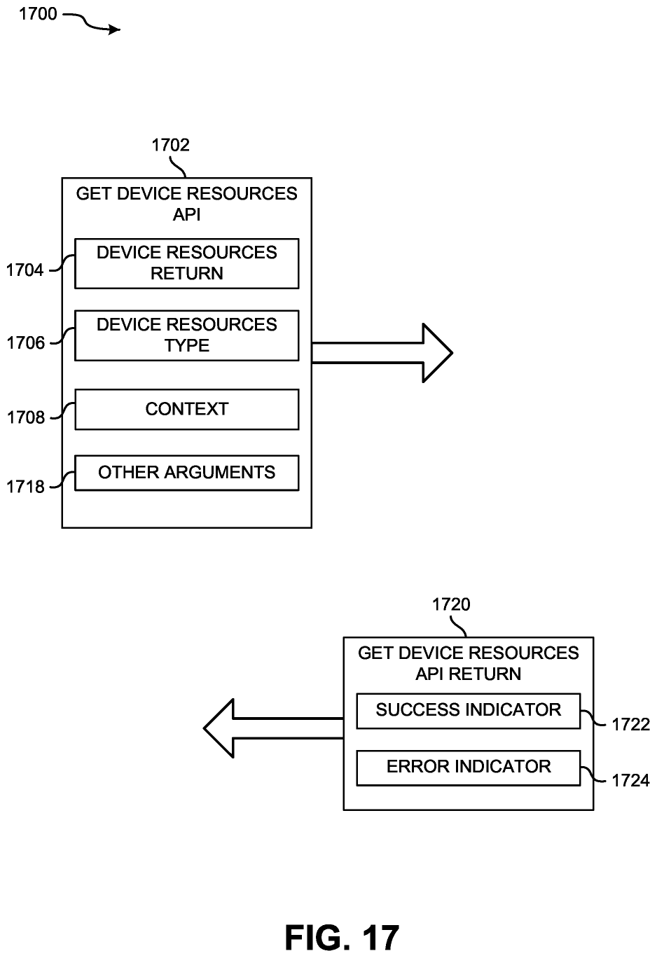

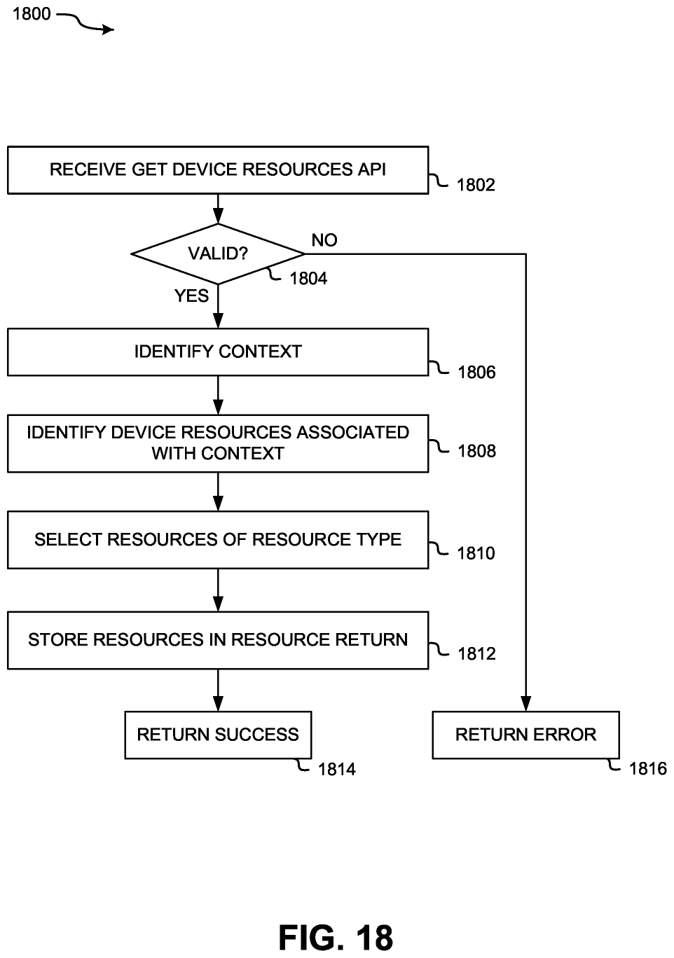

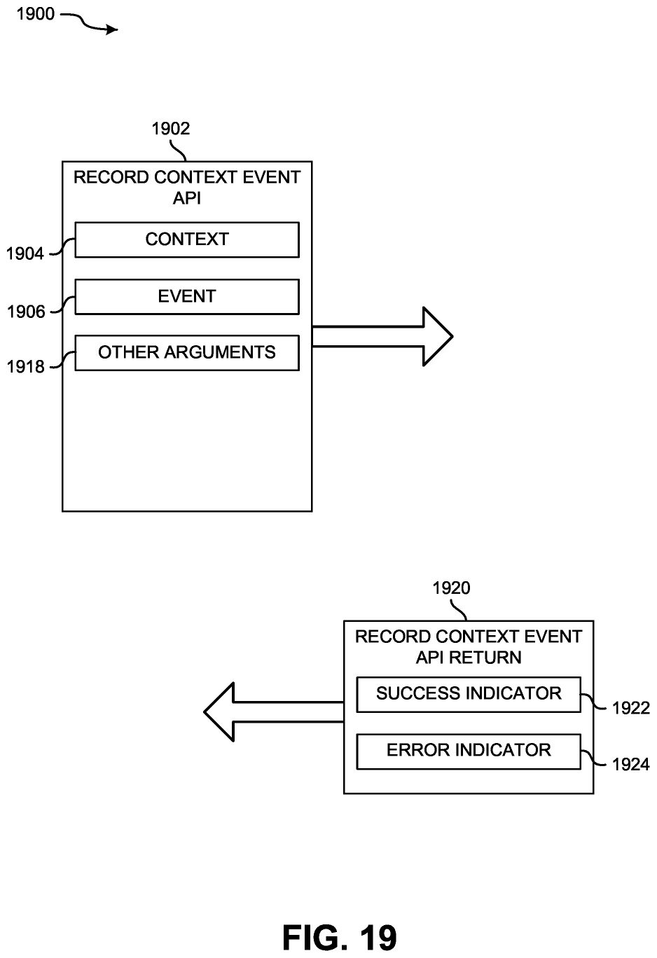

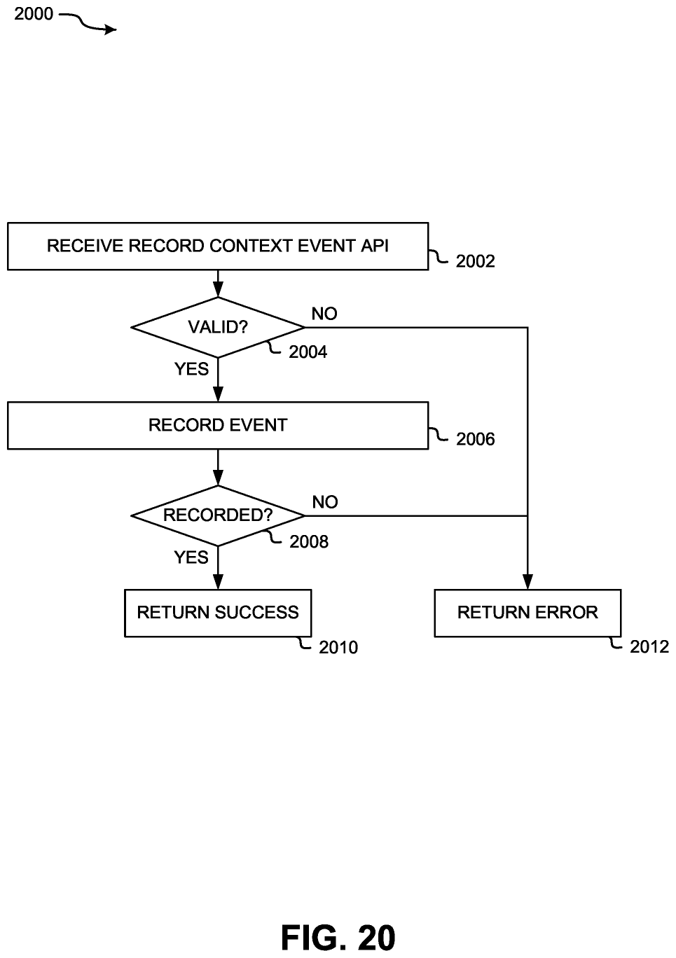

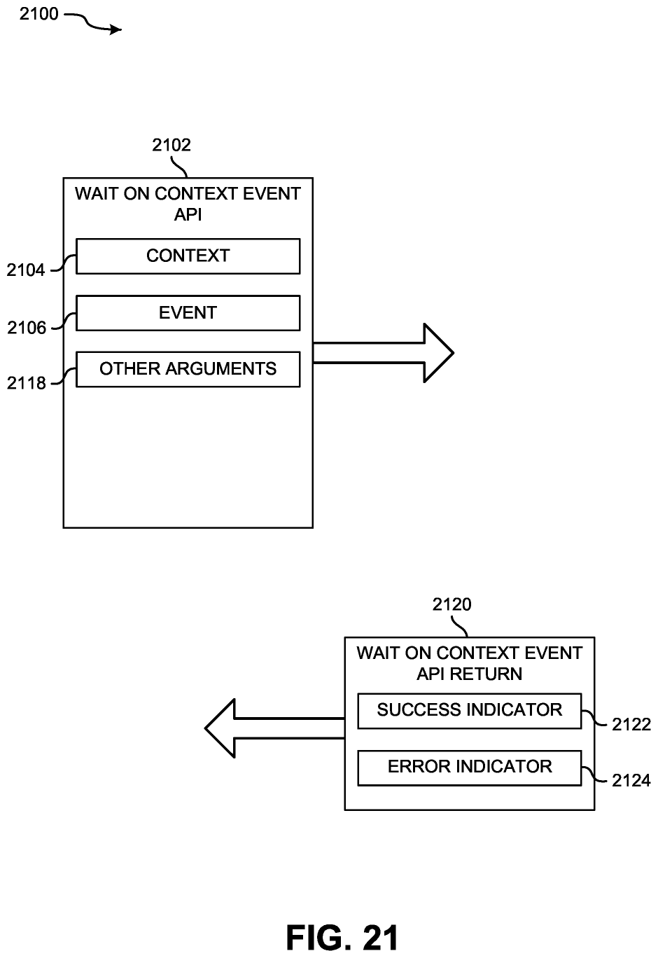

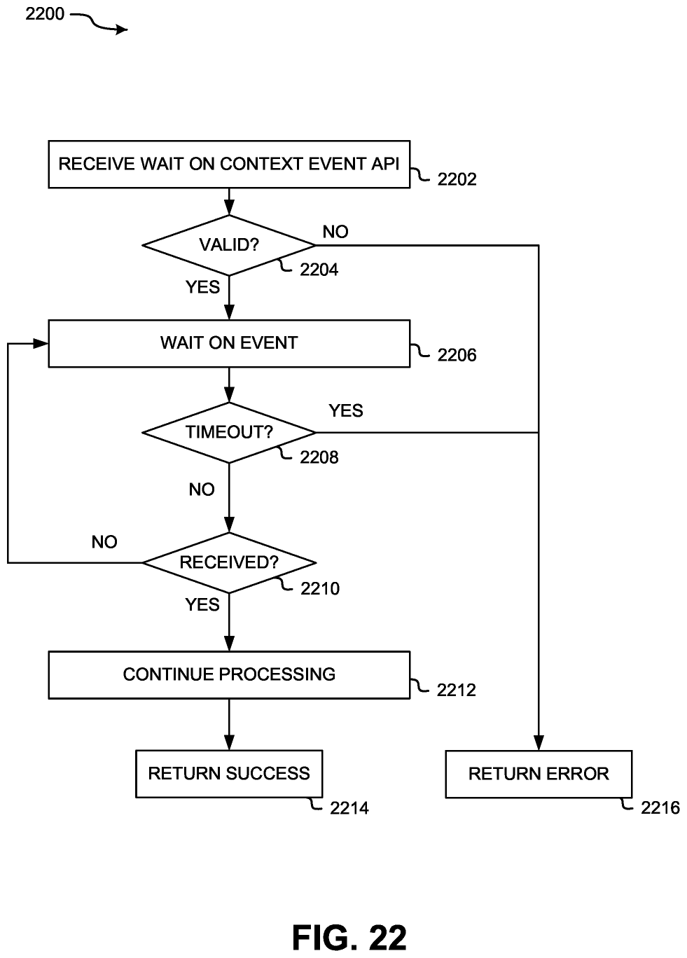

In at least one embodiment, resource operations APIs 108 comprise one or more APIs to manage resources of processors such as processor 110, usable to perform software programs 104. In at least one embodiment, resource operations APIs 108 comprise one or more APIs such as create sub-context API 502 (described herein at least in connection with FIGS. 5 and 6), destroy sub-context API 702 (described herein at least in connection with FIGS. 7 and 8), get sub-context from stream API 902 (described herein at least in connection with FIGS. 9 and 10), get context resource API 1102 (described herein at least in connection with FIGS. 11 and 12), subdivide context resources API 1302 (described herein at least in connection with FIGS. 13 and 14), generate resource descriptor API 1502 (described herein at least in connection with FIGS. 15 and 16), get device resources API 1702 (described herein at least in connection with FIGS. 17 and 18), record context event API 1902 (described herein at least in connection with FIGS. 19 and 20), wait on context event API 2102 (described herein at least in connection with FIGS. 21 and 22), and/or other such resource operations APIs.

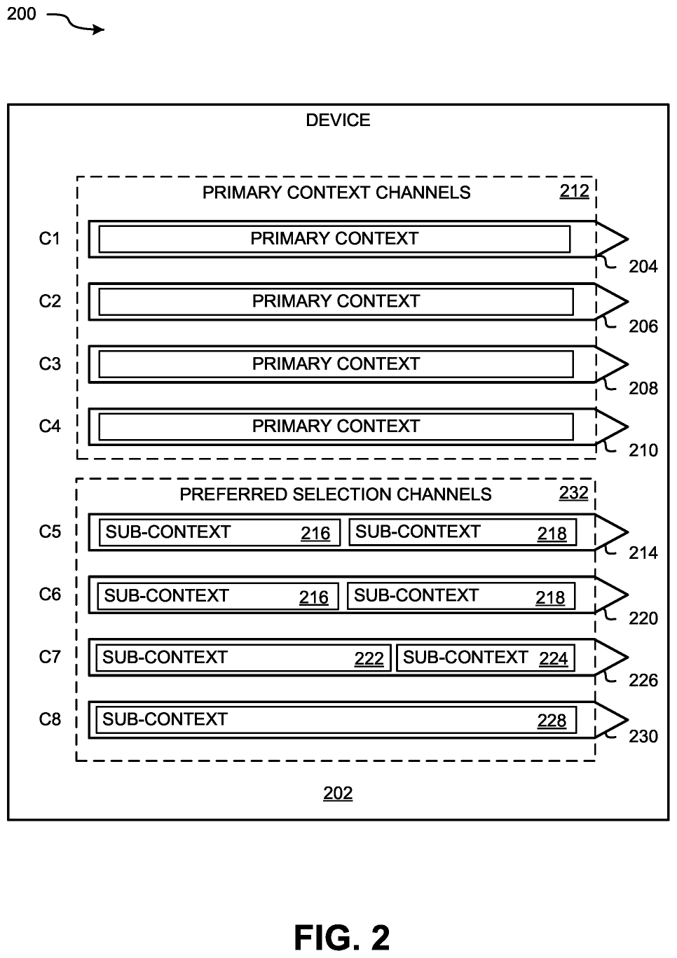

In at least one embodiment, processor 110 receives resource operations APIs 108 and performs one or more operations to create one or more contexts 112 comprising processor resources 114. In at least one embodiment, a context 112 includes a description of resources available to a processor such as processor 110, as described below at least in connection with FIG. 2. In at least one embodiment, processor resources 114 comprise resources available to processor 110 to perform one or more workloads (described below). In at least one embodiment, a context 112 is a primary context of processor 110, which is a previous created and/or default context of processor 110.

In at least one embodiment, processor 110 receives resource operations APIs 108 and performs one or more operations to create one or more sub-contexts (e.g., sub-context 118A-118N) usable to perform one or more workloads (e.g., workload 120A-120N). In at least one embodiment, processor 110 receives resource operations APIs 108 and performs one or more operations to create one or more sub-contexts based on one or more sub-sets of processor resources 114 (e.g., sub-set 116A-116N). In at least one embodiment, sub-contexts (e.g., sub-context 118A-118N) are used to perform workloads (e.g., workload 120A-120N). In at least one embodiment, a sub-context is derived from context 112 that uses a sub-set of resources available to processor 110 (e.g., as described herein at least in connection with FIG. 2). In at least one embodiment, a sub-context is referred to as a green context. In at least one embodiment, a sub-set of processor resources 114 (e.g., sub-set 116A-116N) comprises some or all of processor resources 114 (e.g., a first sub-set of processor resources 114 may contain a first portion of said processor resources, a second sub-set of processor resources 114 may contain a second portion of said processor resources, etc.). In at least one embodiment, a sub-set of processor resources is not empty (e.g., comprises at least a portion of processor resources 114). In at least one embodiment, a workload (e.g., workload 120A-120N) comprises at least a portion of computing operations of software programs 104 to be performed by one or more processors such as processor 110, using systems, methods, and operations such as those described herein. In at least one embodiment, a workload (e.g., workload 120A-120N) is also referred to as a software workload. In at least one embodiment, a workload (e.g., workload 120A-120N) is also referred to as a kernel. In at least one embodiment, a workload (e.g., workload 120A-120N) is also referred to as a software kernel.

In at least one embodiment, not shown in FIG. 1, processor 110 receives resource operations APIs 108 and performs one or more operations to create a sub-context using sub-context API 502, described herein at least in connection with FIGS. 5 and 6. In at least one embodiment, not shown in FIG. 1, processor 110 receives resource operations APIs 108 and performs one or more operations to destroy a sub-context using destroy sub-context API 702, described herein at least in connection with FIGS. 7 and 8. In at least one embodiment, not shown in FIG. 1, processor 110 receives resource operations APIs 108 and performs one or more operations to obtain a sub-context from a stream using get sub-context from stream API 902, described herein at least in connection with FIGS. 9 and 10. In at least one embodiment, not shown in FIG. 1, processor 110 receives resource operations APIs 108 and performs one or more operations to get resources associated with a context using get context resource API 1102, described herein at least in connection with FIGS. 11 and 12. In at least one embodiment, not shown in FIG. 1, processor 110 receives resource operations APIs 108 and performs one or more operations to subdivide context resources using subdivide context resources API 1302, described herein at least in connection with FIGS. 13 and 14. In at least one embodiment, not shown in FIG. 1, processor 110 receives resource operations APIs 108 and performs one or more operations to generate a resource descriptor using generate resource descriptor API 1502, described herein at least in connection with FIGS. 15 and 16. In at least one embodiment, not shown in FIG. 1, processor 110 receives resource operations APIs 108 and performs one or more operations to get resources of a device using get device resources API 1702 (described herein at least in connection with FIGS. 17 and 18. In at least one embodiment, not shown in FIG. 1, processor 110 receives resource operations APIs 108 and performs one or more operations to record a context event using record context event API 1902, described herein at least in connection with FIGS. 19 and 20. In at least one embodiment, not shown in FIG. 1, processor 110 receives resource operations APIs 108 and performs one or more operations to wait on a context event using wait on context event API 2102, described herein at least in connection with FIGS. 21 and 22.

In at least one embodiment, a plurality of sub-sets of processor resources 114 (e.g., a plurality of sub-sets of sub-set 116A-116N) are used by and/or associated with one sub-context (e.g., one of sub-context 118A-118N). In at least one embodiment, one sub-set of processor resources 114 (e.g., one of sub-set 116A-116N) is used by and/or associated with one sub-context (e.g., one of sub-context 118A-118N). In at least one embodiment, one sub-set of processor resources 114 (e.g., one of sub-set 116A-116N) is used by and/or associated with a plurality of sub-contexts (e.g., a plurality of sub-contexts of sub-context 118A-118N). In at least one embodiment, a number of sub-sets of processor resources 114 (e.g., sub-set 116A-116N) differs from a number of sub-contexts (e.g., sub-context 118A-118N). In at least one embodiment, a number of sub-sets of processor resources 114 (e.g., sub-set 116A-116N) is identical to a number of sub-contexts (e.g., sub-context 118A-118N).

In at least one embodiment, a plurality of sub-contexts (e.g., a plurality of sub-contexts of sub-context 118A-118N) are used by and/or associated with one sub-context (e.g., one of sub-context 118A-118N). In at least one embodiment, one sub-set of processor resources 114 (e.g., one of sub-set 116A-116N) is used by and/or associated with one sub-context (e.g., one of sub-context 118A-118N). In at least one embodiment, one sub-set of processor resources 114 (e.g., one of sub-set 116A-116N) is used by and/or associated with a plurality of sub-contexts (e.g., a plurality of sub-contexts of sub-context 118A-118N). In at least one embodiment, a number of sub-sets of processor resources 114 (e.g., sub-set 116A-116N) differs from a number of sub-contexts (e.g., sub-context 118A-118N). In at least one embodiment, a number of sub-sets of processor resources 114 (e.g., sub-set 116A-116N) is identical to a number of sub-contexts (e.g., sub-context 118A-118N).

In at least one embodiment, as used in any implementation described herein, unless otherwise clear from context or stated explicitly to contrary, terms such as “module” and nominalized verbs (e.g., sub-context, workload, context, and/or other terms) each refer to any combination of software logic, firmware logic, hardware logic, and/or circuitry configured to provide functionality described herein. In at least one embodiment, software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. In at least one embodiment, modules may, collectively or individually, be embodied as circuitry that forms part of a larger system, for example, an integrated circuit (IC), system on-chip (SoC), and so forth.

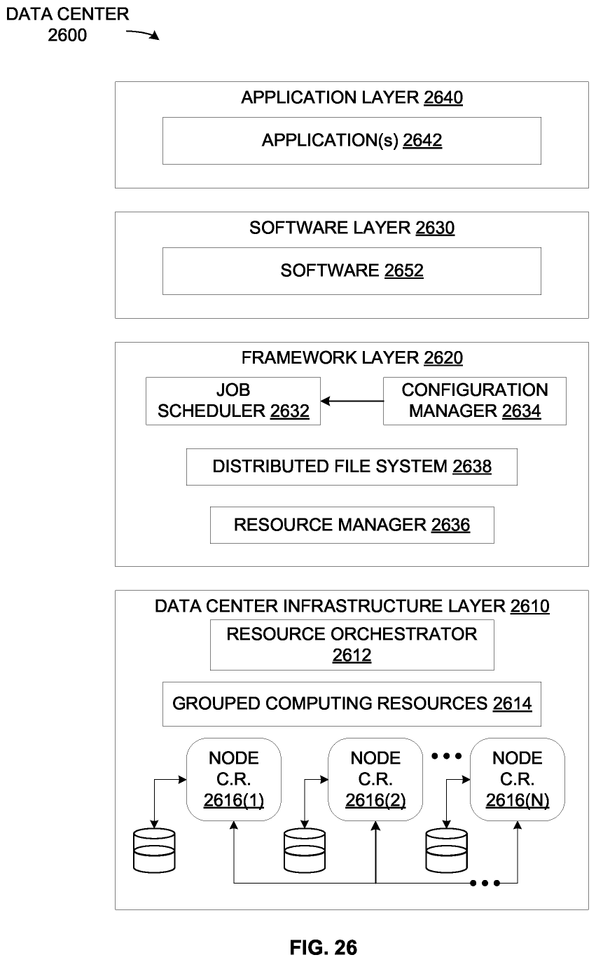

In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to allocate one or more data structures to indicate which of one or more streaming multiprocessors (SMs) of one or more processors are to be used to perform one or more software threads and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to generate one or more masks to indicate one or more subsets of streaming multiprocessors of one or more graphics processing units (GPUs) usable to perform one or more kernels and/or otherwise perform operations described herein. In at least one embodiment, operations and/or instructions described herein in connection with FIG. 1 are included in and/or otherwise include systems, methods, operations, and/or instructions described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, components described herein in connection with FIG. 1 perform one or more processes described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, not shown in FIG. 1, one or more components described herein in connection with FIG. 1 include one or more components described herein in connection with FIGS. 26-58 to perform an application programming interface (API) to allocate one or more data structures to indicate which of one or more streaming multiprocessors (SMs) of one or more processors are to be used to perform one or more software threads and/or otherwise perform operations described herein.

In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to allocate one or more data structures to indicate which of one or more streaming multiprocessors (SMs) of one or more processors are to be used to perform one or more software threads and/or otherwise perform operations described herein. In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to generate one or more masks to indicate one or more subsets of streaming multiprocessors of one or more graphics processing units (GPUs) usable to perform one or more kernels and/or otherwise perform operations described herein.

In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to deallocate one or more data structures to indicate which of one or more streaming multiprocessors (SMs) of one or more processors are to be used to perform one or more software threads and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to cause one or more masks to be deactivated, wherein the one or more masks indicate one or more subsets of streaming multiprocessors of one or more graphics processing units (GPUs) usable to perform one or more kernels and/or otherwise perform operations described herein. In at least one embodiment, operations and/or instructions described herein in connection with FIG. 1 are included in and/or otherwise include systems, methods, operations, and/or instructions described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, components described herein in connection with FIG. 1 perform one or more processes described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, not shown in FIG. 1, one or more components described herein in connection with FIG. 1 include one or more components described herein in connection with FIGS. 26-58 to perform an application programming interface (API) to deallocate one or more data structures to indicate which of one or more streaming multiprocessors (SMs) of one or more processors are to be used to perform one or more software threads and/or otherwise perform operations described herein.

In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to deallocate one or more data structures to indicate which of one or more streaming multiprocessors (SMs) of one or more processors are to be used to perform one or more software threads and/or otherwise perform operations described herein. In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to cause one or more masks to be deactivated, wherein the one or more masks indicate one or more subsets of streaming multiprocessors of one or more graphics processing units (GPUs) usable to perform one or more kernels and/or otherwise perform operations described herein.

In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to cause one or more identifiers of one or more data structures indicating a number of one or more streaming multiprocessors (SMs) of one or more processors to be stored and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to indicate one or more identifiers of one or more masks, wherein the one or more masks indicate one or more subsets of streaming multiprocessors of one or more graphics processing units (GPUs) usable to perform one or more kernels and/or otherwise perform operations described herein. In at least one embodiment, operations and/or instructions described herein in connection with FIG. 1 are included in and/or otherwise include systems, methods, operations, and/or instructions described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, components described herein in connection with FIG. 1 perform one or more processes described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, not shown in FIG. 1, one or more components described herein in connection with FIG. 1 include one or more components described herein in connection with FIGS. 26-58 to perform an application programming interface (API) to cause one or more identifiers of one or more data structures indicating a number of one or more streaming multiprocessors (SMs) of one or more processors to be stored and/or otherwise perform operations described herein.

In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to cause one or more identifiers of one or more data structures indicating a number of one or more streaming multiprocessors (SMs) of one or more processors to be stored and/or otherwise perform operations described herein. In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to indicate one or more identifiers of one or more masks, wherein the one or more masks indicate one or more subsets of streaming multiprocessors of one or more graphics processing units (GPUs) usable to perform one or more kernels and/or otherwise perform operations described herein.

In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to indicate one or more streaming multiprocessors (SMs) of one or more processors available to be used to perform one or more software threads and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to indicate one or more streaming multiprocessors (SMs) of one or more graphics processing units (GPUs) available to be used to perform one or more software kernels and/or otherwise perform operations described herein. In at least one embodiment, operations and/or instructions described herein in connection with FIG. 1 are included in and/or otherwise include systems, methods, operations, and/or instructions described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, components described herein in connection with FIG. 1 perform one or more processes described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, not shown in FIG. 1, one or more components described herein in connection with FIG. 1 include one or more components described herein in connection with FIGS. 26-58 to perform an application programming interface (API) to indicate one or more streaming multiprocessors (SMs) of one or more processors available to be used to perform one or more software threads and/or otherwise perform operations described herein.

In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to indicate one or more streaming multiprocessors (SMs) of one or more processors available to be used to perform one or more software threads and/or otherwise perform operations described herein. In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to indicate one or more streaming multiprocessors (SMs) of one or more graphics processing units (GPUs) available to be used to perform one or more software kernels and/or otherwise perform operations described herein.

In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to generate an indication of one or more subsets of streaming multiprocessors (SMs) of a processor to be available to be used to perform one or more software kernels and/or otherwise perform operations described herein. In at least one embodiment, operations and/or instructions described herein in connection with FIG. 1 are included in and/or otherwise include systems, methods, operations, and/or instructions described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, components described herein in connection with FIG. 1 perform one or more processes described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, not shown in FIG. 1, one or more components described herein in connection with FIG. 1 include one or more components described herein in connection with FIGS. 26-58 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein.

In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to generate an indication of one or more subsets of streaming multiprocessors (SMs) of a processor to be available to be used to perform one or more software kernels and/or otherwise perform operations described herein.

In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to indicate one or more groups of streaming multiprocessors (SMs) of one or more processors, on which to schedule one or more corresponding groups of software threads and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to generate a data structure comprising information to indicate one or more streaming multiprocessors (SMs) of one or more GPUs to be usable to perform one or more software kernels and/or otherwise perform operations described herein. In at least one embodiment, operations and/or instructions described herein in connection with FIG. 1 are included in and/or otherwise include systems, methods, operations, and/or instructions described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, components described herein in connection with FIG. 1 perform one or more processes described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, not shown in FIG. 1, one or more components described herein in connection with FIG. 1 include one or more components described herein in connection with FIGS. 26-58 to perform an application programming interface (API) to indicate one or more groups of streaming multiprocessors (SMs) of one or more processors, on which to schedule one or more corresponding groups of software threads and/or otherwise perform operations described herein.

In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to indicate one or more groups of streaming multiprocessors (SMs) of one or more processors, on which to schedule one or more corresponding groups of software threads and/or otherwise perform operations described herein. In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to generate a data structure comprising information to indicate one or more streaming multiprocessors (SMs) of one or more GPUs to be usable to perform one or more software kernels and/or otherwise perform operations described herein.

In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to cause a number of streaming multiprocessors indicated by one or more masks to be usable to perform one or more software kernels to be indicated and/or otherwise perform operations described herein. In at least one embodiment, operations and/or instructions described herein in connection with FIG. 1 are included in and/or otherwise include systems, methods, operations, and/or instructions described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, components described herein in connection with FIG. 1 perform one or more processes described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, not shown in FIG. 1, one or more components described herein in connection with FIG. 1 include one or more components described herein in connection with FIGS. 26-58 to perform an application programming interface (API) to cause one or more indicators of one or more numbers of one or more streaming multiprocessors (SMs) of one or more processors to be read from one or more data structures storing the one or more indicators and/or otherwise perform operations described herein.

In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to cause a number of streaming multiprocessors indicated by one or more masks to be usable to perform one or more software kernels to be indicated and/or otherwise perform operations described herein.

In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to cause context of one or more first software instructions to be communicated to one or more second software instructions and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to cause one or more indications of one or more events of one or more resources of a first context of the processor to be indicated to one or more resources of a second context of the processor and/or otherwise perform operations described herein. In at least one embodiment, operations and/or instructions described herein in connection with FIG. 1 are included in and/or otherwise include systems, methods, operations, and/or instructions described herein in connection with FIGS. 1-25 to perform an application programming interface (API) to cause context of one or more first software instructions to be communicated to one or more second software instructions and/or otherwise perform operations described herein. In at least one embodiment, components described herein in connection with FIG. 1 perform one or more processes described herein in connection with FIGS. 1-25 to perform an application programming interface (API) to cause context of one or more first software instructions to be communicated to one or more second software instructions and/or otherwise perform operations described herein. In at least one embodiment, not shown in FIG. 1, one or more components described herein in connection with FIG. 1 include one or more components described herein in connection with FIGS. 26-58 to perform an application programming interface (API) to cause context of one or more first software instructions to be communicated to one or more second software instructions and/or otherwise perform operations described herein.

In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to cause context of one or more first software instructions to be communicated to one or more second software instructions and/or otherwise perform operations described herein. In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to cause one or more indications of one or more events of one or more resources of a first context of the processor to be indicated to one or more resources of a second context of the processor and/or otherwise perform operations described herein.

In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to cause one or more second instructions to wait to be performed until the one or more second instructions receives context corresponding to one or more first software instructions and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIG. 1, such as one or more circuits to perform an application programming interface (API) to prevent one or more instructions from being performed by one or more resources of a first context of the processor until one or more indications of one or more events of a second context are generated and/or otherwise perform operations described herein. In at least one embodiment, operations and/or instructions described herein in connection with FIG. 1 are included in and/or otherwise include systems, methods, operations, and/or instructions described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, components described herein in connection with FIG. 1 perform one or more processes described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, not shown in FIG. 1, one or more components described herein in connection with FIG. 1 include one or more components described herein in connection with FIGS. 26-58 to perform an application programming interface (API) to cause one or more second instructions to wait to be performed until the one or more second instructions receives context corresponding to one or more first software instructions and/or otherwise perform operations described herein.

In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to cause one or more second instructions to wait to be performed until the one or more second instructions receives context corresponding to one or more first software instructions and/or otherwise perform operations described herein. In at least one embodiment, not illustrated in FIG. 1, a non-transitory machine-readable medium has stored thereon a set of instructions which, if performed by one or more processors, are to perform operations described herein at least in connection with FIGS. 1-25, such as operations to perform an application programming interface (API) to prevent one or more instructions from being performed by one or more resources of a first context of the processor until one or more indications of one or more events of a second context are generated and/or otherwise perform operations described herein.

FIG. 2 is a block diagram 200 illustrating contexts and sub-contexts, in accordance with at least one embodiment. In at least one embodiment, a device 202 is used to perform one or more workloads (e.g., one or more of workload 120A-120N, described herein at least in connection with FIG. 1). In at least one embodiment, device 202 comprises one or more processors such as processor 110, described herein at least in connection with FIG. 1. In at least one embodiment, device 202 includes one or more channels that are used to perform streams of workloads (e.g., a first workload followed by a second workload, etc.). In at least one embodiment, not shown in FIG. 2, device 202 has one hardware context (e.g., one set of hardware resources). In at least one embodiment, device 202 has a plurality of hardware contexts. In at least one embodiment, performance of device 202 is improved when device 202 has only one hardware context. In at least one embodiment, a hardware context of device 202 has one or more primary contexts associated with said hardware context. In at least one embodiment, a primary context comprises a description of and/or references to resources of device 202 (e.g., of said hardware context). In at least one embodiment, a primary context is a one-to-one mapping with a hardware context of device 202 (e.g., includes only references to hardware resources of device 202).

In at least one embodiment, one or more channels of device 202 are primary context channels 212 (e.g., C1 204, C2 206, C3 208, and C4 210 that are used by a primary context to perform software workloads using device 202. In at least one embodiment, primary context channels 212 are exclusively used by a primary context to perform software workloads. In at least one embodiment, one or more channels of device 202 are preferred selection channels 232 (e.g., C5 214, C6 220, C7 226, and C8 230). In at least one embodiment, preferred selection channels 232 are used by sub-contexts to perform software workloads. In at least one embodiment, sub-contexts are dynamically assigned to one or more preferred selection channels 232. In at least one embodiment, a sub-context (also referred to as a green context) is a subset of a context (e.g., a sub-set of resources of device 202) that does not require any context switching (e.g., switching of a hardware context). In at least one embodiment, a sub-context is a one-to-one mapping of a sub-set of resources of a hardware context. In at least one embodiment, software programs such as software programs 104, described herein at least in connection with FIG. 1 performs computing operations to switch between sub-contexts when performing workloads such as workload 120A-120N using device 202. In at least one embodiment, one or more sub-contexts are managed by a single thread executing on device 202. In at least one embodiment, only one sub-context managed by a thread can be current at a time. In at least one embodiment, a thread performs operations to switch between said sub-contexts managed by said thread to keep one sub-context current at a time.

In at least one embodiment, a sub-context is assigned to a plurality of channels of preferred selection channels 232 (e.g., sub-context 216 assigned to both C5 214 and C6 220 and sub-context 218 also assigned to both C5 214 and C6 220). In at least one embodiment, a sub-context is assigned to a single channel (e.g., sub-context 222 assigned to C7 226 and sub-context 224 also assigned to C7 226). In at least one embodiment, a sub-context is exclusively assigned to a channel (e.g., sub-context 228 assigned to C8 230).

In at least one embodiment, a primary context is referred to as a full context. In at least one embodiment, a full context has access to all of the execution resources of device 202. In at least one embodiment, a primary context is a default context that a CUDA runtime uses to manage resources of device 202. In at least one embodiment, a primary context is thread-safe. In at least one embodiment, a sub-context is mapped onto a primary context and can use a sub-set of resources of device 202. In at least one embodiment, a sub-context can also use other resources (e.g., resources from other devices and/or contexts).

In at least one embodiment, a sub-context comprises a resource group to manage a set of resources used by said sub-context. In at least one embodiment, a sub-context can implicitly set a set of resources a software library or software framework (e.g., as described herein) can use. In at least one embodiment, a resource group represents one or more resources that a particular context, sub-context or API can use. In at least one embodiment, a resource group is a descriptor (e.g., a description of resources) that can be partitioned by one or more APIs such as those described herein to manage resources (e.g., in a hierarchical manner). In at least one embodiment, a resource group includes descriptions or listings of a plurality of different resources of device 202 including, but not limited to, streaming multiprocessors (SMs), device connections (e.g., copy and compute hardware channels), processor bindings, software schedulers, work distribution, etc.). In at least one embodiment, other APIs (e.g., CUDA APIs) can be assigned to a sub-context (e.g., a current sub-context) and use resources of said sub-context. In at least one embodiment, other APIs (e.g., CUDA APIs) can be assigned to a resource group directly (e.g., without using a sub-context).

In at least one embodiment, one or more processors (e.g., such as those described herein) comprise one or more circuits to perform operations and/or instructions described herein in connection with FIG. 2, such as one or more circuits to perform an application programming interface (API) to allocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 2 are included in and/or otherwise include systems, methods, operations, and/or instructions described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, components described herein in connection with FIG. 2 perform one or more processes described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, not shown in FIG. 2, one or more components described herein in connection with FIG. 2 include one or more components described herein in connection with FIGS. 26-58 to perform an application programming interface (API) to allocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 2, such as one or more circuits to perform an application programming interface (API) to deallocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 2 are included in and/or otherwise include systems, methods, operations, and/or instructions described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, components described herein in connection with FIG. 2 perform one or more processes described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, not shown in FIG. 2, one or more components described herein in connection with FIG. 2 include one or more components described herein in connection with FIGS. 26-58 to perform an application programming interface (API) to deallocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 2, such as one or more circuits to perform an application programming interface (API) to cause one or more identifiers of one or more data structures indicating a number of one or more streaming multiprocessors (SMs) of one or more processors to be stored and/or otherwise perform operations described herein. In at least one embodiment, operations and/or instructions described herein in connection with FIG. 2 are included in and/or otherwise include systems, methods, operations, and/or instructions described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, components described herein in connection with FIG. 2 perform one or more processes described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, not shown in FIG. 2, one or more components described herein in connection with FIG. 2 include one or more components described herein in connection with FIGS. 26-58 to perform an application programming interface (API) to cause one or more identifiers of one or more data structures indicating a number of one or more streaming multiprocessors (SMs) of one or more processors to be stored and/or otherwise perform operations described herein.

In at least one embodiment, one or more processors (e.g., such as those described herein) comprise one or more circuits to perform operations and/or instructions described herein in connection with FIG. 2, such as one or more circuits to perform an application programming interface (API) to indicate one or more streaming multiprocessors (SMs) of one or more processors available to be used to perform one or more software threads and/or otherwise perform operations described herein. In at least one embodiment, operations and/or instructions described herein in connection with FIG. 2 are included in and/or otherwise include systems, methods, operations, and/or instructions described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, components described herein in connection with FIG. 2 perform one or more processes described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, not shown in FIG. 2, one or more components described herein in connection with FIG. 2 include one or more components described herein in connection with FIGS. 26-58 to perform an application programming interface (API) to indicate one or more streaming multiprocessors (SMs) of one or more processors available to be used to perform one or more software threads and/or otherwise perform operations described herein.

In at least one embodiment, one or more processors (e.g., such as those described herein) comprise one or more circuits to perform operations and/or instructions described herein in connection with FIG. 2, such as one or more circuits to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, operations and/or instructions described herein in connection with FIG. 2 are included in and/or otherwise include systems, methods, operations, and/or instructions described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, components described herein in connection with FIG. 2 perform one or more processes described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, not shown in FIG. 2, one or more components described herein in connection with FIG. 2 include one or more components described herein in connection with FIGS. 26-58 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein.

In at least one embodiment, one or more processors (e.g., such as those described herein) comprise one or more circuits to perform operations and/or instructions described herein in connection with FIG. 2, such as one or more circuits to perform an application programming interface (API) to indicate one or more groups of streaming multiprocessors (SMs) of one or more processors, on which to schedule one or more corresponding groups of software threads and/or otherwise perform operations described herein. In at least one embodiment, operations and/or instructions described herein in connection with FIG. 2 are included in and/or otherwise include systems, methods, operations, and/or instructions described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, components described herein in connection with FIG. 2 perform one or more processes described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, not shown in FIG. 2, one or more components described herein in connection with FIG. 2 include one or more components described herein in connection with FIGS. 26-58 to perform an application programming interface (API) to indicate one or more groups of streaming multiprocessors (SMs) of one or more processors, on which to schedule one or more corresponding groups of software threads and/or otherwise perform operations described herein.

In at least one embodiment, one or more processors (e.g., such as those described herein) comprise one or more circuits to perform operations and/or instructions described herein in connection with FIG. 2, such as one or more circuits to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, operations and/or instructions described herein in connection with FIG. 2 are included in and/or otherwise include systems, methods, operations, and/or instructions described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, components described herein in connection with FIG. 2 perform one or more processes described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, not shown in FIG. 2, one or more components described herein in connection with FIG. 2 include one or more components described herein in connection with FIGS. 26-58 to perform an application programming interface (API) to cause one or more indicators of one or more numbers of one or more streaming multiprocessors (SMs) of one or more processors to be read from one or more data structures storing the one or more indicators and/or otherwise perform operations described herein.

In at least one embodiment, one or more processors (e.g., such as those described herein) comprise one or more circuits to perform operations and/or instructions described herein in connection with FIG. 2, such as one or more circuits to perform an application programming interface (API) to cause context of one or more first software instructions to be communicated to one or more second software instructions and/or otherwise perform operations described herein. In at least one embodiment, operations and/or instructions described herein in connection with FIG. 2 are included in and/or otherwise include systems, methods, operations, and/or instructions described herein in connection with FIGS. 1-25 to perform an application programming interface (API) to cause context of one or more first software instructions to be communicated to one or more second software instructions and/or otherwise perform operations described herein. In at least one embodiment, components described herein in connection with FIG. 2 perform one or more processes described herein in connection with FIGS. 1-25 to perform an application programming interface (API) to cause context of one or more first software instructions to be communicated to one or more second software instructions and/or otherwise perform operations described herein. In at least one embodiment, not shown in FIG. 2, one or more components described herein in connection with FIG. 2 include one or more components described herein in connection with FIGS. 26-58 to perform an application programming interface (API) to cause context of one or more first software instructions to be communicated to one or more second software instructions and/or otherwise perform operations described herein.

In at least one embodiment, one or more processors (e.g., such as those described herein) comprise one or more circuits to perform operations and/or instructions described herein in connection with FIG. 2, such as one or more circuits to perform an application programming interface (API) to cause one or more second instructions to wait to be performed until the one or more second instructions receives context corresponding to one or more first software instructions and/or otherwise perform operations described herein. In at least one embodiment, operations and/or instructions described herein in connection with FIG. 2 are included in and/or otherwise include systems, methods, operations, and/or instructions described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, components described herein in connection with FIG. 2 perform one or more processes described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, not shown in FIG. 2, one or more components described herein in connection with FIG. 2 include one or more components described herein in connection with FIGS. 26-58 to perform an application programming interface (API) to cause one or more second instructions to wait to be performed until the one or more second instructions receives context corresponding to one or more first software instructions and/or otherwise perform operations described herein.

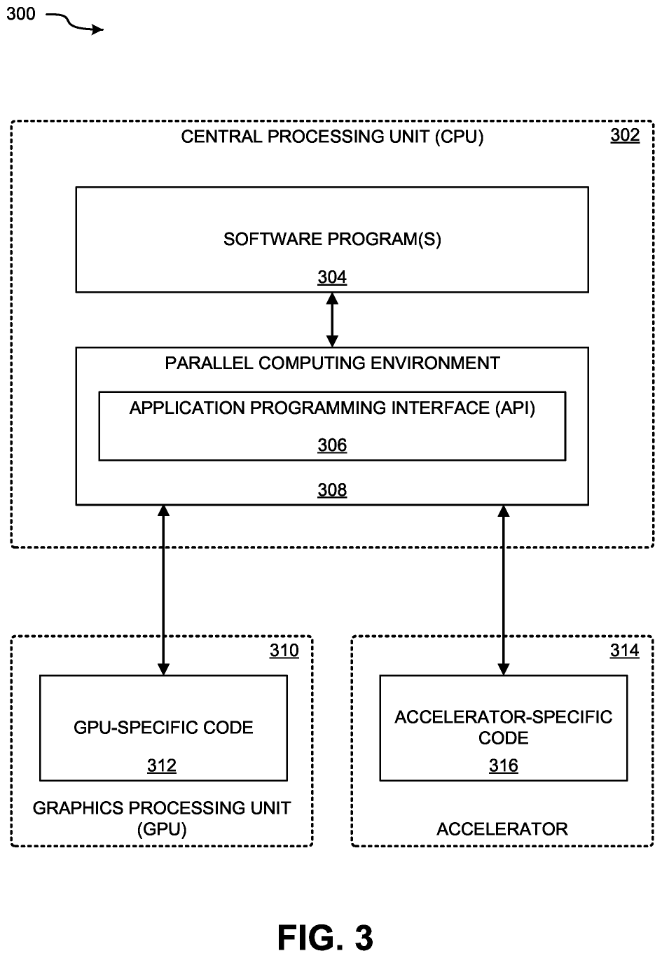

FIG. 3 is a block diagram 300 illustrating a software program to be performed by one or more processors, in accordance with at least one embodiment. In at least one embodiment, block diagram 300 illustrates a software program 304 to be performed by a processor, such as a central processing unit (CPU) 302 as well as a graphics processing unit (GPU) 310 and an accelerator 314 within a heterogeneous processor. In at least one embodiment, CPU 302 is a processor such as processor 102, described herein at least in connection with FIG. 1. In at least one embodiment, CPU 302 is a processor such as processor 110, described herein at least in connection with FIG. 1. In at least one embodiment, a CPU 302 is any processor with any architecture further described herein. In at least one embodiment, a CPU 302 is any general processor with any architecture further described herein. In at least one embodiment, a processor, such as a CPU 302, comprises circuits to perform one or more computing operations. In at least one embodiment, a processor, such as a CPU 302, comprises any configuration of circuits to perform one or more computing operations further described herein.

In at least one embodiment, a processor, such as a central processing unit (CPU) 302, performs a parallel computing environment 308. In at least one embodiment, a processor, such as a CPU 302, is In at least one embodiment, a processor, such as a CPU, performs a parallel computing environment 308, such as compute uniform device architecture (CUDA). In at least one embodiment, parallel computing environment 308 includes instructions that, if performed by one or more processors, such as CPUs 302, facilitate execution of one or more software programs by one or more CPUs 302, one or more parallel processing units (PPUs), such as GPUs 310, and/or one or more accelerators 314 within a heterogeneous processor.

In at least one embodiment, one or more PPUs are processors comprising one or more circuits to perform parallel computational operations, such as GPUs 310 and any other parallel processor further described herein. In at least one embodiment, a GPU 310 is hardware comprising circuits to perform one or more computational operations, as further described below in conjunction with various embodiments. In at least one embodiment, a GPU 310 comprises one or more processing cores to each perform one or more computational operations. In at least one embodiment, a GPU 310 comprises one or more processing cores to perform one or more parallel computational operations. In at least one embodiment, a GPU 310 is packaged together with a CPU 302 or other processors as a system-on-chip (SoC). In at least one embodiment, a GPU 310 is packaged on a shared die or other substrate with a CPU 302 or other processors as a system-on-chip (SoC). In at least one embodiment, one or more accelerators 314 within heterogeneous processors are hardware comprising one or more circuits to perform specific computational operations, such as a deep learning accelerator (DLA), programmable vision accelerator (PVA), field-programmable gate array (FPGA), or any other accelerator further described herein. In at least one embodiment, an accelerator 314 within a heterogeneous processor is packaged together with a CPU 302 or other processors as a system-on-chip (SoC). In at least one embodiment, an accelerator 314 within a heterogeneous processor is packaged on a shared die or other substrate with a CPU 302 or other processors as a system-on-chip (SoC). In at least one embodiment, one or more CPUs 302, one or more GPUs 310 or other PPUs, and/or accelerators 314 within heterogeneous processors are packaged as a as a system-on-chip (SoC). In at least one embodiment, one or more CPUs 302, one or more GPUs 310 or other PPUs, and/or accelerators 314 within heterogeneous processors are packaged on a shared die or other substrate as a system-on-chip (SoC).

In at least one embodiment, parallel computing environment 308, such as CUDA, comprises libraries and other software programs to perform one or more computing operations using one or more PPUs, such as GPUs 310, and/or one or more accelerators 314 within a heterogeneous processor. In at least one embodiment, parallel computing environment 308 comprises libraries and other software programs that, if performed by one or more processors, such as one or more CPUs 302, cause one or more PPUs, such as GPUs 310, and/or one or more accelerators 314 within a heterogeneous processor, to perform one or more computational operations. In at least one embodiment, parallel computing environment 308 comprises libraries that, if performed, cause one or more PPUs, such as GPUs 310, and/or one or more accelerators 314 within heterogeneous processors, to perform mathematical operations. In at least one embodiment, parallel computing environment 308 comprises libraries that, if performed, cause one or more PPUs, such as GPUs 310, and/or one or more accelerators 314 within heterogeneous processors, to perform any other operation further described herein.

In at least one embodiment, one or more PPUs, such as GPUs 310, and/or one or more accelerators 314 within heterogeneous processors, perform one or more computational operations in response to one or more application programming interfaces (APIs). In at least one embodiment, an API is a set of software instructions that, if performed by one or more processors, such as CPUs 302, cause one or more PPUs, such as GPUs 310 and/or one or more accelerators 314 within heterogeneous processors to perform one or more computational operations. In at least one embodiment, parallel computing environment 308 comprises one or more APIs 306 that, if performed by one or more processors, such as CPUs 302, cause one or more PPUs, such as GPUs 310 and/or one or more accelerators 314 within heterogeneous processors to perform one or more computational operations. In at least one embodiment, one or more APIs 306 comprise one or more functions that, if performed, cause one or more processors, such as CPUs 302, to perform one or more operations, such as computational operations, error reporting, scheduling of other operations to be performed by GPUs 310 and/or accelerators 314 within heterogeneous processors, or any other operation further described herein. In at least one embodiment, one or more APIs 306 comprise one or more functions that, if performed, cause one or more PPUs, such as GPUs 310, to perform one or more operations, such as computational operations, error reporting, or any other operation further described herein. In at least one embodiment, one or more APIs 306 comprise one or more functions, such as those described below in conjunction with FIGS. 5-22, that, if performed, cause one or more accelerators 314 within heterogeneous processors to perform one or more operations, such as computational operations, error reporting, or any other operation further described herein. In at least one embodiment, one or more APIs 306 comprise one or more functions to cause a CPU 302 to perform one or more computational operations in response to information or events generated by one or more PPUs, such as GPUs 310, and/or one or more accelerators 314 within heterogeneous processors. In at least one embodiment, one or more APIs 306 comprise one or more functions that, if invoked, cause a CPU 302 to perform one or more computational operations in response to information or events generated by one or more PPUs, such as GPUs 310, and/or one or more accelerators 314 within heterogeneous processors.

In at least one embodiment, a processor, such as a CPU 302, performs one or more software programs 304. In at least one embodiment, one or more software programs are sets of instructions that, if performed, cause one or more processors, such as CPUs 302, PPUs such as GPUs 310, and/or accelerators 314 in heterogeneous processors, to perform computational operations. In at least one embodiment, software programs 304 comprise instructions and/or operations to be performed by one or more PPUs, such as GPUs 310. In at least one embodiment, one or more software programs 304 comprise GPU-specific code 312 and/or accelerator-specific code 316. In at least one embodiment, instructions and/or operations to be performed by one or more PPUs, such as GPUs 310, are PPU-specific or GPU-specific code 312. In at least one embodiment, GPU-specific code 312 is a set of software instructions and/or other operations, as further described herein, to be performed by one or more GPUs 310. In at least one embodiment, software programs 304 comprise instructions and/or operations to be performed by one or more accelerators 314 in heterogeneous processors. In at least one embodiment, instructions and/or operations to be performed by one or more accelerators 314 in heterogeneous processors are accelerator-specific code 316. In at least one embodiment, accelerator-specific code 316 is a set of software instructions and/or other operations, as further described herein, to be performed by one or more accelerators 314. In at least one embodiment, PPU-specific or GPU-specific code 312 and/or accelerator-specific code 316 is to be performed in response to one or more APIs 306, as described below in conjunction with FIGS. 5-22.

In at least one embodiment, one or more processors (e.g., such as those described herein) comprise one or more circuits to perform operations and/or instructions described herein in connection with FIG. 3, such as one or more circuits to perform an application programming interface (API) to allocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 3 are included in and/or otherwise include systems, methods, operations, and/or instructions described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, components described herein in connection with FIG. 3 perform one or more processes described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, not shown in FIG. 3, one or more components described herein in connection with FIG. 3 include one or more components described herein in connection with FIGS. 26-58 to perform an application programming interface (API) to allocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 3, such as one or more circuits to perform an application programming interface (API) to deallocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 3 are included in and/or otherwise include systems, methods, operations, and/or instructions described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, components described herein in connection with FIG. 3 perform one or more processes described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, not shown in FIG. 3, one or more components described herein in connection with FIG. 3 include one or more components described herein in connection with FIGS. 26-58 to perform an application programming interface (API) to deallocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 3, such as one or more circuits to perform an application programming interface (API) to cause one or more identifiers of one or more data structures indicating a number of one or more streaming multiprocessors (SMs) of one or more processors to be stored and/or otherwise perform operations described herein. In at least one embodiment, operations and/or instructions described herein in connection with FIG. 3 are included in and/or otherwise include systems, methods, operations, and/or instructions described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, components described herein in connection with FIG. 3 perform one or more processes described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, not shown in FIG. 3, one or more components described herein in connection with FIG. 3 include one or more components described herein in connection with FIGS. 26-58 to perform an application programming interface (API) to cause one or more identifiers of one or more data structures indicating a number of one or more streaming multiprocessors (SMs) of one or more processors to be stored and/or otherwise perform operations described herein.

In at least one embodiment, one or more processors (e.g., such as those described herein) comprise one or more circuits to perform operations and/or instructions described herein in connection with FIG. 3, such as one or more circuits to perform an application programming interface (API) to indicate one or more streaming multiprocessors (SMs) of one or more processors available to be used to perform one or more software threads and/or otherwise perform operations described herein. In at least one embodiment, operations and/or instructions described herein in connection with FIG. 3 are included in and/or otherwise include systems, methods, operations, and/or instructions described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, components described herein in connection with FIG. 3 perform one or more processes described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, not shown in FIG. 3, one or more components described herein in connection with FIG. 3 include one or more components described herein in connection with FIGS. 26-58 to perform an application programming interface (API) to indicate one or more streaming multiprocessors (SMs) of one or more processors available to be used to perform one or more software threads and/or otherwise perform operations described herein.

In at least one embodiment, one or more processors (e.g., such as those described herein) comprise one or more circuits to perform operations and/or instructions described herein in connection with FIG. 3, such as one or more circuits to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, operations and/or instructions described herein in connection with FIG. 3 are included in and/or otherwise include systems, methods, operations, and/or instructions described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, components described herein in connection with FIG. 3 perform one or more processes described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, not shown in FIG. 3, one or more components described herein in connection with FIG. 3 include one or more components described herein in connection with FIGS. 26-58 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein.

In at least one embodiment, one or more processors (e.g., such as those described herein) comprise one or more circuits to perform operations and/or instructions described herein in connection with FIG. 3, such as one or more circuits to perform an application programming interface (API) to indicate one or more groups of streaming multiprocessors (SMs) of one or more processors, on which to schedule one or more corresponding groups of software threads and/or otherwise perform operations described herein. In at least one embodiment, operations and/or instructions described herein in connection with FIG. 3 are included in and/or otherwise include systems, methods, operations, and/or instructions described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, components described herein in connection with FIG. 3 perform one or more processes described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, not shown in FIG. 3, one or more components described herein in connection with FIG. 3 include one or more components described herein in connection with FIGS. 26-58 to perform an application programming interface (API) to indicate one or more groups of streaming multiprocessors (SMs) of one or more processors, on which to schedule one or more corresponding groups of software threads and/or otherwise perform operations described herein.

In at least one embodiment, one or more processors (e.g., such as those described herein) comprise one or more circuits to perform operations and/or instructions described herein in connection with FIG. 3, such as one or more circuits to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, operations and/or instructions described herein in connection with FIG. 3 are included in and/or otherwise include systems, methods, operations, and/or instructions described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, components described herein in connection with FIG. 3 perform one or more processes described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, not shown in FIG. 3, one or more components described herein in connection with FIG. 3 include one or more components described herein in connection with FIGS. 26-58 to perform an application programming interface (API) to cause one or more indicators of one or more numbers of one or more streaming multiprocessors (SMs) of one or more processors to be read from one or more data structures storing the one or more indicators and/or otherwise perform operations described herein.

In at least one embodiment, one or more processors (e.g., such as those described herein) comprise one or more circuits to perform operations and/or instructions described herein in connection with FIG. 3, such as one or more circuits to perform an application programming interface (API) to cause context of one or more first software instructions to be communicated to one or more second software instructions and/or otherwise perform operations described herein. In at least one embodiment, operations and/or instructions described herein in connection with FIG. 3 are included in and/or otherwise include systems, methods, operations, and/or instructions described herein in connection with FIGS. 1-25 to perform an application programming interface (API) to cause context of one or more first software instructions to be communicated to one or more second software instructions and/or otherwise perform operations described herein. In at least one embodiment, components described herein in connection with FIG. 3 perform one or more processes described herein in connection with FIGS. 1-25 to perform an application programming interface (API) to cause context of one or more first software instructions to be communicated to one or more second software instructions and/or otherwise perform operations described herein. In at least one embodiment, not shown in FIG. 3, one or more components described herein in connection with FIG. 3 include one or more components described herein in connection with FIGS. 26-58 to perform an application programming interface (API) to cause context of one or more first software instructions to be communicated to one or more second software instructions and/or otherwise perform operations described herein.

In at least one embodiment, one or more processors (e.g., such as those described herein) comprise one or more circuits to perform operations and/or instructions described herein in connection with FIG. 3, such as one or more circuits to perform an application programming interface (API) to cause one or more second instructions to wait to be performed until the one or more second instructions receives context corresponding to one or more first software instructions and/or otherwise perform operations described herein. In at least one embodiment, operations and/or instructions described herein in connection with FIG. 3 are included in and/or otherwise include systems, methods, operations, and/or instructions described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, components described herein in connection with FIG. 3 perform one or more processes described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, not shown in FIG. 3, one or more components described herein in connection with FIG. 3 include one or more components described herein in connection with FIGS. 26-58 to perform an application programming interface (API) to cause one or more second instructions to wait to be performed until the one or more second instructions receives context corresponding to one or more first software instructions and/or otherwise perform operations described herein.

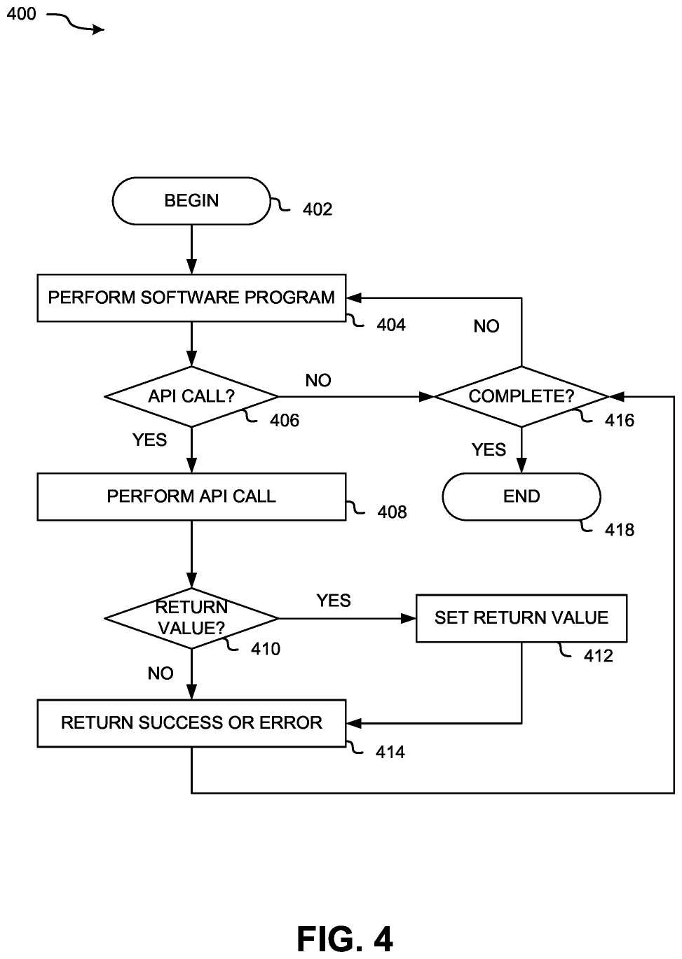

FIG. 4 is a block diagram 400 illustrating a process to perform one or more application programming interfaces (APIs), in accordance with at least one embodiment. In at least one embodiment, said process to perform one or more APIs illustrated in block diagram 4 uses one or more accelerators within a heterogeneous processor by a parallel computing environment, such as parallel computing environment 308, as described herein at least in connection with FIG. 3. In at least one embodiment, said process to perform one or more APIs illustrated in block diagram 400 begins 402 at step 404, whereby one or more processors perform a software program comprising one or more instructions that, if performed, cause said one or more processors and/or one or more other processors, such as graphics processing units (GPUs) and/or one or more accelerators within a heterogeneous processor or heterogeneous processors, to perform one or more computational operations. In at least one embodiment, at step 404, a software program to be performed by one or more processors comprises one or more instructions that, if performed, cause one or more APIs 306 of a parallel computing environment 308 to be performed, as described above. In at least one embodiment, after step 404, said process to perform one or more APIs illustrated in block diagram 400 continues at step 406.

In at least one embodiment, at step 406 of said process to perform one or more APIs illustrated in block diagram 400, a processor performing said process to perform one or more APIs illustrated in block diagram 400 determines whether to perform an API such as those described herein at least in connection with FIGS. 5-22 (e.g., create sub-context API 502, destroy sub-context API 702, get sub-context from stream API 902, get context resource API 1102, subdivide context resources API 1302, generate resource descriptor API 1502, get device resources API 1702, record context event API 1902, and/or wait on context event API 2102). In at least one embodiment, at step 406, if it determined to not perform an API (“NO” branch), said process to perform one or more APIs illustrated in block diagram 400 continues at step 416. In at least one embodiment, at step 406, if it determined to perform an API (“YES” branch), said process to perform one or more APIs illustrated in block diagram 400 continues at step 408.

In at least one embodiment, at step 408 of said process to perform one or more APIs illustrated in block diagram 400, a processor performing said process to perform one or more APIs illustrated in block diagram 400 performs an API such as those described herein at least in connection with FIGS. 5-22. In at least one embodiment, at step 408, one or more processors perform one or more instructions to perform one or more API calls such as those described herein at least in connection with FIGS. 5-22 (e.g., create sub-context API 502, destroy sub-context API 702, get sub-context from stream API 902, get context resource API 1102, subdivide context resources API 1302, generate resource descriptor API 1502, get device resources API 1702, record context event API 1902, and/or wait on context event API 2102) by said one or more processors and/or by one or more other processors, such as GPUs and/or accelerators within a heterogeneous processor, as described above. In at least one embodiment, after step 408, said process to perform one or more APIs illustrated in block diagram 400 continues at step 410.

In at least one embodiment, at step 410 of said process to perform one or more APIs illustrated in block diagram 400, a processor performing said process to perform one or more APIs illustrated in block diagram 400 determines whether to return a return value as a result of performing one or more instructions to perform one or more API calls such as those described herein at least in connection with FIGS. 5-22 (e.g., create sub-context API 502, destroy sub-context API 702, get sub-context from stream API 902, get context resource API 1102, subdivide context resources API 1302, generate resource descriptor API 1502, get device resources API 1702, record context event API 1902, and/or wait on context event API 2102) d by said one or more processors and/or by one or more other processors, such as GPUs and/or accelerators within a heterogeneous processor, as described above. In at least one embodiment, at step 410 a processor performing said process to perform one or more APIs illustrated in block diagram 400 determines whether a return value is to be returned using an API return such as those described herein at least in connection with FIGS. 5-22 (e.g., create sub-context API return 520, destroy sub-context API return 720, get sub-context from stream API return 920, get context resource API return 1120, subdivide context resources API return 1320, generate resource descriptor API return 1520, get device resources API return 1720, record context event API return 1920, and/or wait on context event API return 2120). In at least one embodiment, at step 410, if it is determined to return a return value (“YES” branch), said process to perform one or more APIs illustrated in block diagram 400 continues at step 412. In at least one embodiment, at step 410, if it is determined to not return a return value (“NO” branch), process said process to perform one or more APIs illustrated in block diagram 400 continues at step 414.

In at least one embodiment, at step 412 of said process to perform one or more APIs illustrated in block diagram 400, a processor performing said process to perform one or more APIs illustrated in block diagram 400 sets a return value. In at least one embodiment, at step 412, a return value is set by storing said return value in a memory location specified by an API such as those described herein at least in connection with FIGS. 5-22 (e.g., create sub-context API 502, destroy sub-context API 702, get sub-context from stream API 902, get context resource API 1102, subdivide context resources API 1302, generate resource descriptor API 1502, get device resources API 1702, record context event API 1902, and/or wait on context event API 2102). In at least one embodiment, at step 412, a return value is set by storing said return value in a memory location included in an API return such as those described herein at least in connection with FIGS. 5-22 (e.g., create sub-context API return 520, destroy sub-context API return 720, get sub-context from stream API return 920, get context resource API return 1120, subdivide context resources API return 1320, generate resource descriptor API return 1520, get device resources API return 1720, record context event API return 1920, and/or wait on context event API return 2120). In at least one embodiment, after step 412, said process to perform one or more APIs illustrated in block diagram 400 continues at step 414.

In at least one embodiment, at step 414 of said process to perform one or more APIs illustrated in block diagram 400, a processor performing said process to perform one or more APIs illustrated in block diagram 400 returns success or failure (e.g., an error) using an API return such as those described herein at least in connection with FIGS. 5-22 (e.g., create sub-context API return 520, destroy sub-context API return 720, get sub-context from stream API return 920, get context resource API return 1120, subdivide context resources API return 1320, generate resource descriptor API return 1520, get device resources API return 1720, record context event API return 1920, and/or wait on context event API return 2120). In at least one embodiment, after step 414, said process to perform one or more APIs illustrated in block diagram 400 continues at step 416.

In at least one embodiment, at step 416 of said process to perform one or more APIs illustrated in block diagram 400, a processor performing said process to perform one or more APIs illustrated in block diagram 400 determines whether performance of software program (e.g., started at step 404) is complete. In at least one embodiment, at step 416, a processor performing said process to perform one or more APIs illustrated in block diagram 400 determines that performance of software program (e.g., started at step 404) is complete based, at least in part, on whether one or more processors are executing instructions of software program (e.g., started at step 404). In at least one embodiment, at step 416, if it is determined that performance of software program (e.g., started at step 404) is complete, said process to perform one or more APIs illustrated in block diagram 400 ends 418. In at least one embodiment, at step 416, if it is determined that performance of software program (e.g., started at step 404) is not complete, said process to perform one or more APIs illustrated in block diagram 400 continues at step 404 to continue performing one or more instructions of a software program.

In at least one embodiment, operations of said process to perform one or more APIs illustrated in block diagram 400 are performed in a different order than is illustrated in FIG. 4. In at least one embodiment, operations of said process to perform one or more APIs illustrated in block diagram 400 are performed simultaneously or in parallel. In at least one embodiment, operations of said process to perform one or more APIs illustrated in block diagram 400 that do not depend on each other (e.g., are order independent) are performed simultaneously or in parallel. In at least one embodiment, operations of said process to perform one or more APIs illustrated in block diagram 400 are performed by a plurality of threads executing on a processor such as those described herein.

In at least one embodiment, one or more processors (e.g., such as those described herein) comprise one or more circuits to perform operations and/or instructions described herein in connection with FIG. 4, such as one or more circuits to perform an application programming interface (API) to allocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 4 are included in and/or otherwise include systems, methods, operations, and/or instructions described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, components described herein in connection with FIG. 4 perform one or more processes described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, not shown in FIG. 4, one or more components described herein in connection with FIG. 4 include one or more components described herein in connection with FIGS. 26-58 to perform an application programming interface (API) to allocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 4, such as one or more circuits to perform an application programming interface (API) to deallocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 4 are included in and/or otherwise include systems, methods, operations, and/or instructions described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, components described herein in connection with FIG. 4 perform one or more processes described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, not shown in FIG. 4, one or more components described herein in connection with FIG. 4 include one or more components described herein in connection with FIGS. 26-58 to perform an application programming interface (API) to deallocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 4, such as one or more circuits to perform an application programming interface (API) to cause one or more identifiers of one or more data structures indicating a number of one or more streaming multiprocessors (SMs) of one or more processors to be stored and/or otherwise perform operations described herein. In at least one embodiment, operations and/or instructions described herein in connection with FIG. 4 are included in and/or otherwise include systems, methods, operations, and/or instructions described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, components described herein in connection with FIG. 4 perform one or more processes described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, not shown in FIG. 4, one or more components described herein in connection with FIG. 4 include one or more components described herein in connection with FIGS. 26-58 to perform an application programming interface (API) to cause one or more identifiers of one or more data structures indicating a number of one or more streaming multiprocessors (SMs) of one or more processors to be stored and/or otherwise perform operations described herein.

In at least one embodiment, one or more processors (e.g., such as those described herein) comprise one or more circuits to perform operations and/or instructions described herein in connection with FIG. 4, such as one or more circuits to perform an application programming interface (API) to indicate one or more streaming multiprocessors (SMs) of one or more processors available to be used to perform one or more software threads and/or otherwise perform operations described herein. In at least one embodiment, operations and/or instructions described herein in connection with FIG. 4 are included in and/or otherwise include systems, methods, operations, and/or instructions described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, components described herein in connection with FIG. 4 perform one or more processes described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, not shown in FIG. 4, one or more components described herein in connection with FIG. 4 include one or more components described herein in connection with FIGS. 26-58 to perform an application programming interface (API) to indicate one or more streaming multiprocessors (SMs) of one or more processors available to be used to perform one or more software threads and/or otherwise perform operations described herein.

In at least one embodiment, one or more processors (e.g., such as those described herein) comprise one or more circuits to perform operations and/or instructions described herein in connection with FIG. 4, such as one or more circuits to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, operations and/or instructions described herein in connection with FIG. 4 are included in and/or otherwise include systems, methods, operations, and/or instructions described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, components described herein in connection with FIG. 4 perform one or more processes described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, not shown in FIG. 4, one or more components described herein in connection with FIG. 4 include one or more components described herein in connection with FIGS. 26-58 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein.

In at least one embodiment, one or more processors (e.g., such as those described herein) comprise one or more circuits to perform operations and/or instructions described herein in connection with FIG. 4, such as one or more circuits to perform an application programming interface (API) to indicate one or more groups of streaming multiprocessors (SMs) of one or more processors, on which to schedule one or more corresponding groups of software threads and/or otherwise perform operations described herein. In at least one embodiment, operations and/or instructions described herein in connection with FIG. 4 are included in and/or otherwise include systems, methods, operations, and/or instructions described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, components described herein in connection with FIG. 4 perform one or more processes described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, not shown in FIG. 4, one or more components described herein in connection with FIG. 4 include one or more components described herein in connection with FIGS. 26-58 to perform an application programming interface (API) to indicate one or more groups of streaming multiprocessors (SMs) of one or more processors, on which to schedule one or more corresponding groups of software threads and/or otherwise perform operations described herein.

In at least one embodiment, one or more processors (e.g., such as those described herein) comprise one or more circuits to perform operations and/or instructions described herein in connection with FIG. 4, such as one or more circuits to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, operations and/or instructions described herein in connection with FIG. 4 are included in and/or otherwise include systems, methods, operations, and/or instructions described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, components described herein in connection with FIG. 4 perform one or more processes described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, not shown in FIG. 4, one or more components described herein in connection with FIG. 4 include one or more components described herein in connection with FIGS. 26-58 to perform an application programming interface (API) to cause one or more indicators of one or more numbers of one or more streaming multiprocessors (SMs) of one or more processors to be read from one or more data structures storing the one or more indicators and/or otherwise perform operations described herein.

In at least one embodiment, one or more processors (e.g., such as those described herein) comprise one or more circuits to perform operations and/or instructions described herein in connection with FIG. 4, such as one or more circuits to perform an application programming interface (API) to cause context of one or more first software instructions to be communicated to one or more second software instructions and/or otherwise perform operations described herein. In at least one embodiment, operations and/or instructions described herein in connection with FIG. 4 are included in and/or otherwise include systems, methods, operations, and/or instructions described herein in connection with FIGS. 1-25 to perform an application programming interface (API) to cause context of one or more first software instructions to be communicated to one or more second software instructions and/or otherwise perform operations described herein. In at least one embodiment, components described herein in connection with FIG. 4 perform one or more processes described herein in connection with FIGS. 1-25 to perform an application programming interface (API) to cause context of one or more first software instructions to be communicated to one or more second software instructions and/or otherwise perform operations described herein. In at least one embodiment, not shown in FIG. 4, one or more components described herein in connection with FIG. 4 include one or more components described herein in connection with FIGS. 26-58 to perform an application programming interface (API) to cause context of one or more first software instructions to be communicated to one or more second software instructions and/or otherwise perform operations described herein.

In at least one embodiment, one or more processors (e.g., such as those described herein) comprise one or more circuits to perform operations and/or instructions described herein in connection with FIG. 4, such as one or more circuits to perform an application programming interface (API) to cause one or more second instructions to wait to be performed until the one or more second instructions receives context corresponding to one or more first software instructions and/or otherwise perform operations described herein. In at least one embodiment, operations and/or instructions described herein in connection with FIG. 4 are included in and/or otherwise include systems, methods, operations, and/or instructions described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, components described herein in connection with FIG. 4 perform one or more processes described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, not shown in FIG. 4, one or more components described herein in connection with FIG. 4 include one or more components described herein in connection with FIGS. 26-58 to perform an application programming interface (API) to cause one or more second instructions to wait to be performed until the one or more second instructions receives context corresponding to one or more first software instructions and/or otherwise perform operations described herein.

FIG. 5 is a block diagram 500 illustrating an application programming interface (API) to create a sub-context, in accordance with at least one embodiment. In at least one embodiment, one or more circuits of a processor are to perform a create sub-context API 502, to create a sub-context of a primary context using resources of said primary context. In at least one embodiment, not shown in FIG. 5, one or more circuits of a processor such as those described herein performs one or more instructions to perform create sub-context API 502 to perform an application programming interface (API) to allocate one or more data structures to indicate which of one or more streaming multiprocessors (SMs) of one or more processors are to be used to perform one or more software threads. In at least one embodiment, not shown in FIG. 5, one or more circuits of a processor such as those described herein performs one or more instructions to perform create sub-context API 502 to perform an application programming interface (API) to generate one or more masks to indicate one or more subsets of streaming multiprocessors of one or more graphics processing units (GPUs) usable to perform one or more kernels. In at least one embodiment, also not shown in FIG. 5, one or more circuits of a processor such as those described herein performs one or more instructions to perform create sub-context API 502 to perform an application programming interface (API) to allocate one or more data structures to indicate which of one or more streaming multiprocessors (SMs) of one or more processors are to be used to perform one or more software threads in response to receiving a second API such as those described herein.

In at least one embodiment, create sub-context API 502 receives, when invoked, one or more arguments to indicate information about operations to be performed using techniques such as those described herein. In at least one embodiment, create sub-context API 502 receives, when invoked, one or more arguments to indicate information about instructions to be performed using techniques such as those described herein.

In at least one embodiment, create sub-context API 502 receives, as input, one or more arguments comprising a sub-context return 504. In at least one embodiment, sub-context return 504 is a data value comprising information usable to identify, indicate, or otherwise specify a storage location to store a created sub-context (e.g., created using create sub-context API 502). In at least one embodiment, a sub-context return location identified, indicated, or otherwise specified by sub-context return 504 is one of a plurality of parameters usable by create sub-context API 502 to create a sub-context. In at least one embodiment, sub-context return 504 is a data value to identify, indicate, or otherwise specify to an API such as create sub-context API 502, a set of operations or instructions to be performed by one or more PPUs, such as GPUs, and/or one or more accelerators within a heterogeneous processor, as described herein.

In at least one embodiment, create sub-context API 502 receives, as input, one or more arguments comprising a resource descriptor 506. In at least one embodiment, resource descriptor 506 is a data value comprising information usable to identify, indicate, or otherwise specify a storage location of a resource descriptor used to create a sub-context (e.g., created using create sub-context API 502). In at least one embodiment, a resource descriptor identified, indicated, or otherwise specified by resource descriptor 506 is one of a plurality of parameters usable by create sub-context API 502 to create a sub-context. In at least one embodiment, resource descriptor 506 is a data value to identify, indicate, or otherwise specify to an API such as create sub-context API 502, a set of operations or instructions to be performed by one or more PPUs, such as GPUs, and/or one or more accelerators within a heterogeneous processor, as described herein.

In at least one embodiment, create sub-context API 502 receives, as input, one or more arguments comprising a device 508. In at least one embodiment, device 508 is a data value comprising information usable to identify, indicate, or otherwise specify a device associated with a sub-context (e.g., created using create sub-context API 502). In at least one embodiment, a device identified, indicated, or otherwise specified by device 508 is one of a plurality of parameters usable by create sub-context API 502 to create a sub-context. In at least one embodiment, device 508 is a data value to identify, indicate, or otherwise specify to an API such as create sub-context API 502, a set of operations or instructions to be performed by one or more PPUs, such as GPUs, and/or one or more accelerators within a heterogeneous processor, as described herein.

In at least one embodiment, create sub-context API 502 receives, as input, one or more arguments comprising flags 510. In at least one embodiment, flags 510 is a data value comprising information usable to identify, indicate, or otherwise specify flags used when creating a sub-context (e.g., using create sub-context API 502). In at least one embodiment, flags 510 is a data value indicating which SMs of a device (e.g., indicated by device 508) are to be used to a sub-context created by create sub-context API 502. In at least one embodiment, flags identified, indicated, or otherwise specified by flags 510 is one of a plurality of parameters usable by create sub-context API 502 to create a sub-context. In at least one embodiment, flags 510 is a data value to identify, indicate, or otherwise specify to an API such as create sub-context API 502, a set of operations or instructions to be performed by one or more PPUs, such as GPUs, and/or one or more accelerators within a heterogeneous processor, as described herein.

In at least one embodiment, create sub-context API 502 receives, as input, one or more arguments comprising one or more other arguments 518. In at least one embodiment, other arguments 518 are data comprising information to indicate any other information usable in performing create sub-context API 502 to create a sub-context.

In at least one embodiment, not shown in FIG. 5, a processor performs one or more instructions to perform one or more APIs such as create sub-context API 502 to perform an application programming interface (API) to allocate one or more data structures to indicate which of one or more streaming multiprocessors (SMs) of one or more processors are to be used to perform one or more software threads using one or more arguments including, but not limited to, sub-context return 504, resource descriptor 506, device 508, flags 510, and/or other arguments 518. In at least one embodiment, not shown in FIG. 5, a processor performs one or more instructions to perform one or more APIs such as create sub-context API 502 to perform an application programming interface (API) to generate one or more masks to indicate one or more subsets of streaming multiprocessors of one or more graphics processing units (GPUs) usable to perform one or more kernels using one or more arguments including, but not limited to, sub-context return 504, resource descriptor 506, device 508, flags 510, and/or other arguments 518.

In at least one embodiment, create sub-context API 502, if invoked, causes one or more APIs such as one or more APIs 306, described herein at least in connection with FIG. 3, to add one or more operations or instructions to be added, inserted, or otherwise included in a stream or set of instructions to be performed by one or more accelerators within a heterogenous processor. In at least one embodiment, create sub-context API 502, if invoked, causes one or more APIs such as one or more APIs 306 to, in a parallel computing environment such as parallel computing environment 308, described herein at least in connection with FIG. 3, add one or more operations or instructions to be added, inserted, or otherwise included in a stream or set of instructions to be performed by one or more accelerators within a heterogenous processor.

In at least one embodiment, in response to create sub-context API 502, one or more APIs 306, if performed, are to cause one or more processors to perform a create sub-context API return 520. In at least one embodiment, create sub-context API return 520 is a set of instructions that, if performed, generate and/or indicate one or more data values in response to create sub-context API 502. In at least one embodiment, create sub-context API return 520 indicates a success indicator 522. In at least one embodiment, success indicator 522 is data comprising any value to indicate success of create sub-context API 502. In at least one embodiment, success indicator 522 comprises information indicating one or more specific types of successes generated as a result of performing create sub-context API 502. In at least one embodiment, success indicator 522 comprises information indicating one or more other data values generated as a result of create sub-context API 502.

In at least one embodiment, create sub-context API return 520 indicates an error indicator 524. In at least one embodiment, error indicator 524 is data comprising any value to indicate failure of create sub-context API 502. In at least one embodiment, error indicator 524 comprises information indicating one or more specific types of errors generated as a result of performing create sub-context API 502. In at least one embodiment, error indicator 524 comprises information indicating one or more other data values generated as a result of create sub-context API 502.

In at least one embodiment, parallel computing environment 308 comprising one or more APIs 306 including, but not limited to, create sub-context API 502 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, example software code indicating stream operation types is as follows:

```
/**
* Types of stream operations
*/
typedef enum
{
  /**< Acquire semaphore */
  CUSOCKET_STREAM_OP_SEMA_ACQ,
  /**< Release semaphore */
  CUSOCKET_STREAM_OP_SEMA_REL,
  /**< Flush GPU L2 cache */
  CUSOCKET_STREAM_OP_GPU_L2_FLUSH,
  /**< Invalidate GPU L2 cache */
  CUSOCKET_STREAM_OP_GPU_L2_INVALIDATE,
  /**< Submitting an operation to an external device */
  CUSOCKET_STREAM_OP_EXTERNAL_DEVICE_SUBMIT
} cuSocketStreamOpType;
```

In at least one embodiment, parallel computing environment 308 comprising one or more APIs 306 including, but not limited to, create sub-context API 502 comprises one or more function signatures usable to indicate one or more callback functions for operations to be performed by one or more accelerators within heterogeneous processors. In at least one embodiment, one or more operations cause one or more callback functions to be performed. In at least one embodiment, example software code indicating a function signature for a callback function is as follows:

/**
* Callback function signature for submitting to an external device.
*/
typedef unsigned int (*cuSocketExternalDeviceSubmitCallback)(void
*submitArgs);

In at least one embodiment, in order to specify one or more accelerators within heterogeneous processors to perform one or more operations indicated by create sub-context API 502 to one or more APIs 306, one or more data structures of one or more APIs 306 are usable to specify one or more external devices for which said one or more APIs 306 are to submit said one or more operations. In at least one embodiment, example software code indicating a data structure representing a device node for one or more accelerators within heterogeneous processors is as follows:

/**
* Struct representing the external device node that captures the information
* about a particular task submit for an external device.
*/
typedef struct
{
void *submitArgs;
cuSocketExternalDeviceSubmitCallback callback;
} cuSocketExternalDeviceNodeParams;

In at least one embodiment, in order to specify type and data of one or more operations indicated by one or more operations to be performed by one or more accelerators within heterogeneous processors, one or more data structures of one or more APIs 306 are to be used. In at least one embodiment, example software code indicating a data structure to specify type and data of one or more operations to be performed by one or more accelerators within heterogeneous processors is as follows:

```
/**
* Struct tracking the type and data for stream operations. The \p data is
populated
* with semaphore address and payload for types
* ::CUSOCKET_STREAM_OP_SEMA_ACQ and
* ::CUSOCKET_STREAM_OP_SEMA_REL
*/
typedef struct
{
  /**
  * Type of stream operation
  */
  cuSocketStreamOpType type;
  union {
  /**
  * Parameters for semaphore
  */
  struct {
  /**
  * Address of semaphore to be acquired or released.
  */
  void *semaAddr;
  /**
  * Payload value of semaphore.
  */
    unsigned int payload;
  } sema;
  /**
  * The particular task that needs to be submitted to the external device.
  */
  cuSocketExternalDeviceNodeParams task;
  } data;
} cuSocketStreamOp;
```

In at least one embodiment, one or more APIs 306 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to create sub-context API 502, as described above. In at least one embodiment, example software code indicating a stream operation API call in parallel computing environment 308, such as CUDA, is as follows:

```
/**
* Submit a list of operations to a CUDA stream.
*
* - param[in] usrStream - The stream into which the operations are
submitted.
*
* - param[in] streamOp - The list of operations to be submitted.
*
* - param[in] count - The number of operations to be submitted.
*
* - Returns CUDA_SUCCESS on success, otherwise it returns an
appropriate error.
*/
CUresult cuSocketStreamOps(
  CUstream usrStream,
  cuSocketStreamOp *streamOp,
  unsigned int count,
  unsigned int flags
);
```

In at least one embodiment, one or more APIs 306 comprise instructions that, if performed, cause one or more operations or instructions to be performed by one or more accelerators within heterogeneous processors to be added to one or more executable graphs similar to how one or more operations or instructions to be performed by one or more accelerators within heterogeneous processors are to be added to one or more streams or sets of instructions in response to create sub-context API 502. In at least one embodiment, example software code indicating addition of one or more operations or instructions to one or more executable graphs by one or more APIs 306 of parallel computing environment 308 is as follows:

```
/**
* Submit a task for an external device on a CUDA stream.
*
* - param[in] graphNode - The newly created node.
*
* - param[in] graph - The graph in which this node should be added.
*
* - param[in] dependencies - The dependencies that need to be met before
* this node can be executed.
* - param[in] numDependencies - The number of dependencies.
* - param[in] nodeParams - The execution parameters of the node.
*
* - Returns CUDA_SUCCESS on success, otherwise it returns an
appropriate error.
*/
CUresult cuSocketAddExternalDeviceNode (
  CUgraphNode* graphNode,
  CUgraph graph,
  CUgraphNode* dependencies,
  unsigned int numDependencies,
  cuSocketExternalDeviceNodeParams* nodeParams
);
```

FIG. 6 is a block diagram 600 illustrating a process to perform an application programming interface (API) to create a sub-context, in accordance with at least one embodiment. In at least one embodiment, said process to perform an API to create a sub-context illustrated in block diagram 600 is a process to perform create sub-context API 502, described herein at least in connection with FIG. 5. In at least one embodiment, some or all of said process to perform an API to create a sub-context illustrated in block diagram 600 (or any other processes described herein, or variations and/or combinations thereof) is performed under control of one or more computer systems, servers, processors, integrated circuits, and/or other such device as described in connection with FIGS. 26-58, configured with computer-executable instructions and is implemented as code (e.g., computer-executable instructions, one or more computer programs, or one or more applications) executing collectively on one or more processors, by hardware, software, or combinations thereof. In at least one embodiment, said code is stored on a computer-readable storage medium in form of a computer program comprising a plurality of computer-readable instructions executable by one or more processors such as those described herein. In at least one embodiment, a computer-readable storage medium is a non-transitory computer-readable medium. In at least one embodiment, a processor such as processor 110, described herein at least in connection with FIG. 1, performs one or more steps of said process to perform an API to create a sub-context illustrated in block diagram 600. In at least one embodiment, one or more other processors such as those described herein perform one or more steps of said process to perform an API to create a sub-context illustrated in block diagram 600.

In at least one embodiment, at step 602 of said process to perform an API to create a sub-context illustrated in block diagram 600, a processor performing said process performs one or more operations to receive or otherwise obtain an API to create a sub-context. In at least one embodiment, at step 602, an API to create sub-context is received by otherwise provided to a processor such as processor 110, described herein at least in connection with FIG. 1. In at least one embodiment, at step 602, an API to create sub-context is received from otherwise provided by a processor such as processor 102, described herein at least in connection with FIG. 1. In at least one embodiment, at step 602, an API to create a sub-context includes one or more arguments described herein at least in connection with FIG. 5. In at least one embodiment, after step 602, said process to perform an API to create a sub-context illustrated in block diagram 600 continues at step 604.

In at least one embodiment, at step 604 of said process to perform an API to create a sub-context illustrated in block diagram 600, a processor performing said process performs one or more operations to determine whether an API to create a sub-context (e.g., received at step 602) is valid. In at least one embodiment, at step 604, operations to determine whether an API to create a sub-context is valid comprise operations to verify validity of arguments of said API to create a sub-context (e.g., arguments described herein at least in connection with FIG. 5). In at least one embodiment, at step 604, if it is determined that an API to create a sub-context is valid (“YES” branch), said process to perform an API to create a sub-context illustrated in block diagram 600 continues at step 606. In at least one embodiment, at step 604, if it is determined that an API to create a sub-context is not valid (“NO” branch), said process to perform an API to create a sub-context illustrated in block diagram 600 continues at step 620, described below.

In at least one embodiment, at step 606 of said process to perform an API to create a sub-context illustrated in block diagram 600, a processor performing said process performs one or more operations to get resources from a device. In at least one embodiment, at step 606, one or more operations to get resources from a device comprise one or more operations to query a context (e.g., a primary context) of device such as device 202, described herein at least in connection with FIG. 2, to determine a set of resources available to or otherwise associated with said device, as described herein at least in connection with FIG. 2. In at least one embodiment, a device is an argument of an API to create a subcontext, as described herein at least in connection with FIG. 5. In at least one embodiment, after step 606, said process to perform an API to create a sub-context illustrated in block diagram 600 continues at step 608.

In at least one embodiment, at step 608 of said process to perform an API to create a sub-context illustrated in block diagram 600, a processor performing said process performs one or more operations to determine whether a sub-context can be created based, at least in part, on a list of resources and/or one or more flags (e.g., received as arguments to an API to create a sub-context, as described herein at least in connection with FIG. 5). In at least one embodiment, one or more operations to determine whether a sub-context can be created make said determination based, at least in part, on available resources, a source context (e.g., from which a sub-context is to be created), a device upon which to create said context, etc. In at least one embodiment, after step 608, said process to perform an API to create a sub-context illustrated in block diagram 600 continues at step 6104.

In at least one embodiment, at step 610 of said process to perform an API to create a sub-context illustrated in block diagram 600, a processor performing said process performs one or more operations to determine whether a sub-context can be created (e.g., based on a determination at step 608). In at least one embodiment, at step 604, if it is determined that a sub-context can be created (“YES” branch), said process to perform an API to create a sub-context illustrated in block diagram 600 continues at step 612. In at least one embodiment, at step 610, if it is determined that a sub-context cannot be created (“NO” branch), said process to perform an API to create a sub-context illustrated in block diagram 600 continues at step 620, described below.

In at least one embodiment, at step 612 of said process to perform an API to create a sub-context illustrated in block diagram 600, a processor performing said process performs one or more operations to create a sub-context based on resources and flags received as arguments to an API to create a sub-context. In at least one embodiment, at step 612, a sub-context is created as described herein at least in connection with FIGS. 1 and 2. In at least one embodiment, after step 612, said process to perform an API to create a sub-context illustrated in block diagram 600 continues at step 614.

In at least one embodiment, at step 614 of said process to perform an API to create a sub-context illustrated in block diagram 600, a processor performing said process performs one or more operations to assign a sub-set of a set of resources (e.g., of a primary context and/or of a sub-context) to a created sub-context. In at least one embodiment, at step 614, a sub-set of a set of resources are exclusively assigned to a sub-context (e.g., are assigned to a single context). In at least one embodiment, a sub-set of a set of resources is assigned to a sub-context by, for example, providing a list of said sub-set to said sub-context. In at least one embodiment, after step 614, said process to perform an API to create a sub-context illustrated in block diagram 600 continues at step 616.

In at least one embodiment, at step 616 of said process to perform an API to create a sub-context illustrated in block diagram 600, a processor performing said process performs one or more operations to return a success indicator (e.g., a success indicator 522, described herein at least in connection with FIG. 5). In at least one embodiment, at step 616, a success indicator is returned to a calling process (e.g., a process performed by a processor such as processor 102, described herein at least in connection with FIG. 1). In at least one embodiment, after step 616, said process to perform an API to create a sub-context illustrated in block diagram 600 terminates. In at least one embodiment, not shown in FIG. 6, after step 616, said process to perform an API to create a sub-context illustrated in block diagram 600 continues at step 602, described above.

In at least one embodiment, at step 618 of said process to perform an API to create a sub-context illustrated in block diagram 600, a processor performing said process performs one or more operations to return an error indicator (e.g., an error indicator 524, described herein at least in connection with FIG. 5). In at least one embodiment, at step 618, an error indicator is returned to a calling process (e.g., a process performed by a processor such as processor 102, described herein at least in connection with FIG. 1). In at least one embodiment, after step 618, said process to perform an API to create a sub-context illustrated in block diagram 600 terminates. In at least one embodiment, not shown in FIG. 6, after step 618, said process to perform an API to create a sub-context illustrated in block diagram 600 continues at step 602, described above.

In at least one embodiment, operations of said process to perform an API to create a sub-context illustrated in block diagram 600 are performed in a different order than is illustrated in FIG. 600. In at least one embodiment, operations of said process to perform an API to create a sub-context illustrated in block diagram 600 are performed simultaneously or in parallel. In at least one embodiment, operations of said process to perform an API to create a sub-context illustrated in block diagram 600 that do not depend on each other (e.g., are order independent) are performed simultaneously or in parallel. In at least one embodiment, operations of said process to perform an API to create a sub-context illustrated in block diagram 600 are performed by a plurality of threads executing on a processor such as those described herein.

In at least one embodiment, one or more processors (e.g., processor 102, processor 110, and/or other processors and/or accelerators such as those described herein) comprise one or more circuits to perform operations and/or instructions described herein in connection with FIGS. 5 and 6, such as one or more circuits to perform an application programming interface (API) to allocate one or more data structures to indicate which of one or more streaming multiprocessors (SMs) of one or more processors are to be used to perform one or more software threads and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIGS. 5 and 6, such as one or more circuits to perform an application programming interface (API) to generate one or more masks to indicate one or more subsets of streaming multiprocessors of one or more graphics processing units (GPUs) usable to perform one or more kernels and/or otherwise perform operations described herein. In at least one embodiment, operations and/or instructions described herein in connection with FIGS. 5 and 6 are included in and/or otherwise include systems, methods, operations, and/or instructions described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, components described herein in connection with FIGS. 5 and 6 perform one or more processes described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, not shown in FIGS. 5 and 6, one or more components described herein in connection with FIGS. 5 and 6 include one or more components described herein in connection with FIGS. 26-58 to perform an application programming interface (API) to allocate one or more data structures to indicate which of one or more streaming multiprocessors (SMs) of one or more processors are to be used to perform one or more software threads and/or otherwise perform operations described herein.

FIG. 7 is a block diagram 700 illustrating an application programming interface (API) to destroy a sub-context, in accordance with at least one embodiment. In at least one embodiment, one or more circuits of a processor are to perform a destroy sub-context API 702, to destroy a sub-context created by performing an API to create a sub-context such as create sub-context API 502, described herein at least in connection with FIG. 5. In at least one embodiment, not shown in FIG. 7, one or more circuits of a processor such as those described herein performs one or more instructions to perform destroy sub-context API 702 to perform an application programming interface (API) to deallocate one or more data structures to indicate which of one or more streaming multiprocessors (SMs) of one or more processors are to be used to perform one or more software threads. In at least one embodiment, not shown in FIG. 7, one or more circuits of a processor such as those described herein performs one or more instructions to perform destroy sub-context API 702 to perform an application programming interface (API) to cause one or more masks to be deactivated, wherein the one or more masks indicate one or more subsets of streaming multiprocessors of one or more graphics processing units (GPUs) usable to perform one or more kernels. In at least one embodiment, also not shown in FIG. 7, one or more circuits of a processor such as those described herein performs one or more instructions to perform destroy sub-context API 702 to perform an application programming interface (API) to deallocate one or more data structures to indicate which of one or more streaming multiprocessors (SMs) of one or more processors are to be used to perform one or more software threads in response to receiving a second API such as those described herein.

In at least one embodiment, destroy sub-context API 702 receives, when invoked, one or more arguments to indicate information about operations to be performed using techniques such as those described herein. In at least one embodiment, destroy sub-context API 702 receives, when invoked, one or more arguments to indicate information about instructions to be performed using techniques such as those described herein.

In at least one embodiment, destroy sub-context API 702 receives, as input, one or more arguments comprising a sub-context 704. In at least one embodiment, a sub-context 704 is a data value comprising information usable to identify, indicate, or otherwise specify a sub-context to be destroyed using destroy sub-context API 702. In at least one embodiment, a sub-context identified, indicated, or otherwise specified by sub-context 704 is one of a plurality of parameters usable by destroy sub-context API 702 to destroy a sub-context. In at least one embodiment, sub-context 704 is a data value to identify, indicate, or otherwise specify to an API such as destroy sub-context API 702, a set of operations or instructions to be performed by one or more PPUs, such as GPUs, and/or one or more accelerators within a heterogeneous processor, as described herein.

In at least one embodiment, destroy sub-context API 702 receives, as input, one or more arguments comprising one or more other arguments 718. In at least one embodiment, other arguments 718 are data comprising information to indicate any other information usable in performing destroy sub-context API 702 to destroy a sub-context.

In at least one embodiment, not shown in FIG. 7, a processor performs one or more instructions to perform one or more APIs such as destroy sub-context API 702 to perform an application programming interface (API) to deallocate one or more data structures to indicate which of one or more streaming multiprocessors (SMs) of one or more processors are to be used to perform one or more software threads using one or more arguments including, but not limited to, sub-context 704 and/or other arguments 718. In at least one embodiment, not shown in FIG. 7, a processor performs one or more instructions to perform one or more APIs such as destroy sub-context API 702 to perform an application programming interface (API) to cause one or more masks to be deactivated, wherein the one or more masks indicate one or more subsets of streaming multiprocessors of one or more graphics processing units (GPUs) usable to perform one or more kernels using one or more arguments including, but not limited to, sub-context 704 and/or other arguments 718.

In at least one embodiment, destroy sub-context API 702, if invoked, causes one or more APIs such as one or more APIs 306, described herein at least in connection with FIG. 3, to add one or more operations or instructions to be added, inserted, or otherwise included in a stream or set of instructions to be performed by one or more accelerators within a heterogenous processor. In at least one embodiment, destroy sub-context API 702, if invoked, causes one or more APIs such as one or more APIs 306 to, in a parallel computing environment such as parallel computing environment 308, described herein at least in connection with FIG. 3, add one or more operations or instructions to be added, inserted, or otherwise included in a stream or set of instructions to be performed by one or more accelerators within a heterogenous processor.

In at least one embodiment, in response to destroy sub-context API 702, one or more APIs 306, if performed, are to cause one or more processors to perform a destroy sub-context API return 720. In at least one embodiment, destroy sub-context API return 720 is a set of instructions that, if performed, generate and/or indicate one or more data values in response to destroy sub-context API 702. In at least one embodiment, destroy sub-context API return 720 indicates a success indicator 722. In at least one embodiment, success indicator 722 is data comprising any value to indicate success of destroy sub-context API 702. In at least one embodiment, success indicator 722 comprises information indicating one or more specific types of successes generated as a result of performing destroy sub-context API 702. In at least one embodiment, success indicator 722 comprises information indicating one or more other data values generated as a result of destroy sub-context API 702.

In at least one embodiment, destroy sub-context API return 720 indicates an error indicator 724. In at least one embodiment, error indicator 724 is data comprising any value to indicate failure of destroy sub-context API 702. In at least one embodiment, error indicator 724 comprises information indicating one or more specific types of errors generated as a result of performing destroy sub-context API 702. In at least one embodiment, error indicator 724 comprises information indicating one or more other data values generated as a result of destroy sub-context API 702.

In at least one embodiment, parallel computing environment 308 comprising one or more APIs 306 including, but not limited to, destroy sub-context API 702 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, one or more operations to indicate submission of an operation to an external device use software code such as example software code indicating stream operations as described herein at least in connection with FIG. 5.

In at least one embodiment, parallel computing environment 308 comprising one or more APIs 306 including, but not limited to, destroy sub-context API 702 comprises one or more function signatures usable to indicate one or more callback functions for operations to be performed by one or more accelerators within heterogeneous processors. In at least one embodiment, one or more operations cause one or more callback functions to be performed. In at least one embodiment, one or more operations to cause one or more callback functions to be performed use software code such as example software code indicating a function signature for a callback function as described herein at least in connection with FIG. 5.

In at least one embodiment, in order to specify one or more accelerators within heterogeneous processors to perform one or more operations indicated by destroy sub-context API 702 to one or more APIs 306, one or more data structures of one or more APIs 306 are usable to specify one or more external devices for which said one or more APIs 306 are to submit said one or more operations. In at least one embodiment, one or more data structures of one or more APIs 306 usable to specify one or more external devices for which said one or more APIs 306 are to submit said one or more operations use software code such as example software code indicating a data structure representing a device node for one or more accelerators within heterogeneous processors as described herein at least in connection with FIG. 5.

In at least one embodiment, in order to specify type and data of one or more operations indicated by one or more operations to be performed by one or more accelerators within heterogeneous processors, one or more data structures of one or more APIs 306 are to be used. In at least one embodiment, one or more data structures of one or more APIs 306 used to specify type and data of one or more operations indicated by one or more operations to be performed by one or more accelerators within heterogeneous processors use software code such as example software code indicating a data structure to specify type and data of one or more operations to be performed by one or more accelerators within heterogeneous processors as described herein at least in connection with FIG. 5.

In at least one embodiment, one or more APIs 306 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to destroy sub-context API 702, as described above. In at least one embodiment, instructions to cause one or more operations or instructions to be added to a stream or other set of instructions to be performed in response to destroy sub-context API 702 use software code such as example software code indicating a stream operation API call in parallel computing environment 308 as described herein at least in connection with FIG. 5.

In at least one embodiment, one or more APIs 306 comprise instructions that, if performed, cause one or more operations or instructions to be performed by one or more accelerators within heterogeneous processors to be added to one or more executable graphs. In at least one embodiment, instructions that, if performed, cause one or more operations or instructions to be performed by one or more accelerators within heterogeneous processors to be added to one or more executable graphs are similar to how one or more operations or instructions to be performed by one or more accelerators within heterogeneous processors are to be added to one or more streams or sets of instructions in response to destroy sub-context API 702, as described herein. In at least one embodiment, instructions that, if performed, cause one or more operations or instructions to be performed by one or more accelerators within heterogeneous processors to be added to one or more executable graphs use software code such as example software code indicating addition of one or more operations or instructions to one or more executable graphs by one or more APIs 306 of parallel computing environment 308 as described herein at least in connection with FIG. 5.

FIG. 8 is a block diagram 800 illustrating a process to perform an application programming interface (API) to destroy a subcontext, in accordance with at least one embodiment. In at least one embodiment, said process to perform an API to destroy a sub-context illustrated in block diagram 800 is a process to perform destroy sub-context API 702, described herein at least in connection with FIG. 7. In at least one embodiment, some or all of said process to perform an API to destroy a sub-context illustrated in block diagram 800 (or any other processes described herein, or variations and/or combinations thereof) is performed under control of one or more computer systems, servers, processors, integrated circuits, and/or other such device as described in connection with FIGS. 26-58, configured with computer-executable instructions and is implemented as code (e.g., computer-executable instructions, one or more computer programs, or one or more applications) executing collectively on one or more processors, by hardware, software, or combinations thereof. In at least one embodiment, said code is stored on a computer-readable storage medium in form of a computer program comprising a plurality of computer-readable instructions executable by one or more processors such as those described herein. In at least one embodiment, a computer-readable storage medium is a non-transitory computer-readable medium. In at least one embodiment, a processor such as processor 110, described herein at least in connection with FIG. 1, performs one or more steps of said process to perform an API to destroy a sub-context illustrated in block diagram 800. In at least one embodiment, one or more other processors such as those described herein perform one or more steps of said process to perform an API to destroy a sub-context illustrated in block diagram 800.

In at least one embodiment, at step 802 of said process to perform an API to destroy a sub-context illustrated in block diagram 800, a processor performing said process performs one or more operations to receive or otherwise obtain an API to destroy a sub-context. In at least one embodiment, at step 802, an API to destroy a sub-context is received by otherwise provided to a processor such as processor 110, described herein at least in connection with FIG. 1. In at least one embodiment, at step 802, an API to destroy a sub-context is received from otherwise provided by a processor such as processor 102, described herein at least in connection with FIG. 1. In at least one embodiment, at step 802, an API to destroy a sub-context includes one or more arguments such as those described herein at least in connection with FIG. 7. In at least one embodiment, after step 802, said process to perform an API to destroy a sub-context illustrated in block diagram 800 continues at step 804.

In at least one embodiment, at step 804 of said process to perform an API to destroy a sub-context illustrated in block diagram 800, a processor performing said process performs one or more operations to determine whether an API to destroy a sub-context (e.g., received at step 802) is valid. In at least one embodiment, at step 804, operations to determine whether an API to destroy a sub-context is valid comprise operations to verify validity of arguments of said API to destroy a sub-context (e.g., arguments described herein at least in connection with FIG. 7). In at least one embodiment, at step 804, if it is determined that an API to destroy a sub-context is valid (“YES” branch), said process to perform an API to destroy a sub-context illustrated in block diagram 800 continues at step 806. In at least one embodiment, at step 804, if it is determined that an API to destroy a sub-context is not valid (“NO” branch), said process to perform an API to destroy a sub-context illustrated in block diagram 800 continues at step 816, described below.

In at least one embodiment, at step 806 of said process to perform an API to destroy a sub-context illustrated in block diagram 800, a processor performing said process performs one or more operations to identify a sub-context to destroy. In at least one embodiment, a sub-context is identified as an argument an API to destroy a sub-context, received at step 802. In at least one embodiment, after step 806, said process to perform an API to destroy a sub-context illustrated in block diagram 800 continues at step 808.

In at least one embodiment, at step 808 of said process to perform an API to destroy a sub-context illustrated in block diagram 800, a processor performing said process performs one or more operations to determine whether a sub-context to destroy was identified (e.g., identified at step 806). In at least one embodiment, at step 808, if it is determined that a sub-context to destroy was identified (“YES” branch), said process to perform an API to destroy a sub-context illustrated in block diagram 800 continues at step 810. In at least one embodiment, at step 808, if it is determined that a sub-context to destroy was not identified (“NO” branch), said process to perform an API to destroy a sub-context illustrated in block diagram 800 continues at step 816, described below.

In at least one embodiment, at step 810 of said process to perform an API to destroy a sub-context illustrated in block diagram 800, a processor performing said process performs one or more operations to stop one or more streams associated with a context to destroy (e.g., a sub-context identified at step 806), release any resources associated with said context to destroy, and destroy said context to destroy (e.g., indicate said context to be not valid). In at least one embodiment, streams are allowed to complete current operations before being stopped. In at least one embodiment, streams are stopped immediately (e.g., are not allowed to complete current operations). In at least one embodiment, a plurality of streams associated with a sub-context are stopped. In at least one embodiment, after step 810, said process to perform an API to destroy a sub-context illustrated in block diagram 800 continues at step 812.

In at least one embodiment, at step 812 of said process to perform an API to destroy a sub-context illustrated in block diagram 800, a processor performing said process performs one or more operations to determine whether a sub-context to destroy was destroyed (e.g., by performing step 710). In at least one embodiment, at step 812, if it is determined that a context to destroy was destroyed (“YES” branch), said process to perform an API to destroy a sub-context illustrated in block diagram 800 continues at step 814. In at least one embodiment, at step 812, if it is determined that a context to destroy was not destroyed (“NO” branch), said process to perform an API to destroy a sub-context illustrated in block diagram 800 continues at step 816, described below.

In at least one embodiment, at step 814 of said process to perform an API to destroy a sub-context illustrated in block diagram 800, a processor performing said process performs one or more operations to return a success indicator (e.g., a success indicator 722, described herein at least in connection with FIG. 7). In at least one embodiment, at step 814, a success indicator is returned to a calling process (e.g., a process performed by a processor such as processor 102, described herein at least in connection with FIG. 1). In at least one embodiment, after step 814, said process to perform an API to destroy a sub-context illustrated in block diagram 800 terminates. In at least one embodiment, not shown in FIG. 8, after step 814, said process to perform an API to destroy a sub-context illustrated in block diagram 800 continues at step 802, described above.

In at least one embodiment, at step 816 of said process to perform an API to destroy a sub-context illustrated in block diagram 800, a processor performing said process performs one or more operations to return an error indicator (e.g., an error indicator 724, described herein at least in connection with FIG. 7). In at least one embodiment, at step 816, an error indicator is returned to a calling process (e.g., a process performed by a processor such as processor 102, described herein at least in connection with FIG. 1). In at least one embodiment, after step 816, said process to perform an API to destroy a sub-context illustrated in block diagram 800 terminates. In at least one embodiment, not shown in FIG. 8, after step 816, said process to perform an API to destroy a sub-context illustrated in block diagram 800 continues at step 802, described above.

In at least one embodiment, operations of said process to perform an API to destroy a sub-context illustrated in block diagram 800 are performed in a different order than is illustrated in FIG. 800. In at least one embodiment, operations of said process to perform an API to destroy a sub-context illustrated in block diagram 800 are performed simultaneously or in parallel. In at least one embodiment, operations of said process to perform an API to destroy a sub-context illustrated in block diagram 800 that do not depend on each other (e.g., are order independent) are performed simultaneously or in parallel. In at least one embodiment, operations of said process to perform an API to destroy a sub-context illustrated in block diagram 800 are performed by a plurality of threads executing on a processor such as those described herein.

In at least one embodiment, one or more processors (e.g., processor 102, processor 110, and/or other processors and/or accelerators such as those described herein) comprise one or more circuits to perform operations and/or instructions described herein in connection with FIGS. 7 and 8, such as one or more circuits to perform an application programming interface (API) to deallocate one or more data structures to indicate which of one or more streaming multiprocessors (SMs) of one or more processors are to be used to perform one or more software threads and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIGS. 7 and 8, such as one or more circuits to perform an application programming interface (API) to cause one or more masks to be deactivated, wherein the one or more masks indicate one or more subsets of streaming multiprocessors of one or more graphics processing units (GPUs) usable to perform one or more kernels and/or otherwise perform operations described herein. In at least one embodiment, operations and/or instructions described herein in connection with FIGS. 7 and 8 are included in and/or otherwise include systems, methods, operations, and/or instructions described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, components described herein in connection with FIGS. 7 and 8 perform one or more processes described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, not shown in FIGS. 7 and 8, one or more components described herein in connection with FIGS. 7 and 8 include one or more components described herein in connection with FIGS. 26-58 to perform an application programming interface (API) to deallocate one or more data structures to indicate which of one or more streaming multiprocessors (SMs) of one or more processors are to be used to perform one or more software threads and/or otherwise perform operations described herein.

FIG. 9 is a block diagram 900 illustrating an application programming interface (API) to get a sub-context from a stream, in accordance with at least one embodiment. In at least one embodiment, one or more circuits of a processor are to perform a get sub-context from stream API 902, get a sub-context associated with an identified stream being performed using a channel, as described herein at least in connection with FIGS. 1 and 2. In at least one embodiment, not shown in FIG. 9, one or more circuits of a processor such as those described herein performs one or more instructions to perform get sub-context from stream API 902 to perform an application programming interface (API) to cause one or more identifiers of one or more data structures indicating a number of one or more streaming multiprocessors (SMs) of one or more processors to be stored. In at least one embodiment, not shown in FIG. 9, one or more circuits of a processor such as those described herein performs one or more instructions to perform get sub-context from stream API 902 to perform an application programming interface (API) to indicate one or more identifiers of one or more masks, wherein the one or more masks indicate one or more subsets of streaming multiprocessors of one or more graphics processing units (GPUs) usable to perform one or more kernels. In at least one embodiment, also not shown in FIG. 9, one or more circuits of a processor such as those described herein performs one or more instructions to perform get sub-context from stream API 902 to perform an application programming interface (API) to cause one or more identifiers of one or more data structures indicating a number of one or more streaming multiprocessors (SMs) of one or more processors to be stored in response to receiving a second API such as those described herein.

In at least one embodiment, get sub-context from stream API 902 receives, when invoked, one or more arguments to indicate information about operations to be performed using techniques such as those described herein. In at least one embodiment, get sub-context from stream API 902 receives, when invoked, one or more arguments to indicate information about instructions to be performed using techniques such as those described herein.

In at least one embodiment, get sub-context from stream API 902 receives, as input, one or more arguments comprising a stream 904. In at least one embodiment, stream 904 is a data value comprising information usable to identify, indicate, or otherwise specify a stream to get a sub-context from using get sub-context from stream API 902. In at least one embodiment, a stream identified, indicated, or otherwise specified by stream 904 is one of a plurality of parameters usable by get sub-context from stream API 902 to get a sub-context from a stream. In at least one embodiment, stream 904 is a data value to identify, indicate, or otherwise specify to an API such as get sub-context from stream API 902, a set of operations or instructions to be performed by one or more PPUs, such as GPUs, and/or one or more accelerators within a heterogeneous processor, as described herein.

In at least one embodiment, get sub-context from stream API 902 receives, as input, one or more arguments comprising a sub-context return 906. In at least one embodiment, sub-context return 906 is a data value comprising information usable to identify, indicate, or otherwise specify a storage location to store a sub-context identified using get sub-context from stream API 902. In at least one embodiment, a storage location to store a sub-context identified, indicated, or otherwise specified by sub-context return 906 is one of a plurality of parameters usable by get sub-context from stream API 902 to get a sub-context from a stream. In at least one embodiment, sub-context return 906 is a data value to identify, indicate, or otherwise specify to an API such as get sub-context from stream API 902, a set of operations or instructions to be performed by one or more PPUs, such as GPUs, and/or one or more accelerators within a heterogeneous processor, as described herein.

In at least one embodiment, get sub-context from stream API 902 receives, as input, one or more arguments comprising one or more other arguments 918. In at least one embodiment, other arguments 918 are data comprising information to indicate any other information usable in performing get sub-context from stream API 902 to get a sub-context from a stream.

In at least one embodiment, not shown in FIG. 9, a processor performs one or more instructions to perform one or more APIs such as get sub-context from stream API 902 to perform an application programming interface (API) to cause one or more identifiers of one or more data structures indicating a number of one or more streaming multiprocessors (SMs) of one or more processors to be stored using one or more arguments including, but not limited to, stream 904, sub-context return 906, and/or other arguments 918. In at least one embodiment, not shown in FIG. 9, a processor performs one or more instructions to perform one or more APIs such as get sub-context from stream API 902 to perform an application programming interface (API) to indicate one or more identifiers of one or more masks, wherein the one or more masks indicate one or more subsets of streaming multiprocessors of one or more graphics processing units (GPUs) usable to perform one or more kernels using one or more arguments including, but not limited to, stream 904, sub-context return 906, and/or other arguments 918.

In at least one embodiment, get sub-context from stream API 902, if invoked, causes one or more APIs such as one or more APIs 306, described herein at least in connection with FIG. 3, to add one or more operations or instructions to be added, inserted, or otherwise included in a stream or set of instructions to be performed by one or more accelerators within a heterogenous processor. In at least one embodiment, get sub-context from stream API 902, if invoked, causes one or more APIs such as one or more APIs 306 to, in a parallel computing environment such as parallel computing environment 308, described herein at least in connection with FIG. 3, add one or more operations or instructions to be added, inserted, or otherwise included in a stream or set of instructions to be performed by one or more accelerators within a heterogenous processor.

In at least one embodiment, in response to get sub-context from stream API 902, one or more APIs 306, if performed, are to cause one or more processors to perform a get sub-context from stream API return 920. In at least one embodiment, get sub-context from stream API return 920 is a set of instructions that, if performed, generate and/or indicate one or more data values in response to get sub-context from stream API 902. In at least one embodiment, get sub-context from stream API return 920 indicates a success indicator 922. In at least one embodiment, success indicator 922 is data comprising any value to indicate success of get sub-context from stream API 902. In at least one embodiment, success indicator 922 comprises information indicating one or more specific types of successes generated as a result of performing get sub-context from stream API 902. In at least one embodiment, success indicator 922 comprises information indicating one or more other data values generated as a result of get sub-context from stream API 902.

In at least one embodiment, get sub-context from stream API return 920 indicates an error indicator 924. In at least one embodiment, error indicator 924 is data comprising any value to indicate failure of get sub-context from stream API 902. In at least one embodiment, error indicator 924 comprises information indicating one or more specific types of errors generated as a result of performing get sub-context from stream API 902. In at least one embodiment, error indicator 924 comprises information indicating one or more other data values generated as a result of get sub-context from stream API 902.

In at least one embodiment, parallel computing environment 308 comprising one or more APIs 306 including, but not limited to, get sub-context from stream API 902 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, one or more operations to indicate submission of an operation to an external device use software code such as example software code indicating stream operations as described herein at least in connection with FIG. 5.

In at least one embodiment, parallel computing environment 308 comprising one or more APIs 306 including, but not limited to, get sub-context from stream API 902 comprises one or more function signatures usable to indicate one or more callback functions for operations to be performed by one or more accelerators within heterogeneous processors. In at least one embodiment, one or more operations cause one or more callback functions to be performed. In at least one embodiment, one or more operations to cause one or more callback functions to be performed use software code such as example software code indicating a function signature for a callback function as described herein at least in connection with FIG. 5.

In at least one embodiment, in order to specify one or more accelerators within heterogeneous processors to perform one or more operations indicated by get sub-context from stream API 902 to one or more APIs 306, one or more data structures of one or more APIs 306 are usable to specify one or more external devices for which said one or more APIs 306 are to submit said one or more operations. In at least one embodiment, one or more data structures of one or more APIs 306 usable to specify one or more external devices for which said one or more APIs 306 are to submit said one or more operations use software code such as example software code indicating a data structure representing a device node for one or more accelerators within heterogeneous processors as described herein at least in connection with FIG. 5.

In at least one embodiment, in order to specify type and data of one or more operations indicated by one or more operations to be performed by one or more accelerators within heterogeneous processors, one or more data structures of one or more APIs 306 are to be used. In at least one embodiment, one or more data structures of one or more APIs 306 used to specify type and data of one or more operations indicated by one or more operations to be performed by one or more accelerators within heterogeneous processors use software code such as example software code indicating a data structure to specify type and data of one or more operations to be performed by one or more accelerators within heterogeneous processors as described herein at least in connection with FIG. 5.

In at least one embodiment, one or more APIs 306 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to get sub-context from stream API 902, as described above. In at least one embodiment, instructions to cause one or more operations or instructions to be added to a stream or other set of instructions to be performed in response to get sub-context from stream API 902 use software code such as example software code indicating a stream operation API call in parallel computing environment 308 as described herein at least in connection with FIG. 5.

In at least one embodiment, one or more APIs 306 comprise instructions that, if performed, cause one or more operations or instructions to be performed by one or more accelerators within heterogeneous processors to be added to one or more executable graphs. In at least one embodiment, instructions that, if performed, cause one or more operations or instructions to be performed by one or more accelerators within heterogeneous processors to be added to one or more executable graphs are similar to how one or more operations or instructions to be performed by one or more accelerators within heterogeneous processors are to be added to one or more streams or sets of instructions in response to get sub-context from stream API 902, as described herein. In at least one embodiment, instructions that, if performed, cause one or more operations or instructions to be performed by one or more accelerators within heterogeneous processors to be added to one or more executable graphs use software code such as example software code indicating addition of one or more operations or instructions to one or more executable graphs by one or more APIs 306 of parallel computing environment 308 as described herein at least in connection with FIG. 5.

FIG. 10 is a block diagram 1000 illustrating a process to perform an application programming interface (API) to get a sub-context from a stream, in accordance with at least one embodiment. In at least one embodiment, said process to perform an API to get a sub-context from a stream illustrated in block diagram 1000 is a process to perform get sub-context from stream API 902, described herein at least in connection with FIG. 9. In at least one embodiment, some or all of said process to perform an API to get a sub-context from a stream illustrated in block diagram 1000 (or any other processes described herein, or variations and/or combinations thereof) is performed under control of one or more computer systems, servers, processors, integrated circuits, and/or other such device as described in connection with FIGS. 26-58, configured with computer-executable instructions and is implemented as code (e.g., computer-executable instructions, one or more computer programs, or one or more applications) executing collectively on one or more processors, by hardware, software, or combinations thereof. In at least one embodiment, said code is stored on a computer-readable storage medium in form of a computer program comprising a plurality of computer-readable instructions executable by one or more processors such as those described herein. In at least one embodiment, a computer-readable storage medium is a non-transitory computer-readable medium. In at least one embodiment, a processor such as processor 110, described herein at least in connection with FIG. 1, performs one or more steps of said process to perform an API to get a sub-context from a stream illustrated in block diagram 1000. In at least one embodiment, one or more other processors such as those described herein perform one or more steps of said process to perform an API to get a sub-context from a stream illustrated in block diagram 1000.

In at least one embodiment, at step 1002 of said process to perform an API to get a sub-context from a stream illustrated in block diagram 1000, a processor performing said process performs one or more operations to receive or otherwise obtain an API to get a sub-context from a stream. In at least one embodiment, at step 1002, an API to get a sub-context from a stream is received by otherwise provided to a processor such as processor 110, described herein at least in connection with FIG. 1. In at least one embodiment, at step 1002, an API to get a sub-context from a stream is received from otherwise provided by a processor such as processor 102, described herein at least in connection with FIG. 1. In at least one embodiment, at step 1002, an API to get a sub-context from a stream includes one or more arguments such as those described herein at least in connection with FIG. 9. In at least one embodiment, after step 1002, said process to perform an API to get a sub-context from a stream illustrated in block diagram 1000 continues at step 1004.

In at least one embodiment, at step 1004 of said process to perform an API to get a sub-context from a stream illustrated in block diagram 1000, a processor performing said process performs one or more operations to determine whether an API to get a sub-context from a stream (e.g., received at step 1002) is valid. In at least one embodiment, at step 1004, operations to determine whether an API to get a sub-context from a stream is valid comprise operations to verify validity of arguments of said API to get a sub-context from a stream (e.g., arguments described herein at least in connection with FIG. 9). In at least one embodiment, at step 1004, if it is determined that an API to get a sub-context from a stream is valid (“YES” branch), said process to perform an API to get a sub-context from a stream illustrated in block diagram 1000 continues at step 1006. In at least one embodiment, at step 1004, if it is determined that an API to get a sub-context from a stream is not valid (“NO” branch), said process to perform an API to get a sub-context from a stream illustrated in block diagram 1000 continues at step 1014, described below.

In at least one embodiment, at step 1006 of said process to perform an API to get a sub-context from a stream illustrated in block diagram 1000, a processor performing said process performs one or more operations to identify a sub-context from a stream (e.g., a stream indicated by an argument to an API to get a sub-context from a stream). In at least one embodiment, a sub-context maintains a list of streams associated with said context. In at least one embodiment, each stream maintains a list of a sub-context associated with said stream. In at least one embodiment, after step 1006, said process to perform an API to get a sub-context from a stream illustrated in block diagram 1000 continues at step 1008.

In at least one embodiment, at step 1008 of said process to perform an API to get a sub-context from a stream illustrated in block diagram 1000, a processor performing said process performs one or more operations to determine whether a sub-context was identified (e.g., at step 1006). In at least one embodiment, at step 1008, if it is determined that a sub-context was identified (“YES” branch), said process to perform an API to get a sub-context from a stream illustrated in block diagram 1000 continues at step 1010 In at least one embodiment, at step 1008, if it is determined that a sub-context was not identified (“NO” branch), said process to perform an API to get a sub-context from a stream illustrated in block diagram 1000 continues at step 1014, described below.

In at least one embodiment, at step 1010 of said process to perform an API to get a sub-context from a stream illustrated in block diagram 1000, a processor performing said process performs one or more operations to store an identified sub-context (e.g., identified at step 1006) in a storage location indicated by an API get a sub-context from a stream (e.g., received as an argument to said API to get a sub-context from a stream, received at step 1002). In at least one embodiment, after step 1010, said process to perform an API to get a sub-context from a stream illustrated in block diagram 1000 continues at step 1012.

In at least one embodiment, at step 1012 of said process to perform an API to get a sub-context from a stream illustrated in block diagram 1000, a processor performing said process performs one or more operations to return a success indicator (e.g., a success indicator 922, described herein at least in connection with FIG. 9). In at least one embodiment, at step 1012, a success indicator is returned to a calling process (e.g., a process performed by a processor such as processor 102, described herein at least in connection with FIG. 1). In at least one embodiment, after step 1012, said process to perform an API to get a sub-context from a stream illustrated in block diagram 1000 terminates. In at least one embodiment, not shown in FIG. 6, after step 1012, said process to perform an API to get a sub-context from a stream illustrated in block diagram 1000 continues at step 1002, described above.

In at least one embodiment, at step 1014 of said process to perform an API to get a sub-context from a stream illustrated in block diagram 1000, a processor performing said process performs one or more operations to return an error indicator (e.g., an error indicator 924, described herein at least in connection with FIG. 9). In at least one embodiment, at step 1014, an error indicator is returned to a calling process (e.g., a process performed by a processor such as processor 102, described herein at least in connection with FIG. 1). In at least one embodiment, after step 1014, said process to perform an API to get a sub-context from a stream illustrated in block diagram 1000 terminates. In at least one embodiment, not shown in FIG. 10, after step 1014, said process to perform an API to get a sub-context from a stream illustrated in block diagram 1000 continues at step 1002, described above.

In at least one embodiment, operations of said process to perform an API to get a sub-context from a stream illustrated in block diagram 1000 are performed in a different order than is illustrated in FIG. 1000. In at least one embodiment, operations of said process to perform an API to get a sub-context from a stream illustrated in block diagram 1000 are performed simultaneously or in parallel. In at least one embodiment, operations of said process to perform an API to get a sub-context from a stream illustrated in block diagram 1000 that do not depend on each other (e.g., are order independent) are performed simultaneously or in parallel. In at least one embodiment, operations of said process to perform an API to get a sub-context from a stream illustrated in block diagram 1000 are performed by a plurality of threads executing on a processor such as those described herein.

In at least one embodiment, one or more processors (e.g., processor 102, processor 110, and/or other processors and/or accelerators such as those described herein) comprise one or more circuits to perform operations and/or instructions described herein in connection with FIGS. 9 and 10, such as one or more circuits to perform an application programming interface (API) to cause one or more identifiers of one or more data structures indicating a number of one or more streaming multiprocessors (SMs) of one or more processors to be stored and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIGS. 9 and 10, such as one or more circuits to perform an application programming interface (API) to indicate one or more identifiers of one or more masks, wherein the one or more masks indicate one or more subsets of streaming multiprocessors of one or more graphics processing units (GPUs) usable to perform one or more kernels and/or otherwise perform operations described herein. In at least one embodiment, operations and/or instructions described herein in connection with FIGS. 9 and 10 are included in and/or otherwise include systems, methods, operations, and/or instructions described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, components described herein in connection with FIGS. 9 and 10 perform one or more processes described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, not shown in FIGS. 9 and 10, one or more components described herein in connection with FIGS. 9 and 10 include one or more components described herein in connection with FIGS. 26-58 to perform an application programming interface (API) to cause one or more identifiers of one or more data structures indicating a number of one or more streaming multiprocessors (SMs) of one or more processors to be stored and/or otherwise perform operations described herein.

FIG. 11 is a block diagram 1100 illustrating an application programming interface (API) to get resources associated with a context, in accordance with at least one embodiment. In at least one embodiment, one or more circuits of a processor are to perform a get context resource API 1102, to get resources associated with a context. In at least one embodiment, not shown in FIG. 11, one or more circuits of a processor such as those described herein performs one or more instructions to perform get context resource API 1102 to perform an application programming interface (API) to indicate one or more streaming multiprocessors (SMs) of one or more processors available to be used to perform one or more software threads. In at least one embodiment, not shown in FIG. 11, one or more circuits of a processor such as those described herein performs one or more instructions to perform get context resource API 1102 to perform an application programming interface (API) to indicate one or more streaming multiprocessors (SMs) of one or more graphics processing units (GPUs) available to be used to perform one or more software kernels. In at least one embodiment, also not shown in FIG. 11, one or more circuits of a processor such as those described herein performs one or more instructions to perform get context resource API 1102 to perform an application programming interface (API) to indicate one or more streaming multiprocessors (SMs) of one or more processors available to be used to perform one or more software threads in response to receiving a second API such as those described herein.

In at least one embodiment, get context resource API 1102 receives, when invoked, one or more arguments to indicate information about operations to be performed using techniques such as those described herein. In at least one embodiment, get context resource API 1102 receives, when invoked, one or more arguments to indicate information about instructions to be performed using techniques such as those described herein.

In at least one embodiment, get context resource API 1102 receives, as input, one or more arguments comprising a resource return 1104. In at least one embodiment, resource return 1104 is a data value comprising information usable to identify, indicate, or otherwise specify a storage location to store resources (e.g., a resource descriptor) associated with a context using get context resource API 1102. In at least one embodiment, a storage location to store resources identified, indicated, or otherwise specified by resource return 1104 is one of a plurality of parameters usable by get context resource API 1102 to get resources associated with a context. In at least one embodiment, resource return 1104 is a data value to identify, indicate, or otherwise specify to an API such as get context resource API 1102, a set of operations or instructions to be performed by one or more PPUs, such as GPUs, and/or one or more accelerators within a heterogeneous processor, as described herein.

In at least one embodiment, get context resource API 1102 receives, as input, one or more arguments comprising a context 1106. In at least one embodiment, context 1106 is a data value comprising information usable to identify, indicate, or otherwise specify a context or sub-context from which a set of resources can be identified and returned using get context resource API 1102. In at least one embodiment, a context or sub-context identified, indicated, or otherwise specified by context 1106 is one of a plurality of parameters usable by get context resource API 1102 to get resources associated with a context. In at least one embodiment, context 1106 is a data value to identify, indicate, or otherwise specify to an API such as get context resource API 1102, a set of operations or instructions to be performed by one or more PPUs, such as GPUs, and/or one or more accelerators within a heterogeneous processor, as described herein.

In at least one embodiment, get context resource API 1102 receives, as input, one or more arguments comprising one or more other arguments 1118. In at least one embodiment, other arguments 1118 are data comprising information to indicate any other information usable in performing get context resource API 1102 to get resources associated with a context.

In at least one embodiment, not shown in FIG. 11, a processor performs one or more instructions to perform one or more APIs such as get context resource API 1102 to perform an application programming interface (API) to indicate one or more streaming multiprocessors (SMs) of one or more processors available to be used to perform one or more software threads using one or more arguments including, but not limited to, resource return 1104, context 1106, and/or other arguments 1118. In at least one embodiment, not shown in FIG. 11, a processor performs one or more instructions to perform one or more APIs such as get context resource API 1102 to perform an application programming interface (API) to indicate one or more streaming multiprocessors (SMs) of one or more graphics processing units (GPUs) available to be used to perform one or more software kernels using one or more arguments including, but not limited to, resource return 1104, context 1106, and/or other arguments 1118.

In at least one embodiment, get context resource API 1102, if invoked, causes one or more APIs such as one or more APIs 306, described herein at least in connection with FIG. 3, to add one or more operations or instructions to be added, inserted, or otherwise included in a stream or set of instructions to be performed by one or more accelerators within a heterogenous processor. In at least one embodiment, get context resource API 1102, if invoked, causes one or more APIs such as one or more APIs 306 to, in a parallel computing environment such as parallel computing environment 308, described herein at least in connection with FIG. 3, add one or more operations or instructions to be added, inserted, or otherwise included in a stream or set of instructions to be performed by one or more accelerators within a heterogenous processor.

In at least one embodiment, in response to get context resource API 1102, one or more APIs 306, if performed, are to cause one or more processors to perform a get context resource API return 1120. In at least one embodiment, get context resource API return 1120 is a set of instructions that, if performed, generate and/or indicate one or more data values in response to get context resource API 1102. In at least one embodiment, get context resource API return 1120 indicates a success indicator 1122. In at least one embodiment, success indicator 1122 is data comprising any value to indicate success of get context resource API 1102. In at least one embodiment, success indicator 1122 comprises information indicating one or more specific types of successes generated as a result of performing get context resource API 1102. In at least one embodiment, success indicator 1122 comprises information indicating one or more other data values generated as a result of get context resource API 1102.

In at least one embodiment, get context resource API return 1120 indicates an error indicator 1124. In at least one embodiment, error indicator 1124 is data comprising any value to indicate failure of get context resource API 1102. In at least one embodiment, error indicator 1124 comprises information indicating one or more specific types of errors generated as a result of performing get context resource API 1102. In at least one embodiment, error indicator 1124 comprises information indicating one or more other data values generated as a result of get context resource API 1102.

In at least one embodiment, parallel computing environment 308 comprising one or more APIs 306 including, but not limited to, get context resource API 1102 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, one or more operations to indicate submission of an operation to an external device use software code such as example software code indicating stream operations as described herein at least in connection with FIG. 5.

In at least one embodiment, parallel computing environment 308 comprising one or more APIs 306 including, but not limited to, get context resource API 1102 comprises one or more function signatures usable to indicate one or more callback functions for operations to be performed by one or more accelerators within heterogeneous processors. In at least one embodiment, one or more operations cause one or more callback functions to be performed. In at least one embodiment, one or more operations to cause one or more callback functions to be performed use software code such as example software code indicating a function signature for a callback function as described herein at least in connection with FIG. 5.

In at least one embodiment, in order to specify one or more accelerators within heterogeneous processors to perform one or more operations indicated by get context resource API 1102 to one or more APIs 306, one or more data structures of one or more APIs 306 are usable to specify one or more external devices for which said one or more APIs 306 are to submit said one or more operations. In at least one embodiment, one or more data structures of one or more APIs 306 usable to specify one or more external devices for which said one or more APIs 306 are to submit said one or more operations use software code such as example software code indicating a data structure representing a device node for one or more accelerators within heterogeneous processors as described herein at least in connection with FIG. 5.

In at least one embodiment, in order to specify type and data of one or more operations indicated by one or more operations to be performed by one or more accelerators within heterogeneous processors, one or more data structures of one or more APIs 306 are to be used. In at least one embodiment, one or more data structures of one or more APIs 306 used to specify type and data of one or more operations indicated by one or more operations to be performed by one or more accelerators within heterogeneous processors use software code such as example software code indicating a data structure to specify type and data of one or more operations to be performed by one or more accelerators within heterogeneous processors as described herein at least in connection with FIG. 5.

In at least one embodiment, one or more APIs 306 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to get context resource API 1102, as described above. In at least one embodiment, instructions to cause one or more operations or instructions to be added to a stream or other set of instructions to be performed in response to get context resource API 1102 use software code such as example software code indicating a stream operation API call in parallel computing environment 308 as described herein at least in connection with FIG. 5.

In at least one embodiment, one or more APIs 306 comprise instructions that, if performed, cause one or more operations or instructions to be performed by one or more accelerators within heterogeneous processors to be added to one or more executable graphs. In at least one embodiment, instructions that, if performed, cause one or more operations or instructions to be performed by one or more accelerators within heterogeneous processors to be added to one or more executable graphs are similar to how one or more operations or instructions to be performed by one or more accelerators within heterogeneous processors are to be added to one or more streams or sets of instructions in response to get context resource API 1102, as described herein. In at least one embodiment, instructions that, if performed, cause one or more operations or instructions to be performed by one or more accelerators within heterogeneous processors to be added to one or more executable graphs use software code such as example software code indicating addition of one or more operations or instructions to one or more executable graphs by one or more APIs 306 of parallel computing environment 308 as described herein at least in connection with FIG. 5.

FIG. 12 is a block diagram 1200 illustrating a process to perform an application programming interface (API) to get resources associated with a context, in accordance with at least one embodiment. In at least one embodiment, said process to perform an API to get resources associated with a context illustrated in block diagram 1200 is a process to perform get context resource API 1102, described herein at least in connection with FIG. 11. In at least one embodiment, some or all of said process to perform an API to get resources associated with a context illustrated in block diagram 1200 (or any other processes described herein, or variations and/or combinations thereof) is performed under control of one or more computer systems, servers, processors, integrated circuits, and/or other such device as described in connection with FIGS. 26-58, configured with computer-executable instructions and is implemented as code (e.g., computer-executable instructions, one or more computer programs, or one or more applications) executing collectively on one or more processors, by hardware, software, or combinations thereof. In at least one embodiment, said code is stored on a computer-readable storage medium in form of a computer program comprising a plurality of computer-readable instructions executable by one or more processors such as those described herein. In at least one embodiment, a computer-readable storage medium is a non-transitory computer-readable medium. In at least one embodiment, a processor such as processor 110, described herein at least in connection with FIG. 1, performs one or more steps of said process to perform an API to get resources associated with a context illustrated in block diagram 1200. In at least one embodiment, one or more other processors such as those described herein perform one or more steps of said process to perform an API to get resources associated with a context illustrated in block diagram 1200.

In at least one embodiment, at step 1202 of said process to perform an API to get resources associated with a context illustrated in block diagram 1200, a processor performing said process performs one or more operations to receive or otherwise obtain an API to get resources associated with a context. In at least one embodiment, at step 1202, an API to get resources associated with a context is received by otherwise provided to a processor such as processor 110, described herein at least in connection with FIG. 1. In at least one embodiment, at step 1202, an API to get resources associated with a context is received from otherwise provided by a processor such as processor 102, described herein at least in connection with FIG. 1. In at least one embodiment, at step 1202, an API to get resources associated with a context includes one or more arguments such as those described herein at least in connection with FIG. 11. In at least one embodiment, after step 1202, said process to perform an API to get resources associated with a context illustrated in block diagram 1200 continues at step 1204.

In at least one embodiment, at step 1204 of said process to perform an API to get resources associated with a context illustrated in block diagram 1200 a processor performing said process performs one or more operations to determine whether an API to get resources associated with a context (e.g., received at step 1202) is valid. In at least one embodiment, at step 1204, operations to determine whether an API to get resources associated with a context is valid comprise operations to verify validity of arguments of said API to get resources associated with a context (e.g., arguments described herein at least in connection with FIG. 11). In at least one embodiment, at step 1204, if it is determined that an API to get resources associated with a context is valid (“YES” branch), said process to perform an API to get resources associated with a context illustrated in block diagram 1200 continues at step 1206. In at least one embodiment, at step 1204, if it is determined that an API to get resources associated with a context is not valid (“NO” branch), said process to perform an API to get resources associated with a context illustrated in block diagram 1200 continues at step 1214, described below.

In at least one embodiment, at step 1206 of said process to perform an API to get resources associated with a context illustrated in block diagram 1200, a processor performing said process performs one or more operations to determine a request type of an API to get resources associated with a context (e.g., received at step 1202). In at least one embodiment, a request type can be to get resources associated with a context. In at least one embodiment, a request type can be to get resources associated with a sub-context. In at least one embodiment, a request type can be to get resources associated with a device. In at least one embodiment, a request type is received as an argument to an API to get resources associated with a context (e.g., received at step 1202). In at least one embodiment, after step 1206, said process to perform an API to get resources associated with a context illustrated in block diagram 1200 continues at step 1208.

In at least one embodiment, at step 1208 of said process to perform an API to get resources associated with a context illustrated in block diagram 1200, a processor performing said process performs one or more operations to determine whether a request type (e.g., determined at step 1206) is to get resources associated with a context. In at least one embodiment, at step 1208, if it is determined that a request type is to get resources associated with a context (“YES” branch), said process to perform an API to get resources associated with a context illustrated in block diagram 1200 continues at step 1216. In at least one embodiment, at step 1208, if it is determined that if it is determined that a request type is not to get resources associated with a context (“NO” branch), said process to perform an API to get resources associated with a context illustrated in block diagram 1200 continues at step 1210.

In at least one embodiment, at step 1210 of said process to perform an API to get resources associated with a context illustrated in block diagram 1200, a processor performing said process performs one or more operations to determine a request type (e.g., determined at step 1206) is to get resources associated with a sub-context. In at least one embodiment, at step 1210, if it is determined that if it is determined that a request type is to get resources associated with a sub-context (“YES” branch), said process to perform an API to get resources associated with a context illustrated in block diagram 1200 continues at step 1222. In at least one embodiment, at step 1210, if it is determined that if it is determined that a request type is not to get resources associated with a sub-context (“NO” branch), said process to perform an API to get resources associated with a context illustrated in block diagram 1200 continues at step 1212.

In at least one embodiment, at step 1212 of said process to perform an API to get resources associated with a context illustrated in block diagram 1200, a processor performing said process performs one or more operations to determine whether a request type (e.g., determined at step 1206) is to get resources associated with a device. In at least one embodiment, at step 1212, if it is determined that if it is determined that a request type is to get resources associated with a device (“YES” branch), said process to perform an API to get resources associated with a context illustrated in block diagram 1200 continues at step 1228. In at least one embodiment, at step 1212, if it is determined that if it is determined that if it is determined that a request type is not to get resources associated with a device (“NO” branch), said process to perform an API to get resources associated with a context illustrated in block diagram 1200 continues at step 1214.

In at least one embodiment, at step 1214 of said process to perform an API to get resources associated with a context illustrated in block diagram 1200, a processor performing said process performs one or more operations to return an error indicator (e.g., an error indicator 1124, described herein at least in connection with FIG. 11). In at least one embodiment, at step 1214, an error indicator is returned to a calling process (e.g., a process performed by a processor such as processor 102, described herein at least in connection with FIG. 1). In at least one embodiment, after step 1214, said process to perform an API to get resources associated with a context illustrated in block diagram 1200 terminates. In at least one embodiment, not shown in FIG. 12, after step 614, said process to perform an API to get resources associated with a context illustrated in block diagram 1200 continues at step 1202, described above.

In at least one embodiment, at step 1216 of said process to perform an API to get resources associated with a context illustrated in block diagram 1200, a processor performing said process performs one or more operations to identify a context (e.g., a context received as an argument to an API to get resources associated with a context received at step 1202) using systems, methods, and operations described herein. In at least one embodiment, after step 1216, said process to perform an API to get resources associated with a context illustrated in block diagram 1200 continues at step 1218.

In at least one embodiment, at step 1218 of said process to perform an API to get resources associated with a context illustrated in block diagram 1200, a processor performing said process performs one or more operations to determine whether a context was identified (e.g., at step 1216). In at least one embodiment, at step 1218, if it is determined that a context was identified (“YES” branch), said process to perform an API to get resources associated with a context illustrated in block diagram 1200 continues at step 1220. In at least one embodiment, at step 1204, if it is determined that a context was not identified (“NO” branch), said process to perform an API to get resources associated with a context illustrated in block diagram 1200 continues at step 1214, described above.

In at least one embodiment, at step 1220 of said process to perform an API to get resources associated with a context illustrated in block diagram 1200, a processor performing said process performs one or more operations to store an identified context (e.g., identified at step 1216). In at least one embodiment, at step 1220, a processor performs one or more operations to store an identified context in a storage location received as an argument to an API to get resources associated with a context (e.g., received at step 1202). In at least one embodiment, after step 1220, said process to perform an API to get resources associated with a context illustrated in block diagram 1200 continues at step 1230.

In at least one embodiment, at step 1222 of said process to perform an API to get resources associated with a context illustrated in block diagram 1200, a processor performing said process performs one or more operations to identify a sub-context (e.g., a sub-context received as an argument to an API to get resources associated with a context received at step 1202), as described herein. In at least one embodiment, after step 1222, said process to perform an API to get resources associated with a context illustrated in block diagram 1200 continues at step 1224.

In at least one embodiment, at step 1224 of said process to perform an API to get resources associated with a context illustrated in block diagram 1200, a processor performing said process performs one or more operations to determine whether a sub-context was identified (e.g., at step 1222). In at least one embodiment, at step 1224, if it is determined that a sub-context was identified (“YES” branch), said process to perform an API to get resources associated with a context illustrated in block diagram 1200 continues at step 1226. In at least one embodiment, at step 1224, if it is determined that a sub-context was not identified (“NO” branch), said process to perform an API to get resources associated with a context illustrated in block diagram 1200 continues at step 1214, described above.

In at least one embodiment, at step 1226 of said process to perform an API to get resources associated with a context illustrated in block diagram 1200, a processor performing said process performs one or more operations to store an identified sub-context (e.g., identified at step 1222). In at least one embodiment, at step 1226, a processor performs one or more operations to store an identified sub-context in a storage location received as an argument to an API to get resources associated with a context (e.g., received at step 1202). In at least one embodiment, after step 1226, said process to perform an API to get resources associated with a context illustrated in block diagram 1200 continues at step 1230.

In at least one embodiment, at step 1228 of said process to perform an API to get resources associated with a context illustrated in block diagram 1200 a processor performing said process performs one or more operations to store a device context (e.g., a primary or current context of a device such as device 202, described herein at least in connection with FIG. 2). In at least one embodiment, at step 1228, a processor performs one or more operations to store a device context in a storage location received as an argument to an API to get resources associated with a context (e.g., received at step 1202). In at least one embodiment, at step 1228, a device context stored is a primary, default, or current context of a device. In at least one embodiment, after step 1228, said process to perform an API to get resources associated with a context illustrated in block diagram 1200 continues at step 1230.

In at least one embodiment, at step 1230 of said process to perform an API to get resources associated with a context illustrated in block diagram 1200, a processor performing said process performs one or more operations to return a success indicator (e.g., a success indicator 1122, described herein at least in connection with FIG. 11). In at least one embodiment, at step 1230, a success indicator is returned to a calling process (e.g., a process performed by a processor such as processor 102, described herein at least in connection with FIG. 1). In at least one embodiment, after step 1230, said process to perform an API to get resources associated with a context illustrated in block diagram 1200 terminates. In at least one embodiment, not shown in FIG. 12, after step 1230, said process to perform an API to get resources associated with a context illustrated in block diagram 1200 continues at step 1202, described above.

In at least one embodiment, operations of said process to perform an API to get resources associated with a context illustrated in block diagram 1200 are performed in a different order than is illustrated in FIG. 1200. In at least one embodiment, operations of said process to perform an API to get resources associated with a context illustrated in block diagram 1200 are performed simultaneously or in parallel. In at least one embodiment, operations of said process to perform an API to get resources associated with a context illustrated in block diagram 1200 that do not depend on each other (e.g., are order independent) are performed simultaneously or in parallel. In at least one embodiment, operations of said process to perform an API to get resources associated with a context illustrated in block diagram 1200 are performed by a plurality of threads executing on a processor such as those described herein.

In at least one embodiment, one or more processors (e.g., processor 102, processor 110, and/or other processors and/or accelerators such as those described herein) comprise one or more circuits to perform operations and/or instructions described herein in connection with FIGS. 11 and 12, such as one or more circuits to perform an application programming interface (API) to indicate one or more streaming multiprocessors (SMs) of one or more processors available to be used to perform one or more software threads and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIGS. 11 and 12, such as one or more circuits to perform an application programming interface (API) to indicate one or more streaming multiprocessors (SMs) of one or more graphics processing units (GPUs) available to be used to perform one or more software kernels and/or otherwise perform operations described herein. In at least one embodiment, operations and/or instructions described herein in connection with FIGS. 11 and 12 are included in and/or otherwise include systems, methods, operations, and/or instructions described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, components described herein in connection with FIGS. 11 and 12 perform one or more processes described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, not shown in FIGS. 11 and 12, one or more components described herein in connection with FIGS. 11 and 12 include one or more components described herein in connection with FIGS. 26-58FIGS. 26-58 to perform an application programming interface (API) to indicate one or more streaming multiprocessors (SMs) of one or more processors available to be used to perform one or more software threads and/or otherwise perform operations described herein.

FIG. 13 is a block diagram 1300 illustrating an application programming interface (API) to subdivide context resources, in accordance with at least one embodiment. In at least one embodiment, one or more circuits of a processor are to perform a subdivide context resources API 1302, to subdivide context resources according to one or more received subdivision criteria. In at least one embodiment, not shown in FIG. 13, one or more circuits of a processor such as those described herein performs one or more instructions to perform subdivide context resources API 1302 to perform an application programming interface (API) to cause a plurality of identifiers of a corresponding plurality of streaming multiprocessors (SMs) of one or more processors to be stored according to a plurality of groups, in which the corresponding plurality of SMs are to be used. In at least one embodiment, not shown in FIG. 13, one or more circuits of a processor such as those described herein performs one or more instructions to perform subdivide context resources API 1302 to perform an application programming interface (API) to generate an indication of one or more subsets of streaming multiprocessors (SMs) of a processor to be available to be used to perform one or more software kernels. In at least one embodiment, also not shown in FIG. 13, one or more circuits of a processor such as those described herein performs one or more instructions to perform subdivide context resources API 1302 to perform an application programming interface (API) to cause a plurality of identifiers of a corresponding plurality of streaming multiprocessors (SMs) of one or more processors to be stored according to a plurality of groups, in which the corresponding plurality of SMs are to be used in response to receiving a second API such as those described herein.

In at least one embodiment, subdivide context resources API 1302 receives, when invoked, one or more arguments to indicate information about operations to be performed using techniques such as those described herein. In at least one embodiment, subdivide context resources API 1302 receives, when invoked, one or more arguments to indicate information about instructions to be performed using techniques such as those described herein.

In at least one embodiment, subdivide context resources API 1302 receives, as input, one or more arguments comprising a subdivided resource list return 1304. In at least one embodiment, subdivided resource list return 1304 is a data value comprising information usable to identify, indicate, or otherwise specify a storage location to which a subdivided resource list is to be stored as a result of using subdivide context resources API 1302. In at least one embodiment, a subdivided resource list return identified, indicated, or otherwise specified by subdivided resource list return 1304 is one of a plurality of parameters usable by subdivide context resources API 1302 to subdivide context resources. In at least one embodiment, subdivided resource list return 1304 is a data value to identify, indicate, or otherwise specify to an API such as subdivide context resources API 1302, a set of operations or instructions to be performed by one or more PPUs, such as GPUs, and/or one or more accelerators within a heterogeneous processor, as described herein.

In at least one embodiment, subdivide context resources API 1302 receives, as input, one or more arguments comprising a remaining resource list return 1306. In at least one embodiment, remaining resource list return 1306 is a data value comprising information usable to a storage location to which a remaining resource list (e.g., a list resources remaining after subdivision) is to be stored as a result of using subdivide context resources API 1302. In at least one embodiment, a remaining resource list return identified, indicated, or otherwise specified by remaining resource list return 1306 is one of a plurality of parameters usable by subdivide context resources API 1302 to subdivide context resources. In at least one embodiment, remaining resource list return 1306 is a data value to identify, indicate, or otherwise specify to an API such as subdivide context resources API 1302, a set of operations or instructions to be performed by one or more PPUs, such as GPUs, and/or one or more accelerators within a heterogeneous processor, as described herein.

In at least one embodiment, subdivide context resources API 1302 receives, as input, one or more arguments comprising an input resource list 1308. In at least one embodiment, input resource list 1308 is a data value comprising information usable to identify, indicate, or otherwise specify an list of resources to be subdivided using subdivide context resources API 1302. In at least one embodiment, an input resource list identified, indicated, or otherwise specified by input resource list 1308 is one of a plurality of parameters usable by subdivide context resources API 1302 to subdivide context resources. In at least one embodiment, input resource list 1308 is a data value to identify, indicate, or otherwise specify to an API such as subdivide context resources API 1302, a set of operations or instructions to be performed by one or more PPUs, such as GPUs, and/or one or more accelerators within a heterogeneous processor, as described herein.

In at least one embodiment, subdivide context resources API 1302 receives, as input, one or more arguments comprising flags 1310. In at least one embodiment, flags 1310 is a data value comprising information usable to identify, indicate, or otherwise specify one or more flags at least indicating which resources (e.g., SMs) of input resource list 1308 are to be assigned to a subdivided resource list (e.g., stored in subdivided resource list return 1304) and which are remaining (e.g., stored in remaining resource list return 1306). when using subdivide context resources API 1302. In at least one embodiment, flags identified, indicated, or otherwise specified by flags 1310 is one of a plurality of parameters usable by subdivide context resources API 1302 to subdivide context resources. In at least one embodiment, flags 1310 is a data value to identify, indicate, or otherwise specify to an API such as subdivide context resources API 1302, a set of operations or instructions to be performed by one or more PPUs, such as GPUs, and/or one or more accelerators within a heterogeneous processor, as described herein.

In at least one embodiment, subdivide context resources API 1302 receives, as input, one or more arguments comprising a minimum count 1312. In at least one embodiment, minimum count 1312 is a data value comprising information usable to identify, indicate, or otherwise specify a minimum count (e.g., a smallest or minimum number of subdivided resources in a subdivided resource list) of subdivided resources obtained using subdivide context resources API 1302. In at least one embodiment, a minimum count identified, indicated, or otherwise specified by minimum count 1312 is one of a plurality of parameters usable by subdivide context resources API 1302 to subdivide context resources. In at least one embodiment, minimum count 1312 is a data value to identify, indicate, or otherwise specify to an API such as subdivide context resources API 1302, a set of operations or instructions to be performed by one or more PPUs, such as GPUs, and/or one or more accelerators within a heterogeneous processor, as described herein.

In at least one embodiment, subdivide context resources API 1302 receives, as input, one or more arguments comprising one or more other arguments 1318. In at least one embodiment, other arguments 1318 are data comprising information to indicate any other information usable in performing subdivide context resources API 1302 to subdivide context resources.

In at least one embodiment, not shown in FIG. 13, a processor performs one or more instructions to perform one or more APIs such as subdivide context resources API 1302 to perform an application programming interface (API) to cause a plurality of identifiers of a corresponding plurality of streaming multiprocessors (SMs) of one or more processors to be stored according to a plurality of groups, in which the corresponding plurality of SMs are to be used using one or more arguments including, but not limited to, subdivided resource list return 1304, remaining resource list return 1306, input resource list 1308, flags 1310, minimum count 1312, and/or other arguments 1318. In at least one embodiment, not shown in FIG. 13, a processor performs one or more instructions to perform one or more APIs such as subdivide context resources API 1302 to perform an application programming interface (API) to generate an indication of one or more subsets of streaming multiprocessors (SMs) of a processor to be available to be used to perform one or more software kernels using one or more arguments including, but not limited to, subdivided resource list return 1304, remaining resource list return 1306, input resource list 1308, flags 1310, minimum count 1312, and/or other arguments 1318.

In at least one embodiment, subdivide context resources API 1302, if invoked, causes one or more APIs such as one or more APIs 306, described herein at least in connection with FIG. 3, to add one or more operations or instructions to be added, inserted, or otherwise included in a stream or set of instructions to be performed by one or more accelerators within a heterogenous processor. In at least one embodiment, subdivide context resources API 1302, if invoked, causes one or more APIs such as one or more APIs 306 to, in a parallel computing environment such as parallel computing environment 308, described herein at least in connection with FIG. 3, add one or more operations or instructions to be added, inserted, or otherwise included in a stream or set of instructions to be performed by one or more accelerators within a heterogenous processor.

In at least one embodiment, in response to subdivide context resources API 1302, one or more APIs 306, if performed, are to cause one or more processors to perform a subdivide context resources API return 1320. In at least one embodiment, subdivide context resources API return 1320 is a set of instructions that, if performed, generate and/or indicate one or more data values in response to subdivide context resources API 1302. In at least one embodiment, subdivide context resources API return 1320 indicates a success indicator 1322. In at least one embodiment, success indicator 1322 is data comprising any value to indicate success of subdivide context resources API 1302. In at least one embodiment, success indicator 1322 comprises information indicating one or more specific types of successes generated as a result of performing subdivide context resources API 1302. In at least one embodiment, success indicator 1322 comprises information indicating one or more other data values generated as a result of subdivide context resources API 1302.

In at least one embodiment, subdivide context resources API return 1320 indicates an error indicator 1324. In at least one embodiment, error indicator 1324 is data comprising any value to indicate failure of subdivide context resources API 1302. In at least one embodiment, error indicator 1324 comprises information indicating one or more specific types of errors generated as a result of performing subdivide context resources API 1302. In at least one embodiment, error indicator 1324 comprises information indicating one or more other data values generated as a result of subdivide context resources API 1302.

In at least one embodiment, parallel computing environment 308 comprising one or more APIs 306 including, but not limited to, subdivide context resources API 1302 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, one or more operations to indicate submission of an operation to an external device use software code such as example software code indicating stream operations as described herein at least in connection with FIG. 5.

In at least one embodiment, parallel computing environment 308 comprising one or more APIs 306 including, but not limited to, subdivide context resources API 1302 comprises one or more function signatures usable to indicate one or more callback functions for operations to be performed by one or more accelerators within heterogeneous processors. In at least one embodiment, one or more operations cause one or more callback functions to be performed. In at least one embodiment, one or more operations to cause one or more callback functions to be performed use software code such as example software code indicating a function signature for a callback function as described herein at least in connection with FIG. 5.

In at least one embodiment, in order to specify one or more accelerators within heterogeneous processors to perform one or more operations indicated by subdivide context resources API 1302 to one or more APIs 306, one or more data structures of one or more APIs 306 are usable to specify one or more external devices for which said one or more APIs 306 are to submit said one or more operations. In at least one embodiment, one or more data structures of one or more APIs 306 usable to specify one or more external devices for which said one or more APIs 306 are to submit said one or more operations use software code such as example software code indicating a data structure representing a device node for one or more accelerators within heterogeneous processors as described herein at least in connection with FIG. 5.

In at least one embodiment, in order to specify type and data of one or more operations indicated by one or more operations to be performed by one or more accelerators within heterogeneous processors, one or more data structures of one or more APIs 306 are to be used. In at least one embodiment, one or more data structures of one or more APIs 306 used to specify type and data of one or more operations indicated by one or more operations to be performed by one or more accelerators within heterogeneous processors use software code such as example software code indicating a data structure to specify type and data of one or more operations to be performed by one or more accelerators within heterogeneous processors as described herein at least in connection with FIG. 5.

In at least one embodiment, one or more APIs 306 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to subdivide context resources API 1302, as described above. In at least one embodiment, instructions to cause one or more operations or instructions to be added to a stream or other set of instructions to be performed in response to subdivide context resources API 1302 use software code such as example software code indicating a stream operation API call in parallel computing environment 308 as described herein at least in connection with FIG. 5.

In at least one embodiment, one or more APIs 306 comprise instructions that, if performed, cause one or more operations or instructions to be performed by one or more accelerators within heterogeneous processors to be added to one or more executable graphs. In at least one embodiment, instructions that, if performed, cause one or more operations or instructions to be performed by one or more accelerators within heterogeneous processors to be added to one or more executable graphs are similar to how one or more operations or instructions to be performed by one or more accelerators within heterogeneous processors are to be added to one or more streams or sets of instructions in response to subdivide context resources API 1302, as described herein. In at least one embodiment, instructions that, if performed, cause one or more operations or instructions to be performed by one or more accelerators within heterogeneous processors to be added to one or more executable graphs use software code such as example software code indicating addition of one or more operations or instructions to one or more executable graphs by one or more APIs 306 of parallel computing environment 308 as described herein at least in connection with FIG. 5.

FIG. 14 is a block diagram 1400 illustrating a process to perform an application programming interface (API) to subdivide context resources, in accordance with at least one embodiment. In at least one embodiment, said process to perform an API to subdivide context resources illustrated in block diagram 1400 is a process to perform subdivide context resources API 1302, described herein at least in connection with FIG. 13. In at least one embodiment, some or all of said process to perform an API to subdivide context resources illustrated in block diagram 1400 (or any other processes described herein, or variations and/or combinations thereof) is performed under control of one or more computer systems, servers, processors, integrated circuits, and/or other such device as described in connection with FIGS. 26-58, configured with computer-executable instructions and is implemented as code (e.g., computer-executable instructions, one or more computer programs, or one or more applications) executing collectively on one or more processors, by hardware, software, or combinations thereof. In at least one embodiment, said code is stored on a computer-readable storage medium in form of a computer program comprising a plurality of computer-readable instructions executable by one or more processors such as those described herein. In at least one embodiment, a computer-readable storage medium is a non-transitory computer-readable medium. In at least one embodiment, a processor such as processor 110, described herein at least in connection with FIG. 1, performs one or more steps of said process to perform an API to subdivide context resources illustrated in block diagram 1400. In at least one embodiment, one or more other processors such as those described herein perform one or more steps of said process to perform an API to subdivide context resources illustrated in block diagram 1400.

In at least one embodiment, at step 1402 of said process to perform an API to subdivide context resources illustrated in block diagram 1400, a processor performing said process performs one or more operations to receive or otherwise obtain an API to subdivide context resources In at least one embodiment, at step 1402, an API to subdivide context resources is received by otherwise provided to a processor such as processor 110, described herein at least in connection with FIG. 1. In at least one embodiment, at step 1402, an API to subdivide context resources is received from otherwise provided by a processor such as processor 102, described herein at least in connection with FIG. 1. In at least one embodiment, at step 1402, an API to subdivide context resources includes one or more arguments such as those described herein at least in connection with FIG. 13. In at least one embodiment, after step 1402, said process to perform an API to subdivide context resources] illustrated in block diagram 1400 continues at step 1404.

In at least one embodiment, at step 1404 of said process to perform an API to subdivide context resources illustrated in block diagram 1400, a processor performing said process performs one or more operations to determine whether an API to subdivide context resources (e.g., received at step 1402) is valid. In at least one embodiment, at step 1404, operations to determine whether an API to subdivide context resources is valid comprise operations to verify validity of arguments of said API to subdivide context resources (e.g., arguments described herein at least in connection with FIG. 13). In at least one embodiment, at step 1404, if it is determined that an API to subdivide context resources is valid (“YES” branch), said process to perform an API to subdivide context resources illustrated in block diagram 1400 continues at step 1406. In at least one embodiment, at step 1404, if it is determined that an API to subdivide context resources is not valid (“NO” branch), said process to perform an API to subdivide context resources illustrated in block diagram 1400 continues at step 1418, described below.

In at least one embodiment, at step 1406 of said process to perform an API to subdivide context resources illustrated in block diagram 1400, a processor performing said process performs one or more operations to identify resources in an input resource list (e.g., received as an argument to an API to subdivide context resources received at step 1402), as described herein. In at least one embodiment, after step 1406, said process to perform an API to subdivide context resources illustrated in block diagram 1400 continues at step 1408.

In at least one embodiment, at step 1408 of said process to perform an API to subdivide context resources illustrated in block diagram 1400, a processor performing said process performs one or more operations to subdivide input resources (e.g., identified at step 1406) using flags and/or minimum count (e.g., received as arguments to an API to subdivide context resources received at step 1402). In at least one embodiment, at step 1408, one or more operations to subdivide input resources are performed using an indication of available resources. In at least one embodiment, at step 1408, one or more operations to subdivide input resources are performed to divide said resources into two or more resource lists, as described herein. In at least one embodiment, at step 1408, if an input resource list is not identified at step 1406, step 1408 will not subdivide input resources. In at least one embodiment, after step 1408, said process to perform an API to subdivide context resources illustrated in block diagram 1400 continues at step 1410.

In at least one embodiment, at step 1410 of said process to perform an API to subdivide context resources illustrated in block diagram 1400, a processor performing said process performs one or more operations to determine whether an input resource list was subdivided (e.g., at step 1408). In at least one embodiment, at step 1410, if it is determined that an input resource list was subdivided (“YES” branch), said process to perform an API to subdivide context resources illustrated in block diagram 1400 continues at step 1412. In at least one embodiment, at step 1410, if it is determined that an input resource list was not subdivided (“NO” branch), said process to perform an API to subdivide context resources illustrated in block diagram 1400 continues at step 1418, described below.

In at least one embodiment, at step 1412 of said process to perform an API to subdivide context resources illustrated in block diagram 1400, a processor performing said process performs one or more operations to store a subdivided input resource list (e.g., subdivided at step 1408) in a storage location received as an argument to an API to subdivide context resources received at step 1402. In at least one embodiment, at step 1412, a subdivided input resource list is an empty list (e.g., contains no resources). In at least one embodiment, after step 1412, said process to perform an API to subdivide context resources illustrated in block diagram 1400 continues at step 1414.

In at least one embodiment, at step 1414 of said process to perform an API to subdivide context resources illustrated in block diagram 1400, a processor performing said process performs one or more operations to store a remaining input resource list (e.g., resources remaining after an input resource list is subdivided at step 1408) in a storage location received as an argument to an API to subdivide context resources received at step 1402. In at least one embodiment, at step 1412, a remaining input resource list is an empty list (e.g., contains no resources). In at least one embodiment, after step 1412, said process to perform an API to subdivide context resources illustrated in block diagram 1400 continues at step 14164.

In at least one embodiment, at step 1416 of said process to perform an API to subdivide context resources illustrated in block diagram 1400, a processor performing said process performs one or more operations to return a success indicator (e.g., a success indicator 1322, described herein at least in connection with FIG. 13). In at least one embodiment, at step 1416, a success indicator is returned to a calling process (e.g., a process performed by a processor such as processor 102, described herein at least in connection with FIG. 1). In at least one embodiment, after step 1416, said process to perform an API to subdivide context resources illustrated in block diagram 1400 terminates. In at least one embodiment, not shown in FIG. 14, after step 1416, said process to perform an API to subdivide context resources illustrated in block diagram 1400 continues at step 1402, described above.

In at least one embodiment, at step 1418 of said process to perform an API to subdivide context resources illustrated in block diagram 1400, a processor performing said process performs one or more operations to return an error indicator (e.g., an error indicator 1324, described herein at least in connection with FIG. 13). In at least one embodiment, at step 1418, an error indicator is returned to a calling process (e.g., a process performed by a processor such as processor 102, described herein at least in connection with FIG. 1). In at least one embodiment, after step 1418, said process to perform an API to subdivide context resources illustrated in block diagram 1400 terminates. In at least one embodiment, not shown in FIG. 14, after step 1418, said process to perform an API to subdivide context resources illustrated in block diagram 1400 continues at step 1402, described above.

In at least one embodiment, operations of said process to perform an API to subdivide context resources illustrated in block diagram 1400 are performed in a different order than is illustrated in FIG. 1400. In at least one embodiment, operations of said process to perform an API to subdivide context resources illustrated in block diagram 1400 are performed simultaneously or in parallel. In at least one embodiment, operations of said process to perform an API to subdivide context resources illustrated in block diagram 1400 that do not depend on each other (e.g., are order independent) are performed simultaneously or in parallel. In at least one embodiment, operations of said process to perform an API to subdivide context resources illustrated in block diagram 1400 are performed by a plurality of threads executing on a processor such as those described herein.

In at least one embodiment, one or more processors (e.g., processor 102, processor 110, and/or other processors and/or accelerators such as those described herein) comprise one or more circuits to perform operations and/or instructions described herein in connection with FIGS. 13 and 14, such as one or more circuits to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIGS. 13 and 14, such as one or more circuits to perform an application programming interface (API) to generate an indication of one or more subsets of streaming multiprocessors (SMs) of a processor to be available to be used to perform one or more software kernels and/or otherwise perform operations described herein. In at least one embodiment, operations and/or instructions described herein in connection with FIGS. 13 and 14 are included in and/or otherwise include systems, methods, operations, and/or instructions described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, components described herein in connection with FIGS. 13 and 14 perform one or more processes described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, not shown in FIGS. 13 and 14, one or more components described herein in connection with FIGS. 13 and 14 include one or more components described herein in connection with FIGS. 26-58FIGS. 26-58 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein.

FIG. 15 is a block diagram 1500 illustrating an application programming interface (API) to generate a resource descriptor, in accordance with at least one embodiment. In at least one embodiment, one or more circuits of a processor are to perform a generate resource descriptor API 1502, to generate a descriptor of one or more resources. In at least one embodiment, not shown in FIG. 15, one or more circuits of a processor such as those described herein performs one or more instructions to perform generate resource descriptor API 1502 to perform an application programming interface (API) to indicate one or more groups of streaming multiprocessors (SMs) of one or more processors, on which to schedule one or more corresponding groups of software threads. In at least one embodiment, not shown in FIG. 15, one or more circuits of a processor such as those described herein performs one or more instructions to perform generate resource descriptor API 1502 to perform an application programming interface (API) to generate a data structure comprising information to indicate one or more streaming multiprocessors (SMs) of one or more GPUs to be usable to perform one or more software kernels. In at least one embodiment, also not shown in FIG. 15, one or more circuits of a processor such as those described herein performs one or more instructions to perform generate resource descriptor API 1502 to perform an application programming interface (API) to indicate one or more groups of streaming multiprocessors (SMs) of one or more processors, on which to schedule one or more corresponding groups of software threads in response to receiving a second API such as those described herein.

In at least one embodiment, generate resource descriptor API 1502 receives, when invoked, one or more arguments to indicate information about operations to be performed using techniques such as those described herein. In at least one embodiment, generate resource descriptor API 1502 receives, when invoked, one or more arguments to indicate information about instructions to be performed using techniques such as those described herein.

In at least one embodiment, generate resource descriptor API 1502 receives, as input, one or more arguments comprising a resource descriptor return 1504. In at least one embodiment, resource descriptor return 1504 is a data value comprising information usable to identify, indicate, or otherwise specify a storage location to store a generated resource descriptor generated using generate resource descriptor API 1502. In at least one embodiment, a resource descriptor return location identified, indicated, or otherwise specified by resource descriptor return 1504 is one of a plurality of parameters usable by generate resource descriptor API 1502 to generate a resource descriptor. In at least one embodiment, resource descriptor return 1504 is a data value to identify, indicate, or otherwise specify to an API such as generate resource descriptor API 1502, a set of operations or instructions to be performed by one or more PPUs, such as GPUs, and/or one or more accelerators within a heterogeneous processor, as described herein.

In at least one embodiment, generate resource descriptor API 1502 receives, as input, one or more arguments comprising a resource list 1506. In at least one embodiment, resource list 1506 is a data value comprising information usable to identify, indicate, or otherwise specify a resource list from which a resource descriptor is generated using generate resource descriptor API 1502. In at least one embodiment, a resource list identified, indicated, or otherwise specified by resource list 1506 is one of a plurality of parameters usable by generate resource descriptor API 1502 to generate a resource descriptor. In at least one embodiment, resource list 1506 is a data value to identify, indicate, or otherwise specify to an API such as generate resource descriptor API 1502, a set of operations or instructions to be performed by one or more PPUs, such as GPUs, and/or one or more accelerators within a heterogeneous processor, as described herein.

In at least one embodiment, generate resource descriptor API 1502 receives, as input, one or more arguments comprising a number of resources 1508. In at least one embodiment, number of resources 1508 is a data value comprising information usable to identify, indicate, or otherwise specify a number of resources in resource list 1506 usable to generate a resource descriptor using generate resource descriptor API 1502. In at least one embodiment, a number of resources identified, indicated, or otherwise specified by number of resources 1508 is one of a plurality of parameters usable by generate resource descriptor API 1502 to generate a resource descriptor. In at least one embodiment, number of resources 1508 is a data value to identify, indicate, or otherwise specify to an API such as generate resource descriptor API 1502, a set of operations or instructions to be performed by one or more PPUs, such as GPUs, and/or one or more accelerators within a heterogeneous processor, as described herein.

In at least one embodiment, generate resource descriptor API 1502 receives, as input, one or more arguments comprising one or more other arguments 1518. In at least one embodiment, other arguments 1518 are data comprising information to indicate any other information usable in performing generate resource descriptor API 1502 to generate a resource descriptor.

In at least one embodiment, not shown in FIG. 15, a processor performs one or more instructions to perform one or more APIs such as generate resource descriptor API 1502 to perform an application programming interface (API) to indicate one or more groups of streaming multiprocessors (SMs) of one or more processors, on which to schedule one or more corresponding groups of software threads using one or more arguments including, but not limited to, resource descriptor return 1504, resource list 1506, number of resources 1508, and/or other arguments 1518. In at least one embodiment, not shown in FIG. 15, a processor performs one or more instructions to perform one or more APIs such as generate resource descriptor API 1502 to perform an application programming interface (API) to generate a data structure comprising information to indicate one or more streaming multiprocessors (SMs) of one or more GPUs to be usable to perform one or more software kernels using one or more arguments including, but not limited to, resource descriptor return 1504, resource list 1506, number of resources 1508, and/or other arguments 1518.

In at least one embodiment, generate resource descriptor API 1502, if invoked, causes one or more APIs such as one or more APIs 306, described herein at least in connection with FIG. 3, to add one or more operations or instructions to be added, inserted, or otherwise included in a stream or set of instructions to be performed by one or more accelerators within a heterogenous processor. In at least one embodiment, generate resource descriptor API 1502, if invoked, causes one or more APIs such as one or more APIs 306 to, in a parallel computing environment such as parallel computing environment 308, described herein at least in connection with FIG. 3, add one or more operations or instructions to be added, inserted, or otherwise included in a stream or set of instructions to be performed by one or more accelerators within a heterogenous processor.

In at least one embodiment, in response to generate resource descriptor API 1502, one or more APIs 306, if performed, are to cause one or more processors to perform a generate resource descriptor API return 1520. In at least one embodiment, generate resource descriptor API return 1520 is a set of instructions that, if performed, generate and/or indicate one or more data values in response to generate resource descriptor API 1502. In at least one embodiment, generate resource descriptor API return 1520 indicates a success indicator 1522. In at least one embodiment, success indicator 1522 is data comprising any value to indicate success of generate resource descriptor API 1502. In at least one embodiment, success indicator 1522 comprises information indicating one or more specific types of successes generated as a result of performing generate resource descriptor API 1502. In at least one embodiment, success indicator 1522 comprises information indicating one or more other data values generated as a result of generate resource descriptor API 1502.

In at least one embodiment, generate resource descriptor API return 1520 indicates an error indicator 1524. In at least one embodiment, error indicator 1524 is data comprising any value to indicate failure of generate resource descriptor API 1502. In at least one embodiment, error indicator 1524 comprises information indicating one or more specific types of errors generated as a result of performing generate resource descriptor API 1502. In at least one embodiment, error indicator 1524 comprises information indicating one or more other data values generated as a result of generate resource descriptor API 1502.

In at least one embodiment, parallel computing environment 308 comprising one or more APIs 306 including, but not limited to, generate resource descriptor API 1502 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, one or more operations to indicate submission of an operation to an external device use software code such as example software code indicating stream operations as described herein at least in connection with FIG. 5.

In at least one embodiment, parallel computing environment 308 comprising one or more APIs 306 including, but not limited to, generate resource descriptor API 1502 comprises one or more function signatures usable to indicate one or more callback functions for operations to be performed by one or more accelerators within heterogeneous processors. In at least one embodiment, one or more operations cause one or more callback functions to be performed. In at least one embodiment, one or more operations to cause one or more callback functions to be performed use software code such as example software code indicating a function signature for a callback function as described herein at least in connection with FIG. 5.

In at least one embodiment, in order to specify one or more accelerators within heterogeneous processors to perform one or more operations indicated by generate resource descriptor API 1502 to one or more APIs 306, one or more data structures of one or more APIs 306 are usable to specify one or more external devices for which said one or more APIs 306 are to submit said one or more operations. In at least one embodiment, one or more data structures of one or more APIs 306 usable to specify one or more external devices for which said one or more APIs 306 are to submit said one or more operations use software code such as example software code indicating a data structure representing a device node for one or more accelerators within heterogeneous processors as described herein at least in connection with FIG. 5.

In at least one embodiment, in order to specify type and data of one or more operations indicated by one or more operations to be performed by one or more accelerators within heterogeneous processors, one or more data structures of one or more APIs 306 are to be used. In at least one embodiment, one or more data structures of one or more APIs 306 used to specify type and data of one or more operations indicated by one or more operations to be performed by one or more accelerators within heterogeneous processors use software code such as example software code indicating a data structure to specify type and data of one or more operations to be performed by one or more accelerators within heterogeneous processors as described herein at least in connection with FIG. 5.

In at least one embodiment, one or more APIs 306 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to generate resource descriptor API 1502, as described above. In at least one embodiment, instructions to cause one or more operations or instructions to be added to a stream or other set of instructions to be performed in response to generate resource descriptor API 1502 use software code such as example software code indicating a stream operation API call in parallel computing environment 308 as described herein at least in connection with FIG. 5.

In at least one embodiment, one or more APIs 306 comprise instructions that, if performed, cause one or more operations or instructions to be performed by one or more accelerators within heterogeneous processors to be added to one or more executable graphs. In at least one embodiment, instructions that, if performed, cause one or more operations or instructions to be performed by one or more accelerators within heterogeneous processors to be added to one or more executable graphs are similar to how one or more operations or instructions to be performed by one or more accelerators within heterogeneous processors are to be added to one or more streams or sets of instructions in response to generate resource descriptor API 1502, as described herein. In at least one embodiment, instructions that, if performed, cause one or more operations or instructions to be performed by one or more accelerators within heterogeneous processors to be added to one or more executable graphs use software code such as example software code indicating addition of one or more operations or instructions to one or more executable graphs by one or more APIs 306 of parallel computing environment 308 as described herein at least in connection with FIG. 5.

FIG. 16 is a block diagram 1600 illustrating a process to perform an application programming interface (API) to generate a resource descriptor, in accordance with at least one embodiment. In at least one embodiment, said process to perform an API to generate a resource descriptor illustrated in block diagram 1600 is a process to perform generate resource descriptor API 1502, described herein at least in connection with FIG. 15. In at least one embodiment, some or all of said process to perform an API to generate a resource descriptor illustrated in block diagram 1600 (or any other processes described herein, or variations and/or combinations thereof) is performed under control of one or more computer systems, servers, processors, integrated circuits, and/or other such device as described in connection with FIGS. 26-58, configured with computer-executable instructions and is implemented as code (e.g., computer-executable instructions, one or more computer programs, or one or more applications) executing collectively on one or more processors, by hardware, software, or combinations thereof. In at least one embodiment, said code is stored on a computer-readable storage medium in form of a computer program comprising a plurality of computer-readable instructions executable by one or more processors such as those described herein. In at least one embodiment, a computer-readable storage medium is a non-transitory computer-readable medium. In at least one embodiment, a processor such as processor 110, described herein at least in connection with FIG. 1, performs one or more steps of said process to perform an API to generate a resource descriptor illustrated in block diagram 1600. In at least one embodiment, one or more other processors such as those described herein perform one or more steps of said process to perform an API to generate a resource descriptor illustrated in block diagram 1600.

In at least one embodiment, at step 1602 of said process to perform an API to generate a resource descriptor illustrated in block diagram 1600, a processor performing said process performs one or more operations to receive or otherwise obtain an API to generate a resource descriptor. In at least one embodiment, at step 1602, an API to generate a resource descriptor is received by otherwise provided to a processor such as processor 110, described herein at least in connection with FIG. 1. In at least one embodiment, at step 1602, an API to generate a resource descriptor is received from otherwise provided by a processor such as processor 102, described herein at least in connection with FIG. 1. In at least one embodiment, at step 1602, an API to generate a resource descriptor includes one or more arguments such as those described herein at least in connection with FIG. 15. In at least one embodiment, after step 1602, said process to perform an API to generate a resource descriptor illustrated in block diagram 1600 continues at step 1604.

In at least one embodiment, at step 1604 of said process to perform an API to generate a resource descriptor illustrated in block diagram 1600, a processor performing said process performs one or more operations to determine whether an API to generate a resource descriptor (e.g., received at step 1602) is valid. In at least one embodiment, at step 1604, operations to determine whether an API to generate a resource descriptor is valid comprise operations to verify validity of arguments of said API to generate a resource descriptor (e.g., arguments described herein at least in connection with FIG. 15). In at least one embodiment, at step 1604, if it is determined that an API to generate a resource descriptor is valid (“YES” branch), said process to perform an API to generate a resource descriptor illustrated in block diagram 1600 continues at step 1606. In at least one embodiment, at step 1604, if it is determined that an API to generate a resource descriptor is not valid (“NO” branch), said process to perform an API to generate a resource descriptor illustrated in block diagram 1600 continues at step 1620, described below.

In at least one embodiment, at step 1606 of said process to perform an API to generate a resource descriptor illustrated in block diagram 1600, a processor performing said process performs one or more operations to generate a resource descriptor from a resource list and a number of resources (e.g., received as arguments to an API to generate a resource descriptor received at step 1602). In at least one embodiment, a resource descriptor is a list of resources available to other APIs (e.g., as described herein at least in connection with FIGS. 5-22) to perform one or more other resource operation APIs. In at least one embodiment, after step 1606, said process to perform an API to generate a resource descriptor illustrated in block diagram 1600 continues at step 1608.

In at least one embodiment, at step 1608 of said process to perform an API to generate a resource descriptor illustrated in block diagram 1600, a processor performing said process performs one or more operations to determine whether a resource descriptor was generated (e.g., at step 1606). In at least one embodiment, at step 1608, if it is determined that a resource descriptor was generated (“YES” branch), said process to perform an API to generate a resource descriptor illustrated in block diagram 1600 continues at step 1610. In at least one embodiment, at step 1604, if it is determined that a resource descriptor was not generated (“NO” branch), said process to perform an API to generate a resource descriptor illustrated in block diagram 1600 continues at step 1614, described below.

In at least one embodiment, at step 1610 of said process to perform an API to generate a resource descriptor illustrated in block diagram 1600, a processor performing said process performs one or more operations to store a generated resource descriptor (e.g., generated at step 1606) in a storage location received as an argument to an API to generate a resource descriptor, received at step 1602. In at least one embodiment, after step 1610, said process to perform an API to generate a resource descriptor illustrated in block diagram 1600 continues at step 1612.

In at least one embodiment, at step 1612 of said process to perform an API to generate a resource descriptor illustrated in block diagram 1600, a processor performing said process performs one or more operations to return a success indicator (e.g., an success indicator 1522, described herein at least in connection with FIG. 15). In at least one embodiment, at step 1612, a success indicator is returned to a calling process (e.g., a process performed by a processor such as processor 102, described herein at least in connection with FIG. 1). In at least one embodiment, after step 1618, said process to perform an API to generate a resource descriptor illustrated in block diagram 1600 terminates. In at least one embodiment, not shown in FIG. 16, after step 1612, said process to perform an API to generate a resource descriptor illustrated in block diagram 1600 continues at step 1602, described above.

In at least one embodiment, at step 1614 of said process to perform an API to generate a resource descriptor illustrated in block diagram 1600, a processor performing said process performs one or more operations to return an error indicator (e.g., an error indicator 1524, described herein at least in connection with FIG. 15). In at least one embodiment, at step 1614, an error indicator is returned to a calling process (e.g., a process performed by a processor such as processor 102, described herein at least in connection with FIG. 1). In at least one embodiment, after step 1614, said process to perform an API to generate a resource descriptor illustrated in block diagram 1600 terminates. In at least one embodiment, not shown in FIG. 16, after step 1614, said process to perform an API to generate a resource descriptor illustrated in block diagram 1600 continues at step 1602, described above.

In at least one embodiment, operations of said process to perform an API to generate a resource descriptor illustrated in block diagram 1600 are performed in a different order than is illustrated in FIG. 1600. In at least one embodiment, operations of said process to perform an API to generate a resource descriptor illustrated in block diagram 1600 are performed simultaneously or in parallel. In at least one embodiment, operations of said process to perform an API to generate a resource descriptor illustrated in block diagram 1600 that do not depend on each other (e.g., are order independent) are performed simultaneously or in parallel. In at least one embodiment, operations of said process to perform an API to generate a resource descriptor illustrated in block diagram 1600 are performed by a plurality of threads executing on a processor such as those described herein.

In at least one embodiment, one or more processors (e.g., processor 102, processor 110, and/or other processors and/or accelerators such as those described herein) comprise one or more circuits to perform operations and/or instructions described herein in connection with FIGS. 15 and 16, such as one or more circuits to perform an application programming interface (API) to indicate one or more groups of streaming multiprocessors (SMs) of one or more processors, on which to schedule one or more corresponding groups of software threads and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIGS. 15 and 16, such as one or more circuits to perform an application programming interface (API) to generate a data structure comprising information to indicate one or more streaming multiprocessors (SMs) of one or more GPUs to be usable to perform one or more software kernels and/or otherwise perform operations described herein. In at least one embodiment, operations and/or instructions described herein in connection with FIGS. 15 and 16 are included in and/or otherwise include systems, methods, operations, and/or instructions described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, components described herein in connection with FIGS. 15 and 16 perform one or more processes described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, not shown in FIGS. 15 and 16, one or more components described herein in connection with FIGS. 15 and 16 include one or more components described herein in connection with FIGS. 26-58 to perform an application programming interface (API) to indicate one or more groups of streaming multiprocessors (SMs) of one or more processors, on which to schedule one or more corresponding groups of software threads and/or otherwise perform operations described herein.

FIG. 17 is a block diagram 1700 illustrating an application programming interface (API) to get device resources of a context, in accordance with at least one embodiment. In at least one embodiment, one or more circuits of a processor are to perform a get device resources API 1702, to get device resources associated with a context or sub-context, as described herein. In at least one embodiment, not shown in FIG. 17, one or more circuits of a processor such as those described herein performs one or more instructions to perform get device resources API 1702 to perform an application programming interface (API) to cause one or more indicators of one or more numbers of one or more streaming multiprocessors (SMs) of one or more processors to be read from one or more data structures storing the one or more indicators. In at least one embodiment, not shown in FIG. 17, one or more circuits of a processor such as those described herein performs one or more instructions to perform get device resources API 1702 to perform an application programming interface (API) to cause a number of streaming multiprocessors indicated by one or more masks to be usable to perform one or more software kernels to be indicated. In at least one embodiment, also not shown in FIG. 17, one or more circuits of a processor such as those described herein performs one or more instructions to perform get device resources API 1702 to perform an application programming interface (API) to cause one or more indicators of one or more numbers of one or more streaming multiprocessors (SMs) of one or more processors to be read from one or more data structures storing the one or more indicators in response to receiving a second API such as those described herein.

In at least one embodiment, get device resources API 1702 receives, when invoked, one or more arguments to indicate information about operations to be performed using techniques such as those described herein. In at least one embodiment, get device resources API 1702 receives, when invoked, one or more arguments to indicate information about instructions to be performed using techniques such as those described herein.

In at least one embodiment, get device resources API 1702 receives, as input, one or more arguments comprising a device resources return 1704. In at least one embodiment, device resources return 1704 is a data value comprising information usable to identify, indicate, or otherwise specify a storage location to store a list of device resources obtained using get device resources API 1702. In at least one embodiment, location to store a list of device resources identified, indicated, or otherwise specified by device resources return 1704 is one of a plurality of parameters usable by get device resources API 1702 to get device resources of a context. In at least one embodiment, device resources return 1704 is a data value to identify, indicate, or otherwise specify to an API such as get device resources API 1702, a set of operations or instructions to be performed by one or more PPUs, such as GPUs, and/or one or more accelerators within a heterogeneous processor, as described herein.

In at least one embodiment, get device resources API 1702 receives, as input, one or more arguments comprising a device resources type 1706. In at least one embodiment, device resources type 1706 is a data value comprising information usable to identify, indicate, or otherwise specify a type of resources including, but not limited to, streaming multiprocessors (SMs), device connections (e.g., copy and compute hardware channels), processor bindings, software schedulers, work distribution, and/or other such resources, to return using get device resources API 1702. In at least one embodiment, a type of resources to return identified, indicated, or otherwise specified by device resources type 1706 is one of a plurality of parameters usable by get device resources API 1702 to get device resources of a context. In at least one embodiment, device resources type 1706 is a data value to identify, indicate, or otherwise specify to an API such as get device resources API 1702, a set of operations or instructions to be performed by one or more PPUs, such as GPUs, and/or one or more accelerators within a heterogeneous processor, as described herein.

In at least one embodiment, get device resources API 1702 receives, as input, one or more arguments comprising a context 1708. In at least one embodiment, context 1708 is a data value comprising information usable to identify, indicate, or otherwise specify a context from which a resource list is obtained (e.g., a list of resources associated with said context) using get device resources API 1702. In at least one embodiment, a context identified, indicated, or otherwise specified by context 1708 is one of a plurality of parameters usable by get device resources API 1702 to get device resources of a context. In at least one embodiment, context 1708 is a data value to identify, indicate, or otherwise specify to an API such as get device resources API 1702, a set of operations or instructions to be performed by one or more PPUs, such as GPUs, and/or one or more accelerators within a heterogeneous processor, as described herein.

In at least one embodiment, get device resources API 1702 receives, as input, one or more arguments comprising one or more other arguments 1718. In at least one embodiment, other arguments 1718 are data comprising information to indicate any other information usable in performing get device resources API 1702 to get device resources of a context.

In at least one embodiment, not shown in FIG. 17, a processor performs one or more instructions to perform one or more APIs such as get device resources API 1702 to perform an application programming interface (API) to cause one or more indicators of one or more numbers of one or more streaming multiprocessors (SMs) of one or more processors to be read from one or more data structures storing the one or more indicators using one or more arguments including, but not limited to, device resources return 1704, device resources type 1706, context 1708, and/or other arguments 1718. In at least one embodiment, not shown in FIG. 17, a processor performs one or more instructions to perform one or more APIs such as get device resources API 1702 to perform an application programming interface (API) to cause a number of streaming multiprocessors indicated by one or more masks to be usable to perform one or more software kernels to be indicated using one or more arguments including, but not limited to, device resources return 1704, device resources type 1706, context 1708, and/or other arguments 1718.

In at least one embodiment, get device resources API 1702, if invoked, causes one or more APIs such as one or more APIs 306, described herein at least in connection with FIG. 3, to add one or more operations or instructions to be added, inserted, or otherwise included in a stream or set of instructions to be performed by one or more accelerators within a heterogenous processor. In at least one embodiment, get device resources API 1702, if invoked, causes one or more APIs such as one or more APIs 306 to, in a parallel computing environment such as parallel computing environment 308, described herein at least in connection with FIG. 3, add one or more operations or instructions to be added, inserted, or otherwise included in a stream or set of instructions to be performed by one or more accelerators within a heterogenous processor.

In at least one embodiment, in response to get device resources API 1702, one or more APIs 306, if performed, are to cause one or more processors to perform a get device resources API return 1720. In at least one embodiment, get device resources API return 1720 is a set of instructions that, if performed, generate and/or indicate one or more data values in response to get device resources API 1702. In at least one embodiment, get device resources API return 1720 indicates a success indicator 1722. In at least one embodiment, success indicator 1722 is data comprising any value to indicate success of get device resources API 1702. In at least one embodiment, success indicator 1722 comprises information indicating one or more specific types of successes generated as a result of performing get device resources API 1702. In at least one embodiment, success indicator 1722 comprises information indicating one or more other data values generated as a result of get device resources API 1702.

In at least one embodiment, get device resources API return 1720 indicates an error indicator 1724. In at least one embodiment, error indicator 1724 is data comprising any value to indicate failure of get device resources API 1702. In at least one embodiment, error indicator 1724 comprises information indicating one or more specific types of errors generated as a result of performing get device resources API 1702. In at least one embodiment, error indicator 1724 comprises information indicating one or more other data values generated as a result of get device resources API 1702.

In at least one embodiment, parallel computing environment 308 comprising one or more APIs 306 including, but not limited to, get device resources API 1702 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, one or more operations to indicate submission of an operation to an external device use software code such as example software code indicating stream operations as described herein at least in connection with FIG. 5.

In at least one embodiment, parallel computing environment 308 comprising one or more APIs 306 including, but not limited to, get device resources API 1702 comprises one or more function signatures usable to indicate one or more callback functions for operations to be performed by one or more accelerators within heterogeneous processors. In at least one embodiment, one or more operations cause one or more callback functions to be performed. In at least one embodiment, one or more operations to cause one or more callback functions to be performed use software code such as example software code indicating a function signature for a callback function as described herein at least in connection with FIG. 5.

In at least one embodiment, in order to specify one or more accelerators within heterogeneous processors to perform one or more operations indicated by get device resources API 1702 to one or more APIs 306, one or more data structures of one or more APIs 306 are usable to specify one or more external devices for which said one or more APIs 306 are to submit said one or more operations. In at least one embodiment, one or more data structures of one or more APIs 306 usable to specify one or more external devices for which said one or more APIs 306 are to submit said one or more operations use software code such as example software code indicating a data structure representing a device node for one or more accelerators within heterogeneous processors as described herein at least in connection with FIG. 5.

In at least one embodiment, in order to specify type and data of one or more operations indicated by one or more operations to be performed by one or more accelerators within heterogeneous processors, one or more data structures of one or more APIs 306 are to be used. In at least one embodiment, one or more data structures of one or more APIs 306 used to specify type and data of one or more operations indicated by one or more operations to be performed by one or more accelerators within heterogeneous processors use software code such as example software code indicating a data structure to specify type and data of one or more operations to be performed by one or more accelerators within heterogeneous processors as described herein at least in connection with FIG. 5.

In at least one embodiment, one or more APIs 306 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to get device resources API 1702, as described above. In at least one embodiment, instructions to cause one or more operations or instructions to be added to a stream or other set of instructions to be performed in response to get device resources API 1702 use software code such as example software code indicating a stream operation API call in parallel computing environment 308 as described herein at least in connection with FIG. 5.

In at least one embodiment, one or more APIs 306 comprise instructions that, if performed, cause one or more operations or instructions to be performed by one or more accelerators within heterogeneous processors to be added to one or more executable graphs. In at least one embodiment, instructions that, if performed, cause one or more operations or instructions to be performed by one or more accelerators within heterogeneous processors to be added to one or more executable graphs are similar to how one or more operations or instructions to be performed by one or more accelerators within heterogeneous processors are to be added to one or more streams or sets of instructions in response to get device resources API 1702, as described herein. In at least one embodiment, instructions that, if performed, cause one or more operations or instructions to be performed by one or more accelerators within heterogeneous processors to be added to one or more executable graphs use software code such as example software code indicating addition of one or more operations or instructions to one or more executable graphs by one or more APIs 306 of parallel computing environment 308 as described herein at least in connection with FIG. 5.

FIG. 18 is a block diagram 1800 illustrating a process to perform an application programming interface (API) to get device resources of a context, in accordance with at least one embodiment. In at least one embodiment, said process to perform an API to get device resources of a context illustrated in block diagram 1800 is a process to perform get device resources API 1702, described herein at least in connection with FIG. 17. In at least one embodiment, some or all of said process to perform an API to get device resources of a context illustrated in block diagram 1800 (or any other processes described herein, or variations and/or combinations thereof) is performed under control of one or more computer systems, servers, processors, integrated circuits, and/or other such device as described in connection with FIGS. 26-58, configured with computer-executable instructions and is implemented as code (e.g., computer-executable instructions, one or more computer programs, or one or more applications) executing collectively on one or more processors, by hardware, software, or combinations thereof. In at least one embodiment, said code is stored on a computer-readable storage medium in form of a computer program comprising a plurality of computer-readable instructions executable by one or more processors such as those described herein. In at least one embodiment, a computer-readable storage medium is a non-transitory computer-readable medium. In at least one embodiment, a processor such as processor 110, described herein at least in connection with FIG. 1, performs one or more steps of said process to perform an API to get device resources of a context illustrated in block diagram 1800. In at least one embodiment, one or more other processors such as those described herein perform one or more steps of said process to perform an API to get device resources of a context illustrated in block diagram 1800.

In at least one embodiment, at step 1802 of said process to perform an API to get device resources illustrated in block diagram 1800, a processor performing said process performs one or more operations to receive or otherwise obtain an API to get device resources. In at least one embodiment, at step 1802, an API to get device resources is received by otherwise provided to a processor such as processor 110, described herein at least in connection with FIG. 1. In at least one embodiment, at step 1802, an API to get device resources is received from otherwise provided by a processor such as processor 102, described herein at least in connection with FIG. 1. In at least one embodiment, at step 1802, an API to get device resources includes one or more arguments such as those described herein at least in connection with FIG. 17. In at least one embodiment, after step 1802, said process to perform an API to get device resources illustrated in block diagram 1800 continues at step 1804.

In at least one embodiment, at step 1804 of said process to perform an API to get device resources of a context illustrated in block diagram 1800, a processor performing said process performs one or more operations to determine whether an API to get device resources (e.g., received at step 1802) is valid. In at least one embodiment, at step 1804, operations to determine whether an API to get device resources is valid comprise operations to verify validity of arguments of said API to get device resources (e.g., arguments described herein at least in connection with FIG. 17). In at least one embodiment, at step 1804, if it is determined that an API to get device resources is valid (“YES” branch), said process to perform an API to get device resources illustrated in block diagram 1800 continues at step 1806. In at least one embodiment, at step 1804, if it is determined that an API to get device resources is not valid (“NO” branch), said process to perform an API to get device resources of a context illustrated in block diagram 1800 continues at step 1816, described below.

In at least one embodiment, at step 1806 of said process to perform an API to get device resources of a context illustrated in block diagram 1800, a processor performing said process performs one or more operations to identify a context (e.g., a context received as an argument to an API to get device resources of a context, received at step 1802). In at least one embodiment, after step 1806, said process to perform an API to get device resources of a context illustrated in block diagram 1800 continues at step 1808.

In at least one embodiment, at step 1808 of said process to perform an API to get device resources of a context illustrated in block diagram 1800, a processor performing said process performs one or more operations to identify device resources associated with a context (e.g., a context identified at step 1806), as described herein. In at least one embodiment, after step 1808, said process to perform an API to get device resources of a context illustrated in block diagram 1800 continues at step 1810.

In at least one embodiment, at step 1810 of said process to perform an API to get device resources of a context illustrated in block diagram 1800, a processor performing said process performs one or more operations to select resource of a resource type (e.g., a resource type received as an argument to an API to get device resources of a context, received at step 1802). In at least one embodiment, not shown in FIG. 18, step 1808 and step 1810 of said process to perform an API to get device resources of a context illustrated in block diagram 1800 are performed as a single step so that, for example, one or more operations to identify device resources associated with a context comprise one or more operations to identify device resources associated with a context that are of a specified resource type. In at least one embodiment, after step 1810, said process to perform an API to get device resources of a context illustrated in block diagram 1800 continues at step 1812.

In at least one embodiment, at step 1812 of said process to perform an API to get device resources of a context illustrated in block diagram 1800, a processor performing said process performs one or more operations to store selected resources (e.g., selected at step 1810) are stored in a resource return location (e.g., received as an argument to an API to get device resources, received at step 1802). In at least one embodiment, after step 1812, said process to perform an API to get device resources of a context illustrated in block diagram 1800 continues at step 1814.

In at least one embodiment, at step 1814 of said process to perform an API to get device resources illustrated in block diagram 1800, a processor performing said process performs one or more operations to return a success indicator (e.g., a success indicator 1722, described herein at least in connection with FIG. 17). In at least one embodiment, at step 1814, a success indicator is returned to a calling process (e.g., a process performed by a processor such as processor 102, described herein at least in connection with FIG. 1). In at least one embodiment, after step 1817, said process to perform an API to get device resources illustrated in block diagram 1800 terminates. In at least one embodiment, not shown in FIG. 18, after step 1814, said process to perform an API to get device resources illustrated in block diagram 1800 continues at step 1802, described above.

In at least one embodiment, at step 1816 of said process to perform an API to get device resources illustrated in block diagram 1800, a processor performing said process performs one or more operations to return an error indicator (e.g., an error indicator 1724, described herein at least in connection with FIG. 17). In at least one embodiment, at step 1816, an error indicator is returned to a calling process (e.g., a process performed by a processor such as processor 102, described herein at least in connection with FIG. 1). In at least one embodiment, after step 1816, said process to perform an API to get device resources illustrated in block diagram 1800 terminates. In at least one embodiment, not shown in FIG. 18, after step 1816, said process to perform an API to get device resources illustrated in block diagram 1800 continues at step 1802, described above.

In at least one embodiment, operations of said process to perform an API to get device resources of a context illustrated in block diagram 1800 are performed in a different order than is illustrated in FIG. 1800. In at least one embodiment, operations of said process to perform an API to get device resources of a context illustrated in block diagram 1800 are performed simultaneously or in parallel. In at least one embodiment, operations of said process to perform an API to get device resources of a context illustrated in block diagram 1800 that do not depend on each other (e.g., are order independent) are performed simultaneously or in parallel. In at least one embodiment, operations of said process to perform an API to get device resources of a context illustrated in block diagram 1800 are performed by a plurality of threads executing on a processor such as those described herein.

In at least one embodiment, one or more processors (e.g., processor 102, processor 110, and/or other processors and/or accelerators such as those described herein) comprise one or more circuits to perform operations and/or instructions described herein in connection with FIGS. 17 and 18, such as one or more circuits to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIGS. 17 and 18, such as one or more circuits to perform an application programming interface (API) to cause a number of streaming multiprocessors indicated by one or more masks to be usable to perform one or more software kernels to be indicated and/or otherwise perform operations described herein. In at least one embodiment, operations and/or instructions described herein in connection with FIGS. 17 and 18 are included in and/or otherwise include systems, methods, operations, and/or instructions described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, components described herein in connection with FIGS. 17 and 18 perform one or more processes described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, not shown in FIGS. 17 and 18, one or more components described herein in connection with FIGS. 17 and 18 include one or more components described herein in connection with FIGS. 26-58 to perform an application programming interface (API) to cause one or more indicators of one or more numbers of one or more streaming multiprocessors (SMs) of one or more processors to be read from one or more data structures storing the one or more indicators and/or otherwise perform operations described herein.

FIG. 19 is a block diagram 1900 illustrating an application programming interface (API) to record a context event, in accordance with at least one embodiment. In at least one embodiment, one or more circuits of a processor are to perform a record context event API 1902, to record an event that can be used by another context to synchronize performance of context (e.g., a first context records an event to signal to a second context that an execution point has been reached, thereby allowing said second context, waiting on said event, to continue execution). In at least one embodiment, not shown in FIG. 19, one or more circuits of a processor such as those described herein performs one or more instructions to perform record context event API 1902 to perform an application programming interface (API) to cause context of one or more first software instructions to be communicated to one or more second software instructions. In at least one embodiment, not shown in FIG. 19, one or more circuits of a processor such as those described herein performs one or more instructions to perform record context event API 1902 to perform an application programming interface (API) to cause one or more indications of one or more events of one or more resources of a first context of the processor to be indicated to one or more resources of a second context of the processor. In at least one embodiment, also not shown in FIG. 19, one or more circuits of a processor such as those described herein performs one or more instructions to perform record context event API 1902 to perform an application programming interface (API) to cause context of one or more first software instructions to be communicated to one or more second software instructions in response to receiving a second API such as those described herein.

In at least one embodiment, record context event API 1902 receives, when invoked, one or more arguments to indicate information about operations to be performed using techniques such as those described herein. In at least one embodiment, record context event API 1902 receives, when invoked, one or more arguments to indicate information about instructions to be performed using techniques such as those described herein.

In at least one embodiment, record context event API 1902 receives, as input, one or more arguments comprising a context 1904. In at least one embodiment, context 1904 is a data value comprising information usable to identify, indicate, or otherwise specify a context that records an event using record context event API 1902. In at least one embodiment, a context that records an event identified, indicated, or otherwise specified by context 1904 is one of a plurality of parameters usable by record context event API 1902 to record a context event. In at least one embodiment, context 1904 is a data value to identify, indicate, or otherwise specify to an API such as record context event API 1902, a set of operations or instructions to be performed by one or more PPUs, such as GPUs, and/or one or more accelerators within a heterogeneous processor, as described herein.

In at least one embodiment, record context event API 1902 receives, as input, one or more arguments comprising an event 1906. In at least one embodiment, event 1906 is a data value comprising information usable to identify, indicate, or otherwise specify an event to record using record context event API 1902. In at least one embodiment, an event identified, indicated, or otherwise specified by event 1906 is one of a plurality of parameters usable by record context event API 1902 to record a context event. In at least one embodiment, event 1906 is a data value to identify, indicate, or otherwise specify to an API such as record context event API 1902, a set of operations or instructions to be performed by one or more PPUs, such as GPUs, and/or one or more accelerators within a heterogeneous processor, as described herein.

In at least one embodiment, record context event API 1902 receives, as input, one or more arguments comprising one or more other arguments 1918. In at least one embodiment, other arguments 1918 are data comprising information to indicate any other information usable in performing record context event API 1902 to record a context event.

In at least one embodiment, not shown in FIG. 19, a processor performs one or more instructions to perform one or more APIs such as record context event API 1902 to perform an application programming interface (API) to cause context of one or more first software instructions to be communicated to one or more second software instructions using one or more arguments including, but not limited to, context 1904, event 1906, and/or other arguments 1918. In at least one embodiment, not shown in FIG. 19, a processor performs one or more instructions to perform one or more APIs such as record context event API 1902 to perform an application programming interface (API) to cause one or more indications of one or more events of one or more resources of a first context of the processor to be indicated to one or more resources of a second context of the processor using one or more arguments including, but not limited to, context 1904, event 1906, and/or other arguments 1918.

In at least one embodiment, record context event API 1902, if invoked, causes one or more APIs such as one or more APIs 306, described herein at least in connection with FIG. 3, to add one or more operations or instructions to be added, inserted, or otherwise included in a stream or set of instructions to be performed by one or more accelerators within a heterogenous processor. In at least one embodiment, record context event API 1902, if invoked, causes one or more APIs such as one or more APIs 306 to, in a parallel computing environment such as parallel computing environment 308, described herein at least in connection with FIG. 3, add one or more operations or instructions to be added, inserted, or otherwise included in a stream or set of instructions to be performed by one or more accelerators within a heterogenous processor.

In at least one embodiment, in response to record context event API 1902, one or more APIs 306, if performed, are to cause one or more processors to perform a record context event API return 1920. In at least one embodiment, record context event API return 1920 is a set of instructions that, if performed, generate and/or indicate one or more data values in response to record context event API 1902. In at least one embodiment, record context event API return 1920 indicates a success indicator 1922. In at least one embodiment, success indicator 1922 is data comprising any value to indicate success of record context event API 1902. In at least one embodiment, success indicator 1922 comprises information indicating one or more specific types of successes generated as a result of performing record context event API 1902. In at least one embodiment, success indicator 1922 comprises information indicating one or more other data values generated as a result of record context event API 1902.

In at least one embodiment, record context event API return 1920 indicates an error indicator 1924. In at least one embodiment, error indicator 1924 is data comprising any value to indicate failure of record context event API 1902. In at least one embodiment, error indicator 1924 comprises information indicating one or more specific types of errors generated as a result of performing record context event API 1902. In at least one embodiment, error indicator 1924 comprises information indicating one or more other data values generated as a result of record context event API 1902.

In at least one embodiment, parallel computing environment 308 comprising one or more APIs 306 including, but not limited to, record context event API 1902 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, one or more operations to indicate submission of an operation to an external device use software code such as example software code indicating stream operations as described herein at least in connection with FIG. 5.

In at least one embodiment, parallel computing environment 308 comprising one or more APIs 306 including, but not limited to, record context event API 1902 comprises one or more function signatures usable to indicate one or more callback functions for operations to be performed by one or more accelerators within heterogeneous processors. In at least one embodiment, one or more operations cause one or more callback functions to be performed. In at least one embodiment, one or more operations to cause one or more callback functions to be performed use software code such as example software code indicating a function signature for a callback function as described herein at least in connection with FIG. 5.

In at least one embodiment, in order to specify one or more accelerators within heterogeneous processors to perform one or more operations indicated by record context event API 1902 to one or more APIs 306, one or more data structures of one or more APIs 306 are usable to specify one or more external devices for which said one or more APIs 306 are to submit said one or more operations. In at least one embodiment, one or more data structures of one or more APIs 306 usable to specify one or more external devices for which said one or more APIs 306 are to submit said one or more operations use software code such as example software code indicating a data structure representing a device node for one or more accelerators within heterogeneous processors as described herein at least in connection with FIG. 5.

In at least one embodiment, in order to specify type and data of one or more operations indicated by one or more operations to be performed by one or more accelerators within heterogeneous processors, one or more data structures of one or more APIs 306 are to be used. In at least one embodiment, one or more data structures of one or more APIs 306 used to specify type and data of one or more operations indicated by one or more operations to be performed by one or more accelerators within heterogeneous processors use software code such as example software code indicating a data structure to specify type and data of one or more operations to be performed by one or more accelerators within heterogeneous processors as described herein at least in connection with FIG. 5.

In at least one embodiment, one or more APIs 306 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to record context event API 1902, as described above. In at least one embodiment, instructions to cause one or more operations or instructions to be added to a stream or other set of instructions to be performed in response to record context event API 1902 use software code such as example software code indicating a stream operation API call in parallel computing environment 308 as described herein at least in connection with FIG. 5.

In at least one embodiment, one or more APIs 306 comprise instructions that, if performed, cause one or more operations or instructions to be performed by one or more accelerators within heterogeneous processors to be added to one or more executable graphs. In at least one embodiment, instructions that, if performed, cause one or more operations or instructions to be performed by one or more accelerators within heterogeneous processors to be added to one or more executable graphs are similar to how one or more operations or instructions to be performed by one or more accelerators within heterogeneous processors are to be added to one or more streams or sets of instructions in response to record context event API 1902, as described herein. In at least one embodiment, instructions that, if performed, cause one or more operations or instructions to be performed by one or more accelerators within heterogeneous processors to be added to one or more executable graphs use software code such as example software code indicating addition of one or more operations or instructions to one or more executable graphs by one or more APIs 306 of parallel computing environment 308 as described herein at least in connection with FIG. 5.

FIG. 20 is a block diagram 2000 illustrating a process to perform an application programming interface (API) to record a context event, in accordance with at least one embodiment. In at least one embodiment, said process to perform an API to record a context event illustrated in block diagram 2000 is a process to perform record context event API 1902, described herein at least in connection with FIG. 19. In at least one embodiment, some or all of said process to perform an API to record a context event illustrated in block diagram 2000 (or any other processes described herein, or variations and/or combinations thereof) is performed under control of one or more computer systems, servers, processors, integrated circuits, and/or other such device as described in connection with FIGS. 26-58, configured with computer-executable instructions and is implemented as code (e.g., computer-executable instructions, one or more computer programs, or one or more applications) executing collectively on one or more processors, by hardware, software, or combinations thereof. In at least one embodiment, said code is stored on a computer-readable storage medium in form of a computer program comprising a plurality of computer-readable instructions executable by one or more processors such as those described herein. In at least one embodiment, a computer-readable storage medium is a non-transitory computer-readable medium. In at least one embodiment, a processor such as processor 110, described herein at least in connection with FIG. 1, performs one or more steps of said process to perform an API to record a context event illustrated in block diagram 2000. In at least one embodiment, one or more other processors such as those described herein perform one or more steps of said process to perform an API to record a context event illustrated in block diagram 2000.

In at least one embodiment, at step 2002 of said process to perform an API to record a context event illustrated in block diagram 2000, a processor performing said process performs one or more operations to receive or otherwise obtain an API to record a context event. In at least one embodiment, at step 2002, an API to record a context event is received by otherwise provided to a processor such as processor 110, described herein at least in connection with FIG. 1. In at least one embodiment, at step 2002, an API to record a context event is received from otherwise provided by a processor such as processor 102, described herein at least in connection with FIG. 1. In at least one embodiment, at step 2002, an API to record a context event includes one or more arguments such as those described herein at least in connection with FIG. 19. In at least one embodiment, after step 2002, said process to perform an API to record a context event illustrated in block diagram 2000 continues at step 2004.

In at least one embodiment, at step 2004 of said process to perform an API to record a context event illustrated in block diagram 2000, a processor performing said process performs one or more operations to determine whether an API to record a context event (e.g., received at step 2002) is valid. In at least one embodiment, at step 2004, operations to determine whether an API to record a context event is valid comprise operations to verify validity of arguments of said API to record a context event (e.g., arguments described herein at least in connection with FIG. 19). In at least one embodiment, at step 2004, if it is determined that an API to record a context event is valid (“YES” branch), said process to perform an API to record a context event illustrated in block diagram 2000 continues at step 2006. In at least one embodiment, at step 2004, if it is determined that an API to record a context event is not valid (“NO” branch), said process to perform an API to record a context event illustrated in block diagram 2000 continues at step 2012, described below.

In at least one embodiment, at step 2006 of said process to perform an API to record a context event illustrated in block diagram 2000, a processor performing said process performs one or more operations to record an event (e.g., an event received as an argument to an API to record a context event, received at step 2002). In at least one embodiment, an event recorded at step 2006, records all activities of a context at a time that said event is called (including activities of blocking streams and non-blocking streams). In at least one embodiment, an event recorded at step 2006 is an event to be waited on using a wait on context event API, described herein at least in connection with FIGS. 21 and 22. In at least one embodiment, after step 2006, said process to perform an API to record a context event illustrated in block diagram 2000 continues at step 2008.

In at least one embodiment, at step 2008 of said process to perform an API to record a context event illustrated in block diagram 2000, a processor performing said process performs one or more operations to determine whether an event was recorded (e.g., at step 2006). In at least one embodiment, at step 2008, if it is determined that an event was recorded (“YES” branch), said process to perform an API to record a context event illustrated in block diagram 2000 continues at step 2010. In at least one embodiment, at step 2008, if it is determined that an event was not recorded (“NO” branch), said process to perform an API to record a context event illustrated in block diagram 2000 continues at step 2012, described below. In at least one embodiment, said process to perform an API to record a context event illustrated in block diagram 2000 does not determine whether an event was recorded at step 2008 and, instead, proceeds directly to step 2010.

In at least one embodiment, at step 2010 of said process to perform an API to record a context event illustrated in block diagram 2000, a processor performing said process performs one or more operations to return a success indicator (e.g., a success indicator 1922, described herein at least in connection with FIG. 19). In at least one embodiment, at step 2010, a success indicator is returned to a calling process (e.g., a process performed by a processor such as processor 102, described herein at least in connection with FIG. 1). In at least one embodiment, after step 2010, said process to perform an API to record a context event illustrated in block diagram 2000 terminates. In at least one embodiment, not shown in FIG. 20, after step 2010, said process to perform an API to record a context event illustrated in block diagram 2000 continues at step 2002, described above.

In at least one embodiment, at step 2012 of said process to perform an API to record a context event illustrated in block diagram 2000, a processor performing said process performs one or more operations to return a success indicator (e.g., a success indicator 1922, described herein at least in connection with FIG. 19). In at least one embodiment, at step 2012, a success indicator is returned to a calling process (e.g., a process performed by a processor such as processor 102, described herein at least in connection with FIG. 1). In at least one embodiment, after step 2012, said process to perform an API to record a context event illustrated in block diagram 600 terminates. In at least one embodiment, not shown in FIG. 20, after step 2012, said process to perform an API to record a context event illustrated in block diagram 2000 continues at step 2002, described above.

In at least one embodiment, operations of said process to perform an API to record a context event illustrated in block diagram 2000 are performed in a different order than is illustrated in FIG. 2000. In at least one embodiment, operations of said process to perform an API to record a context event illustrated in block diagram 2000 are performed simultaneously or in parallel. In at least one embodiment, operations of said process to perform an API to record a context event illustrated in block diagram 2000 that do not depend on each other (e.g., are order independent) are performed simultaneously or in parallel. In at least one embodiment, operations of said process to perform an API to record a context event illustrated in block diagram 2000 are performed by a plurality of threads executing on a processor such as those described herein.

In at least one embodiment, one or more processors (e.g., processor 102, processor 110, and/or other processors and/or accelerators such as those described herein) comprise one or more circuits to perform operations and/or instructions described herein in connection with FIGS. 19 and 20, such as one or more circuits to perform an application programming interface (API) to cause context of one or more first software instructions to be communicated to one or more second software instructions and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIGS. 19 and 20, such as one or more circuits to perform an application programming interface (API) to cause one or more indications of one or more events of one or more resources of a first context of the processor to be indicated to one or more resources of a second context of the processor and/or otherwise perform operations described herein. In at least one embodiment, operations and/or instructions described herein in connection with FIGS. 19 and 20 are included in and/or otherwise include systems, methods, operations, and/or instructions described herein in connection with FIGS. 1-25 to perform an application programming interface (API) to cause context of one or more first software instructions to be communicated to one or more second software instructions and/or otherwise perform operations described herein. In at least one embodiment, components described herein in connection with FIGS. 19 and 20 perform one or more processes described herein in connection with FIGS. 1-25 to perform an application programming interface (API) to cause context of one or more first software instructions to be communicated to one or more second software instructions and/or otherwise perform operations described herein. In at least one embodiment, not shown in FIGS. 19 and 20, one or more components described herein in connection with FIGS. 19 and 20 include one or more components described herein in connection with FIGS. 26-58 to perform an application programming interface (API) to cause context of one or more first software instructions to be communicated to one or more second software instructions and/or otherwise perform operations described herein.

FIG. 21 is a block diagram 2100 illustrating an application programming interface (API) to wait on a context event, in accordance with at least one embodiment. In at least one embodiment, one or more circuits of a processor are to perform a wait on context event API 2102, to wait on an event that can be used by another context to synchronize performance of context (e.g., a first context records an event to signal to a second context that an execution point has been reached, thereby allowing said second context waiting on said event to continue execution). In at least one embodiment, not shown in FIG. 21, one or more circuits of a processor such as those described herein performs one or more instructions to perform wait on context event API 2102 to perform an application programming interface (API) to cause one or more second instructions to wait to be performed until the one or more second instructions receives context corresponding to one or more first software instructions. In at least one embodiment, not shown in FIG. 21, one or more circuits of a processor such as those described herein performs one or more instructions to perform wait on context event API 2102 to perform an application programming interface (API) to prevent one or more instructions from being performed by one or more resources of a first context of the processor until one or more indications of one or more events of a second context are generated. In at least one embodiment, also not shown in FIG. 21, one or more circuits of a processor such as those described herein performs one or more instructions to perform wait on context event API 2102 to perform an application programming interface (API) to cause one or more second instructions to wait to be performed until the one or more second instructions receives context corresponding to one or more first software instructions in response to receiving a second API such as those described herein.

In at least one embodiment, wait on context event API 2102 receives, when invoked, one or more arguments to indicate information about operations to be performed using techniques such as those described herein. In at least one embodiment, wait on context event API 2102 receives, when invoked, one or more arguments to indicate information about instructions to be performed using techniques such as those described herein.

In at least one embodiment, wait on context event API 2102 receives, as input, one or more arguments comprising a context 2104. In at least one embodiment, context 2104 is a data value comprising information usable to identify, indicate, or otherwise specify a context that is to wait on an event using wait on context event API 2102. In at least one embodiment, a context identified, indicated, or otherwise specified by context 2104 is one of a plurality of parameters usable by wait on context event API 2102 to wait on a context event. In at least one embodiment, context 2104 is a data value to identify, indicate, or otherwise specify to an API such as wait on context event API 2102, a set of operations or instructions to be performed by one or more PPUs, such as GPUs, and/or one or more accelerators within a heterogeneous processor, as described herein.

In at least one embodiment, wait on context event API 2102 receives, as input, one or more arguments comprising an event 2106. In at least one embodiment, event 2106 is a data value comprising information usable to identify, indicate, or otherwise specify an event that a context is to wait on, using wait on context event API 2102. In at least one embodiment, an event identified, indicated, or otherwise specified by event 2106 is one of a plurality of parameters usable by wait on context event API 2102 to wait on a context event. In at least one embodiment, event 2106 is a data value to identify, indicate, or otherwise specify to an API such as wait on context event API 2102, a set of operations or instructions to be performed by one or more PPUs, such as GPUs, and/or one or more accelerators within a heterogeneous processor, as described herein.

In at least one embodiment, wait on context event API 2102 receives, as input, one or more arguments comprising one or more other arguments 2118. In at least one embodiment, other arguments 2118 are data comprising information to indicate any other information usable in performing wait on context event API 2102 to wait on a context event.

In at least one embodiment, not shown in FIG. 21, a processor performs one or more instructions to perform one or more APIs such as wait on context event API 2102 to perform an application programming interface (API) to cause one or more second instructions to wait to be performed until the one or more second instructions receives context corresponding to one or more first software instructions using one or more arguments including, but not limited to, context 2104, event 2106, and/or other arguments 2118. In at least one embodiment, not shown in FIG. 21, a processor performs one or more instructions to perform one or more APIs such as wait on context event API 2102 to perform an application programming interface (API) to prevent one or more instructions from being performed by one or more resources of a first context of the processor until one or more indications of one or more events of a second context are generated using one or more arguments including, but not limited to, context 2104, event 2106, and/or other arguments 2118.

In at least one embodiment, wait on context event API 2102, if invoked, causes one or more APIs such as one or more APIs 306, described herein at least in connection with FIG. 3, to add one or more operations or instructions to be added, inserted, or otherwise included in a stream or set of instructions to be performed by one or more accelerators within a heterogenous processor. In at least one embodiment, wait on context event API 2102, if invoked, causes one or more APIs such as one or more APIs 306 to, in a parallel computing environment such as parallel computing environment 308, described herein at least in connection with FIG. 3, add one or more operations or instructions to be added, inserted, or otherwise included in a stream or set of instructions to be performed by one or more accelerators within a heterogenous processor.

In at least one embodiment, in response to wait on context event API 2102, one or more APIs 306, if performed, are to cause one or more processors to perform a wait on context event API return 2120. In at least one embodiment, wait on context event API return 2120 is a set of instructions that, if performed, generate and/or indicate one or more data values in response to wait on context event API 2102. In at least one embodiment, wait on context event API return 2120 indicates a success indicator 2122. In at least one embodiment, success indicator 2122 is data comprising any value to indicate success of wait on context event API 2102. In at least one embodiment, success indicator 2122 comprises information indicating one or more specific types of successes generated as a result of performing wait on context event API 2102. In at least one embodiment, success indicator 2122 comprises information indicating one or more other data values generated as a result of wait on context event API 2102.

In at least one embodiment, wait on context event API return 2120 indicates an error indicator 2124. In at least one embodiment, error indicator 2124 is data comprising any value to indicate failure of wait on context event API 2102. In at least one embodiment, error indicator 2124 comprises information indicating one or more specific types of errors generated as a result of performing wait on context event API 2102. In at least one embodiment, error indicator 2124 comprises information indicating one or more other data values generated as a result of wait on context event API 2102.

In at least one embodiment, parallel computing environment 308 comprising one or more APIs 306 including, but not limited to, wait on context event API 2102 adds various operations of various types to a stream to be performed by one or more accelerators within a heterogeneous processor. In at least one embodiment, stream operations comprise an acquire semaphore operation. In at least one embodiment, stream operations comprise a release semaphore operation. In at least one embodiment, stream operations comprise one or more operations to flush and/or invalidate cache memory, such as L2 cache memory of a PPU, such as a GPU, and/or cache memory of one or more accelerators within a heterogeneous processor. In at least one embodiment, stream operations comprise one or more operations to indicate submission of an operation to an external device, such as one or more accelerators within a heterogeneous processor. In at least one embodiment, one or more operations to indicate submission of an operation to an external device use software code such as example software code indicating stream operations as described herein at least in connection with FIG. 5.

In at least one embodiment, parallel computing environment 308 comprising one or more APIs 306 including, but not limited to, wait on context event API 2102 comprises one or more function signatures usable to indicate one or more callback functions for operations to be performed by one or more accelerators within heterogeneous processors. In at least one embodiment, one or more operations cause one or more callback functions to be performed. In at least one embodiment, one or more operations to cause one or more callback functions to be performed use software code such as example software code indicating a function signature for a callback function as described herein at least in connection with FIG. 5.

In at least one embodiment, in order to specify one or more accelerators within heterogeneous processors to perform one or more operations indicated by wait on context event API 2102 to one or more APIs 306, one or more data structures of one or more APIs 306 are usable to specify one or more external devices for which said one or more APIs 306 are to submit said one or more operations. In at least one embodiment, one or more data structures of one or more APIs 306 usable to specify one or more external devices for which said one or more APIs 306 are to submit said one or more operations use software code such as example software code indicating a data structure representing a device node for one or more accelerators within heterogeneous processors as described herein at least in connection with FIG. 5.

In at least one embodiment, in order to specify type and data of one or more operations indicated by one or more operations to be performed by one or more accelerators within heterogeneous processors, one or more data structures of one or more APIs 306 are to be used. In at least one embodiment, one or more data structures of one or more APIs 306 used to specify type and data of one or more operations indicated by one or more operations to be performed by one or more accelerators within heterogeneous processors use software code such as example software code indicating a data structure to specify type and data of one or more operations to be performed by one or more accelerators within heterogeneous processors as described herein at least in connection with FIG. 5.

In at least one embodiment, one or more APIs 306 comprise instructions that, if performed, cause one or more operations or instructions to be added to a stream or other set of instructions to be performed by one or more accelerators within heterogeneous processors. In at least one embodiment, instructions to cause one or more operations or instructions to be added to a stream or other set of instructions are to be performed in response to wait on context event API 2102, as described above. In at least one embodiment, instructions to cause one or more operations or instructions to be added to a stream or other set of instructions to be performed in response to wait on context event API 2102 use software code such as example software code indicating a stream operation API call in parallel computing environment 308 as described herein at least in connection with FIG. 5.

In at least one embodiment, one or more APIs 306 comprise instructions that, if performed, cause one or more operations or instructions to be performed by one or more accelerators within heterogeneous processors to be added to one or more executable graphs. In at least one embodiment, instructions that, if performed, cause one or more operations or instructions to be performed by one or more accelerators within heterogeneous processors to be added to one or more executable graphs are similar to how one or more operations or instructions to be performed by one or more accelerators within heterogeneous processors are to be added to one or more streams or sets of instructions in response to wait on context event API 2102, as described herein. In at least one embodiment, instructions that, if performed, cause one or more operations or instructions to be performed by one or more accelerators within heterogeneous processors to be added to one or more executable graphs use software code such as example software code indicating addition of one or more operations or instructions to one or more executable graphs by one or more APIs 306 of parallel computing environment 308 as described herein at least in connection with FIG. 5.

FIG. 22 is a block diagram 2200 illustrating a process to perform an application programming interface (API) to wait on a context event, in accordance with at least one embodiment. In at least one embodiment, said process to perform an API to wait on a context event illustrated in block diagram 2200 is a process to perform wait on context event API 2102, described herein at least in connection with FIG. 21. In at least one embodiment, some or all of said process to perform an API to wait on a context event illustrated in block diagram 2200 (or any other processes described herein, or variations and/or combinations thereof) is performed under control of one or more computer systems, servers, processors, integrated circuits, and/or other such device as described in connection with FIGS. 26-58, configured with computer-executable instructions and is implemented as code (e.g., computer-executable instructions, one or more computer programs, or one or more applications) executing collectively on one or more processors, by hardware, software, or combinations thereof. In at least one embodiment, said code is stored on a computer-readable storage medium in form of a computer program comprising a plurality of computer-readable instructions executable by one or more processors such as those described herein. In at least one embodiment, a computer-readable storage medium is a non-transitory computer-readable medium. In at least one embodiment, a processor such as processor 110, described herein at least in connection with FIG. 1, performs one or more steps of said process to perform an API to wait on a context event illustrated in block diagram 2200. In at least one embodiment, one or more other processors such as those described herein perform one or more steps of said process to perform an API to wait on a context event illustrated in block diagram 2200.

In at least one embodiment, at step 2202 of said process to perform an API to wait on a context event illustrated in block diagram 2200, a processor performing said process performs one or more operations to receive or otherwise obtain an API to wait on a context event. In at least one embodiment, at step 2202, an API to wait on a context event is received by otherwise provided to a processor such as processor 110, described herein at least in connection with FIG. 1. In at least one embodiment, at step 2202, an API to wait on a context event is received from otherwise provided by a processor such as processor 102, described herein at least in connection with FIG. 1. In at least one embodiment, at step 2202, an API to wait on a context event includes one or more arguments such as those described herein at least in connection with FIG. 21. In at least one embodiment, after step 2202, said process to perform an API to wait on a context event illustrated in block diagram 2200 continues at step 2204.

In at least one embodiment, at step 2204 of said process to perform an API to wait on a context event illustrated in block diagram 2200, a processor performing said process performs one or more operations to determine whether an API to wait on a context event (e.g., received at step 2202) is valid. In at least one embodiment, at step 2204, operations to determine whether an API to wait on a context event is valid comprise operations to verify validity of arguments of said API to wait on a context event (e.g., arguments described herein at least in connection with FIG. 21). In at least one embodiment, at step 2204, if it is determined that an API to wait on a context event is valid (“YES” branch), said process to perform an API to wait on a context event illustrated in block diagram 2200 continues at step 2206. In at least one embodiment, at step 2204, if it is determined that an API to wait on a context event is not valid (“NO” branch), said process to perform an API to wait on a context event illustrated in block diagram 2200 continues at step 2216, described below.

In at least one embodiment, at step 2206 of said process to perform an API to wait on a context event illustrated in block diagram 2200, a processor performing said process performs one or more operations to wait on an event (e.g., an event received as an argument to an API to wait on a context event, received at step 2202). In at least one embodiment, an event to wait on at step 2206 is an event to wait on (e.g., an event as described above at least in connection with FIGS. 19 and 20). In at least one embodiment, an event to wait on at step 2206 is an event recorded by a record context event API, described herein at least in connection with FIGS. 19 and 20. In at least one embodiment, after step 2206, said process to perform an API to wait on a context event illustrated in block diagram 2200 continues at step 2208.

In at least one embodiment, at step 2208 of said process to perform an API to wait on a context event illustrated in block diagram 2200, a processor performing said process performs one or more operations to determine whether a timeout occurred. In at least one embodiment, at step 2208, if it is determined that a timeout did occur (“YES” branch), said process to perform an API to wait on a context event illustrated in block diagram 2200 continues at step 2216, described below. In at least one embodiment, not shown at step 2208, if it is determined that a timeout did occur (“YES” branch), said process to perform an API to wait on a context event illustrated in block diagram 2200 terminates. In at least one embodiment, at step 2208, if it is determined that a timeout did not occur (“NO” branch), said process to perform an API to wait on a context event illustrated in block diagram 2200 continues at step 2210.

In at least one embodiment, at step 2210 of said process to perform an API to wait on a context event illustrated in block diagram 2200, a processor performing said process performs one or more operations to determine whether an event was received (e.g., recorded by another context). In at least one embodiment, at step 2210, if it is determined that an event was received (“YES” branch), said process to perform an API to wait on a context event illustrated in block diagram 2200 continues at step 2212. In at least one embodiment, at step 2210, if it is determined that an event was not received (“NO” branch), said process to perform an API to wait on a context event illustrated in block diagram 2200 continues at step 2206 to continue waiting on an event.

In at least one embodiment, at step 2212 of said process to perform an API to wait on a context event illustrated in block diagram 2200, a processor performing said process performs one or more operations to continue processing workloads associated with a context (e.g., a context waiting on an event). In at least one embodiment, after step 2212, said process to perform an API to wait on a context event illustrated in block diagram 2200 continues at step 2214.

In at least one embodiment, at step 2210 of said process to perform an API to wait on a context event illustrated in block diagram 2200, a processor performing said process performs one or more operations to return a success indicator (e.g., a success indicator 2122, described herein at least in connection with FIG. 21). In at least one embodiment, at step 2210, a success indicator is returned to a calling process (e.g., a process performed by a processor such as processor 102, described herein at least in connection with FIG. 1). In at least one embodiment, after step 2210, said process to perform an API to wait on a context event illustrated in block diagram 2200 terminates. In at least one embodiment, not shown in FIG. 22, after step 2210, said process to perform an API to wait on a context event illustrated in block diagram 2200 continues at step 2202, described above.

In at least one embodiment, at step 2212 of said process to perform an API to wait on a context event illustrated in block diagram 2200, a processor performing said process performs one or more operations to return an error indicator (e.g., an error indicator 2124, described herein at least in connection with FIG. 21). In at least one embodiment, at step 2212, an error indicator is returned to a calling process (e.g., a process performed by a processor such as processor 102, described herein at least in connection with FIG. 1). In at least one embodiment, after step 2212, said process to perform an API to wait on a context event illustrated in block diagram 2200 terminates. In at least one embodiment, not shown in FIG. 22, after step 2212, said process to perform an API to wait on a context event illustrated in block diagram 2200 continues at step 2202, described above.

In at least one embodiment, operations of said process to perform an API to wait on a context event illustrated in block diagram 2200 are performed in a different order than is illustrated in FIG. 2200. In at least one embodiment, operations of said process to perform an API to wait on a context event illustrated in block diagram 2200 are performed simultaneously or in parallel. In at least one embodiment, operations of said process to perform an API to wait on a context event illustrated in block diagram 2200 that do not depend on each other (e.g., are order independent) are performed simultaneously or in parallel. In at least one embodiment, operations of said process to perform an API to wait on a context event illustrated in block diagram 2200 are performed by a plurality of threads executing on a processor such as those described herein.

In at least one embodiment, one or more processors (e.g., processor 102, processor 110, and/or other processors and/or accelerators such as those described herein) comprise one or more circuits to perform operations and/or instructions described herein in connection with FIGS. 21 and 22, such as one or more circuits to perform an application programming interface (API) to cause one or more second instructions to wait to be performed until the one or more second instructions receives context corresponding to one or more first software instructions and/or otherwise perform operations described herein. In at least one embodiment, one or more processors (e.g., processor 102, processor 110, and/or other processors and/or accelerators such as those described herein) comprise one or more circuits to perform operations and/or instructions described herein in connection with FIGS. 21 and 22, such as one or more circuits to perform an application programming interface (API) to prevent one or more instructions from being performed by one or more resources of a first context of the processor until one or more indications of one or more events of a second context are generated and/or otherwise perform operations described herein. In at least one embodiment, operations and/or instructions described herein in connection with FIGS. 21 and 22 are included in and/or otherwise include systems, methods, operations, and/or instructions described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, components described herein in connection with FIGS. 21 and 22 perform one or more processes described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, not shown in FIGS. 21 and 22, one or more components described herein in connection with FIGS. 21 and 22 include one or more components described herein in connection with FIGS. 26-58 to perform an application programming interface (API) to cause one or more second instructions to wait to be performed until the one or more second instructions receives context corresponding to one or more first software instructions and/or otherwise perform operations described herein.

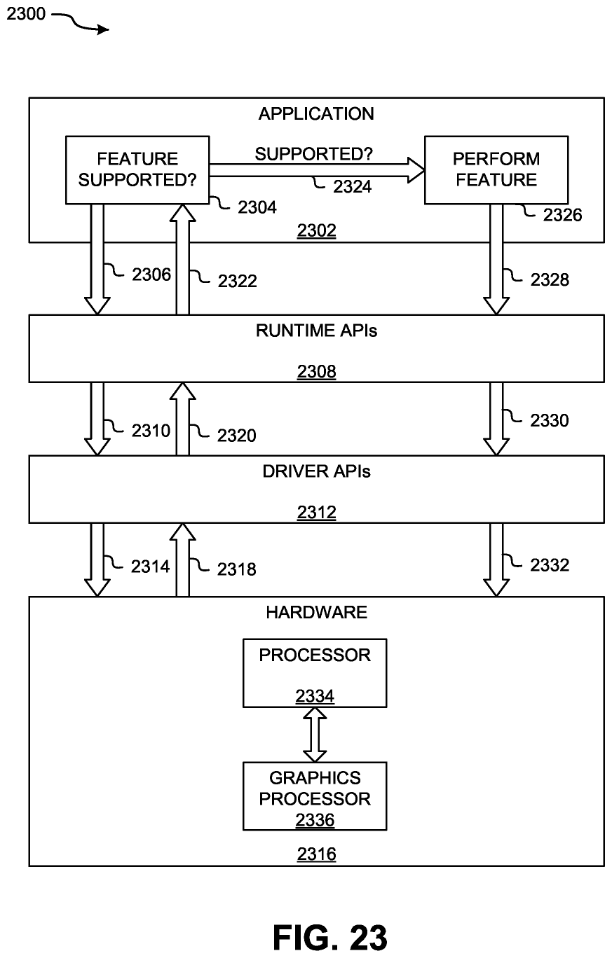

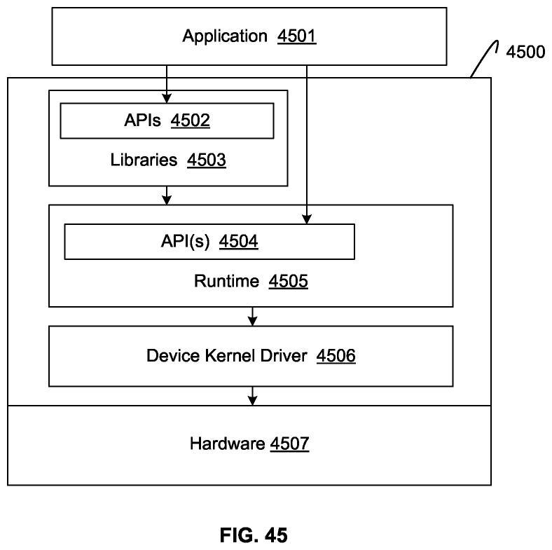

FIG. 23 is a block diagram 2300 illustrating an example software stack where application programming interfaces (API) are processed, in accordance with at least one embodiment. In at least one embodiment, example software stack illustrated in block diagram 2300 is at least a part of a software stack such as those described herein at least in connection with FIGS. 45-48. In at least one embodiment, an application 2302 executes a command to determine if a feature 2304 is supported. In at least one embodiment, an application 2302 executes a command to determine if feature 2304 to perform one or more resource operation APIs such as those described herein at least in connection with FIGS. 5-22, is supported.

In at least one embodiment, application 2302 uses 2306 one or more runtime APIs 2308 to determine if feature 2304 is supported. In at least one embodiment, runtime APIs 2308 use 2310 one or more driver APIs 2312 to determine if feature 2304 is supported. In at least one embodiment, not shown in FIG. 23, application 2302 uses one or more driver APIs 2312 to determine if feature 2304 is supported. In at least one embodiment, driver APIs 2312 query 2314 computer system hardware 2316 to determine if feature 2304 is supported.

In at least one embodiment, computer system hardware 2316 determines if feature 2304 is supported by a processor 2334, by querying a set of capabilities associated with processor 2334. In at least one embodiment, processor 2334 is a processor such as processor 102 and/or processor 110, both described herein at least in connection with FIG. 1. In at least one embodiment, computer system hardware 2316 determines if a feature 2304 is supported by processor 2334, using an operating system of processor 2334. In at least one embodiment, computer system hardware 2316 determines if feature is supported by a graphics processor 2336 by querying a set of capabilities associated with graphics processor 2336. In at least one embodiment, graphics processor 2336 is a graphics processor such as graphics processors described herein. In at least one embodiment, computer system hardware 2316 determines if feature 2304 is supported by graphics processor 2336 using an operating system of processor 2334. In at least one embodiment, computer system hardware 2316 determines if feature 2304 is supported by graphics processor 2336, using an operating system of graphics processor 2336.

In at least one embodiment, after computer system hardware 2316 determines whether feature 2304 is supported, computer system hardware 2316 returns 2318 a determination result using driver APIs 2312, which may return 2320 a determination result using runtime APIs 2308, which may return 2322 a determination result to application 2302. In at least one embodiment, if application 2302 receives a determination result that indicates that feature 2304 is supported 2324, application 2302 performs a feature 2326 using one or more APIs such as those described herein. In at least one embodiment, application 2302 performs feature 2326 using systems and methods such as those described herein. In at least one embodiment, application 2302 performs feature 2326 using 2328 runtime APIs 2308 including, but not limited to, runtime versions of APIs such as those described herein at least in connection with FIGS. 5-22.

In at least one embodiment, runtime APIs 2308 perform feature 2326 using 2330 driver APIs 2312 including, but not limited to, driver versions of APIs such as those described herein. In at least one embodiment, not shown in FIG. 23, application 2302 performs feature 2326 using 2330 driver APIs 2312. In at least one embodiment, driver APIs 2312 perform feature 2326 using 2332 computer system hardware 2316.

In at least one embodiment, an API such as create sub-context API 502 as described herein at least in connection with FIGS. 5 and 6 is processed using example software stack illustrated in block diagram 2300 to perform an application programming interface (API) to allocate one or more data structures to indicate which of one or more streaming multiprocessors (SMs) of one or more processors are to be used to perform one or more software threads.

In at least one embodiment, an API such as destroy sub-context API 702 as described herein at least in connection with FIGS. 7 and 8 is processed using example software stack illustrated in block diagram 2300 to perform an application programming interface (API) to deallocate one or more data structures to indicate which of one or more streaming multiprocessors (SMs) of one or more processors are to be used to perform one or more software threads.

In at least one embodiment, an API such as get sub-context from stream API 902 as described herein at least in connection with FIGS. 9 and 10 is processed using example software stack illustrated in block diagram 2300 to perform an application programming interface (API) to cause one or more identifiers of one or more data structures indicating a number of one or more streaming multiprocessors (SMs) of one or more processors to be stored.

In at least one embodiment, an API such as get context resource API 1102 as described herein at least in connection with FIGS. 11 and 12 is processed using example software stack illustrated in block diagram 2300 to perform an application programming interface (API) to indicate one or more streaming multiprocessors (SMs) of one or more processors available to be used to perform one or more software threads.

In at least one embodiment, an API such as subdivide context resources API 1302 as described herein at least in connection with FIGS. 13 and 14 is processed example software stack illustrated in block diagram 23000 to perform an application programming interface (API) to cause a plurality of identifiers of a corresponding plurality of streaming multiprocessors (SMs) of one or more processors to be stored according to a plurality of groups, in which the corresponding plurality of SMs are to be used.

In at least one embodiment, an API such as generate resource descriptor API 1502 as described herein at least in connection with FIGS. 15 and 16 is processed using software stack 2300 to perform an application programming interface (API) to indicate one or more groups of streaming multiprocessors (SMs) of one or more processors, on which to schedule one or more corresponding groups of software threads.

In at least one embodiment, an API such as get device resources API 1702 as described herein at least in connection with FIGS. 17 and 18 is processed using example software stack illustrated in block diagram 2300 to perform an application programming interface (API) to cause one or more indicators of one or more numbers of one or more streaming multiprocessors (SMs) of one or more processors to be read from one or more data structures storing the one or more indicators.

In at least one embodiment, an API such as record context event API 1902 as described herein at least in connection with FIGS. 19 and 20 is processed using example software stack illustrated in block diagram 2300 to perform an application programming interface (API) to cause context of one or more first software instructions to be communicated to one or more second software instructions.

In at least one embodiment, an API such as wait on context event API 2102 as described herein at least in connection with FIGS. 21 and 22 is processed using example software stack illustrated in block diagram 2300 to perform an application programming interface (API) to cause one or more second instructions to wait to be performed until the one or more second instructions receives context corresponding to one or more first software instructions.

In at least one embodiment, one or more processors (e.g., such as those described herein) comprise one or more circuits to perform operations and/or instructions described herein in connection with FIG. 23, such as one or more circuits to perform an application programming interface (API) to allocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 23 are included in and/or otherwise include systems, methods, operations, and/or instructions described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, components described herein in connection with FIG. 23 perform one or more processes described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, not shown in FIG. 23, one or more components described herein in connection with FIG. 23 include one or more components described herein in connection with FIGS. 26-58 to perform an application programming interface (API) to allocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 23, such as one or more circuits to perform an application programming interface (API) to deallocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 23 are included in and/or otherwise include systems, methods, operations, and/or instructions described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, components described herein in connection with FIG. 23 perform one or more processes described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, not shown in FIG. 23, one or more components described herein in connection with FIG. 23 include one or more components described herein in connection with FIGS. 26-58 to perform an application programming interface (API) to deallocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 23, such as one or more circuits to perform an application programming interface (API) to cause one or more identifiers of one or more data structures indicating a number of one or more streaming multiprocessors (SMs) of one or more processors to be stored and/or otherwise perform operations described herein. In at least one embodiment, operations and/or instructions described herein in connection with FIG. 23 are included in and/or otherwise include systems, methods, operations, and/or instructions described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, components described herein in connection with FIG. 23 perform one or more processes described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, not shown in FIG. 23, one or more components described herein in connection with FIG. 23 include one or more components described herein in connection with FIGS. 26-58 to perform an application programming interface (API) to cause one or more identifiers of one or more data structures indicating a number of one or more streaming multiprocessors (SMs) of one or more processors to be stored and/or otherwise perform operations described herein.

In at least one embodiment, one or more processors (e.g., such as those described herein) comprise one or more circuits to perform operations and/or instructions described herein in connection with FIG. 23, such as one or more circuits to perform an application programming interface (API) to indicate one or more streaming multiprocessors (SMs) of one or more processors available to be used to perform one or more software threads and/or otherwise perform operations described herein. In at least one embodiment, operations and/or instructions described herein in connection with FIG. 23 are included in and/or otherwise include systems, methods, operations, and/or instructions described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, components described herein in connection with FIG. 23 perform one or more processes described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, not shown in FIG. 23, one or more components described herein in connection with FIG. 23 include one or more components described herein in connection with FIGS. 26-58 to perform an application programming interface (API) to indicate one or more streaming multiprocessors (SMs) of one or more processors available to be used to perform one or more software threads and/or otherwise perform operations described herein.

In at least one embodiment, one or more processors (e.g., such as those described herein) comprise one or more circuits to perform operations and/or instructions described herein in connection with FIG. 23, such as one or more circuits to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, operations and/or instructions described herein in connection with FIG. 23 are included in and/or otherwise include systems, methods, operations, and/or instructions described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, components described herein in connection with FIG. 23 perform one or more processes described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, not shown in FIG. 23, one or more components described herein in connection with FIG. 23 include one or more components described herein in connection with FIGS. 26-58 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein.

In at least one embodiment, one or more processors (e.g., such as those described herein) comprise one or more circuits to perform operations and/or instructions described herein in connection with FIG. 23, such as one or more circuits to perform an application programming interface (API) to indicate one or more groups of streaming multiprocessors (SMs) of one or more processors, on which to schedule one or more corresponding groups of software threads and/or otherwise perform operations described herein. In at least one embodiment, operations and/or instructions described herein in connection with FIG. 23 are included in and/or otherwise include systems, methods, operations, and/or instructions described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, components described herein in connection with FIG. 23 perform one or more processes described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, not shown in FIG. 23, one or more components described herein in connection with FIG. 23 include one or more components described herein in connection with FIGS. 26-58 to perform an application programming interface (API) to indicate one or more groups of streaming multiprocessors (SMs) of one or more processors, on which to schedule one or more corresponding groups of software threads and/or otherwise perform operations described herein.

In at least one embodiment, one or more processors (e.g., such as those described herein) comprise one or more circuits to perform operations and/or instructions described herein in connection with FIG. 23, such as one or more circuits to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, operations and/or instructions described herein in connection with FIG. 23 are included in and/or otherwise include systems, methods, operations, and/or instructions described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, components described herein in connection with FIG. 23 perform one or more processes described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, not shown in FIG. 23, one or more components described herein in connection with FIG. 23 include one or more components described herein in connection with FIGS. 26-58 to perform an application programming interface (API) to cause one or more indicators of one or more numbers of one or more streaming multiprocessors (SMs) of one or more processors to be read from one or more data structures storing the one or more indicators and/or otherwise perform operations described herein.

In at least one embodiment, one or more processors (e.g., such as those described herein) comprise one or more circuits to perform operations and/or instructions described herein in connection with FIG. 23, such as one or more circuits to perform an application programming interface (API) to cause context of one or more first software instructions to be communicated to one or more second software instructions and/or otherwise perform operations described herein. In at least one embodiment, operations and/or instructions described herein in connection with FIG. 23 are included in and/or otherwise include systems, methods, operations, and/or instructions described herein in connection with FIGS. 1-25 to perform an application programming interface (API) to cause context of one or more first software instructions to be communicated to one or more second software instructions and/or otherwise perform operations described herein. In at least one embodiment, components described herein in connection with FIG. 23 perform one or more processes described herein in connection with FIGS. 1-25 to perform an application programming interface (API) to cause context of one or more first software instructions to be communicated to one or more second software instructions and/or otherwise perform operations described herein. In at least one embodiment, not shown in FIG. 23, one or more components described herein in connection with FIG. 23 include one or more components described herein in connection with FIGS. 26-58 to perform an application programming interface (API) to cause context of one or more first software instructions to be communicated to one or more second software instructions and/or otherwise perform operations described herein.

In at least one embodiment, one or more processors (e.g., such as those described herein) comprise one or more circuits to perform operations and/or instructions described herein in connection with FIG. 23, such as one or more circuits to perform an application programming interface (API) to cause one or more second instructions to wait to be performed until the one or more second instructions receives context corresponding to one or more first software instructions and/or otherwise perform operations described herein. In at least one embodiment, operations and/or instructions described herein in connection with FIG. 23 are included in and/or otherwise include systems, methods, operations, and/or instructions described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, components described herein in connection with FIG. 23 perform one or more processes described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, not shown in FIG. 23, one or more components described herein in connection with FIG. 23 include one or more components described herein in connection with FIGS. 26-58 to perform an application programming interface (API) to cause one or more second instructions to wait to be performed until the one or more second instructions receives context corresponding to one or more first software instructions and/or otherwise perform operations described herein.

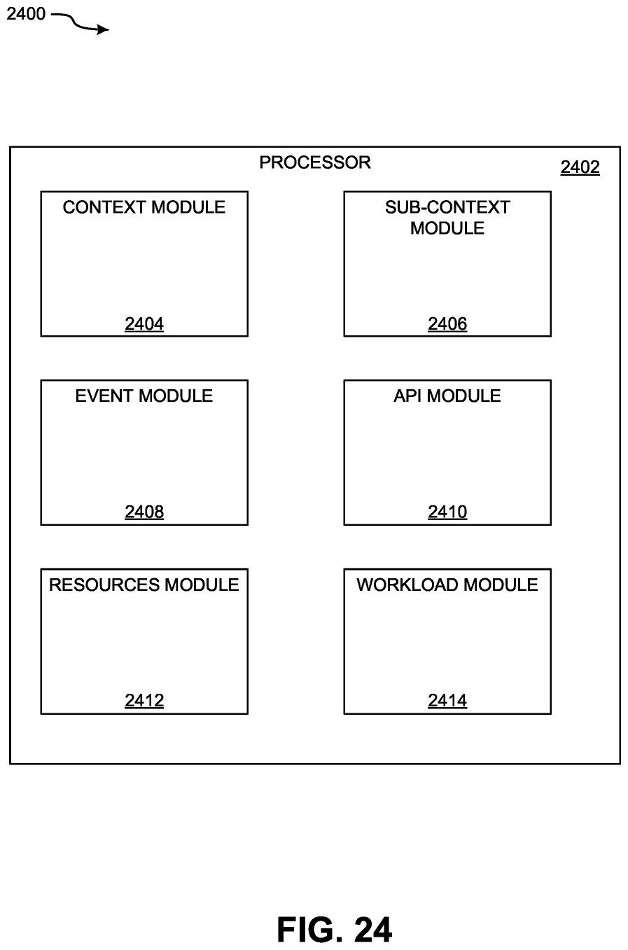

FIG. 24 is a block diagram 2400 illustrating a processor and modules, in accordance with at least one embodiment. In at least one embodiment, processor 2402 comprises one or more processors such as those described in connection with FIGS. 26-58. In at least one embodiment, processor 2402 is a processor such as processor 102, described herein at least in connection with FIG. 1. In at least one embodiment, processor 2402 is any suitable processing unit and/or combination of processing units, such as one or more CPUs, GPUs, GPGPUs, PPUs, and/or variations thereof. In at least one embodiment, processor 2402 comprises or has access to one or more of a context module 2404, a sub-context module 2406, an event module 2408, an API module 2410, a resources module 2412, and a workload module 2414. In at least one embodiment, context module 2404, sub-context module 2406, event module 2408, API module 2410, resources module 2412, and/or workload module 2414 are part of processor 2402 and/or one or more other processors such as those described herein. In at least one embodiment, context module 2404, sub-context module 2406, event module 2408, API module 2410, resources module 2412, and/or workload module 2414 are distributed among multiple processors that communicate over a bus, network, by writing to shared memory, and/or any suitable communication process such as those described herein.

In at least one embodiment, a module as used in any implementation described herein, unless otherwise clear from context or stated explicitly to contrary, refers to any combination of software logic, firmware logic, hardware logic, and/or circuitry configured to provide functionality described herein. In at least one embodiment, software may be embodied as a software package, code and/or instruction set or instructions, and “hardware,” as used, such as by a processor, in any implementation described herein, may include, for example, singly or in any combination, hardwired circuitry, programmable circuitry, state machine circuitry, fixed function circuitry, execution unit circuitry, and/or firmware that stores instructions executed by programmable circuitry. In at least one embodiment, modules may, collectively or individually, be embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUs, GPGPUs, PPUs, and/or variations thereof.

In at least one embodiment, processor 2402 uses context module 2404 to perform one or more resource operation APIs using systems, methods, operations, and/or instructions described herein in connection with FIGS. 1-23. In at least one embodiment, processor 2402 performs context module 2404 and processes such as those described herein, by at least including or otherwise encoding instructions that cause performance of, or otherwise can be utilized to perform, said one or more processes (e.g., by processor 2402). In at least one embodiment, processor 2402 performing context module 2404 obtains or is otherwise provided with one or more APIs such as those described herein in connection with FIGS. 5-22. In at least one embodiment, processor 2402 uses context module 2404 with one or more of sub-context module 2406, event module 2408, API module 2410, resources module 2412, and workload module 2414 to perform one or more resource operation APIs.

In at least one embodiment, processor 2402 uses sub-context module 2406 to perform one or more resource operation APIs using systems, methods, operations, and/or instructions described herein in connection with FIGS. 1-23. In at least one embodiment, processor 2402 performs sub-context module 2406 and processes such as those described herein, by at least including or otherwise encoding instructions that cause performance of, or otherwise can be utilized to perform, said one or more processes (e.g., by processor 2402). In at least one embodiment, processor 2402 performing sub-context module 2406 obtains or is otherwise provided with one or more APIs such as those described herein in connection with FIGS. 5-22. In at least one embodiment, processor 2402 uses sub-context module 2406 with one or more of context module 2404, event module 2408, API module 2410, resources module 2412, and workload module 2414 to perform one or more resource operation APIs.

In at least one embodiment, processor 2402 uses event module 2408 to perform one or more resource operation APIs using systems, methods, operations, and/or instructions described herein in connection with FIGS. 1-23. In at least one embodiment, processor 2402 performs event module 2408 and processes such as those described herein, by at least including or otherwise encoding instructions that cause performance of, or otherwise can be utilized to perform, said one or more processes (e.g., by processor 2402). In at least one embodiment, processor 2402 performing event module 2408 obtains or is otherwise provided with one or more APIs such as those described herein in connection with FIGS. 5-22. In at least one embodiment, processor 2402 uses event module 2408 with one or more of context module 2404, sub-context module 2406, API module 2410, resources module 2412, and workload module 2414 to perform one or more resource operation APIs.

In at least one embodiment, processor 2402 uses API module 2410 to perform one or more resource operation APIs using systems, methods, operations, and/or instructions described herein in connection with FIGS. 1-23. In at least one embodiment, processor 2402 performs API module 2410 and processes such as those described herein, by at least including or otherwise encoding instructions that cause performance of, or otherwise can be utilized to perform, said one or more processes (e.g., by processor 2402). In at least one embodiment, processor 2402 performing API module 2410 obtains or is otherwise provided with one or more APIs such as those described herein in connection with FIGS. 5-22. In at least one embodiment, processor 2402 uses API module 2410 with one or more of context module 2404, sub-context module 2406, event module 2408, resources module 2412, and workload module 2414 to perform one or more resource operation APIs.

In at least one embodiment, processor 2402 uses resources module 2412 to perform one or more resource operation APIs using systems, methods, operations, and/or instructions described herein in connection with FIGS. 1-23. In at least one embodiment, processor 2402 performs resources module 2412 and processes such as those described herein, by at least including or otherwise encoding instructions that cause performance of, or otherwise can be utilized to perform, said one or more processes (e.g., by processor 2402). In at least one embodiment, processor 2402 performing resources module 2412 obtains or is otherwise provided with one or more APIs such as those described herein in connection with FIGS. 5-22. In at least one embodiment, processor 2402 uses resources module 2412 with one or more of context module 2404, sub-context module 2406, event module 2408, API module 2410, and workload module 2414 to perform one or more resource operation APIs.

In at least one embodiment, processor 2402 uses workload module 2414 to perform one or more resource operation APIs using systems, methods, operations, and/or instructions described herein in connection with FIGS. 1-23. In at least one embodiment, processor 2402 performs workload module 2414 and processes such as those described herein, by at least including or otherwise encoding instructions that cause performance of, or otherwise can be utilized to perform, said one or more processes (e.g., by processor 2402). In at least one embodiment, processor 2402 performing workload module 2414 obtains or is otherwise provided with one or more APIs such as those described herein in connection with FIGS. 5-22. In at least one embodiment, processor 2402 uses workload module 2414 with one or more of context module 2404, sub-context module 2406, event module 2408, API module 2410, and resources module 2412 to perform one or more resource operation APIs.

In at least one embodiment, processor 2402 comprises circuitry to cause one or more circuits of processor 2402 to perform an application programming interface (API) to allocate one or more data structures to indicate which of one or more streaming multiprocessors (SMs) of one or more processors are to be used to perform one or more software threads using one or more of context module 2404, sub-context module 2406, event module 2408, API module 2410, resources module 2412, and/or workload module 2414 using systems, methods, operations, and/or instructions described herein at least in connection with FIGS. 1-23.

In at least one embodiment, processor 2402 comprises circuitry to cause one or more circuits of processor 2402 to perform an application programming interface (API) to deallocate one or more data structures to indicate which of one or more streaming multiprocessors (SMs) of one or more processors are to be used to perform one or more software threads using one or more of context module 2404, sub-context module 2406, event module 2408, API module 2410, resources module 2412, and/or workload module 2414 using systems, methods, operations, and/or instructions described herein at least in connection with FIGS. 1-23.

In at least one embodiment, processor 2402 comprises circuitry to cause one or more circuits of processor 2402 to perform an application programming interface (API) to cause one or more identifiers of one or more data structures indicating a number of one or more streaming multiprocessors (SMs) of one or more processors to be stored using one or more of context module 2404, sub-context module 2406, event module 2408, API module 2410, resources module 2412, and/or workload module 2414 using systems, methods, operations, and/or instructions described herein at least in connection with FIGS. 1-23.

In at least one embodiment, processor 2402 comprises circuitry to cause one or more circuits of processor 2402 to perform an application programming interface (API) to indicate one or more streaming multiprocessors (SMs) of one or more processors available to be used to perform one or more software threads using one or more of context module 2404, sub-context module 2406, event module 2408, API module 2410, resources module 2412, and/or workload module 2414 using systems, methods, operations, and/or instructions described herein at least in connection with FIGS. 1-23.

In at least one embodiment, processor 2402 comprises circuitry to cause one or more circuits of processor 2402 to perform an application programming interface (API) to cause a plurality of identifiers of a corresponding plurality of streaming multiprocessors (SMs) of one or more processors to be stored according to a plurality of groups, in which the corresponding plurality of SMs are to be used using one or more of context module 2404, sub-context module 2406, event module 2408, API module 2410, resources module 2412, and/or workload module 2414 using systems, methods, operations, and/or instructions described herein at least in connection with FIGS. 1-23.

In at least one embodiment, processor 2402 comprises circuitry to cause one or more circuits of processor 2402 to perform an application programming interface (API) to indicate one or more groups of streaming multiprocessors (SMs) of one or more processors, on which to schedule one or more corresponding groups of software threads using one or more of context module 2404, sub-context module 2406, event module 2408, API module 2410, resources module 2412, and/or workload module 2414 using systems, methods, operations, and/or instructions described herein at least in connection with FIGS. 1-23.

In at least one embodiment, processor 2402 comprises circuitry to cause one or more circuits of processor 2402 to perform an application programming interface (API) to cause one or more indicators of one or more numbers of one or more streaming multiprocessors (SMs) of one or more processors to be read from one or more data structures storing the one or more indicators using one or more of context module 2404, sub-context module 2406, event module 2408, API module 2410, resources module 2412, and/or workload module 2414 using systems, methods, operations, and/or instructions described herein at least in connection with FIGS. 1-23.

In at least one embodiment, processor 2402 comprises circuitry to cause one or more circuits of processor 2402 to perform an application programming interface (API) to cause context of one or more first software instructions to be communicated to one or more second software instructions using one or more of context module 2404, sub-context module 2406, event module 2408, API module 2410, resources module 2412, and/or workload module 2414 using systems, methods, operations, and/or instructions described herein at least in connection with FIGS. 1-23.

In at least one embodiment, processor 2402 comprises circuitry to cause one or more circuits of processor 2402 to perform an application programming interface (API) to cause one or more second instructions to wait to be performed until the one or more second instructions receives context corresponding to one or more first software instructions using one or more of context module 2404, sub-context module 2406, event module 2408, API module 2410, resources module 2412, and/or workload module 2414 using systems, methods, operations, and/or instructions described herein at least in connection with FIGS. 1-23.

In at least one embodiment, one or more processors (e.g., such as those described herein) comprise one or more circuits to perform operations and/or instructions described herein in connection with FIG. 24, such as one or more circuits to perform an application programming interface (API) to allocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 24 are included in and/or otherwise include systems, methods, operations, and/or instructions described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, components described herein in connection with FIG. 24 perform one or more processes described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, not shown in FIG. 24, one or more components described herein in connection with FIG. 24 include one or more components described herein in connection with FIGS. 26-58 to perform an application programming interface (API) to allocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 24, such as one or more circuits to perform an application programming interface (API) to deallocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 24 are included in and/or otherwise include systems, methods, operations, and/or instructions described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, components described herein in connection with FIG. 24 perform one or more processes described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, not shown in FIG. 24, one or more components described herein in connection with FIG. 24 include one or more components described herein in connection with FIGS. 26-58 to perform an application programming interface (API) to deallocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 24, such as one or more circuits to perform an application programming interface (API) to cause one or more identifiers of one or more data structures indicating a number of one or more streaming multiprocessors (SMs) of one or more processors to be stored and/or otherwise perform operations described herein. In at least one embodiment, operations and/or instructions described herein in connection with FIG. 24 are included in and/or otherwise include systems, methods, operations, and/or instructions described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, components described herein in connection with FIG. 24 perform one or more processes described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, not shown in FIG. 24, one or more components described herein in connection with FIG. 24 include one or more components described herein in connection with FIGS. 26-58 to perform an application programming interface (API) to cause one or more identifiers of one or more data structures indicating a number of one or more streaming multiprocessors (SMs) of one or more processors to be stored and/or otherwise perform operations described herein.

In at least one embodiment, one or more processors (e.g., such as those described herein) comprise one or more circuits to perform operations and/or instructions described herein in connection with FIG. 24, such as one or more circuits to perform an application programming interface (API) to indicate one or more streaming multiprocessors (SMs) of one or more processors available to be used to perform one or more software threads and/or otherwise perform operations described herein. In at least one embodiment, operations and/or instructions described herein in connection with FIG. 24 are included in and/or otherwise include systems, methods, operations, and/or instructions described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, components described herein in connection with FIG. 24 perform one or more processes described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, not shown in FIG. 24, one or more components described herein in connection with FIG. 24 include one or more components described herein in connection with FIGS. 26-58 to perform an application programming interface (API) to indicate one or more streaming multiprocessors (SMs) of one or more processors available to be used to perform one or more software threads and/or otherwise perform operations described herein.

In at least one embodiment, one or more processors (e.g., such as those described herein) comprise one or more circuits to perform operations and/or instructions described herein in connection with FIG. 24, such as one or more circuits to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, operations and/or instructions described herein in connection with FIG. 24 are included in and/or otherwise include systems, methods, operations, and/or instructions described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, components described herein in connection with FIG. 24 perform one or more processes described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, not shown in FIG. 24, one or more components described herein in connection with FIG. 24 include one or more components described herein in connection with FIGS. 26-58 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein.

In at least one embodiment, one or more processors (e.g., such as those described herein) comprise one or more circuits to perform operations and/or instructions described herein in connection with FIG. 24, such as one or more circuits to perform an application programming interface (API) to indicate one or more groups of streaming multiprocessors (SMs) of one or more processors, on which to schedule one or more corresponding groups of software threads and/or otherwise perform operations described herein. In at least one embodiment, operations and/or instructions described herein in connection with FIG. 24 are included in and/or otherwise include systems, methods, operations, and/or instructions described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, components described herein in connection with FIG. 24 perform one or more processes described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, not shown in FIG. 24, one or more components described herein in connection with FIG. 24 include one or more components described herein in connection with FIGS. 26-58 to perform an application programming interface (API) to indicate one or more groups of streaming multiprocessors (SMs) of one or more processors, on which to schedule one or more corresponding groups of software threads and/or otherwise perform operations described herein.

In at least one embodiment, one or more processors (e.g., such as those described herein) comprise one or more circuits to perform operations and/or instructions described herein in connection with FIG. 24, such as one or more circuits to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, operations and/or instructions described herein in connection with FIG. 24 are included in and/or otherwise include systems, methods, operations, and/or instructions described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, components described herein in connection with FIG. 24 perform one or more processes described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, not shown in FIG. 24, one or more components described herein in connection with FIG. 24 include one or more components described herein in connection with FIGS. 26-58 to perform an application programming interface (API) to cause one or more indicators of one or more numbers of one or more streaming multiprocessors (SMs) of one or more processors to be read from one or more data structures storing the one or more indicators and/or otherwise perform operations described herein.

In at least one embodiment, one or more processors (e.g., such as those described herein) comprise one or more circuits to perform operations and/or instructions described herein in connection with FIG. 24, such as one or more circuits to perform an application programming interface (API) to cause context of one or more first software instructions to be communicated to one or more second software instructions and/or otherwise perform operations described herein. In at least one embodiment, operations and/or instructions described herein in connection with FIG. 24 are included in and/or otherwise include systems, methods, operations, and/or instructions described herein in connection with FIGS. 1-25 to perform an application programming interface (API) to cause context of one or more first software instructions to be communicated to one or more second software instructions and/or otherwise perform operations described herein. In at least one embodiment, components described herein in connection with FIG. 24 perform one or more processes described herein in connection with FIGS. 1-25 to perform an application programming interface (API) to cause context of one or more first software instructions to be communicated to one or more second software instructions and/or otherwise perform operations described herein. In at least one embodiment, not shown in FIG. 24, one or more components described herein in connection with FIG. 24 include one or more components described herein in connection with FIGS. 26-58 to perform an application programming interface (API) to cause context of one or more first software instructions to be communicated to one or more second software instructions and/or otherwise perform operations described herein.

In at least one embodiment, one or more processors (e.g., such as those described herein) comprise one or more circuits to perform operations and/or instructions described herein in connection with FIG. 24, such as one or more circuits to perform an application programming interface (API) to cause one or more second instructions to wait to be performed until the one or more second instructions receives context corresponding to one or more first software instructions and/or otherwise perform operations described herein. In at least one embodiment, operations and/or instructions described herein in connection with FIG. 24 are included in and/or otherwise include systems, methods, operations, and/or instructions described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, components described herein in connection with FIG. 24 perform one or more processes described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, not shown in FIG. 24, one or more components described herein in connection with FIG. 24 include one or more components described herein in connection with FIGS. 26-58 to perform an application programming interface (API) to cause one or more second instructions to wait to be performed until the one or more second instructions receives context corresponding to one or more first software instructions and/or otherwise perform operations described herein.

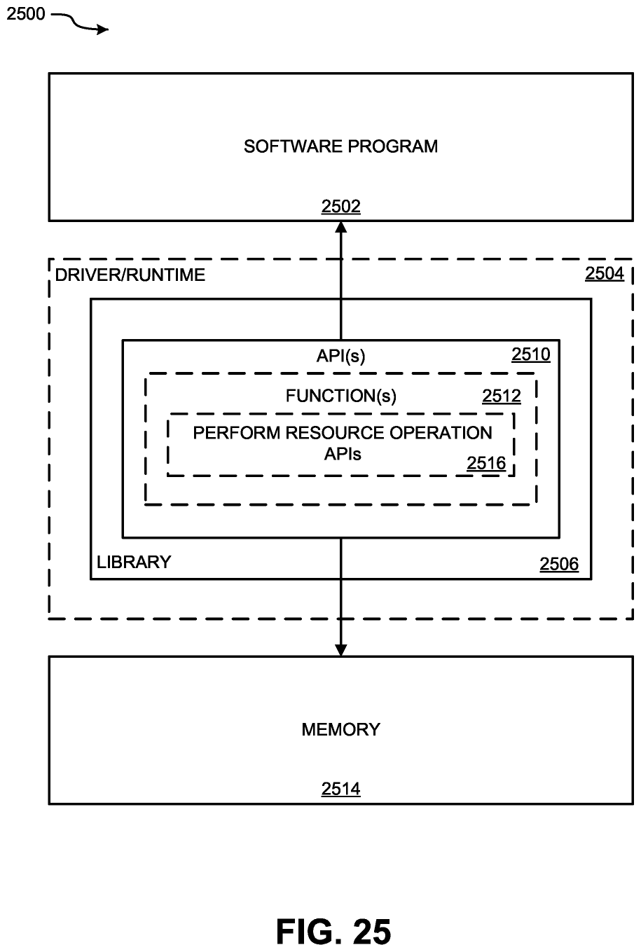

FIG. 25 is a block diagram 2500 illustrating a driver and/or runtime comprising one or more libraries to provide one or more application programming interfaces (APIs), in accordance with at least one embodiment. In at least one embodiment, a software program 2502 is a software module. In at least one embodiment, a software program 2502 comprises one or more software modules including, but not limited to, those described herein at least in connection with FIG. 24. In at least one embodiment, a software module is as further described non-exclusively in FIG. 24. In at least one embodiment, one or more APIs 2510 are sets of software instructions that, if executed, cause one or more processors to perform one or more computational operations.

In at least one embodiment, one or more APIs 2510 are sets of software instructions (e.g., as described herein at least in connection with FIGS. 5-22) that, if executed, cause one or more processors to perform one or more computational operations to perform an application programming interface (API) to allocate one or more data structures to indicate which of one or more streaming multiprocessors (SMs) of one or more processors are to be used to perform one or more software threads.

In at least one embodiment, one or more APIs 2510 are sets of software instructions (e.g., as described herein at least in connection with FIGS. 5-22) that, if executed, cause one or more processors to perform one or more computational operations to perform an application programming interface (API) to deallocate one or more data structures to indicate which of one or more streaming multiprocessors (SMs) of one or more processors are to be used to perform one or more software threads.

In at least one embodiment, one or more APIs 2510 are sets of software instructions (e.g., as described herein at least in connection with FIGS. 5-22) that, if executed, cause one or more processors to perform one or more computational operations to perform an application programming interface (API) to cause one or more identifiers of one or more data structures indicating a number of one or more streaming multiprocessors (SMs) of one or more processors to be stored.

In at least one embodiment, one or more APIs 2510 are sets of software instructions (e.g., as described herein at least in connection with FIGS. 5-22) that, if executed, cause one or more processors to perform one or more computational operations to perform an application programming interface (API) to indicate one or more streaming multiprocessors (SMs) of one or more processors available to be used to perform one or more software threads.

In at least one embodiment, one or more APIs 2510 are sets of software instructions (e.g., as described herein at least in connection with FIGS. 5-22) that, if executed, cause one or more processors to perform one or more computational operations to perform an application programming interface (API) to cause a plurality of identifiers of a corresponding plurality of streaming multiprocessors (SMs) of one or more processors to be stored according to a plurality of groups, in which the corresponding plurality of SMs are to be used.

In at least one embodiment, one or more APIs 2510 are sets of software instructions (e.g., as described herein at least in connection with FIGS. 5-22) that, if executed, cause one or more processors to perform one or more computational operations to perform an application programming interface (API) to indicate one or more groups of streaming multiprocessors (SMs) of one or more processors, on which to schedule one or more corresponding groups of software threads.

In at least one embodiment, one or more APIs 2510 are sets of software instructions (e.g., as described herein at least in connection with FIGS. 5-22) that, if executed, cause one or more processors to perform one or more computational operations to perform an application programming interface (API) to cause one or more indicators of one or more numbers of one or more streaming multiprocessors (SMs) of one or more processors to be read from one or more data structures storing the one or more indicators.

In at least one embodiment, one or more APIs 2510 are sets of software instructions (e.g., as described herein at least in connection with FIGS. 5-22) that, if executed, cause one or more processors to perform one or more computational operations to perform an application programming interface (API) to cause context of one or more first software instructions to be communicated to one or more second software instructions.

In at least one embodiment, one or more APIs 2510 are sets of software instructions (e.g., as described herein at least in connection with FIGS. 5-22) that, if executed, cause one or more processors to perform one or more computational operations to perform an application programming interface (API) to cause one or more second instructions to wait to be performed until the one or more second instructions receives context corresponding to one or more first software instructions.

In at least one embodiment, one or more APIs 2510 are distributed or otherwise provided as a part of one or more libraries 2506, drivers and/or runtimes 2504, and/or any other grouping of software and/or executable code further described herein. In at least one embodiment, one or more APIs 2510 perform one or more computational operations in response to invocation by software programs 2502. In at least one embodiment, a software program 2502 is a collection of software code, commands, instructions, or other sequences of text to instruct a computing device to perform one or more computational operations and/or invoke one or more other sets of instructions, such as APIs 2510 or API functions 2512, to be executed. In at least one embodiment, functionality provided by one or more APIs 2510 include software functions 2512, such as those usable to accelerate one or more portions of software programs 2502 using one or more parallel processing units (PPUs), such as graphics processing units (GPUs).

In at least one embodiment, APIs 2510 are hardware interfaces to one or more circuits to perform one or more computational operations. In at least one embodiment, one or more software APIs 2510 described herein are implemented as one or more circuits to perform one or more techniques described herein in conjunction with FIGS. 1-24. In at least one embodiment, one or more software programs 2502 comprise instructions that, if executed, cause one or more hardware devices and/or circuits to perform one or more techniques described herein in conjunction with FIGS. 1-24.

In at least one embodiment, software programs 2502, such as user-implemented software programs, utilize one or more application programming interfaces (APIs) 2510 to perform various computing operations, such as memory reservation, matrix multiplication, arithmetic operations, or any computing operation performed by parallel processing units (PPUs), such as graphics processing units (GPUs), as further described herein. In at least one embodiment, one or more APIs 2510 provide a set of callable functions 2512, referred to herein as APIs, API functions, and/or functions, that individually perform one or more computing operations, such as computing operations related to parallel computing. For example, in an embodiment, one or more APIs 2510 provide functions 2512 to launch workloads, monitor workloads, and/or terminate workloads, as described herein.

In at least one embodiment, one or more software programs 2502 interact or otherwise communicate with one or more APIs 2510 to perform one or more computing operations using one or more PPUs, such as GPUs. In at least one embodiment, one or more computing operations using one or more PPUs comprise at least one or more groups of computing operations to be accelerated by execution at least in part by said one or more PPUs. In at least one embodiment, one or more software programs 2502 interact with one or more APIs 2510 to facilitate parallel computing using a remote or local interface.

In at least one embodiment, an interface is software instructions that, if executed, provide access to one or more functions 2512 provided by one or more APIs 2510. In at least one embodiment, a software program 2502 uses a local interface when a software developer compiles one or more software programs 2502 in conjunction with one or more libraries 2506 comprising or otherwise providing access to one or more APIs 2510. In at least one embodiment, one or more software programs 2502 are compiled statically in conjunction with pre-compiled libraries 2506 or uncompiled source code comprising instructions to perform one or more APIs 2510. In at least one embodiment, one or more software programs 2502 are compiled dynamically and said one or more software programs utilize a linker to link to one or more pre-compiled libraries 2506 comprising one or more APIs 2510.

In at least one embodiment, a software program 2502 uses a remote interface when a software developer executes a software program that utilizes or otherwise communicates with a library 2506 comprising one or more APIs 2510 over a network or other remote communication medium. In at least one embodiment, one or more libraries 2506 comprising one or more APIs 2510 are to be performed by a remote computing service, such as a computing resource services provider. In another embodiment, one or more libraries 2506 comprising one or more APIs 2510 are to be performed by any other computing host providing said one or more APIs 2510 to one or more software programs 2502.

In at least one embodiment, a processor performing or using one or more software programs 2502 call, use, perform, or otherwise implement one or more APIs 2510 to allocate and otherwise manage memory to be used by said software programs 2502. In at least one embodiment, one or more software programs 2502 utilize one or more APIs 2510 to allocate and otherwise manage memory to be used by one or more portions of said software programs 2502 to be accelerated using one or more PPUs, such as GPUs or any other accelerator or processor further described herein. Those software programs 2502 request a processor to launch workloads, monitor workloads, and/or terminate workloads using functions 2512 provided, in an embodiment, by one or more APIs 2510.

In at least one embodiment, an API 2510 is an API to facilitate parallel computing. In at least one embodiment, an API 2510 is any other API further described herein. In at least one embodiment, an API 2510 is provided by a driver and/or runtime 2504. In at least one embodiment, an API 2510 is provided by a CUDA user-mode driver. In at least one embodiment, an API 2510 is provided by a CUDA runtime. In at least one embodiment, a driver and/or runtime 2504 is data values and software instructions that, if executed, perform or otherwise facilitate operation of one or more functions 2512 of an API 2510 during load and execution of one or more portions of a software program 2502. In at least one embodiment, drivers and/or runtimes 2504 is data values and software instructions that, if executed, perform or otherwise facilitate operation of one or more functions 2512 of an API 2510 during execution of a software program 2502. In at least one embodiment, one or more software programs 2502 utilize one or more APIs 2510 implemented or otherwise provided by a driver and/or runtime 2504 to perform combined arithmetic operations by said one or more software programs 2502 during execution by one or more PPUs, such as GPUs.

In at least one embodiment, one or more software programs 2502 utilize one or more APIs 2510 provided by a driver and/or runtime 2504 to perform combine arithmetic operations of one or more PPUs, such as GPUs. In at least one embodiment, one or more APIs 2510 provide combined arithmetic operations through a driver and/or runtime 2504, as described above. In at least one embodiment, one or more software programs 2502 utilize one or more APIs 2510 provided by a driver and/or runtime 2504 to allocate or otherwise reserve one or more blocks of memory 2514 of one or more PPUs, such as GPUs. In at least one embodiment, one or more software programs 2502 utilize one or more APIs 2510 provided by a driver and/or runtime 2504 to allocate or otherwise reserve blocks of memory. In at least one embodiment, one or more APIs 2510 are to perform combined arithmetic operations, as described herein in conjunction with FIGS. 1-24.

To improve software programs 2502 usability and/or optimization of one or more portions of said software programs 2502 to be accelerated by one or more PPUs, such as GPUs, in an embodiment, one or more APIs 2510 provide one or more API functions 2512 to launch workloads, monitor workloads, and/or terminate workloads where said workloads are usable or used by one or more computing devices as described above and further described herein in conjunction with FIGS. 1-24. In at least one embodiment, block diagram 2500 depicts a processor, comprising one or more circuits to perform one or more software programs to combine two or more application programming interfaces (APIs) into a single API. In at least one embodiment, block diagram 2500 depicts a system, comprising one or more processors to perform one or more software programs to combine two or more application programming interfaces (APIs) into a single API. In at least one embodiment, a processor uses an API such as those described herein at least in connection with FIGS. 5-22 to perform one or more resource operation APIs 2516, as described herein. In at least one embodiment, resource operation APIs used by a processor when said processor performs one or more resource operation APIs 2516 are one or more of create sub-context API 502, destroy sub-context API 702, get sub-context from stream API 902, get context resource API 1102, subdivide context resources API 1302, generate resource descriptor API 1502, get device resources API 1702, record context event API 1902, and/or wait on context event API 2102 described herein at least in connection with FIGS. 5-22.

In at least one embodiment, one or more processors (e.g., such as those described herein) comprise one or more circuits to perform operations and/or instructions described herein in connection with FIG. 25, such as one or more circuits to perform an application programming interface (API) to allocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 25 are included in and/or otherwise include systems, methods, operations, and/or instructions described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, components described herein in connection with FIG. 25 perform one or more processes described herein in connection with FIGS. 1-25 to perform an application programming interface (API) to allocate one or more data structures to indicate which of one or more streaming multiprocessors (SMs) of one or more processors are to be used to perform one or more software threads and/or otherwise perform operations described herein. In at least one embodiment, not shown in FIG. 25, one or more components described herein in connection with FIG. 25 include one or more components described herein in connection with FIGS. 26-58 to perform an application programming interface (API) to allocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 25, such as one or more circuits to perform an application programming interface (API) to deallocate one or more data structures to indicate which of one or more streaming multiprocessors (SMs) of one or more processors are to be used to perform one or more software threads and/or otherwise perform operations described herein. In at least one embodiment, operations and/or instructions described herein in connection with FIG. 25 are included in and/or otherwise include systems, methods, operations, and/or instructions described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, components described herein in connection with FIG. 25 perform one or more processes described herein in connection with FIGS. 1-25 to perform an application programming interface (API) to deallocate one or more data structures to indicate which of one or more streaming multiprocessors (SMs) of one or more processors are to be used to perform one or more software threads and/or otherwise perform operations described herein. In at least one embodiment, not shown in FIG. 25, one or more components described herein in connection with FIG. 25 include one or more components described herein in connection with FIGS. 26-58 to perform an application programming interface (API) to deallocate one or more data structures to indicate which of one or more streaming multiprocessors (SMs) of one or more processors are to be used to perform one or more software threads and/or otherwise perform operations described herein.

In at least one embodiment, one or more processors (e.g., such as those described herein) comprise one or more circuits to perform operations and/or instructions described herein in connection with FIG. 25, such as one or more circuits to perform an application programming interface (API) to cause one or more identifiers of one or more data structures indicating a number of one or more streaming multiprocessors (SMs) of one or more processors to be stored and/or otherwise perform operations described herein. In at least one embodiment, operations and/or instructions described herein in connection with FIG. 25 are included in and/or otherwise include systems, methods, operations, and/or instructions described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, components described herein in connection with FIG. 25 perform one or more processes described herein in connection with FIGS. 1-25 to perform an application programming interface (API) to cause one or more identifiers of one or more data structures indicating a number of one or more streaming multiprocessors (SMs) of one or more processors to be stored and/or otherwise perform operations described herein. In at least one embodiment, not shown in FIG. 25, one or more components described herein in connection with FIG. 25 include one or more components described herein in connection with FIGS. 26-58 to perform an application programming interface (API) to cause one or more identifiers of one or more data structures indicating a number of one or more streaming multiprocessors (SMs) of one or more processors to be stored and/or otherwise perform operations described herein.

In at least one embodiment, one or more processors (e.g., such as those described herein) comprise one or more circuits to perform operations and/or instructions described herein in connection with FIG. 25, such as one or more circuits to perform an application programming interface (API) to indicate one or more streaming multiprocessors (SMs) of one or more processors available to be used to perform one or more software threads and/or otherwise perform operations described herein. In at least one embodiment, operations and/or instructions described herein in connection with FIG. 25 are included in and/or otherwise include systems, methods, operations, and/or instructions described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, components described herein in connection with FIG. 25 perform one or more processes described herein in connection with FIGS. 1-25 to perform an application programming interface (API) to indicate one or more streaming multiprocessors (SMs) of one or more processors available to be used to perform one or more software threads and/or otherwise perform operations described herein. In at least one embodiment, not shown in FIG. 25, one or more components described herein in connection with FIG. 25 include one or more components described herein in connection with FIGS. 26-58 to perform an application programming interface (API) to indicate one or more streaming multiprocessors (SMs) of one or more processors available to be used to perform one or more software threads and/or otherwise perform operations described herein.

In at least one embodiment, one or more processors (e.g., such as those described herein) comprise one or more circuits to perform operations and/or instructions described herein in connection with FIG. 25, such as one or more circuits to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, operations and/or instructions described herein in connection with FIG. 25 are included in and/or otherwise include systems, methods, operations, and/or instructions described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, components described herein in connection with FIG. 25 perform one or more processes described herein in connection with FIGS. 1-25 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein. In at least one embodiment, not shown in FIG. 25, one or more components described herein in connection with FIG. 25 include one or more components described herein in connection with FIGS. 26-58 to perform an application programming interface (API) to cause a plurality of identifiers of a corresponding plurality of streaming multiprocessors (SMs) of one or more processors to be stored according to a plurality of groups, in which the corresponding plurality of SMs are to be used and/or otherwise perform operations described herein.

In at least one embodiment, one or more processors (e.g., such as those described herein) comprise one or more circuits to perform operations and/or instructions described herein in connection with FIG. 25, such as one or more circuits to perform an application programming interface (API) to indicate one or more groups of streaming multiprocessors (SMs) of one or more processors, on which to schedule one or more corresponding groups of software threads and/or otherwise perform operations described herein. In at least one embodiment, operations and/or instructions described herein in connection with FIG. 25 are included in and/or otherwise include systems, methods, operations, and/or instructions described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, components described herein in connection with FIG. 25 perform one or more processes described herein in connection with FIGS. 1-25 to perform an application programming interface (API) to indicate one or more groups of streaming multiprocessors (SMs) of one or more processors, on which to schedule one or more corresponding groups of software threads and/or otherwise perform operations described herein. In at least one embodiment, not shown in FIG. 25, one or more components described herein in connection with FIG. 25 include one or more components described herein in connection with FIGS. 26-58 to perform an application programming interface (API) to indicate one or more groups of streaming multiprocessors (SMs) of one or more processors, on which to schedule one or more corresponding groups of software threads and/or otherwise perform operations described herein.

In at least one embodiment, one or more processors (e.g., such as those described herein) comprise one or more circuits to perform operations and/or instructions described herein in connection with FIG. 25, such as one or more circuits to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, operations and/or instructions described herein in connection with FIG. 25 are included in and/or otherwise include systems, methods, operations, and/or instructions described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, components described herein in connection with FIG. 25 perform one or more processes described herein in connection with FIGS. 1-25 to perform an application programming interface (API) to cause one or more indicators of one or more numbers of one or more streaming multiprocessors (SMs) of one or more processors to be read from one or more data structures storing the one or more indicators and/or otherwise perform operations described herein. In at least one embodiment, not shown in FIG. 25, one or more components described herein in connection with FIG. 25 include one or more components described herein in connection with FIGS. 26-58 to perform an application programming interface (API) to cause one or more indicators of one or more numbers of one or more streaming multiprocessors (SMs) of one or more processors to be read from one or more data structures storing the one or more indicators and/or otherwise perform operations described herein.

In at least one embodiment, one or more processors (e.g., such as those described herein) comprise one or more circuits to perform operations and/or instructions described herein in connection with FIG. 25, such as one or more circuits to perform an application programming interface (API) to cause context of one or more first software instructions to be communicated to one or more second software instructions and/or otherwise perform operations described herein. In at least one embodiment, operations and/or instructions described herein in connection with FIG. 25 are included in and/or otherwise include systems, methods, operations, and/or instructions described herein in connection with FIGS. 1-25 to perform an application programming interface (API) to cause context of one or more first software instructions to be communicated to one or more second software instructions and/or otherwise perform operations described herein. In at least one embodiment, components described herein in connection with FIG. 25 perform one or more processes described herein in connection with FIGS. 1-25 to perform an application programming interface (API) to cause context of one or more first software instructions to be communicated to one or more second software instructions and/or otherwise perform operations described herein. In at least one embodiment, not shown in FIG. 25, one or more components described herein in connection with FIG. 25 include one or more components described herein in connection with FIGS. 26-58 to perform an application programming interface (API) to cause context of one or more first software instructions to be communicated to one or more second software instructions and/or otherwise perform operations described herein.

In at least one embodiment, one or more processors (e.g., such as those described herein) comprise one or more circuits to perform operations and/or instructions described herein in connection with FIG. 25, such as one or more circuits to perform an application programming interface (API) to cause one or more second instructions to wait to be performed until the one or more second instructions receives context corresponding to one or more first software instructions and/or otherwise perform operations described herein. In at least one embodiment, operations and/or instructions described herein in connection with FIG. 25 are included in and/or otherwise include systems, methods, operations, and/or instructions described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, components described herein in connection with FIG. 25 perform one or more processes described herein in connection with FIGS. 1-25 to perform an application programming interface (API) to cause one or more second instructions to wait to be performed until the one or more second instructions receives context corresponding to one or more first software instructions and/or otherwise perform operations described herein. In at least one embodiment, not shown in FIG. 25, one or more components described herein in connection with FIG. 25 include one or more components described herein in connection with FIGS. 26-58 to perform an application programming interface (API) to cause one or more second instructions to wait to be performed until the one or more second instructions receives context corresponding to one or more first software instructions and/or otherwise perform operations described herein.

In the following description, numerous specific details are set forth to provide a more thorough understanding of at least one embodiment. However, it will be apparent to one skilled in the art that the inventive concepts may be practiced without one or more of these specific details.

### Data Center

FIG. 26 illustrates an exemplary data center 2600, in accordance with at least one embodiment. In at least one embodiment, data center 2600 includes, without limitation, a data center infrastructure layer 2610, a framework layer 2620, a software layer 2630 and an application layer 2640.

In at least one embodiment, as shown in FIG. 26, data center infrastructure layer 2610 may include a resource orchestrator 2612, grouped computing resources 2614, and node computing resources (“node C.R.s”) 2616(1)-2616(N), where “N” represents any whole, positive integer. In at least one embodiment, node C.R.s 2616(1)-2616(N) may include, but are not limited to, any number of central processing units (“CPUs”) or other processors (including accelerators, field programmable gate arrays (“FPGAs”), data processing units (“DPUs”) in network devices, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 2616(1)-2616(N) may be a server having one or more of above-mentioned computing resources.

In at least one embodiment, grouped computing resources 2614 may include separate groupings of node C.R.s housed within one or more racks (not shown), or many racks housed in data centers at various geographical locations (also not shown). Separate groupings of node C.R.s within grouped computing resources 2614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 2612 may configure or otherwise control one or more node C.R.s 2616(1)-2616(N) and/or grouped computing resources 2614. In at least one embodiment, resource orchestrator 2612 may include a software design infrastructure (“SDI”) management entity for data center 2600. In at least one embodiment, resource orchestrator 2612 may include hardware, software or some combination thereof.

In at least one embodiment, as shown in FIG. 26, framework layer 2620 includes, without limitation, a job scheduler 2632, a configuration manager 2634, a resource manager 2636 and a distributed file system 2638. In at least one embodiment, framework layer 2620 may include a framework to support software 2652 of software layer 2630 and/or one or more application(s) 2642 of application layer 2640. In at least one embodiment, software 2652 or application(s) 2642 may respectively include web-based service software or applications, such as those provided by Amazon Web Services, Google Cloud and Microsoft Azure. In at least one embodiment, framework layer 2620 may be, but is not limited to, a type of free and open-source software web application framework such as Apache Spark™ (hereinafter “Spark”) that may utilize distributed file system 2638 for large-scale data processing (e.g., “big data”). In at least one embodiment, job scheduler 2632 may include a Spark driver to facilitate scheduling of workloads supported by various layers of data center 2600. In at least one embodiment, configuration manager 2634 may be capable of configuring different layers such as software layer 2630 and framework layer 2620, including Spark and distributed file system 2638 for supporting large-scale data processing. In at least one embodiment, resource manager 2636 may be capable of managing clustered or grouped computing resources mapped to or allocated for support of distributed file system 2638 and job scheduler 2632. In at least one embodiment, clustered or grouped computing resources may include grouped computing resource 2614 at data center infrastructure layer 2610. In at least one embodiment, resource manager 2636 may coordinate with resource orchestrator 2612 to manage these mapped or allocated computing resources.

In at least one embodiment, software 2652 included in software layer 2630 may include software used by at least portions of node C.R.s 2616(1)-2616(N), grouped computing resources 2614, and/or distributed file system 2638 of framework layer 2620. One or more types of software may include, but are not limited to, Internet web page search software, e-mail virus scan software, database software, and streaming video content software.

In at least one embodiment, application(s) 2642 included in application layer 2640 may include one or more types of applications used by at least portions of node C.R.s 2616(1)-2616(N), grouped computing resources 2614, and/or distributed file system 2638 of framework layer 2620. In at least one or more types of applications may include, without limitation, CUDA applications.

In at least one embodiment, any of configuration manager 2634, resource manager 2636, and resource orchestrator 2612 may implement any number and type of self-modifying actions based on any amount and type of data acquired in any technically feasible fashion. In at least one embodiment, self-modifying actions may relieve a data center operator of data center 2600 from making possibly bad configuration decisions and possibly avoiding underutilized and/or poor performing portions of a data center.

In at least one embodiment, at least one component shown or described with respect to FIG. 26 is used to perform techniques and/or functions described in connection with FIGS. 1-25. In at least one embodiment, at least one component shown or described with respect to FIG. 26 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 26 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 26 is used to perform at least one aspect described with respect to FIGS. 1-25, and/or other systems, methods, or operations described herein.

In at least one embodiment, at least one component shown or described with respect to FIG. 26 is used to perform techniques and/or functions described in connection with FIGS. 1-25. In at least one embodiment, at least one component shown or described with respect to FIG. 26 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 26 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 26 is used to perform techniques and/or functions described in connection with FIGS. 1-25. In at least one embodiment, at least one component shown or described with respect to FIG. 26 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 26 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 26 is used to perform techniques and/or functions described in connection with FIGS. 1-25. In at least one embodiment, at least one component shown or described with respect to FIG. 26 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 26 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 26 is used to perform techniques and/or functions described in connection with FIGS. 1-25. In at least one embodiment, at least one component shown or described with respect to FIG. 26 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 26 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 26 is used to perform techniques and/or functions described in connection with FIGS. 1-25. In at least one embodiment, at least one component shown or described with respect to FIG. 26 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 26 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 26 is used to perform techniques and/or functions described in connection with FIGS. 1-25. In at least one embodiment, at least one component shown or described with respect to FIG. 26 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 26 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 26 is used to perform techniques and/or functions described in connection with FIGS. 1-25. In at least one embodiment, at least one component shown or described with respect to FIG. 26 is used to perform an application programming interface (API) to cause context of one or more first software instructions to be communicated to one or more second software instructions, and/or other systems, methods, or operations described herein. In at least one embodiment, at least one component shown or described with respect to FIG. 26 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 26 is used to perform techniques and/or functions described in connection with FIGS. 1-25. In at least one embodiment, at least one component shown or described with respect to FIG. 26 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 26 is used to perform an application programming interface (API) to prevent one or more instructions from being performed by one or more resources of a first context of the processor until one or more indications of one or more events of a second context are generated, and/or other systems, methods, or operations described herein.

### Computer-Based Systems

The following figures set forth, without limitation, exemplary computer-based systems that can be used to implement at least one embodiment.

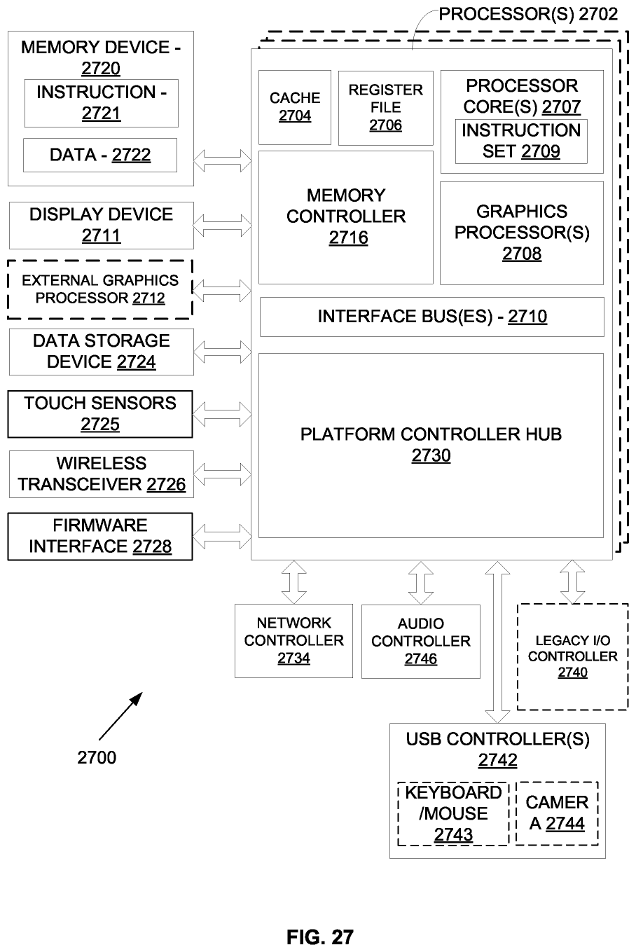

FIG. 27 illustrates a processing system 2700, in accordance with at least one embodiment. In at least one embodiment, processing system 2700 includes one or more processors 2702 and one or more graphics processors 2708, and may be a single processor desktop system, a multiprocessor workstation system, or a server system having a large number of processors 2702 or processor cores 2707. In at least one embodiment, processing system 2700 is a processing platform incorporated within a system-on-a-chip (“SoC”) integrated circuit for use in mobile, handheld, or embedded devices. In at least one embodiment, a processors core 2707 is referred to as a computing unit or compute unit.

In at least one embodiment, processing system 2700 can include, or be incorporated within a server-based gaming platform, a game console, a media console, a mobile gaming console, a handheld game console, or an online game console. In at least one embodiment, processing system 2700 is a mobile phone, smart phone, tablet computing device or mobile Internet device. In at least one embodiment, processing system 2700 can also include, couple with, or be integrated within a wearable device, such as a smart watch wearable device, smart eyewear device, augmented reality device, or virtual reality device. In at least one embodiment, processing system 2700 is a television or set top box device having one or more processors 2702 and a graphical interface generated by one or more graphics processors 2708.

In at least one embodiment, one or more processors 2702 each include one or more processor cores 2707 to process instructions which, when executed, perform operations for system and user software. In at least one embodiment, each of one or more processor cores 2707 is configured to process a specific instruction set 2709. In at least one embodiment, instruction set 2709 may facilitate Complex Instruction Set Computing (“CISC”), Reduced Instruction Set Computing (“RISC”), or computing via a Very Long Instruction Word (“VLIW”). In at least one embodiment, processor cores 2707 may each process a different instruction set 2709, which may include instructions to facilitate emulation of other instruction sets. In at least one embodiment, processor core 2707 may also include other processing devices, such as a digital signal processor (“DSP”).

In at least one embodiment, processor 2702 includes cache memory (‘cache”) 2704. In at least one embodiment, processor 2702 can have a single internal cache or multiple levels of internal cache. In at least one embodiment, cache memory is shared among various components of processor 2702. In at least one embodiment, processor 2702 also uses an external cache (e.g., a Level 3 (“L3”) cache or Last Level Cache (“LLC”)) (not shown), which may be shared among processor cores 2707 using known cache coherency techniques. In at least one embodiment, register file 2706 is additionally included in processor 2702 which may include different types of registers for storing different types of data (e.g., integer registers, floating point registers, status registers, and an instruction pointer register). In at least one embodiment, register file 2706 may include general-purpose registers or other registers.

In at least one embodiment, one or more processor(s) 2702 are coupled with one or more interface bus(es) 2710 to transmit communication signals such as address, data, or control signals between processor 2702 and other components in processing system 2700. In at least one embodiment interface bus 2710, in one embodiment, can be a processor bus, such as a version of a Direct Media Interface (“DMI”) bus. In at least one embodiment, interface bus 2710 is not limited to a DMI bus, and may include one or more Peripheral Component Interconnect buses (e.g., “PCI,” PCI Express (“PCIe”)), memory buses, or other types of interface buses. In at least one embodiment processor(s) 2702 include an integrated memory controller 2716 and a platform controller hub 2730. In at least one embodiment, memory controller 2716 facilitates communication between a memory device and other components of processing system 2700, while platform controller hub (“PCH”) 2730 provides connections to Input/Output (“I/O”) devices via a local I/O bus. In at least one embodiment, one or more Peripheral Component Interconnect buses include PCIe Gen 5, which provides an interface for processors.

In at least one embodiment, memory device 2720 can be a dynamic random access memory (“DRAM”) device, a static random access memory (“SRAM”) device, flash memory device, phase-change memory device, or some other memory device having suitable performance to serve as processor memory. In at least one embodiment memory device 2720 can operate as system memory for processing system 2700, to store data 2722 and instructions 2721 for use when one or more processors 2702 executes an application or process. In at least one embodiment, memory controller 2716 also couples with an optional external graphics processor 2712, which may communicate with one or more graphics processors 2708 in processors 2702 to perform graphics and media operations. In at least one embodiment, a display device 2711 can connect to processor(s) 2702. In at least one embodiment display device 2711 can include one or more of an internal display device, as in a mobile electronic device or a laptop device or an external display device attached via a display interface (e.g., DisplayPort, etc.). In at least one embodiment, display device 2711 can include a head mounted display (“HMD”) such as a stereoscopic display device for use in virtual reality (“VR”) applications or augmented reality (“AR”) applications.

In at least one embodiment, platform controller hub 2730 enables peripherals to connect to memory device 2720 and processor 2702 via a high-speed I/O bus. In at least one embodiment, I/O peripherals include, but are not limited to, an audio controller 2746, a network controller 2734, a firmware interface 2728, a wireless transceiver 2726, touch sensors 2725, a data storage device 2724 (e.g., hard disk drive, flash memory, etc.). In at least one embodiment, data storage device 2724 can connect via a storage interface (e.g., SATA) or via a peripheral bus, such as PCI, or PCIe. In at least one embodiment, touch sensors 2725 can include touch screen sensors, pressure sensors, or fingerprint sensors. In at least one embodiment, wireless transceiver 2726 can be a Wi-Fi transceiver, a Bluetooth transceiver, or a mobile network transceiver such as a 3G, 4G, or Long Term Evolution (“LTE”) transceiver. In at least one embodiment, firmware interface 2728 enables communication with system firmware, and can be, for example, a unified extensible firmware interface (“UEFI”). In at least one embodiment, network controller 2734 can enable a network connection to a wired network. In at least one embodiment, a high-performance network controller (not shown) couples with interface bus 2710. In at least one embodiment, audio controller 2746 is a multi-channel high definition audio controller. In at least one embodiment, processing system 2700 includes an optional legacy I/O controller 2740 for coupling legacy (e.g., Personal System 2 (“PS/2”)) devices to processing system 2700. In at least one embodiment, platform controller hub 2730 can also connect to one or more Universal Serial Bus (“USB”) controllers 2742 connect input devices, such as keyboard and mouse 2743 combinations, a camera 2744, or other USB input devices.

In at least one embodiment, an instance of memory controller 2716 and platform controller hub 2730 may be integrated into a discreet external graphics processor, such as external graphics processor 2712. In at least one embodiment, platform controller hub 2730 and/or memory controller 2716 may be external to one or more processor(s) 2702. For example, in at least one embodiment, processing system 2700 can include an external memory controller 2716 and platform controller hub 2730, which may be configured as a memory controller hub and peripheral controller hub within a system chipset that is in communication with processor(s) 2702.

In at least one embodiment, at least one component shown or described with respect to FIG. 27 is used to perform techniques and/or functions described in connection with FIGS. 1-25. In at least one embodiment, at least one component shown or described with respect to FIG. 27 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 27 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 27 is used to perform at least one aspect described with respect to FIGS. 1-25, and/or other systems, methods, or operations described herein.

In at least one embodiment, at least one component shown or described with respect to FIG. 27 is used to perform techniques and/or functions described in connection with FIGS. 1-25. In at least one embodiment, at least one component shown or described with respect to FIG. 27 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 27 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 27 is used to perform techniques and/or functions described in connection with FIGS. 1-25. In at least one embodiment, at least one component shown or described with respect to FIG. 27 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 27 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 27 is used to perform techniques and/or functions described in connection with FIGS. 1-25. In at least one embodiment, at least one component shown or described with respect to FIG. 27 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 27 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 27 is used to perform techniques and/or functions described in connection with FIGS. 1-25. In at least one embodiment, at least one component shown or described with respect to FIG. 27 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 27 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 27 is used to perform techniques and/or functions described in connection with FIGS. 1-25. In at least one embodiment, at least one component shown or described with respect to FIG. 27 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 27 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 27 is used to perform techniques and/or functions described in connection with FIGS. 1-25. In at least one embodiment, at least one component shown or described with respect to FIG. 27 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 27 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 27 is used to perform techniques and/or functions described in connection with FIGS. 1-25. In at least one embodiment, at least one component shown or described with respect to FIG. 27 is used to perform an application programming interface (API) to cause context of one or more first software instructions to be communicated to one or more second software instructions, and/or other systems, methods, or operations described herein. In at least one embodiment, at least one component shown or described with respect to FIG. 27 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 27 is used to perform techniques and/or functions described in connection with FIGS. 1-25. In at least one embodiment, at least one component shown or described with respect to FIG. 27 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 27 is used to perform an application programming interface (API) to prevent one or more instructions from being performed by one or more resources of a first context of the processor until one or more indications of one or more events of a second context are generated, and/or other systems, methods, or operations described herein.

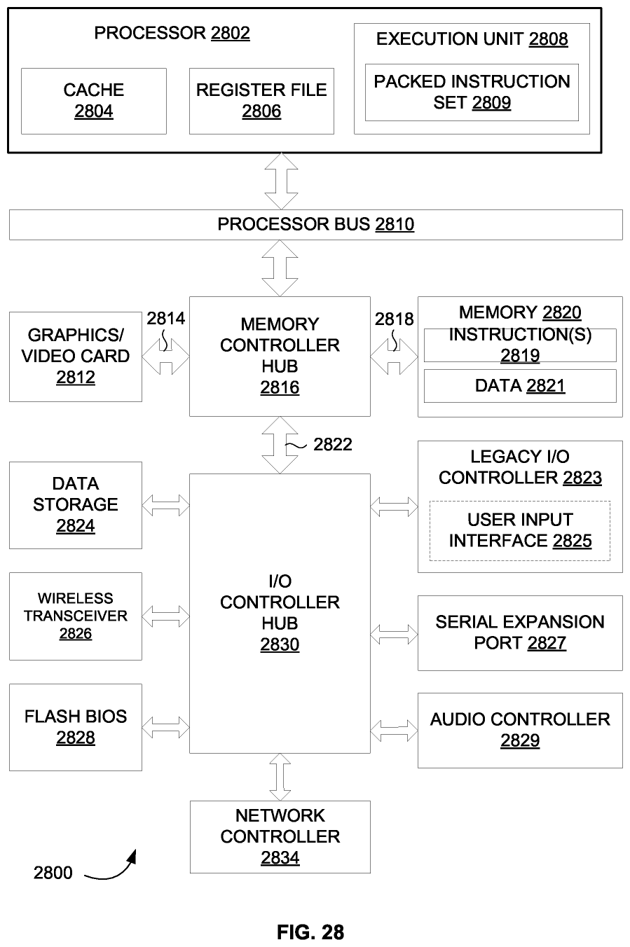

FIG. 28 illustrates a computer system 2800, in accordance with at least one embodiment. In at least one embodiment, computer system 2800 may be a system with interconnected devices and components, an SOC, or some combination. In at least on embodiment, computer system 2800 is formed with a processor 2802 that may include execution units to execute an instruction. In at least one embodiment, computer system 2800 may include, without limitation, a component, such as processor 2802 to employ execution units including logic to perform algorithms for processing data. In at least one embodiment, computer system 2800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 2800 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 2800 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions.

In at least one embodiment, computer system 2800 may include, without limitation, processor 2802 that may include, without limitation, one or more execution units 2808 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 2800 is a single processor desktop or server system. In at least one embodiment, computer system 2800 may be a multiprocessor system. In at least one embodiment, processor 2802 may include, without limitation, a CISC microprocessor, a RISC microprocessor, a VLIW microprocessor, a processor implementing a combination of instruction sets, or any other processor device, such as a digital signal processor, for example. In at least one embodiment, processor 2802 may be coupled to a processor bus 2810 that may transmit data signals between processor 2802 and other components in computer system 2800.

In at least one embodiment, processor 2802 may include, without limitation, a Level 1 (“L1”) internal cache memory (“cache”) 2804. In at least one embodiment, processor 2802 may have a single internal cache or multiple levels of internal cache. In at least one embodiment, cache memory may reside external to processor 2802. In at least one embodiment, processor 2802 may also include a combination of both internal and external caches. In at least one embodiment, a register file 2806 may store different types of data in various registers including, without limitation, integer registers, floating point registers, status registers, and instruction pointer register.

In at least one embodiment, execution unit 2808, including, without limitation, logic to perform integer and floating point operations, also resides in processor 2802. Processor 2802 may also include a microcode (“ucode”) read only memory (“ROM”) that stores microcode for certain macro instructions. In at least one embodiment, execution unit 2808 may include logic to handle a packed instruction set 2809. In at least one embodiment, by including packed instruction set 2809 in an instruction set of a general-purpose processor 2802, along with associated circuitry to execute instructions, operations used by many multimedia applications may be performed using packed data in a general-purpose processor 2802. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 2808 may also be used in microcontrollers, embedded processors, graphics devices, DSPs, and other types of logic circuits. In at least one embodiment, computer system 2800 may include, without limitation, a memory 2820. In at least one embodiment, memory 2820 may be implemented as a DRAM device, an SRAM device, flash memory device, or other memory device. Memory 2820 may store instruction(s) 2819 and/or data 2821 represented by data signals that may be executed by processor 2802.

In at least one embodiment, a system logic chip may be coupled to processor bus 2810 and memory 2820. In at least one embodiment, the system logic chip may include, without limitation, a memory controller hub (“MCH”) 2816, and processor 2802 may communicate with MCH 2816 via processor bus 2810. In at least one embodiment, MCH 2816 may provide a high bandwidth memory path 2818 to memory 2820 for instruction and data storage and for storage of graphics commands, data and textures. In at least one embodiment, MCH 2816 may direct data signals between processor 2802, memory 2820, and other components in computer system 2800 and to bridge data signals between processor bus 2810, memory 2820, and a system I/O 2822. In at least one embodiment, system logic chip may provide a graphics port for coupling to a graphics controller. In at least one embodiment, MCH 2816 may be coupled to memory 2820 through high bandwidth memory path 2818 and graphics/video card 2812 may be coupled to MCH 2816 through an Accelerated Graphics Port (“AGP”) interconnect 2814.

In at least one embodiment, computer system 2800 may use system I/O 2822 that is a proprietary hub interface bus to couple MCH 2816 to I/O controller hub (“ICH”) 2830. In at least one embodiment, ICH 2830 may provide direct connections to some I/O devices via a local I/O bus. In at least one embodiment, local I/O bus may include, without limitation, a high-speed I/O bus for connecting peripherals to memory 2820, a chipset, and processor 2802. Examples may include, without limitation, an audio controller 2829, a firmware hub (“flash BIOS”) 2828, a wireless transceiver 2826, a data storage 2824, a legacy I/O controller 2823 containing a user input interface 2825 and a keyboard interface, a serial expansion port 2827, such as a USB, and a network controller 2834. Data storage 2824 may comprise a hard disk drive, a floppy disk drive, a CD-ROM device, a flash memory device, or other mass storage device.

In at least one embodiment, FIG. 28 illustrates a system, which includes interconnected hardware devices or “chips.” In at least one embodiment, FIG. 28 may illustrate an exemplary SoC. In at least one embodiment, devices illustrated in FIG. 28 may be interconnected with proprietary interconnects, standardized interconnects (e.g., PCIe), or some combination thereof. In at least one embodiment, one or more components of system 2800 are interconnected using compute express link (“CXL”) interconnects.

In at least one embodiment, at least one component shown or described with respect to FIG. 28 is used to perform techniques and/or functions described in connection with FIGS. 1-25. In at least one embodiment, at least one component shown or described with respect to FIG. 28 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 28 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 28 is used to perform at least one aspect described with respect to FIGS. 1-25, and/or other systems, methods, or operations described herein.

In at least one embodiment, at least one component shown or described with respect to FIG. 28 is used to perform techniques and/or functions described in connection with FIGS. 1-25. In at least one embodiment, at least one component shown or described with respect to FIG. 28 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 28 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 28 is used to perform techniques and/or functions described in connection with FIGS. 1-25. In at least one embodiment, at least one component shown or described with respect to FIG. 28 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 28 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 28 is used to perform techniques and/or functions described in connection with FIGS. 1-25. In at least one embodiment, at least one component shown or described with respect to FIG. 28 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 28 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 28 is used to perform techniques and/or functions described in connection with FIGS. 1-25. In at least one embodiment, at least one component shown or described with respect to FIG. 28 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 28 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 28 is used to perform techniques and/or functions described in connection with FIGS. 1-25. In at least one embodiment, at least one component shown or described with respect to FIG. 28 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 28 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 28 is used to perform techniques and/or functions described in connection with FIGS. 1-25. In at least one embodiment, at least one component shown or described with respect to FIG. 28 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 28 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 28 is used to perform techniques and/or functions described in connection with FIGS. 1-25. In at least one embodiment, at least one component shown or described with respect to FIG. 28 is used to perform an application programming interface (API) to cause context of one or more first software instructions to be communicated to one or more second software instructions, and/or other systems, methods, or operations described herein. In at least one embodiment, at least one component shown or described with respect to FIG. 28 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 28 is used to perform techniques and/or functions described in connection with FIGS. 1-25. In at least one embodiment, at least one component shown or described with respect to FIG. 28 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 28 is used to perform an application programming interface (API) to prevent one or more instructions from being performed by one or more resources of a first context of the processor until one or more indications of one or more events of a second context are generated, and/or other systems, methods, or operations described herein.

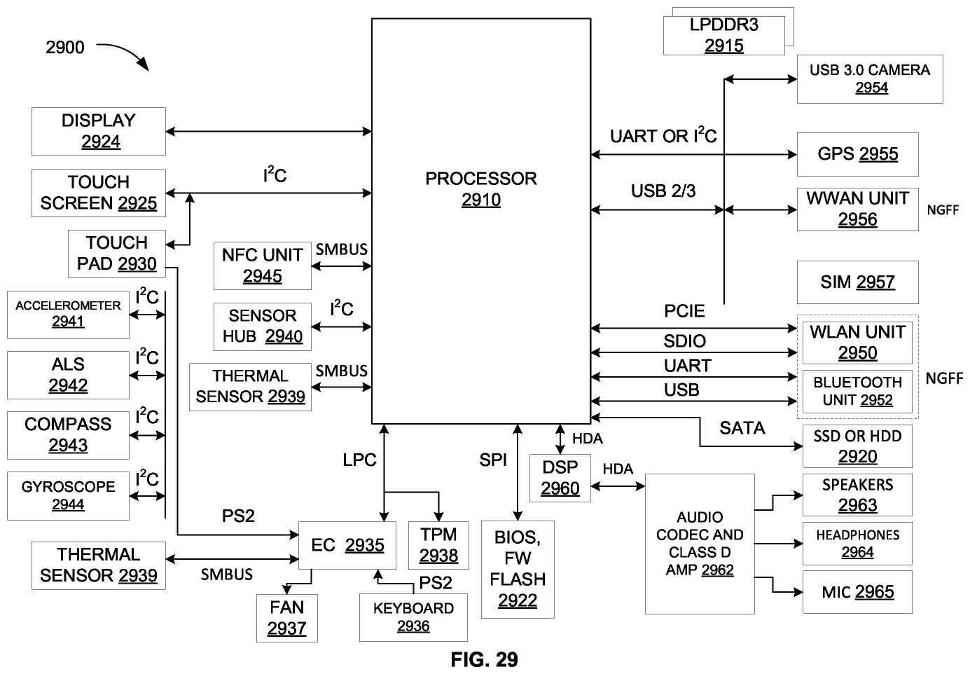

FIG. 29 illustrates a system 2900, in accordance with at least one embodiment. In at least one embodiment, system 2900 is an electronic device that utilizes a processor 2910. In at least one embodiment, system 2900 may be, for example and without limitation, a notebook, a tower server, a rack server, a blade server, an edge device communicatively coupled to one or more on-premise or cloud service providers, a laptop, a desktop, a tablet, a mobile device, a phone, an embedded computer, or any other suitable electronic device.

In at least one embodiment, system 2900 may include, without limitation, processor 2910 communicatively coupled to any suitable number or kind of components, peripherals, modules, or devices. In at least one embodiment, processor 2910 is coupled using a bus or interface, such as an I²C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3), or a Universal Asynchronous Receiver/Transmitter (“UART”) bus. In at least one embodiment, FIG. 29 illustrates a system which includes interconnected hardware devices or “chips.” In at least one embodiment, FIG. 29 may illustrate an exemplary SoC. In at least one embodiment, devices illustrated in FIG. 29 may be interconnected with proprietary interconnects, standardized interconnects (e.g., PCIe) or some combination thereof. In at least one embodiment, one or more components of FIG. 29 are interconnected using CXL interconnects.

In at least one embodiment, FIG. 29 may include a display 2924, a touch screen 2925, a touch pad 2930, a Near Field Communications unit (“NFC”) 2945, a sensor hub 2940, a thermal sensor 2946, an Express Chipset (“EC”) 2935, a Trusted Platform Module (“TPM”) 2938, BIOS/firmware/flash memory (“BIOS, FW Flash”) 2922, a DSP 2960, a Solid State Disk (“SSD”) or Hard Disk Drive (“HDD”) 2920, a wireless local area network unit (“WLAN”) 2950, a Bluetooth unit 2952, a Wireless Wide Area Network unit (“WWAN”) 2956, a Global Positioning System (“GPS”) 2955, a camera (“USB 3.0 camera”) 2954 such as a USB 3.0 camera, or a Low Power Double Data Rate (“LPDDR”) memory unit (“LPDDR3”) 2915 implemented in, for example, LPDDR3 standard. These components may each be implemented in any suitable manner.

In at least one embodiment, other components may be communicatively coupled to processor 2910 through components discussed above. In at least one embodiment, an accelerometer 2941, an Ambient Light Sensor (“ALS”) 2942, a compass 2943, and a gyroscope 2944 may be communicatively coupled to sensor hub 2940. In at least one embodiment, a thermal sensor 2939, a fan 2937, a keyboard 2936, and a touch pad 2930 may be communicatively coupled to EC 2935. In at least one embodiment, a speaker 2963, a headphones 2964, and a microphone (“mic”) 2965 may be communicatively coupled to an audio unit (“audio codec and class d amp”) 2962, which may in turn be communicatively coupled to DSP 2960. In at least one embodiment, audio unit 2962 may include, for example and without limitation, an audio coder/decoder (“codec”) and a class D amplifier. In at least one embodiment, a SIM card (“SIM”) 2957 may be communicatively coupled to WWAN unit 2956. In at least one embodiment, components such as WLAN unit 2950 and Bluetooth unit 2952, as well as WWAN unit 2956 may be implemented in a Next Generation Form Factor (“NGFF”).

In at least one embodiment, at least one component shown or described with respect to FIG. 29 is used to perform techniques and/or functions described in connection with FIGS. 1-25. In at least one embodiment, at least one component shown or described with respect to FIG. 29 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 29 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 29 is used to perform at least one aspect described with respect to FIGS. 1-25, and/or other systems, methods, or operations described herein.

In at least one embodiment, at least one component shown or described with respect to FIG. 29 is used to perform techniques and/or functions described in connection with FIGS. 1-25. In at least one embodiment, at least one component shown or described with respect to FIG. 29 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 29 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 29 is used to perform techniques and/or functions described in connection with FIGS. 1-25. In at least one embodiment, at least one component shown or described with respect to FIG. 29 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 29 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 29 is used to perform techniques and/or functions described in connection with FIGS. 1-25. In at least one embodiment, at least one component shown or described with respect to FIG. 29 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 29 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 29 is used to perform techniques and/or functions described in connection with FIGS. 1-25. In at least one embodiment, at least one component shown or described with respect to FIG. 29 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 29 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 29 is used to perform techniques and/or functions described in connection with FIGS. 1-25. In at least one embodiment, at least one component shown or described with respect to FIG. 29 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 29 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 29 is used to perform techniques and/or functions described in connection with FIGS. 1-25. In at least one embodiment, at least one component shown or described with respect to FIG. 29 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 29 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 29 is used to perform techniques and/or functions described in connection with FIGS. 1-25. In at least one embodiment, at least one component shown or described with respect to FIG. 29 is used to perform an application programming interface (API) to cause context of one or more first software instructions to be communicated to one or more second software instructions, and/or other systems, methods, or operations described herein. In at least one embodiment, at least one component shown or described with respect to FIG. 29 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 29 is used to perform techniques and/or functions described in connection with FIGS. 1-25. In at least one embodiment, at least one component shown or described with respect to FIG. 29 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 29 is used to perform an application programming interface (API) to prevent one or more instructions from being performed by one or more resources of a first context of the processor until one or more indications of one or more events of a second context are generated, and/or other systems, methods, or operations described herein.

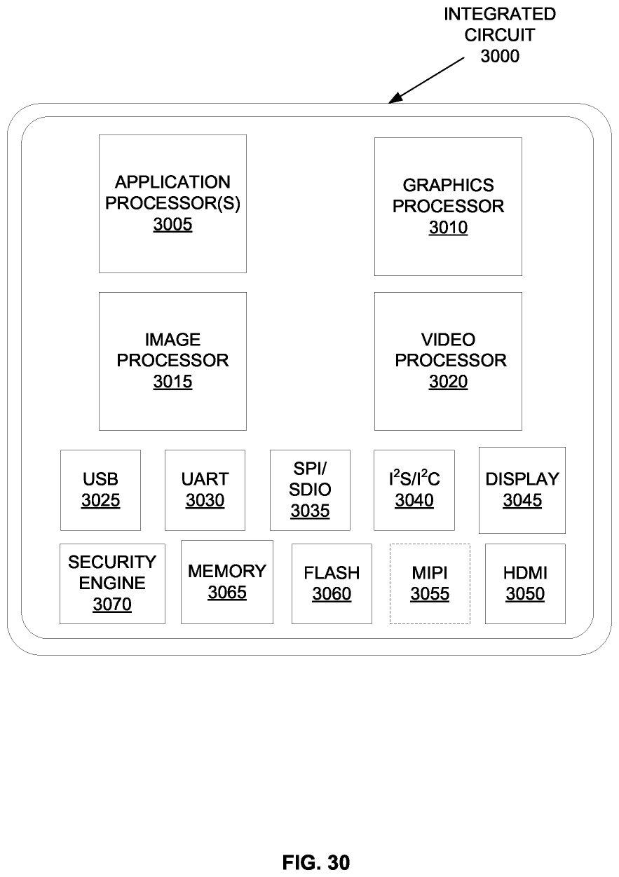

FIG. 30 illustrates an exemplary integrated circuit 3000, in accordance with at least one embodiment. In at least one embodiment, exemplary integrated circuit 3000 is an SoC that may be fabricated using one or more IP cores. In at least one embodiment, integrated circuit 3000 includes one or more application processor(s) 3005 (e.g., CPUs, DPUs), at least one graphics processor 3010, and may additionally include an image processor 3015 and/or a video processor 3020, any of which may be a modular IP core. In at least one embodiment, integrated circuit 3000 includes peripheral or bus logic including a USB controller 3025, a UART controller 3030, an SPI/SDIO controller 3035, and an I²S/I²C controller 3040. In at least one embodiment, integrated circuit 3000 can include a display device 3045 coupled to one or more of a high-definition multimedia interface (“HDMI”) controller 3050 and a mobile industry processor interface (“MIPI”) display interface 3055. In at least one embodiment, storage may be provided by a flash memory subsystem 3060 including flash memory and a flash memory controller. In at least one embodiment, a memory interface may be provided via a memory controller 3065 for access to SDRAM or SRAM memory devices. In at least one embodiment, some integrated circuits additionally include an embedded security engine 3070.

In at least one embodiment, at least one component shown or described with respect to FIG. 30 is used to perform techniques and/or functions described in connection with FIGS. 1-25. In at least one embodiment, at least one component shown or described with respect to FIG. 30 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 30 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 30 is used to perform at least one aspect described with respect to FIGS. 1-25, and/or other systems, methods, or operations described herein.

In at least one embodiment, at least one component shown or described with respect to FIG. 30 is used to perform techniques and/or functions described in connection with FIGS. 1-25. In at least one embodiment, at least one component shown or described with respect to FIG. 30 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 30 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 30 is used to perform techniques and/or functions described in connection with FIGS. 1-25. In at least one embodiment, at least one component shown or described with respect to FIG. 30 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 30 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 30 is used to perform techniques and/or functions described in connection with FIGS. 1-25. In at least one embodiment, at least one component shown or described with respect to FIG. 30 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 30 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 30 is used to perform techniques and/or functions described in connection with FIGS. 1-25. In at least one embodiment, at least one component shown or described with respect to FIG. 30 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 30 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 30 is used to perform techniques and/or functions described in connection with FIGS. 1-25. In at least one embodiment, at least one component shown or described with respect to FIG. 30 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 30 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 30 is used to perform techniques and/or functions described in connection with FIGS. 1-25. In at least one embodiment, at least one component shown or described with respect to FIG. 30 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 30 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 30 is used to perform techniques and/or functions described in connection with FIGS. 1-25. In at least one embodiment, at least one component shown or described with respect to FIG. 30 is used to perform an application programming interface (API) to cause context of one or more first software instructions to be communicated to one or more second software instructions, and/or other systems, methods, or operations described herein. In at least one embodiment, at least one component shown or described with respect to FIG. 30 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 30 is used to perform techniques and/or functions described in connection with FIGS. 1-25. In at least one embodiment, at least one component shown or described with respect to FIG. 30 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 30 is used to perform an application programming interface (API) to prevent one or more instructions from being performed by one or more resources of a first context of the processor until one or more indications of one or more events of a second context are generated, and/or other systems, methods, or operations described herein.

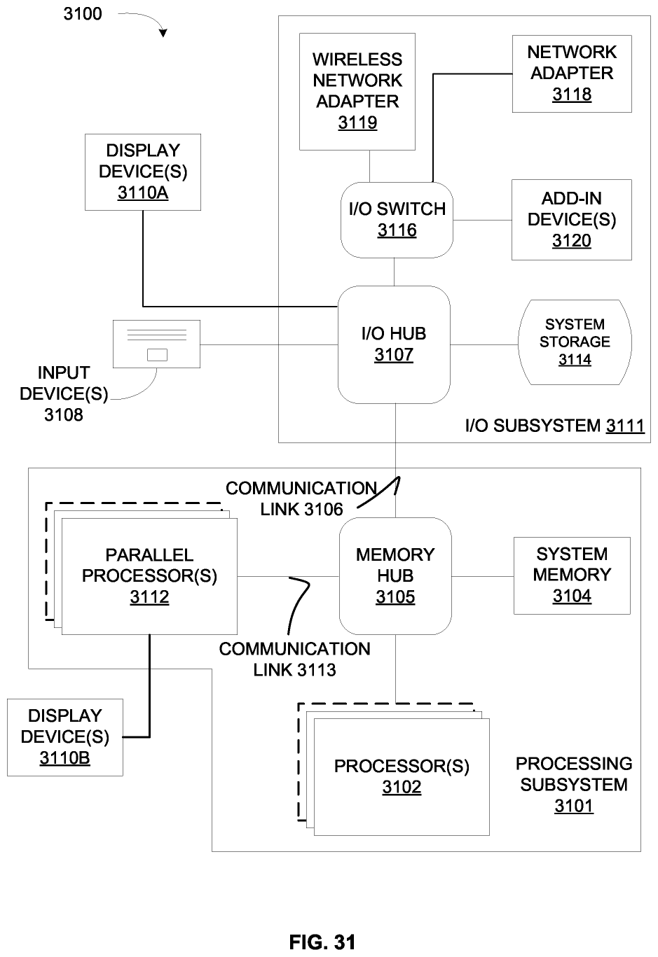

FIG. 31 illustrates a computing system 3100, according to at least one embodiment; In at least one embodiment, computing system 3100 includes a processing subsystem 3101 having one or more processor(s) 3102 and a system memory 3104 communicating via an interconnection path that may include a memory hub 3105. In at least one embodiment, memory hub 3105 may be a separate component within a chipset component or may be integrated within one or more processor(s) 3102. In at least one embodiment, memory hub 3105 couples with an I/O subsystem 3111 via a communication link 3106. In at least one embodiment, I/O subsystem 3111 includes an I/O hub 3107 that can enable computing system 3100 to receive input from one or more input device(s) 3108. In at least one embodiment, I/O hub 3107 can enable a display controller, which may be included in one or more processor(s) 3102, to provide outputs to one or more display device(s) 3110A. In at least one embodiment, one or more display device(s) 3110A coupled with I/O hub 3107 can include a local, internal, or embedded display device.

In at least one embodiment, processing subsystem 3101 includes one or more parallel processor(s) 3112 coupled to memory hub 3105 via a bus or other communication link 3113. In at least one embodiment, communication link 3113 may be one of any number of standards based communication link technologies or protocols, such as, but not limited to PCIe, or may be a vendor specific communications interface or communications fabric. In at least one embodiment, one or more parallel processor(s) 3112 form a computationally focused parallel or vector processing system that can include a large number of processing cores and/or processing clusters, such as a many integrated core processor or compute units. In at least one embodiment, one or more parallel processor(s) 3112 form a graphics processing subsystem that can output pixels to one of one or more display device(s) 3110A coupled via I/O Hub 3107. In at least one embodiment, one or more parallel processor(s) 3112 can also include a display controller and display interface (not shown) to enable a direct connection to one or more display device(s) 3110B.

In at least one embodiment, a system storage unit 3114 can connect to I/O hub 3107 to provide a storage mechanism for computing system 3100. In at least one embodiment, an I/O switch 3116 can be used to provide an interface mechanism to enable connections between I/O hub 3107 and other components, such as a network adapter 3118 and/or wireless network adapter 3119 that may be integrated into a platform, and various other devices that can be added via one or more add-in device(s) 3120. In at least one embodiment, network adapter 3118 can be an Ethernet adapter or another wired network adapter. In at least one embodiment, wireless network adapter 3119 can include one or more of a Wi-Fi, Bluetooth, NFC, or other network device that includes one or more wireless radios.

In at least one embodiment, computing system 3100 can include other components not explicitly shown, including USB or other port connections, optical storage drives, video capture devices, and the like, that may also be connected to I/O hub 3107. In at least one embodiment, communication paths interconnecting various components in FIG. 31 may be implemented using any suitable protocols, such as PCI based protocols (e.g., PCIe), or other bus or point-to-point communication interfaces and/or protocol(s), such as NVLink high-speed interconnect, or interconnect protocols.

In at least one embodiment, one or more parallel processor(s) 3112 incorporate circuitry optimized for graphics and video processing, including, for example, video output circuitry, and constitutes a graphics processing unit (“GPU”). In at least one embodiment, one or more parallel processor(s) 3112 incorporate circuitry optimized for general purpose processing. In at least embodiment, components of computing system 3100 may be integrated with one or more other system elements on a single integrated circuit. For example, in at least one embodiment, one or more parallel processor(s) 3112, memory hub 3105, processor(s) 3102, and I/O hub 3107 can be integrated into an SoC integrated circuit. In at least one embodiment, components of computing system 3100 can be integrated into a single package to form a system in package (“SIP”) configuration. In at least one embodiment, at least a portion of the components of computing system 3100 can be integrated into a multi-chip module (“MCM”), which can be interconnected with other multi-chip modules into a modular computing system. In at least one embodiment, I/O subsystem 3111 and display devices 3110B are omitted from computing system 3100. In at least one embodiment, one or more parallel processor(s) 3112 include one or more tensor memory accelerators (TMA) units that can transfer blocks of data between global memory and shared memory. In at least one embodiment, one or more processors uses or access one or more TMAs to perform bi-directional copy operations, e.g., from global to shared memory and vice versa.

In at least one embodiment, at least one component shown or described with respect to FIG. 31 is used to perform techniques and/or functions described in connection with FIGS. 1-25. In at least one embodiment, at least one component shown or described with respect to FIG. 31 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 31 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 31 is used to perform at least one aspect described with respect to FIGS. 1-25, and/or other systems, methods, or operations described herein.

In at least one embodiment, at least one component shown or described with respect to FIG. 31 is used to perform techniques and/or functions described in connection with FIGS. 1-25. In at least one embodiment, at least one component shown or described with respect to FIG. 31 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 31 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 31 is used to perform techniques and/or functions described in connection with FIGS. 1-25. In at least one embodiment, at least one component shown or described with respect to FIG. 31 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 31 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 31 is used to perform techniques and/or functions described in connection with FIGS. 1-25. In at least one embodiment, at least one component shown or described with respect to FIG. 31 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 31 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 31 is used to perform techniques and/or functions described in connection with FIGS. 1-25. In at least one embodiment, at least one component shown or described with respect to FIG. 31 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 31 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 31 is used to perform techniques and/or functions described in connection with FIGS. 1-25. In at least one embodiment, at least one component shown or described with respect to FIG. 31 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 31 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 31 is used to perform techniques and/or functions described in connection with FIGS. 1-25. In at least one embodiment, at least one component shown or described with respect to FIG. 31 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 31 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 31 is used to perform techniques and/or functions described in connection with FIGS. 1-25. In at least one embodiment, at least one component shown or described with respect to FIG. 31 is used to perform an application programming interface (API) to cause context of one or more first software instructions to be communicated to one or more second software instructions, and/or other systems, methods, or operations described herein. In at least one embodiment, at least one component shown or described with respect to FIG. 31 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 31 is used to perform techniques and/or functions described in connection with FIGS. 1-25. In at least one embodiment, at least one component shown or described with respect to FIG. 31 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 31 is used to perform an application programming interface (API) to prevent one or more instructions from being performed by one or more resources of a first context of the processor until one or more indications of one or more events of a second context are generated, and/or other systems, methods, or operations described herein.

### Processing Systems

The following figures set forth, without limitation, exemplary processing systems that can be used to implement at least one embodiment.

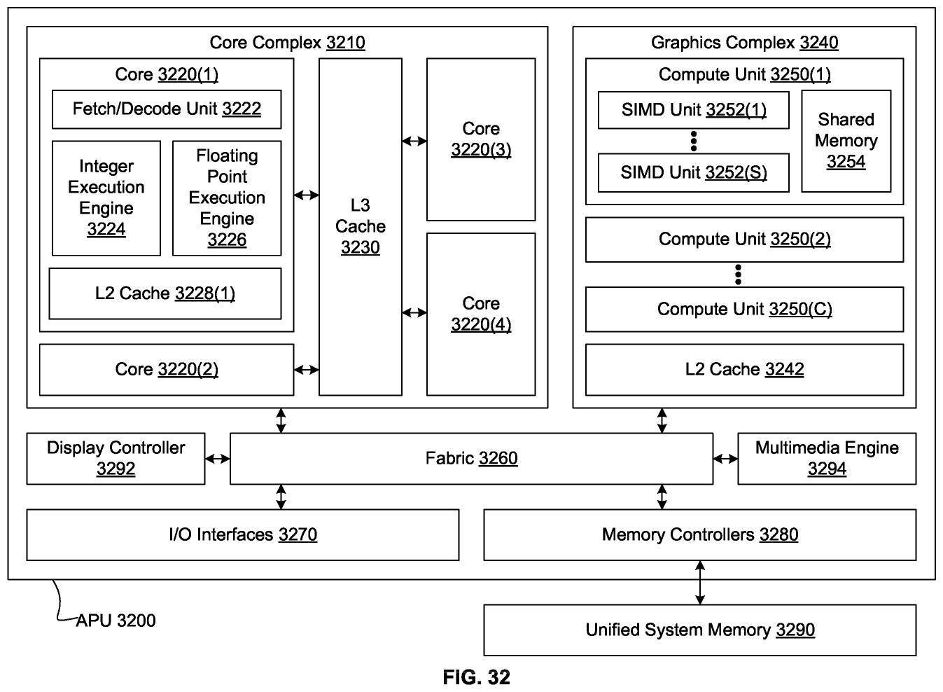

FIG. 32 illustrates an accelerated processing unit (“APU”) 3200, in accordance with at least one embodiment. In at least one embodiment, APU 3200 is developed by AMD Corporation of Santa Clara, CA. In at least one embodiment, APU 3200 can be configured to execute an application program, such as a CUDA program. In at least one embodiment, APU 3200 includes, without limitation, a core complex 3210, a graphics complex 3240, fabric 3260, I/O interfaces 3270, memory controllers 3280, a display controller 3292, and a multimedia engine 3294. In at least one embodiment, APU 3200 may include, without limitation, any number of core complexes 3210, any number of graphics complexes 3250, any number of display controllers 3292, and any number of multimedia engines 3294 in any combination. For explanatory purposes, multiple instances of like objects are denoted herein with reference numbers identifying the object and parenthetical numbers identifying the instance where needed.

In at least one embodiment, core complex 3210 is a CPU, graphics complex 3240 is a GPU, and APU 3200 is a processing unit that integrates, without limitation, 3210 and 3240 onto a single chip. In at least one embodiment, some tasks may be assigned to core complex 3210 and other tasks may be assigned to graphics complex 3240. In at least one embodiment, core complex 3210 is configured to execute main control software associated with APU 3200, such as an operating system. In at least one embodiment, core complex 3210 is the master processor of APU 3200, controlling and coordinating operations of other processors. In at least one embodiment, core complex 3210 issues commands that control the operation of graphics complex 3240. In at least one embodiment, core complex 3210 can be configured to execute host executable code derived from CUDA source code, and graphics complex 3240 can be configured to execute device executable code derived from CUDA source code.

In at least one embodiment, core complex 3210 includes, without limitation, cores 3220(1)-3220(4) and an L3 cache 3230. In at least one embodiment, core complex 3210 may include, without limitation, any number of cores 3220 and any number and type of caches in any combination. In at least one embodiment, cores 3220 are configured to execute instructions of a particular instruction set architecture (“ISA”). In at least one embodiment, each core 3220 is a CPU core. In at least one embodiment, core 3220 is referred to as a computing unit or compute unit.

In at least one embodiment, each core 3220 includes, without limitation, a fetch/decode unit 3222, an integer execution engine 3224, a floating point execution engine 3226, and an L2 cache 3228. In at least one embodiment, fetch/decode unit 3222 fetches instructions, decodes such instructions, generates micro-operations, and dispatches separate micro-instructions to integer execution engine 3224 and floating point execution engine 3226. In at least one embodiment, fetch/decode unit 3222 can concurrently dispatch one micro-instruction to integer execution engine 3224 and another micro-instruction to floating point execution engine 3226. In at least one embodiment, integer execution engine 3224 executes, without limitation, integer and memory operations. In at least one embodiment, floating point engine 3226 executes, without limitation, floating point and vector operations. In at least one embodiment, fetch-decode unit 3222 dispatches micro-instructions to a single execution engine that replaces both integer execution engine 3224 and floating point execution engine 3226.

In at least one embodiment, each core 3220(i), where i is an integer representing a particular instance of core 3220, may access L2 cache 3228(i) included in core 3220(i). In at least one embodiment, each core 3220 included in core complex 3210(j), where j is an integer representing a particular instance of core complex 3210, is connected to other cores 3220 included in core complex 3210(j) via L3 cache 3230(j) included in core complex 3210(j). In at least one embodiment, cores 3220 included in core complex 3210(j), where j is an integer representing a particular instance of core complex 3210, can access all of L3 cache 3230(j) included in core complex 3210(j). In at least one embodiment, L3 cache 3230 may include, without limitation, any number of slices.

In at least one embodiment, graphics complex 3240 can be configured to perform compute operations in a highly-parallel fashion. In at least one embodiment, graphics complex 3240 is configured to execute graphics pipeline operations such as draw commands, pixel operations, geometric computations, and other operations associated with rendering an image to a display. In at least one embodiment, graphics complex 3240 is configured to execute operations unrelated to graphics. In at least one embodiment, graphics complex 3240 is configured to execute both operations related to graphics and operations unrelated to graphics.

In at least one embodiment, graphics complex 3240 includes, without limitation, any number of compute units 3250 and an L2 cache 3242. In at least one embodiment, compute units 3250 share L2 cache 3242. In at least one embodiment, L2 cache 3242 is partitioned. In at least one embodiment, graphics complex 3240 includes, without limitation, any number of compute units 3250 and any number (including zero) and type of caches. In at least one embodiment, graphics complex 3240 includes, without limitation, any amount of dedicated graphics hardware.

In at least one embodiment, each compute unit 3250 includes, without limitation, any number of SIMD units 3252 and a shared memory 3254. In at least one embodiment, each SIMD unit 3252 implements a SIMD architecture and is configured to perform operations in parallel. In at least one embodiment, each compute unit 3250 may execute any number of thread blocks, but each thread block executes on a single compute unit 3250. In at least one embodiment, a thread block includes, without limitation, any number of threads of execution. In at least one embodiment, a workgroup is a thread block. In at least one embodiment, each SIMD unit 3252 executes a different warp. In at least one embodiment, a warp is a group of threads (e.g., 16 threads), where each thread in the warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 3254. In at least one embodiment, each compute unit 3250 includes one or more thread block clusters, where a thread block cluster can enable programmatic control of locality at a granularity larger than a single thread block of a single streaming multiprocessor (SM). In at least one embodiment, thread block clusters (also referred to as “clusters”) enables multiple thread blocks running concurrently across streaming multiprocessors to synchronize and collaboratively fetch, exchange, or otherwise use data.

In at least one embodiment, fabric 3260 is a system interconnect that facilitates data and control transmissions across core complex 3210, graphics complex 3240, I/O interfaces 3270, memory controllers 3280, display controller 3292, and multimedia engine 3294. In at least one embodiment, APU 3200 may include, without limitation, any amount and type of system interconnect in addition to or instead of fabric 3260 that facilitates data and control transmissions across any number and type of directly or indirectly linked components that may be internal or external to APU 3200. In at least one embodiment, I/O interfaces 3270 are representative of any number and type of I/O interfaces (e.g., PCI, PCI-Extended (“PCI-X”), PCIe, gigabit Ethernet (“GBE”), USB, etc.). In at least one embodiment, various types of peripheral devices are coupled to I/O interfaces 3270 In at least one embodiment, peripheral devices that are coupled to I/O interfaces 3270 may include, without limitation, keyboards, mice, printers, scanners, joysticks or other types of game controllers, media recording devices, external storage devices, network interface cards, and so forth.

In at least one embodiment, display controller AMD92 displays images on one or more display device(s), such as a liquid crystal display (“LCD”) device. In at least one embodiment, multimedia engine 3294 includes, without limitation, any amount and type of circuitry that is related to multimedia, such as a video decoder, a video encoder, an image signal processor, etc. In at least one embodiment, memory controllers 3280 facilitate data transfers between APU 3200 and a unified system memory 3290. In at least one embodiment, core complex 3210 and graphics complex 3240 share unified system memory 3290.

In at least one embodiment, APU 3200 implements a memory subsystem that includes, without limitation, any amount and type of memory controllers 3280 and memory devices (e.g., shared memory 3254) that may be dedicated to one component or shared among multiple components. In at least one embodiment, APU 3200 implements a cache subsystem that includes, without limitation, one or more cache memories (e.g., L2 caches 3328, L3 cache 3230, and L2 cache 3242) that may each be private to or shared between any number of components (e.g., cores 3220, core complex 3210, SIMD units 3252, compute units 3250, and graphics complex 3240).

In at least one embodiment, at least one component shown or described with respect to FIG. 32 is used to perform techniques and/or functions described in connection with FIGS. 1-25. In at least one embodiment, at least one component shown or described with respect to FIG. 32 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 32 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 32 is used to perform at least one aspect described with respect to FIGS. 1-25, and/or other systems, methods, or operations described herein.

In at least one embodiment, at least one component shown or described with respect to FIG. 32 is used to perform techniques and/or functions described in connection with FIGS. 1-25. In at least one embodiment, at least one component shown or described with respect to FIG. 32 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 32 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 32 is used to perform techniques and/or functions described in connection with FIGS. 1-25. In at least one embodiment, at least one component shown or described with respect to FIG. 32 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 32 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 32 is used to perform techniques and/or functions described in connection with FIGS. 1-25. In at least one embodiment, at least one component shown or described with respect to FIG. 32 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 32 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 32 is used to perform techniques and/or functions described in connection with FIGS. 1-25. In at least one embodiment, at least one component shown or described with respect to FIG. 32 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 32 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 32 is used to perform techniques and/or functions described in connection with FIGS. 1-25. In at least one embodiment, at least one component shown or described with respect to FIG. 32 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 32 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 32 is used to perform techniques and/or functions described in connection with FIGS. 1-25. In at least one embodiment, at least one component shown or described with respect to FIG. 32 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 32 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 32 is used to perform techniques and/or functions described in connection with FIGS. 1-25. In at least one embodiment, at least one component shown or described with respect to FIG. 32 is used to perform an application programming interface (API) to cause context of one or more first software instructions to be communicated to one or more second software instructions, and/or other systems, methods, or operations described herein. In at least one embodiment, at least one component shown or described with respect to FIG. 32 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 32 is used to perform techniques and/or functions described in connection with FIGS. 1-25. In at least one embodiment, at least one component shown or described with respect to FIG. 32 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 32 is used to perform an application programming interface (API) to prevent one or more instructions from being performed by one or more resources of a first context of the processor until one or more indications of one or more events of a second context are generated, and/or other systems, methods, or operations described herein.

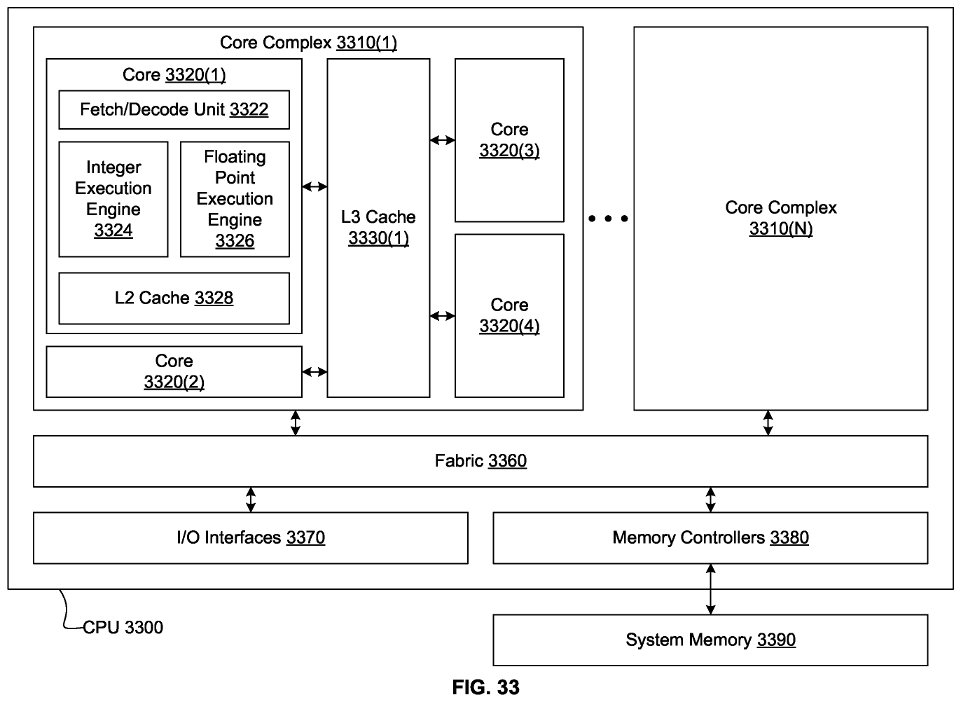

FIG. 33 illustrates a CPU 3300, in accordance with at least one embodiment. In at least one embodiment, CPU 3300 is developed by AMD Corporation of Santa Clara, CA. In at least one embodiment, CPU 3300 can be configured to execute an application program. In at least one embodiment, CPU 3300 is configured to execute main control software, such as an operating system. In at least one embodiment, CPU 3300 issues commands that control the operation of an external GPU (not shown). In at least one embodiment, CPU 3300 can be configured to execute host executable code derived from CUDA source code, and an external GPU can be configured to execute device executable code derived from such CUDA source code. In at least one embodiment, CPU 3300 includes, without limitation, any number of core complexes 3310, fabric 3360, I/O interfaces 3370, and memory controllers 3380.

In at least one embodiment, core complex 3310 includes, without limitation, cores 3320(1)-3320(4) and an L3 cache 3330. In at least one embodiment, core complex 3310 may include, without limitation, any number of cores 3320 and any number and type of caches in any combination. In at least one embodiment, cores 3320 are configured to execute instructions of a particular ISA. In at least one embodiment, each core 3320 is a CPU core.

In at least one embodiment, each core 3320 includes, without limitation, a fetch/decode unit 3322, an integer execution engine 3324, a floating point execution engine 3326, and an L2 cache 3328. In at least one embodiment, fetch/decode unit 3322 fetches instructions, decodes such instructions, generates micro-operations, and dispatches separate micro-instructions to integer execution engine 3324 and floating point execution engine 3326. In at least one embodiment, fetch/decode unit 3322 can concurrently dispatch one micro-instruction to integer execution engine 3324 and another micro-instruction to floating point execution engine 3326. In at least one embodiment, integer execution engine 3324 executes, without limitation, integer and memory operations. In at least one embodiment, floating point engine 3326 executes, without limitation, floating point and vector operations. In at least one embodiment, fetch-decode unit 3322 dispatches micro-instructions to a single execution engine that replaces both integer execution engine 3324 and floating point execution engine 3326.

In at least one embodiment, each core 3320(i), where i is an integer representing a particular instance of core 3320, may access L2 cache 3328(i) included in core 3320(i). In at least one embodiment, each core 3320 included in core complex 3310(j), where j is an integer representing a particular instance of core complex 3310, is connected to other cores 3320 in core complex 3310(j) via L3 cache 3330(j) included in core complex 3310(j). In at least one embodiment, cores 3320 included in core complex 3310(j), where j is an integer representing a particular instance of core complex 3310, can access all of L3 cache 3330(j) included in core complex 3310(j). In at least one embodiment, L3 cache 3330 may include, without limitation, any number of slices.

In at least one embodiment, fabric 3360 is a system interconnect that facilitates data and control transmissions across core complexes 3310(1)-3310(N) (where N is an integer greater than zero), I/O interfaces 3370, and memory controllers 3380. In at least one embodiment, CPU 3300 may include, without limitation, any amount and type of system interconnect in addition to or instead of fabric 3360 that facilitates data and control transmissions across any number and type of directly or indirectly linked components that may be internal or external to CPU 3300. In at least one embodiment, I/O interfaces 3370 are representative of any number and type of I/O interfaces (e.g., PCI, PCI-X, PCIe, GBE, USB, etc.). In at least one embodiment, various types of peripheral devices are coupled to I/O interfaces 3370 In at least one embodiment, peripheral devices that are coupled to I/O interfaces 3370 may include, without limitation, displays, keyboards, mice, printers, scanners, joysticks or other types of game controllers, media recording devices, external storage devices, network interface cards, and so forth.

In at least one embodiment, memory controllers 3380 facilitate data transfers between CPU 3300 and a system memory 3390. In at least one embodiment, core complex 3310 and graphics complex 3340 share system memory 3390. In at least one embodiment, CPU 3300 implements a memory subsystem that includes, without limitation, any amount and type of memory controllers 3380 and memory devices that may be dedicated to one component or shared among multiple components. In at least one embodiment, CPU 3300 implements a cache subsystem that includes, without limitation, one or more cache memories (e.g., L2 caches 3328 and L3 caches 3330) that may each be private to or shared between any number of components (e.g., cores 3320 and core complexes 3310).

In at least one embodiment, at least one component shown or described with respect to FIG. 33 is used to perform techniques and/or functions described in connection with FIGS. 1-25. In at least one embodiment, at least one component shown or described with respect to FIG. 33 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 33 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 33 is used to perform at least one aspect described with respect to FIGS. 1-25, and/or other systems, methods, or operations described herein.

In at least one embodiment, at least one component shown or described with respect to FIG. 33 is used to perform techniques and/or functions described in connection with FIGS. 1-25. In at least one embodiment, at least one component shown or described with respect to FIG. 33 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 33 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 33 is used to perform techniques and/or functions described in connection with FIGS. 1-25. In at least one embodiment, at least one component shown or described with respect to FIG. 33 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 33 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 33 is used to perform techniques and/or functions described in connection with FIGS. 1-25. In at least one embodiment, at least one component shown or described with respect to FIG. 33 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 33 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 33 is used to perform techniques and/or functions described in connection with FIGS. 1-25. In at least one embodiment, at least one component shown or described with respect to FIG. 33 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 33 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 33 is used to perform techniques and/or functions described in connection with FIGS. 1-25. In at least one embodiment, at least one component shown or described with respect to FIG. 33 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 33 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 33 is used to perform techniques and/or functions described in connection with FIGS. 1-25. In at least one embodiment, at least one component shown or described with respect to FIG. 33 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 33 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 33 is used to perform techniques and/or functions described in connection with FIGS. 1-25. In at least one embodiment, at least one component shown or described with respect to FIG. 33 is used to perform an application programming interface (API) to cause context of one or more first software instructions to be communicated to one or more second software instructions, and/or other systems, methods, or operations described herein. In at least one embodiment, at least one component shown or described with respect to FIG. 33 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 33 is used to perform techniques and/or functions described in connection with FIGS. 1-25. In at least one embodiment, at least one component shown or described with respect to FIG. 33 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 33 is used to perform an application programming interface (API) to prevent one or more instructions from being performed by one or more resources of a first context of the processor until one or more indications of one or more events of a second context are generated, and/or other systems, methods, or operations described herein.

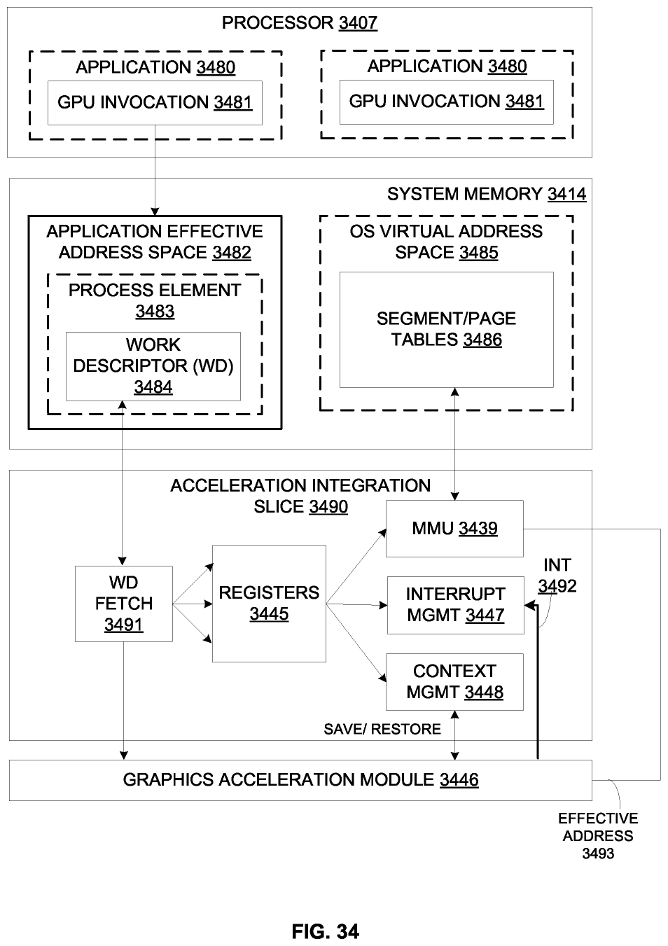

FIG. 34 illustrates an exemplary accelerator integration slice 3490, in accordance with at least one embodiment. As used herein, a “slice” comprises a specified portion of processing resources of an accelerator integration circuit. In at least one embodiment, the accelerator integration circuit provides cache management, memory access, context management, and interrupt management services on behalf of multiple graphics processing engines included in a graphics acceleration module. The graphics processing engines may each comprise a separate GPU. Alternatively, the graphics processing engines may comprise different types of graphics processing engines within a GPU such as graphics execution units, media processing engines (e.g., video encoders/decoders), samplers, and blit engines. In at least one embodiment, the graphics acceleration module may be a GPU with multiple graphics processing engines. In at least one embodiment, the graphics processing engines may be individual GPUs integrated on a common package, line card, or chip.

An application effective address space 3482 within system memory 3414 stores process elements 3483. In one embodiment, process elements 3483 are stored in response to GPU invocations 3481 from applications 3480 executed on processor 3407. A process element 3483 contains process state for corresponding application 3480. A work descriptor (“WD”) 3484 contained in process element 3483 can be a single job requested by an application or may contain a pointer to a queue of jobs. In at least one embodiment, WD 3484 is a pointer to a job request queue in application effective address space 3482.

Graphics acceleration module 3446 and/or individual graphics processing engines can be shared by all or a subset of processes in a system. In at least one embodiment, an infrastructure for setting up process state and sending WD 3484 to graphics acceleration module 3446 to start a job in a virtualized environment may be included.

In at least one embodiment, a dedicated-process programming model is implementation-specific. In this model, a single process owns graphics acceleration module 3446 or an individual graphics processing engine. Because graphics acceleration module 3446 is owned by a single process, a hypervisor initializes an accelerator integration circuit for an owning partition and an operating system initializes accelerator integration circuit for an owning process when graphics acceleration module 3446 is assigned.

In operation, a WD fetch unit 3491 in accelerator integration slice 3490 fetches next WD 3484 which includes an indication of work to be done by one or more graphics processing engines of graphics acceleration module 3446. Data from WD 3484 may be stored in registers 3445 and used by a memory management unit (“MMU”) 3439, interrupt management circuit 3447 and/or context management circuit 3448 as illustrated. For example, one embodiment of MMU 3439 includes segment/page walk circuitry for accessing segment/page tables 3486 within OS virtual address space 3485. Interrupt management circuit 3447 may process interrupt events (“INT”) 3492 received from graphics acceleration module 3446. When performing graphics operations, an effective address 3493 generated by a graphics processing engine is translated to a real address by MMU 3439.

In one embodiment, a same set of registers 3445 are duplicated for each graphics processing engine and/or graphics acceleration module 3446 and may be initialized by a hypervisor or operating system. Each of these duplicated registers may be included in accelerator integration slice 3490. Exemplary registers that may be initialized by a hypervisor are shown in Table 1.

TABLE 1
Hypervisor Initialized Registers

| | |
|---|---|
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization Record Pointer |
| 9 | Storage Description Register |

Exemplary registers that may be initialized by an operating system are shown in Table 2.

TABLE 2
Operating System Initialized Registers

| | |
|---|---|
| 1 | Process and Thread Identification |
| 2 | Effective Address (EA) Context Save/Restore Pointer |
| 3 | Virtual Address (VA) Accelerator Utilization Record Pointer |
| 4 | Virtual Address (VA) Storage Segment Table Pointer |
| 5 | Authority Mask |
| 6 | Work descriptor |

In one embodiment, each WD 3484 is specific to a particular graphics acceleration module 3446 and/or a particular graphics processing engine. It contains all information required by a graphics processing engine to do work or it can be a pointer to a memory location where an application has set up a command queue of work to be completed.

In at least one embodiment, at least one component shown or described with respect to FIG. 34 is used to perform techniques and/or functions described in connection with FIGS. 1-25. In at least one embodiment, at least one component shown or described with respect to FIG. 34 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 34 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 34 is used to perform at least one aspect described with respect to FIGS. 1-25, and/or other systems, methods, or operations described herein.

In at least one embodiment, at least one component shown or described with respect to FIG. 34 is used to perform techniques and/or functions described in connection with FIGS. 1-25. In at least one embodiment, at least one component shown or described with respect to FIG. 34 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 34 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 34 is used to perform techniques and/or functions described in connection with FIGS. 1-25. In at least one embodiment, at least one component shown or described with respect to FIG. 34 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 34 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 34 is used to perform techniques and/or functions described in connection with FIGS. 1-25. In at least one embodiment, at least one component shown or described with respect to FIG. 34 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 34 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 34 is used to perform techniques and/or functions described in connection with FIGS. 1-25. In at least one embodiment, at least one component shown or described with respect to FIG. 34 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 34 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 34 is used to perform techniques and/or functions described in connection with FIGS. 1-25. In at least one embodiment, at least one component shown or described with respect to FIG. 34 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 34 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 34 is used to perform techniques and/or functions described in connection with FIGS. 1-25. In at least one embodiment, at least one component shown or described with respect to FIG. 34 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 34 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 34 is used to perform techniques and/or functions described in connection with FIGS. 1-25. In at least one embodiment, at least one component shown or described with respect to FIG. 34 is used to perform an application programming interface (API) to cause context of one or more first software instructions to be communicated to one or more second software instructions, and/or other systems, methods, or operations described herein. In at least one embodiment, at least one component shown or described with respect to FIG. 34 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 34 is used to perform techniques and/or functions described in connection with FIGS. 1-25. In at least one embodiment, at least one component shown or described with respect to FIG. 34 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 34 is used to perform an application programming interface (API) to prevent one or more instructions from being performed by one or more resources of a first context of the processor until one or more indications of one or more events of a second context are generated, and/or other systems, methods, or operations described herein.

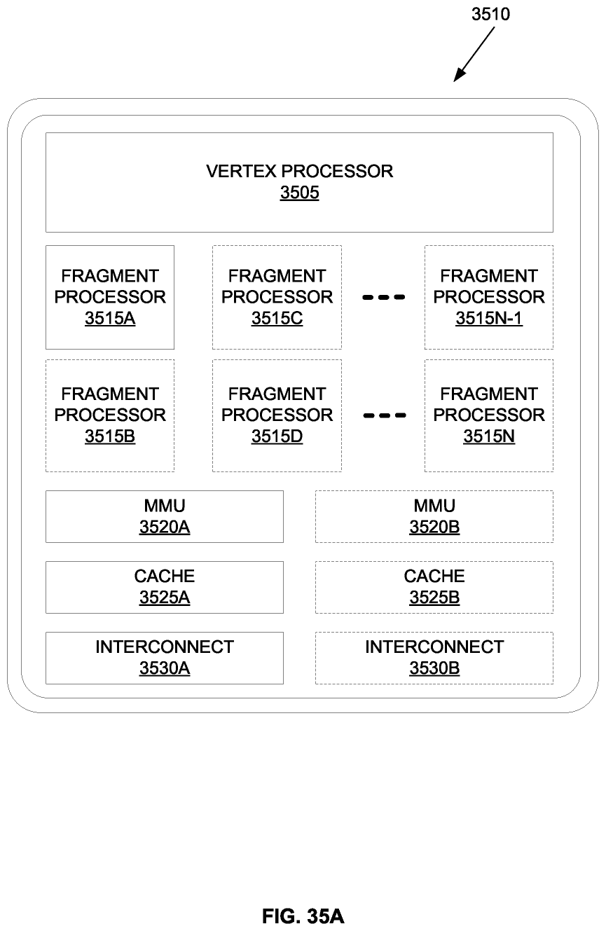

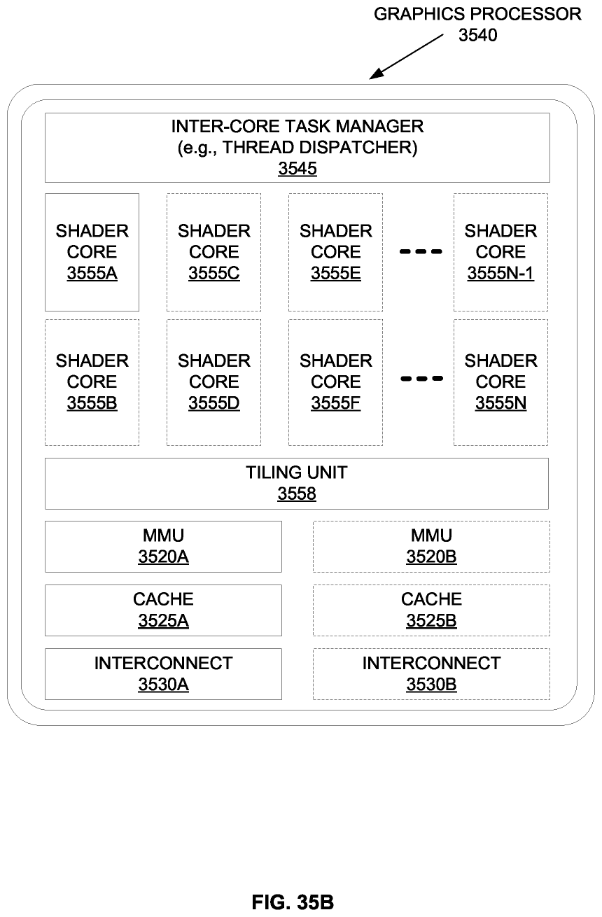

FIGS. 35A-35B illustrate exemplary graphics processors, in accordance with at least one embodiment. In at least one embodiment, any of the exemplary graphics processors may be fabricated using one or more IP cores. In addition to what is illustrated, other logic and circuits may be included in at least one embodiment, including additional graphics processors/cores, peripheral interface controllers, or general-purpose processor cores. In at least one embodiment, the exemplary graphics processors are for use within an SoC.

FIG. 35A illustrates an exemplary graphics processor 3510 of an SoC integrated circuit that may be fabricated using one or more IP cores, in accordance with at least one embodiment. FIG. 35B illustrates an additional exemplary graphics processor 3540 of an SoC integrated circuit that may be fabricated using one or more IP cores, in accordance with at least one embodiment. In at least one embodiment, graphics processor 3510 of FIG. 35A is a low power graphics processor core. In at least one embodiment, graphics processor 3540 of FIG. 35B is a higher performance graphics processor core. In at least one embodiment, each of graphics processors 3510, 3540 can be variants of graphics processor 3010 of FIG. 30.

In at least one embodiment, graphics processor 3510 includes a vertex processor 3505 and one or more fragment processor(s) 3515A-3515N (e.g., 3515A, 3515B, 3515C, 3515D, through 3515N−1, and 3515N). In at least one embodiment, graphics processor 3510 can execute different shader programs via separate logic, such that vertex processor 3505 is optimized to execute operations for vertex shader programs, while one or more fragment processor(s) 3515A-3515N execute fragment (e.g., pixel) shading operations for fragment or pixel shader programs. In at least one embodiment, vertex processor 3505 performs a vertex processing stage of a 3D graphics pipeline and generates primitives and vertex data. In at least one embodiment, fragment processor(s) 3515A-3515N use primitive and vertex data generated by vertex processor 3505 to produce a framebuffer that is displayed on a display device. In at least one embodiment, fragment processor(s) 3515A-3515N are optimized to execute fragment shader programs as provided for in an OpenGL API, which may be used to perform similar operations as a pixel shader program as provided for in a Direct 3D API.

In at least one embodiment, graphics processor 3510 additionally includes one or more MMU(s) 3520A-3520B, cache(s) 3525A-3525B, and circuit interconnect(s) 3530A-3530B. In at least one embodiment, one or more MMU(s) 3520A-3520B provide for virtual to physical address mapping for graphics processor 3510, including for vertex processor 3505 and/or fragment processor(s) 3515A-3515N, which may reference vertex or image/texture data stored in memory, in addition to vertex or image/texture data stored in one or more cache(s) 3525A-3525B. In at least one embodiment, one or more MMU(s) 3520A-3520B may be synchronized with other MMUs within a system, including one or more MMUs associated with one or more application processor(s) 3005, image processors 3015, and/or video processors 3020 of FIG. 30, such that each processor 3005-3020 can participate in a shared or unified virtual memory system. In at least one embodiment, one or more circuit interconnect(s) 3530A-3530B enable graphics processor 3510 to interface with other IP cores within an SoC, either via an internal bus of the SoC or via a direct connection.

In at least one embodiment, graphics processor 3540 includes one or more MMU(s) 3520A-3520B, caches 3525A-3525B, and circuit interconnects 3530A-3530B of graphics processor 3510 of FIG. 35A. In at least one embodiment, graphics processor 3540 includes one or more shader core(s) 3555A-3555N (e.g., 3555A, 3555B, 3555C, 3555D, 3555E, 3555F, through 3555N−1, and 3555N), which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 3540 includes an inter-core task manager 3545, which acts as a thread dispatcher to dispatch execution threads to one or more shader cores 3555A-3555N and a tiling unit 3558 to accelerate tiling operations for tile-based rendering, in which rendering operations for a scene are subdivided in image space, for example to exploit local spatial coherence within a scene or to optimize use of internal caches.

In at least one embodiment, at least one component shown or described with respect to FIGS. 35A-35B is used to perform techniques and/or functions described in connection with FIGS. 1-25. In at least one embodiment, at least one component shown or described with respect to FIGS. 35A-35 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIGS. 35A-35B is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIGS. 35A-35B is used to perform at least one aspect described with respect to FIGS. 1-25, and/or other systems, methods, or operations described herein.

In at least one embodiment, at least one component shown or described with respect to FIGS. 35A-35B is used to perform techniques and/or functions described in connection with FIGS. 1-25. In at least one embodiment, at least one component shown or described with respect to FIGS. 35A-35B is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIGS. 35A-35B is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIGS. 35A-35B is used to perform techniques and/or functions described in connection with FIGS. 1-25. In at least one embodiment, at least one component shown or described with respect to FIGS. 35A-35B is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIGS. 35A-35B is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIGS. 35A-35B is used to perform techniques and/or functions described in connection with FIGS. 1-25. In at least one embodiment, at least one component shown or described with respect to FIGS. 35A-35B is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIGS. 35A-35B is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIGS. 35A-35B is used to perform techniques and/or functions described in connection with FIGS. 1-25. In at least one embodiment, at least one component shown or described with respect to FIGS. 35A-35B is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIGS. 35A-35B is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIGS. 35A-35B is used to perform techniques and/or functions described in connection with FIGS. 1-25. In at least one embodiment, at least one component shown or described with respect to FIGS. 35A-35B is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIGS. 35A-35B is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIGS. 35A-35B is used to perform techniques and/or functions described in connection with FIGS. 1-25. In at least one embodiment, at least one component shown or described with respect to FIGS. 35A-35B is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIGS. 35A-35B is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIGS. 35A-35B is used to perform techniques and/or functions described in connection with FIGS. 1-25. In at least one embodiment, at least one component shown or described with respect to FIGS. 35A-35B is used to perform an application programming interface (API) to cause context of one or more first software instructions to be communicated to one or more second software instructions, and/or other systems, methods, or operations described herein. In at least one embodiment, at least one component shown or described with respect to FIGS. 35A-35B is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIGS. 35A-35B is used to perform techniques and/or functions described in connection with FIGS. 1-25. In at least one embodiment, at least one component shown or described with respect to FIGS. 35A-35B is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIGS. 35A-35B is used to perform an application programming interface (API) to prevent one or more instructions from being performed by one or more resources of a first context of the processor until one or more indications of one or more events of a second context are generated, and/or other systems, methods, or operations described herein.

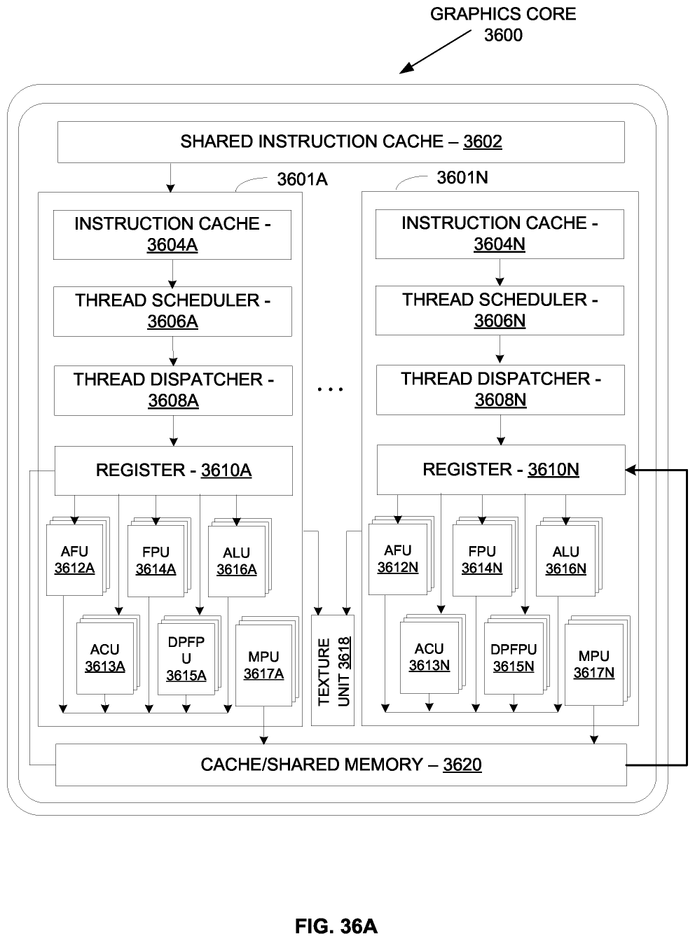

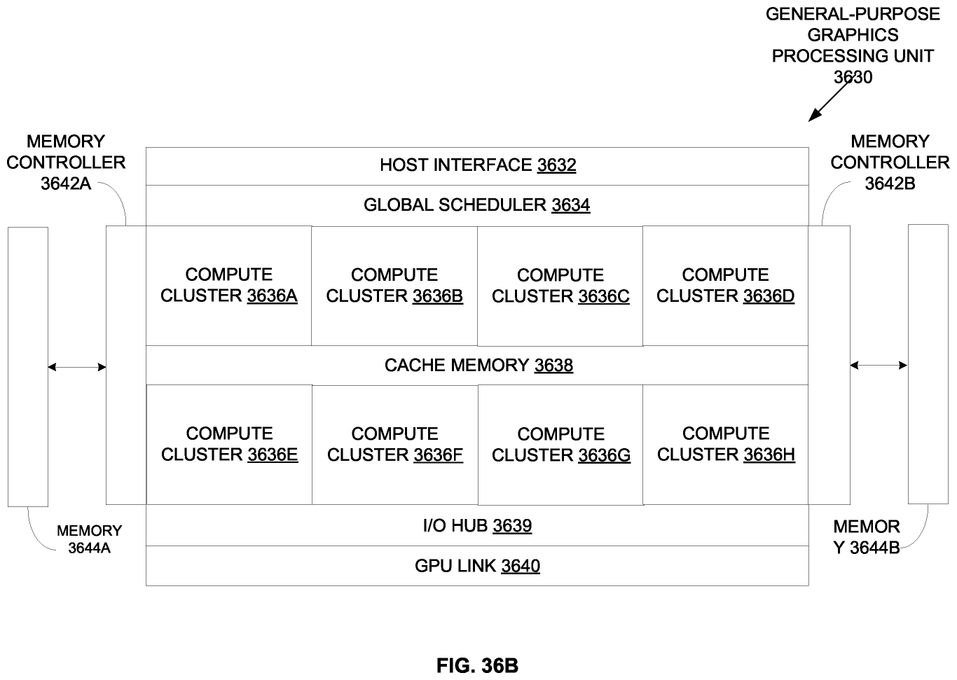

FIG. 36A illustrates a graphics core 3600, in accordance with at least one embodiment. In at least one embodiment, graphics core 3600 may be included within graphics processor 3010 of FIG. 30. In at least one embodiment, graphics core 3600 may be a unified shader core 3555A-3555N as in FIG. 35B. In at least one embodiment, graphics core 3600 includes a shared instruction cache 3602, a texture unit 3618, and a cache/shared memory 3620 that are common to execution resources within graphics core 3600. In at least one embodiment, graphics core 3600 can include multiple slices 3601A-3601N or partition for each core, and a graphics processor can include multiple instances of graphics core 3600. Slices 3601A-3601N can include support logic including a local instruction cache 3604A-3604N, a thread scheduler 3606A-3606N, a thread dispatcher 3608A-3608N, and a set of registers 3610A-3610N. In at least one embodiment, slices 3601A-3601N can include a set of additional function units (“AFUs”) 3612A-3612N, floating-point units (“FPUs”) 3614A-3614N, integer arithmetic logic units (“ALUs”) 3616-3616N, address computational units (“ACUs”) 3613A-3613N, double-precision floating-point units (“DPFPUs”) 3615A-3615N, and matrix processing units (“MPUs”) 3617A-3617N. In at least one embodiment, a graphics core 3600 is referred to as a compute unit or computing unit.

In at least one embodiment, FPUs 3614A-3614N can perform single-precision (32-bit) and half-precision (16-bit) floating point operations, while DPFPUs 3615A-3615N perform double precision (64-bit) floating point operations. In at least one embodiment, ALUs 3616A-3616N can perform variable precision integer operations at 8-bit, 16-bit, and 32-bit precision, and can be configured for mixed precision operations. In at least one embodiment, MPUs 3617A-3617N can also be configured for mixed precision matrix operations, including half-precision floating point and 8-bit integer operations. In at least one embodiment, MPUs 3617-3617N can perform a variety of matrix operations to accelerate CUDA programs, including enabling support for accelerated general matrix to matrix multiplication (“GEMM”). In at least one embodiment, AFUs 3612A-3612N can perform additional logic operations not supported by floating-point or integer units, including trigonometric operations (e.g., Sine, Cosine, etc.).

FIG. 36B illustrates a general-purpose graphics processing unit (“GPGPU”) 3630, in accordance with at least one embodiment. In at least one embodiment, GPGPU 3630 is highly-parallel and suitable for deployment on a multi-chip module. In at least one embodiment, GPGPU 3630 can be configured to enable highly-parallel compute operations to be performed by an array of GPUs. In at least one embodiment, GPGPU 3630 can be linked directly to other instances of GPGPU 3630 to create a multi-GPU cluster to improve execution time for CUDA programs. In at least one embodiment, GPGPU 3630 includes a host interface 3632 to enable a connection with a host processor. In at least one embodiment, host interface 3632 is a PCIe interface. In at least one embodiment, host interface 3632 can be a vendor specific communications interface or communications fabric. In at least one embodiment, GPGPU 3630 receives commands from a host processor and uses a global scheduler 3634 to distribute execution threads associated with those commands to a set of compute clusters 3636A-3636H. In at least one embodiment, compute clusters 3636A-3636H share a cache memory 3638. In at least one embodiment, cache memory 3638 can serve as a higher-level cache for cache memories within compute clusters 3636A-3636H.

In at least one embodiment, GPGPU 3630 includes memory 3644A-3644B coupled with compute clusters 3636A-3636H via a set of memory controllers 3642A-3642B. In at least one embodiment, memory 3644A-3644B can include various types of memory devices including DRAM or graphics random access memory, such as synchronous graphics random access memory (“SGRAM”), including graphics double data rate (“GDDR”) memory.

In at least one embodiment, compute clusters 3636A-3636H each include a set of graphics cores, such as graphics core 3600 of FIG. 36A, which can include multiple types of integer and floating point logic units that can perform computational operations at a range of precisions including suited for computations associated with CUDA programs. For example, in at least one embodiment, at least a subset of floating point units in each of compute clusters 3636A-3636H can be configured to perform 16-bit or 32-bit floating point operations, while a different subset of floating point units can be configured to perform 64-bit floating point operations.

In at least one embodiment, multiple instances of GPGPU 3630 can be configured to operate as a compute cluster. Compute clusters 3636A-3636H may implement any technically feasible communication techniques for synchronization and data exchange. In at least one embodiment, multiple instances of GPGPU 3630 communicate over host interface 3632. In at least one embodiment, GPGPU 3630 includes an I/O hub 3639 that couples GPGPU 3630 with a GPU link 3640 that enables a direct connection to other instances of GPGPU 3630. In at least one embodiment, GPU link 3640 is coupled to a dedicated GPU-to-GPU bridge that enables communication and synchronization between multiple instances of GPGPU 3630. In at least one embodiment GPU link 3640 couples with a high speed interconnect to transmit and receive data to other GPGPUs 3630 or parallel processors. In at least one embodiment, multiple instances of GPGPU 3630 are located in separate data processing systems and communicate via a network device that is accessible via host interface 3632. In at least one embodiment GPU link 3640 can be configured to enable a connection to a host processor in addition to or as an alternative to host interface 3632. In at least one embodiment, GPGPU 3630 can be configured to execute a CUDA program.

In at least one embodiment, at least one component shown or described with respect to FIGS. 36A-36B is used to perform techniques and/or functions described in connection with FIGS. 1-25. In at least one embodiment, at least one component shown or described with respect to FIGS. 36A-36 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIGS. 36A-36B is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIGS. 36A-36B is used to perform at least one aspect described with respect to FIGS. 1-25, and/or other systems, methods, or operations described herein.

In at least one embodiment, at least one component shown or described with respect to FIGS. 36A-36B is used to perform techniques and/or functions described in connection with FIGS. 1-25. In at least one embodiment, at least one component shown or described with respect to FIGS. 36A-36B is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIGS. 36A-36B is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIGS. 36A-36B is used to perform techniques and/or functions described in connection with FIGS. 1-25. In at least one embodiment, at least one component shown or described with respect to FIGS. 36A-36B is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIGS. 36A-36B is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIGS. 36A-36B is used to perform techniques and/or functions described in connection with FIGS. 1-25. In at least one embodiment, at least one component shown or described with respect to FIGS. 36A-36B is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIGS. 36A-36B is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIGS. 36A-36B is used to perform techniques and/or functions described in connection with FIGS. 1-25. In at least one embodiment, at least one component shown or described with respect to FIGS. 36A-36B is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIGS. 36A-36B is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIGS. 36A-36B is used to perform techniques and/or functions described in connection with FIGS. 1-25. In at least one embodiment, at least one component shown or described with respect to FIGS. 36A-36B is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIGS. 36A-36B is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIGS. 36A-36B is used to perform techniques and/or functions described in connection with FIGS. 1-25. In at least one embodiment, at least one component shown or described with respect to FIGS. 36A-36B is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIGS. 36A-36B is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIGS. 36A-36B is used to perform techniques and/or functions described in connection with FIGS. 1-25. In at least one embodiment, at least one component shown or described with respect to FIGS. 36A-36B is used to perform an application programming interface (API) to cause context of one or more first software instructions to be communicated to one or more second software instructions, and/or other systems, methods, or operations described herein. In at least one embodiment, at least one component shown or described with respect to FIGS. 36A-36B is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIGS. 36A-36B is used to perform techniques and/or functions described in connection with FIGS. 1-25. In at least one embodiment, at least one component shown or described with respect to FIGS. 36A-36B is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIGS. 36A-36B is used to perform an application programming interface (API) to prevent one or more instructions from being performed by one or more resources of a first context of the processor until one or more indications of one or more events of a second context are generated, and/or other systems, methods, or operations described herein.

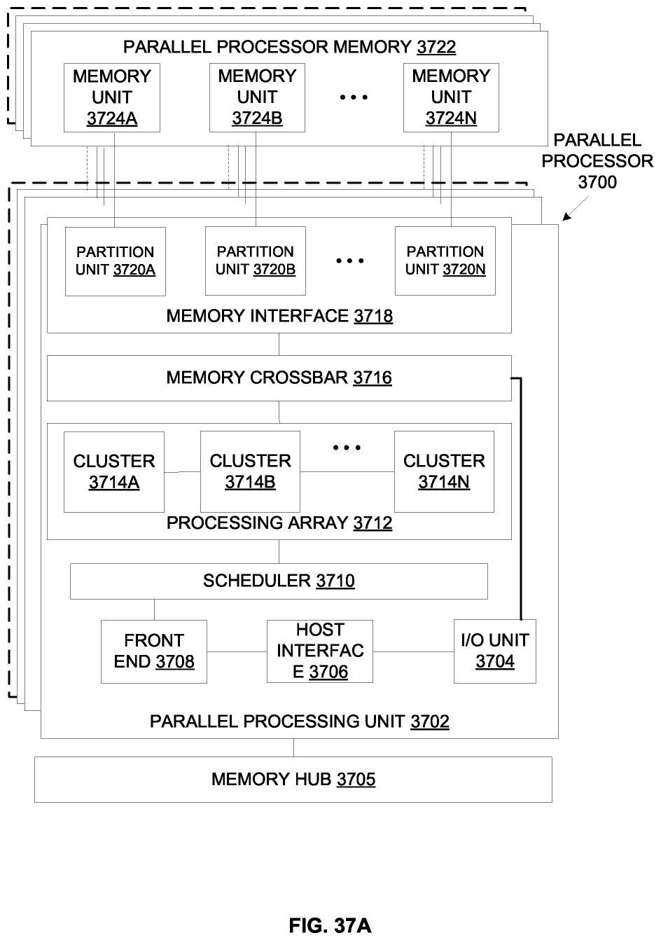

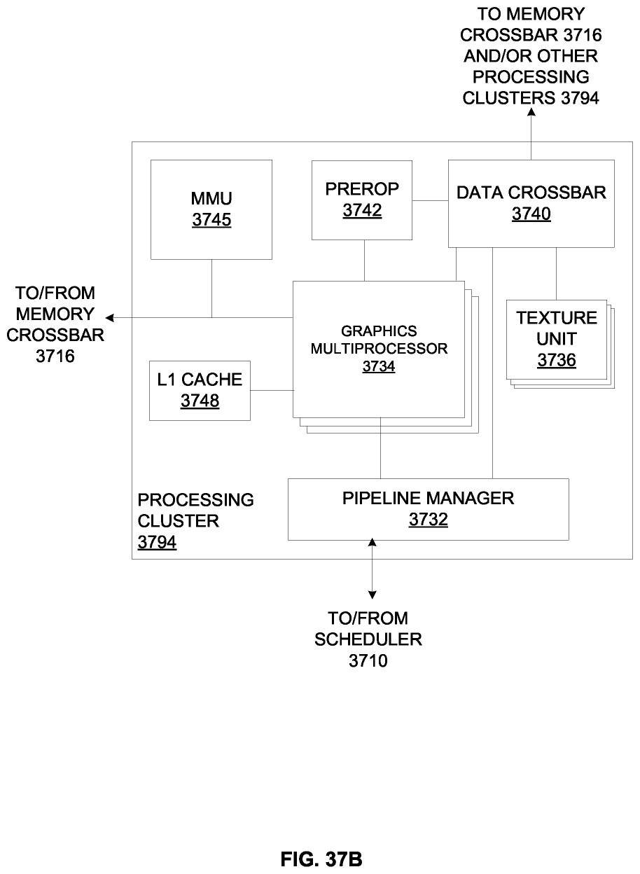

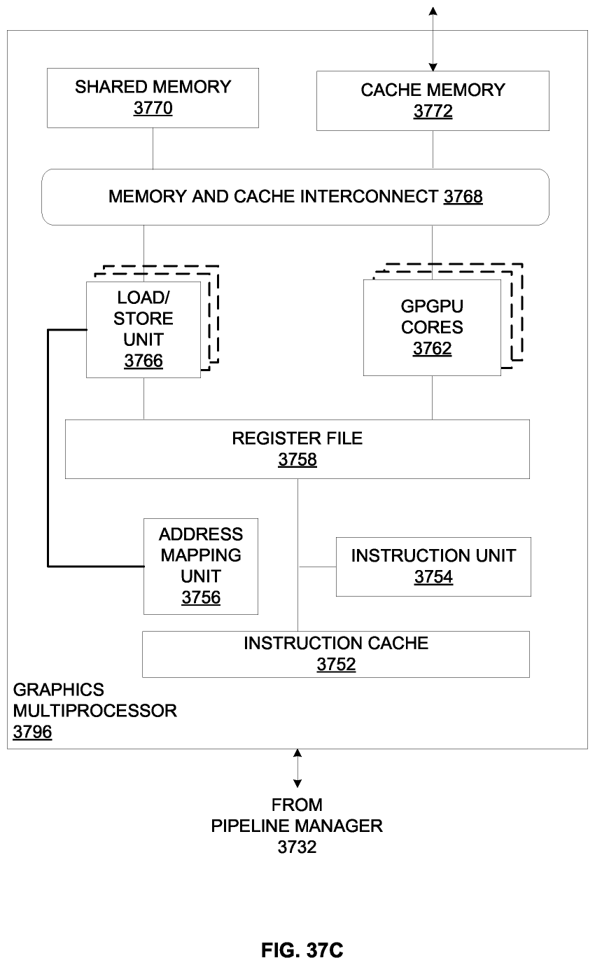

FIG. 37A illustrates a parallel processor 3700, in accordance with at least one embodiment. In at least one embodiment, various components of parallel processor 3700 may be implemented using one or more integrated circuit devices, such as programmable processors, application specific integrated circuits (“ASICs”), or FPGAs.

In at least one embodiment, parallel processor 3700 includes a parallel processing unit 3702. In at least one embodiment, parallel processing unit 3702 includes an I/O unit 3704 that enables communication with other devices, including other instances of parallel processing unit 3702. In at least one embodiment, I/O unit 3704 may be directly connected to other devices. In at least one embodiment, I/O unit 3704 connects with other devices via use of a hub or switch interface, such as memory hub 3705. In at least one embodiment, connections between memory hub 3705 and I/O unit 3704 form a communication link. In at least one embodiment, I/O unit 3704 connects with a host interface 3706 and a memory crossbar 3716, where host interface 3706 receives commands directed to performing processing operations and memory crossbar 3716 receives commands directed to performing memory operations.

In at least one embodiment, when host interface 3706 receives a command buffer via I/O unit 3704, host interface 3706 can direct work operations to perform those commands to a front end 3708. In at least one embodiment, front end 3708 couples with a scheduler 3710, which is configured to distribute commands or other work items to a processing array 3712. In at least one embodiment, scheduler 3710 ensures that processing array 3712 is properly configured and in a valid state before tasks are distributed to processing array 3712. In at least one embodiment, scheduler 3710 is implemented via firmware logic executing on a microcontroller. In at least one embodiment, microcontroller implemented scheduler 3710 is configurable to perform complex scheduling and work distribution operations at coarse and fine granularity, enabling rapid preemption and context switching of threads executing on processing array 3712. In at least one embodiment, host software can prove workloads for scheduling on processing array 3712 via one of multiple graphics processing doorbells. In at least one embodiment, workloads can then be automatically distributed across processing array 3712 by scheduler 3710 logic within a microcontroller including scheduler 3710.

In at least one embodiment, processing array 3712 can include up to “N” clusters (e.g., cluster 3714A, cluster 3714B, through cluster 3714N). In at least one embodiment, each cluster 3714A-3714N of processing array 3712 can execute a large number of concurrent threads. In at least one embodiment, scheduler 3710 can allocate work to clusters 3714A-3714N of processing array 3712 using various scheduling and/or work distribution algorithms, which may vary depending on the workload arising for each type of program or computation. In at least one embodiment, scheduling can be handled dynamically by scheduler 3710, or can be assisted in part by compiler logic during compilation of program logic configured for execution by processing array 3712. In at least one embodiment, different clusters 3714A-3714N of processing array 3712 can be allocated for processing different types of programs or for performing different types of computations.

In at least one embodiment, processing array 3712 can be configured to perform various types of parallel processing operations. In at least one embodiment, processing array 3712 is configured to perform general-purpose parallel compute operations. For example, in at least one embodiment, processing array 3712 can include logic to execute processing tasks including filtering of video and/or audio data, performing modeling operations, including physics operations, and performing data transformations.

In at least one embodiment, processing array 3712 is configured to perform parallel graphics processing operations. In at least one embodiment, processing array 3712 can include additional logic to support execution of such graphics processing operations, including, but not limited to texture sampling logic to perform texture operations, as well as tessellation logic and other vertex processing logic. In at least one embodiment, processing array 3712 can be configured to execute graphics processing related shader programs such as, but not limited to vertex shaders, tessellation shaders, geometry shaders, and pixel shaders. In at least one embodiment, parallel processing unit 3702 can transfer data from system memory via I/O unit 3704 for processing. In at least one embodiment, during processing, transferred data can be stored to on-chip memory (e.g., a parallel processor memory 3722) during processing, then written back to system memory.

In at least one embodiment, when parallel processing unit 3702 is used to perform graphics processing, scheduler 3710 can be configured to divide a processing workload into approximately equal sized tasks, to better enable distribution of graphics processing operations to multiple clusters 3714A-3714N of processing array 3712. In at least one embodiment, portions of processing array 3712 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 3714A-3714N may be stored in buffers to allow intermediate data to be transmitted between clusters 3714A-3714N for further processing.

In at least one embodiment, processing array 3712 can receive processing tasks to be executed via scheduler 3710, which receives commands defining processing tasks from front end 3708. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 3710 may be configured to fetch indices corresponding to tasks or may receive indices from front end 3708. In at least one embodiment, front end 3708 can be configured to ensure processing array 3712 is configured to a valid state before a workload specified by incoming command buffers (e.g., batch-buffers, push buffers, etc.) is initiated.

In at least one embodiment, each of one or more instances of parallel processing unit 3702 can couple with parallel processor memory 3722. In at least one embodiment, parallel processor memory 3722 can be accessed via memory crossbar 3716, which can receive memory requests from processing array 3712 as well as I/O unit 3704. In at least one embodiment, memory crossbar 3716 can access parallel processor memory 3722 via a memory interface 3718. In at least one embodiment, memory interface 3718 can include multiple partition units (e.g., a partition unit 3720A, partition unit 3720B, through partition unit 3720N) that can each couple to a portion (e.g., memory unit) of parallel processor memory 3722. In at least one embodiment, a number of partition units 3720A-3720N is configured to be equal to a number of memory units, such that a first partition unit 3720A has a corresponding first memory unit 3724A, a second partition unit 3720B has a corresponding memory unit 3724B, and an Nth partition unit 3720N has a corresponding Nth memory unit 3724N. In at least one embodiment, a number of partition units 3720A-3720N may not be equal to a number of memory devices.

In at least one embodiment, memory units 3724A-3724N can include various types of memory devices, including DRAM or graphics random access memory, such as SGRAM, including GDDR memory. In at least one embodiment, memory units 3724A-3724N may also include 3D stacked memory, including but not limited to high bandwidth memory (“HBM”). In at least one embodiment, render targets, such as frame buffers or texture maps may be stored across memory units 3724A-3724N, allowing partition units 3720A-3720N to write portions of each render target in parallel to efficiently use available bandwidth of parallel processor memory 3722. In at least one embodiment, a local instance of parallel processor memory 3722 may be excluded in favor of a unified memory design that utilizes system memory in conjunction with local cache memory.

In at least one embodiment, any one of clusters 3714A-3714N of processing array 3712 can process data that will be written to any of memory units 3724A-3724N within parallel processor memory 3722. In at least one embodiment, memory crossbar 3716 can be configured to transfer an output of each cluster 3714A-3714N to any partition unit 3720A-3720N or to another cluster 3714A-3714N, which can perform additional processing operations on an output. In at least one embodiment, each cluster 3714A-3714N can communicate with memory interface 3718 through memory crossbar 3716 to read from or write to various external memory devices. In at least one embodiment, memory crossbar 3716 has a connection to memory interface 3718 to communicate with I/O unit 3704, as well as a connection to a local instance of parallel processor memory 3722, enabling processing units within different clusters 3714A-3714N to communicate with system memory or other memory that is not local to parallel processing unit 3702. In at least one embodiment, memory crossbar 3716 can use virtual channels to separate traffic streams between clusters 3714A-3714N and partition units 3720A-3720N.

In at least one embodiment, multiple instances of parallel processing unit 3702 can be provided on a single add-in card, or multiple add-in cards can be interconnected. In at least one embodiment, different instances of parallel processing unit 3702 can be configured to interoperate even if different instances have different numbers of processing cores, different amounts of local parallel processor memory, and/or other configuration differences. For example, in at least one embodiment, some instances of parallel processing unit 3702 can include higher precision floating point units relative to other instances. In at least one embodiment, systems incorporating one or more instances of parallel processing unit 3702 or parallel processor 3700 can be implemented in a variety of configurations and form factors, including but not limited to desktop, laptop, or handheld personal computers, servers, workstations, game consoles, and/or embedded systems.

In at least one embodiment, at least one component shown or described with respect to FIG. 37A is used to perform techniques and/or functions described in connection with FIGS. 1-25. In at least one embodiment, at least one component shown or described with respect to FIG. 37A is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 37A is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 37A is used to perform at least one aspect described with respect to FIGS. 1-25, and/or other systems, methods, or operations described herein.

In at least one embodiment, at least one component shown or described with respect to FIG. 37A is used to perform techniques and/or functions described in connection with FIGS. 1-25. In at least one embodiment, at least one component shown or described with respect to FIG. 37A is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 37A is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 37A is used to perform techniques and/or functions described in connection with FIGS. 1-25. In at least one embodiment, at least one component shown or described with respect to FIG. 37A is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 37A is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 37A is used to perform techniques and/or functions described in connection with FIGS. 1-25. In at least one embodiment, at least one component shown or described with respect to FIG. 37A is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 37A is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 37A is used to perform techniques and/or functions described in connection with FIGS. 1-25. In at least one embodiment, at least one component shown or described with respect to FIG. 37A is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 37A is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 37A is used to perform techniques and/or functions described in connection with FIGS. 1-25. In at least one embodiment, at least one component shown or described with respect to FIG. 37A is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 37A is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 37A is used to perform techniques and/or functions described in connection with FIGS. 1-25. In at least one embodiment, at least one component shown or described with respect to FIG. 37A is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 37A is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 37A is used to perform techniques and/or functions described in connection with FIGS. 1-25. In at least one embodiment, at least one component shown or described with respect to FIG. 37A is used to perform an application programming interface (API) to cause context of one or more first software instructions to be communicated to one or more second software instructions, and/or other systems, methods, or operations described herein. In at least one embodiment, at least one component shown or described with respect to FIG. 37A is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 37A is used to perform techniques and/or functions described in connection with FIGS. 1-25. In at least one embodiment, at least one component shown or described with respect to FIG. 37A is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 37A is used to perform an application programming interface (API) to prevent one or more instructions from being performed by one or more resources of a first context of the processor until one or more indications of one or more events of a second context are generated, and/or other systems, methods, or operations described herein.

FIG. 37B illustrates a processing cluster 3794, in accordance with at least one embodiment. In at least one embodiment, processing cluster 3794 is included within a parallel processing unit. In at least one embodiment, processing cluster 3794 is one of processing clusters 3714A-3714N of FIG. 37. In at least one embodiment, processing cluster 3794 can be configured to execute many threads in parallel, where the term “thread” refers to an instance of a particular program executing on a particular set of input data. In at least one embodiment, single instruction, multiple data (“SIMD”) instruction issue techniques are used to support parallel execution of a large number of threads without providing multiple independent instruction units. In at least one embodiment, single instruction, multiple thread (“SIMT”) techniques are used to support parallel execution of a large number of generally synchronized threads, using a common instruction unit configured to issue instructions to a set of processing engines within each processing cluster 3794.

In at least one embodiment, operation of processing cluster 3794 can be controlled via a pipeline manager 3732 that distributes processing tasks to SIMT parallel processors. In at least one embodiment, pipeline manager 3732 receives instructions from scheduler 3710 of FIG. 37 and manages execution of those instructions via a graphics multiprocessor 3734 and/or a texture unit 3736. In at least one embodiment, graphics multiprocessor 3734 is an exemplary instance of a SIMT parallel processor. However, in at least one embodiment, various types of SIMT parallel processors of differing architectures may be included within processing cluster 3794. In at least one embodiment, one or more instances of graphics multiprocessor 3734 can be included within processing cluster 3794. In at least one embodiment, graphics multiprocessor 3734 can process data and a data crossbar 3740 can be used to distribute processed data to one of multiple possible destinations, including other shader units. In at least one embodiment, pipeline manager 3732 can facilitate distribution of processed data by specifying destinations for processed data to be distributed via data crossbar 3740.

In at least one embodiment, each graphics multiprocessor 3734 within processing cluster 3794 can include an identical set of functional execution logic (e.g., arithmetic logic units, load/store units (“LSUs”), etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 3794 constitute a thread. In at least one embodiment, a set of threads executing across a set of parallel processing engines is a thread group. In at least one embodiment, a thread group executes a program on different input data. In at least one embodiment, each thread within a thread group can be assigned to a different processing engine within graphics multiprocessor 3734. In at least one embodiment, a thread group may include fewer threads than a number of processing engines within graphics multiprocessor 3734. In at least one embodiment, when a thread group includes fewer threads than a number of processing engines, one or more of the processing engines may be idle during cycles in which that thread group is being processed. In at least one embodiment, a thread group may also include more threads than a number of processing engines within graphics multiprocessor 3734. In at least one embodiment, when a thread group includes more threads than the number of processing engines within graphics multiprocessor 3734, processing can be performed over consecutive clock cycles. In at least one embodiment, multiple thread groups can be executed concurrently on graphics multiprocessor 3734.

In at least one embodiment, graphics multiprocessor 3734 includes an internal cache memory to perform load and store operations. In at least one embodiment, graphics multiprocessor 3734 can forego an internal cache and use a cache memory (e.g., L1 cache 3748) within processing cluster 3794. In at least one embodiment, each graphics multiprocessor 3734 also has access to Level 2 (“L2”) caches within partition units (e.g., partition units 3720A-3720N of FIG. 37A) that are shared among all processing clusters 3794 and may be used to transfer data between threads. In at least one embodiment, graphics multiprocessor 3734 may also access off-chip global memory, which can include one or more of local parallel processor memory and/or system memory. In at least one embodiment, any memory external to parallel processing unit 3702 may be used as global memory. In at least one embodiment, processing cluster 3794 includes multiple instances of graphics multiprocessor 3734 that can share common instructions and data, which may be stored in L1 cache 3748.

In at least one embodiment, each processing cluster 3794 may include an MMU 3745 that is configured to map virtual addresses into physical addresses. In at least one embodiment, one or more instances of MMU 3745 may reside within memory interface 3718 of FIG. 37. In at least one embodiment, MMU 3745 includes a set of page table entries (“PTEs”) used to map a virtual address to a physical address of a tile and optionally a cache line index. In at least one embodiment, MMU 3745 may include address translation lookaside buffers (“TLBs”) or caches that may reside within graphics multiprocessor 3734 or L1 cache 3748 or processing cluster 3794. In at least one embodiment, a physical address is processed to distribute surface data access locality to allow efficient request interleaving among partition units. In at least one embodiment, a cache line index may be used to determine whether a request for a cache line is a hit or miss.

In at least one embodiment, processing cluster 3794 may be configured such that each graphics multiprocessor 3734 is coupled to a texture unit 3736 for performing texture mapping operations, e.g., determining texture sample positions, reading texture data, and filtering texture data. In at least one embodiment, texture data is read from an internal texture L1 cache (not shown) or from an L1 cache within graphics multiprocessor 3734 and is fetched from an L2 cache, local parallel processor memory, or system memory, as needed. In at least one embodiment, each graphics multiprocessor 3734 outputs a processed task to data crossbar 3740 to provide the processed task to another processing cluster 3794 for further processing or to store the processed task in an L2 cache, a local parallel processor memory, or a system memory via memory crossbar 3716. In at least one embodiment, a pre-raster operations unit (“preROP”) 3742 is configured to receive data from graphics multiprocessor 3734, direct data to ROP units, which may be located with partition units as described herein (e.g., partition units 3720A-3720N of FIG. 37). In at least one embodiment, PreROP 3742 can perform optimizations for color blending, organize pixel color data, and perform address translations.

In at least one embodiment, at least one component shown or described with respect to FIG. 37B is used to perform techniques and/or functions described in connection with FIGS. 1-25. In at least one embodiment, at least one component shown or described with respect to FIG. 37B is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 37B is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 37B is used to perform at least one aspect described with respect to FIGS. 1-25, and/or other systems, methods, or operations described herein.

In at least one embodiment, at least one component shown or described with respect to FIG. 37B is used to perform techniques and/or functions described in connection with FIGS. 1-25. In at least one embodiment, at least one component shown or described with respect to FIG. 37B is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 37B is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 37B is used to perform techniques and/or functions described in connection with FIGS. 1-25. In at least one embodiment, at least one component shown or described with respect to FIG. 37B is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 37B is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 37B is used to perform techniques and/or functions described in connection with FIGS. 1-25. In at least one embodiment, at least one component shown or described with respect to FIG. 37B is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 37B is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 37B is used to perform techniques and/or functions described in connection with FIGS. 1-25. In at least one embodiment, at least one component shown or described with respect to FIG. 37B is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 37B is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 37B is used to perform techniques and/or functions described in connection with FIGS. 1-25. In at least one embodiment, at least one component shown or described with respect to FIG. 37B is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 37B is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 37B is used to perform techniques and/or functions described in connection with FIGS. 1-25. In at least one embodiment, at least one component shown or described with respect to FIG. 37B is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 37B is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 37B is used to perform techniques and/or functions described in connection with FIGS. 1-25. In at least one embodiment, at least one component shown or described with respect to FIG. 37B is used to perform an application programming interface (API) to cause context of one or more first software instructions to be communicated to one or more second software instructions, and/or other systems, methods, or operations described herein. In at least one embodiment, at least one component shown or described with respect to FIG. 37B is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 37B is used to perform techniques and/or functions described in connection with FIGS. 1-25. In at least one embodiment, at least one component shown or described with respect to FIG. 37B is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 37B is used to perform an application programming interface (API) to prevent one or more instructions from being performed by one or more resources of a first context of the processor until one or more indications of one or more events of a second context are generated, and/or other systems, methods, or operations described herein.

FIG. 37C illustrates a graphics multiprocessor 3796, in accordance with at least one embodiment. In at least one embodiment, graphics multiprocessor 3796 is graphics multiprocessor 3734 of FIG. 37B. In at least one embodiment, graphics multiprocessor 3796 couples with pipeline manager 3732 of processing cluster 3794. In at least one embodiment, graphics multiprocessor 3796 has an execution pipeline including but not limited to an instruction cache 3752, an instruction unit 3754, an address mapping unit 3756, a register file 3758, one or more GPGPU cores 3762, and one or more LSUs 3766. GPGPU cores 3762 and LSUs 3766 are coupled with cache memory 3772 and shared memory 3770 via a memory and cache interconnect 3768.

In at least one embodiment, instruction cache 3752 receives a stream of instructions to execute from pipeline manager 3732. In at least one embodiment, instructions are cached in instruction cache 3752 and dispatched for execution by instruction unit 3754. In at least one embodiment, instruction unit 3754 can dispatch instructions as thread groups (e.g., warps), with each thread of a thread group assigned to a different execution unit within GPGPU core 3762. In at least one embodiment, an instruction can access any of a local, shared, or global address space by specifying an address within a unified address space. In at least one embodiment, address mapping unit 3756 can be used to translate addresses in a unified address space into a distinct memory address that can be accessed by LSUs 3766.

In at least one embodiment, register file 3758 provides a set of registers for functional units of graphics multiprocessor 3796. In at least one embodiment, register file 3758 provides temporary storage for operands connected to data paths of functional units (e.g., GPGPU cores 3762, LSUs 3766) of graphics multiprocessor 3796. In at least one embodiment, register file 3758 is divided between each of functional units such that each functional unit is allocated a dedicated portion of register file 3758. In at least one embodiment, register file 3758 is divided between different thread groups being executed by graphics multiprocessor 3796.

In at least one embodiment, GPGPU cores 3762 can each include FPUs and/or integer ALUs that are used to execute instructions of graphics multiprocessor 3796. GPGPU cores 3762 can be similar in architecture or can differ in architecture. In at least one embodiment, a first portion of GPGPU cores 3762 include a single precision FPU and an integer ALU while a second portion of GPGPU cores 3762 include a double precision FPU. In at least one embodiment, FPUs can implement IEEE 754-2008 standard for floating point arithmetic or enable variable precision floating point arithmetic. In at least one embodiment, graphics multiprocessor 3796 can additionally include one or more fixed function or special function units to perform specific functions such as copy rectangle or pixel blending operations. In at least one embodiment one or more of GPGPU cores 3762 can also include fixed or special function logic.

In at least one embodiment, GPGPU cores 3762 include SIMD logic capable of performing a single instruction on multiple sets of data. In at least one embodiment GPGPU cores 3762 can physically execute SIMD4, SIMD8, and SIMD16 instructions and logically execute SIMD1, SIMD2, and SIMD32 instructions. In at least one embodiment, SIMD instructions for GPGPU cores 3762 can be generated at compile time by a shader compiler or automatically generated when executing programs written and compiled for single program multiple data (“SPMD”) or SIMT architectures. In at least one embodiment, multiple threads of a program configured for an SIMT execution model can executed via a single SIMD instruction. For example, in at least one embodiment, eight SIMT threads that perform the same or similar operations can be executed in parallel via a single SIMD8 logic unit.

In at least one embodiment, memory and cache interconnect 3768 is an interconnect network that connects each functional unit of graphics multiprocessor 3796 to register file 3758 and to shared memory 3770. In at least one embodiment, memory and cache interconnect 3768 is a crossbar interconnect that allows LSU 3766 to implement load and store operations between shared memory 3770 and register file 3758. In at least one embodiment, register file 3758 can operate at a same frequency as GPGPU cores 3762, thus data transfer between GPGPU cores 3762 and register file 3758 is very low latency. In at least one embodiment, shared memory 3770 can be used to enable communication between threads that execute on functional units within graphics multiprocessor 3796. In at least one embodiment, cache memory 3772 can be used as a data cache for example, to cache texture data communicated between functional units and texture unit 3736. In at least one embodiment, shared memory 3770 can also be used as a program managed cached. In at least one embodiment, threads executing on GPGPU cores 3762 can programmatically store data within shared memory in addition to automatically cached data that is stored within cache memory 3772.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high speed interconnect such as PCIe or NVLink). In at least one embodiment, a GPU may be integrated on the same package or chip as cores and communicatively coupled to cores over a processor bus/interconnect that is internal to a package or a chip. In at least one embodiment, regardless of the manner in which a GPU is connected, processor cores may allocate work to the GPU in the form of sequences of commands/instructions contained in a WD. In at least one embodiment, the GPU then uses dedicated circuitry/logic for efficiently processing these commands/instructions.

In at least one embodiment, at least one component shown or described with respect to FIG. 37C is used to perform techniques and/or functions described in connection with FIGS. 1-25. In at least one embodiment, at least one component shown or described with respect to FIG. 37C is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 37C is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 37C is used to perform at least one aspect described with respect to FIGS. 1-25, and/or other systems, methods, or operations described herein.

In at least one embodiment, at least one component shown or described with respect to FIG. 37C is used to perform techniques and/or functions described in connection with FIGS. 1-25. In at least one embodiment, at least one component shown or described with respect to FIG. 37C is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 37C is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 37C is used to perform techniques and/or functions described in connection with FIGS. 1-25. In at least one embodiment, at least one component shown or described with respect to FIG. 37C is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 37C is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 37C is used to perform techniques and/or functions described in connection with FIGS. 1-25. In at least one embodiment, at least one component shown or described with respect to FIG. 37C is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 37C is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 37C is used to perform techniques and/or functions described in connection with FIGS. 1-25. In at least one embodiment, at least one component shown or described with respect to FIG. 37C is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 37C is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 37C is used to perform techniques and/or functions described in connection with FIGS. 1-25. In at least one embodiment, at least one component shown or described with respect to FIG. 37C is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 37C is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 37C is used to perform techniques and/or functions described in connection with FIGS. 1-25. In at least one embodiment, at least one component shown or described with respect to FIG. 37C is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 37C is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 37C is used to perform techniques and/or functions described in connection with FIGS. 1-25. In at least one embodiment, at least one component shown or described with respect to FIG. 37C is used to perform an application programming interface (API) to cause context of one or more first software instructions to be communicated to one or more second software instructions, and/or other systems, methods, or operations described herein. In at least one embodiment, at least one component shown or described with respect to FIG. 37C is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 37C is used to perform techniques and/or functions described in connection with FIGS. 1-25. In at least one embodiment, at least one component shown or described with respect to FIG. 37C is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 37C is used to perform an application programming interface (API) to prevent one or more instructions from being performed by one or more resources of a first context of the processor until one or more indications of one or more events of a second context are generated, and/or other systems, methods, or operations described herein.

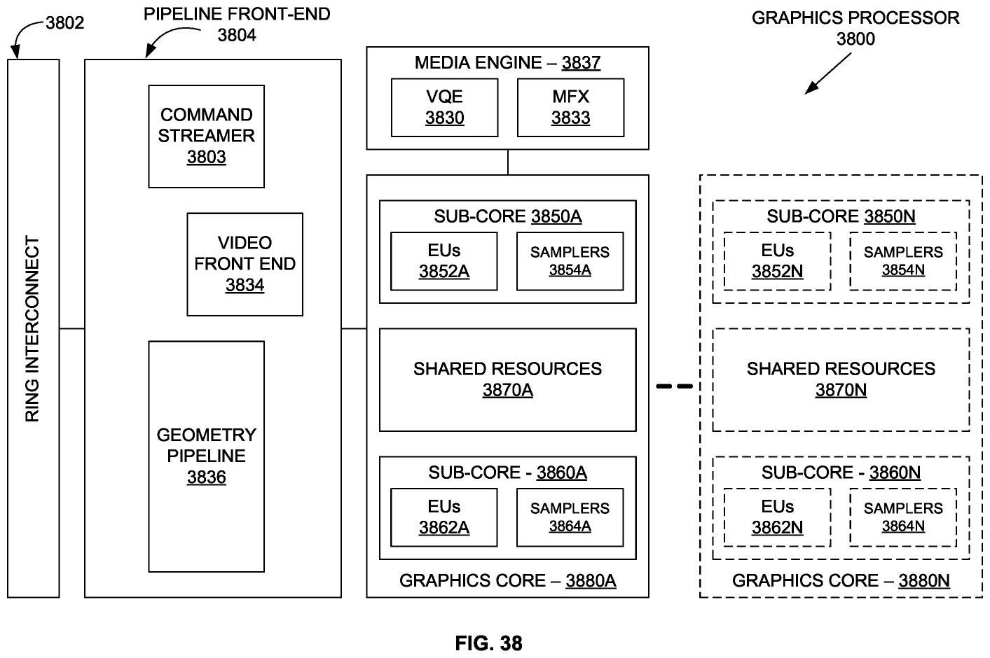

FIG. 38 illustrates a graphics processor 3800, in accordance with at least one embodiment. In at least one embodiment, graphics processor 3800 includes a ring interconnect 3802, a pipeline front-end 3804, a media engine 3837, and graphics cores 3880A-3880N. In at least one embodiment, ring interconnect 3802 couples graphics processor 3800 to other processing units, including other graphics processors or one or more general-purpose processor cores. In at least one embodiment, graphics processor 3800 is one of many processors integrated within a multi-core processing system.

In at least one embodiment, graphics processor 3800 receives batches of commands via ring interconnect 3802. In at least one embodiment, incoming commands are interpreted by a command streamer 3803 in pipeline front-end 3804. In at least one embodiment, graphics processor 3800 includes scalable execution logic to perform 3D geometry processing and media processing via graphics core(s) 3880A-3880N. In at least one embodiment, for 3D geometry processing commands, command streamer 3803 supplies commands to geometry pipeline 3836. In at least one embodiment, for at least some media processing commands, command streamer 3803 supplies commands to a video front end 3834, which couples with a media engine 3837. In at least one embodiment, media engine 3837 includes a Video Quality Engine (“VQE”) 3830 for video and image post-processing and a multi-format encode/decode (“MFX”) engine 3833 to provide hardware-accelerated media data encode and decode. In at least one embodiment, geometry pipeline 3836 and media engine 3837 each generate execution threads for thread execution resources provided by at least one graphics core 3880A.

In at least one embodiment, graphics processor 3800 includes scalable thread execution resources featuring modular graphics cores 3880A-3880N (sometimes referred to as core slices), each having multiple sub-cores 3850A-550N, 3860A-3860N (sometimes referred to as core sub-slices). In at least one embodiment, graphics processor 3800 can have any number of graphics cores 3880A through 3880N. In at least one embodiment, graphics processor 3800 includes a graphics core 3880A having at least a first sub-core 3850A and a second sub-core 3860A. In at least one embodiment, graphics processor 3800 is a low power processor with a single sub-core (e.g., sub-core 3850A). In at least one embodiment, graphics processor 3800 includes multiple graphics cores 3880A-3880N, each including a set of first sub-cores 3850A-3850N and a set of second sub-cores 3860A-3860N. In at least one embodiment, each sub-core in first sub-cores 3850A-3850N includes at least a first set of execution units (“EUs”) 3852A-3852N and media/texture samplers 3854A-3854N. In at least one embodiment, each sub-core in second sub-cores 3860A-3860N includes at least a second set of execution units 3862A-3862N and samplers 3864A-3864N. In at least one embodiment, each sub-core 3850A-3850N, 3860A-3860N shares a set of shared resources 3870A-3870N. In at least one embodiment, shared resources 3870 include shared cache memory and pixel operation logic.

In at least one embodiment, at least one component shown or described with respect to FIG. 38 is used to perform techniques and/or functions described in connection with FIGS. 1-25. In at least one embodiment, at least one component shown or described with respect to FIG. 38 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 38 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 38 is used to perform at least one aspect described with respect to FIGS. 1-25, and/or other systems, methods, or operations described herein.

In at least one embodiment, at least one component shown or described with respect to FIG. 38 is used to perform techniques and/or functions described in connection with FIGS. 1-25. In at least one embodiment, at least one component shown or described with respect to FIG. 38 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 38 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 38 is used to perform techniques and/or functions described in connection with FIGS. 1-25. In at least one embodiment, at least one component shown or described with respect to FIG. 38 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 38 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 38 is used to perform techniques and/or functions described in connection with FIGS. 1-25. In at least one embodiment, at least one component shown or described with respect to FIG. 38 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 38 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 38 is used to perform techniques and/or functions described in connection with FIGS. 1-25. In at least one embodiment, at least one component shown or described with respect to FIG. 38 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 38 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 38 is used to perform techniques and/or functions described in connection with FIGS. 1-25. In at least one embodiment, at least one component shown or described with respect to FIG. 38 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 38 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 38 is used to perform techniques and/or functions described in connection with FIGS. 1-25. In at least one embodiment, at least one component shown or described with respect to FIG. 38 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 38 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 38 is used to perform techniques and/or functions described in connection with FIGS. 1-25. In at least one embodiment, at least one component shown or described with respect to FIG. 38 is used to perform an application programming interface (API) to cause context of one or more first software instructions to be communicated to one or more second software instructions, and/or other systems, methods, or operations described herein. In at least one embodiment, at least one component shown or described with respect to FIG. 38 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 38 is used to perform techniques and/or functions described in connection with FIGS. 1-25. In at least one embodiment, at least one component shown or described with respect to FIG. 38 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 38 is used to perform an application programming interface (API) to prevent one or more instructions from being performed by one or more resources of a first context of the processor until one or more indications of one or more events of a second context are generated, and/or other systems, methods, or operations described herein.

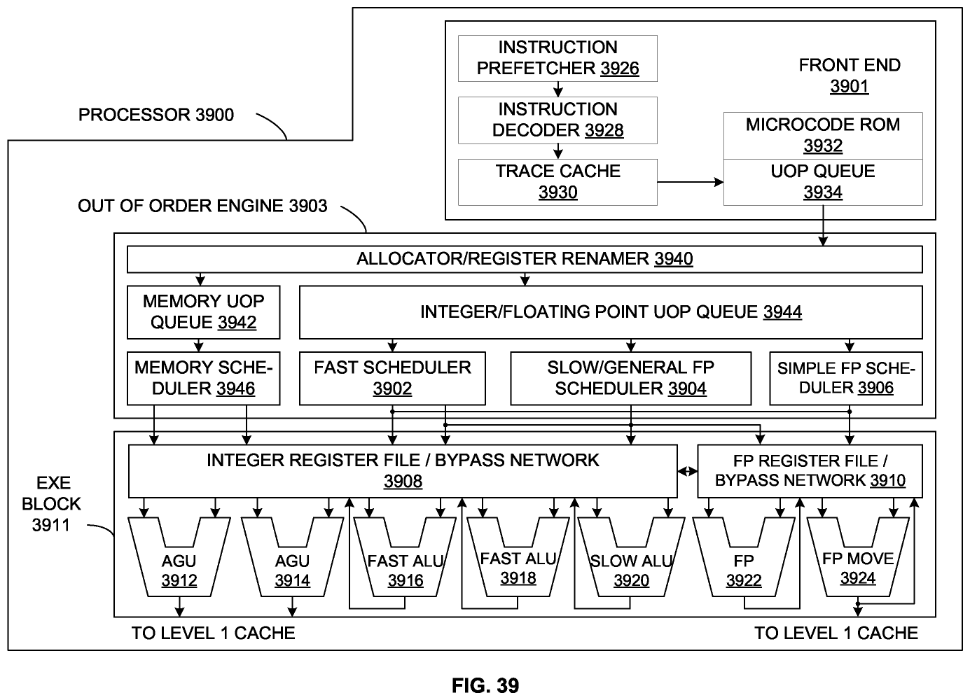

FIG. 39 illustrates a processor 3900, in accordance with at least one embodiment. In at least one embodiment, processor 3900 may include, without limitation, logic circuits to perform instructions. In at least one embodiment, processor 3900 may perform instructions, including x86 instructions, ARM instructions, specialized instructions for ASICs, etc. In at least one embodiment, processor 3910 may include registers to store packed data, such as 64-bit wide MMX™ registers in microprocessors enabled with MMX technology from Intel Corporation of Santa Clara, Calif. In at least one embodiment, MMX registers, available in both integer and floating point forms, may operate with packed data elements that accompany SIMD and streaming SIMD extensions (“SSE”) instructions. In at least one embodiment, 128-bit wide XMM registers relating to SSE2, SSE3, SSE4, AVX, or beyond (referred to generically as “SSEx”) technology may hold such packed data operands. In at least one embodiment, processors 3910 may perform instructions to accelerate CUDA programs.

In at least one embodiment, processor 3900 includes an in-order front end (“front end”) 3901 to fetch instructions to be executed and prepare instructions to be used later in processor pipeline. In at least one embodiment, front end 3901 may include several units. In at least one embodiment, an instruction prefetcher 3926 fetches instructions from memory and feeds instructions to an instruction decoder 3928 which in turn decodes or interprets instructions. For example, in at least one embodiment, instruction decoder 3928 decodes a received instruction into one or more operations called “micro-instructions” or “micro-operations” (also called “micro ops” or “uops”) for execution. In at least one embodiment, instruction decoder 3928 parses instruction into an opcode and corresponding data and control fields that may be used by micro-architecture to perform operations. In at least one embodiment, a trace cache 3930 may assemble decoded uops into program ordered sequences or traces in a uop queue 3934 for execution. In at least one embodiment, when trace cache 3930 encounters a complex instruction, a microcode ROM 3932 provides uops needed to complete an operation.

In at least one embodiment, some instructions may be converted into a single micro-op, whereas others need several micro-ops to complete full operation. In at least one embodiment, if more than four micro-ops are needed to complete an instruction, instruction decoder 3928 may access microcode ROM 3932 to perform instruction. In at least one embodiment, an instruction may be decoded into a small number of micro-ops for processing at instruction decoder 3928. In at least one embodiment, an instruction may be stored within microcode ROM 3932 should a number of micro-ops be needed to accomplish operation. In at least one embodiment, trace cache 3930 refers to an entry point programmable logic array (“PLA”) to determine a correct micro-instruction pointer for reading microcode sequences to complete one or more instructions from microcode ROM 3932. In at least one embodiment, after microcode ROM 3932 finishes sequencing micro-ops for an instruction, front end 3901 of machine may resume fetching micro-ops from trace cache 3930.

In at least one embodiment, out-of-order execution engine (“out of order engine”) 3903 may prepare instructions for execution. In at least one embodiment, out-of-order execution logic has a number of buffers to smooth out and re-order the flow of instructions to optimize performance as they go down a pipeline and get scheduled for execution. Out-of-order execution engine 3903 includes, without limitation, an allocator/register renamer 3940, a memory uop queue 3942, an integer/floating point uop queue 3944, a memory scheduler 3946, a fast scheduler 3902, a slow/general floating point scheduler (“slow/general FP scheduler”) 3904, and a simple floating point scheduler (“simple FP scheduler”) 3906. In at least one embodiment, fast schedule 3902, slow/general floating point scheduler 3904, and simple floating point scheduler 3906 are also collectively referred to herein as “uop schedulers 3902, 3904, 3906.” Allocator/register renamer 3940 allocates machine buffers and resources that each uop needs in order to execute. In at least one embodiment, allocator/register renamer 3940 renames logic registers onto entries in a register file. In at least one embodiment, allocator/register renamer 3940 also allocates an entry for each uop in one of two uop queues, memory uop queue 3942 for memory operations and integer/floating point uop queue 3944 for non-memory operations, in front of memory scheduler 3946 and uop schedulers 3902, 3904, 3906. In at least one embodiment, uop schedulers 3902, 3904, 3906, determine when a uop is ready to execute based on readiness of their dependent input register operand sources and availability of execution resources uops need to complete their operation. In at least one embodiment, fast scheduler 3902 of at least one embodiment may schedule on each half of main clock cycle while slow/general floating point scheduler 3904 and simple floating point scheduler 3906 may schedule once per main processor clock cycle. In at least one embodiment, uop schedulers 3902, 3904, 3906 arbitrate for dispatch ports to schedule uops for execution.

In at least one embodiment, execution block 3911 includes, without limitation, an integer register file/bypass network 3908, a floating point register file/bypass network (“FP register file/bypass network”) 3910, address generation units (“AGUs”) 3912 and 3914, fast ALUs 3916 and 3918, a slow ALU 3920, a floating point ALU (“FP”) 3922, and a floating point move unit (“FP move”) 3924. In at least one embodiment, integer register file/bypass network 3908 and floating point register file/bypass network 3910 are also referred to herein as “register files 3908, 3910.” In at least one embodiment, AGUSs 3912 and 3914, fast ALUs 3916 and 3918, slow ALU 3920, floating point ALU 3922, and floating point move unit 3924 are also referred to herein as “execution units 3912, 3914, 3916, 3918, 3920, 3922, and 3924.” In at least one embodiment, an execution block may include, without limitation, any number (including zero) and type of register files, bypass networks, address generation units, and execution units, in any combination.

In at least one embodiment, register files 3908, 3910 may be arranged between uop schedulers 3902, 3904, 3906, and execution units 3912, 3914, 3916, 3918, 3920, 3922, and 3924. In at least one embodiment, integer register file/bypass network 3908 performs integer operations. In at least one embodiment, floating point register file/bypass network 3910 performs floating point operations. In at least one embodiment, each of register files 3908, 3910 may include, without limitation, a bypass network that may bypass or forward just completed results that have not yet been written into register file to new dependent uops. In at least one embodiment, register files 3908, 3910 may communicate data with each other. In at least one embodiment, integer register file/bypass network 3908 may include, without limitation, two separate register files, one register file for low-order thirty-two bits of data and a second register file for high order thirty-two bits of data. In at least one embodiment, floating point register file/bypass network 3910 may include, without limitation, 128-bit wide entries because floating point instructions typically have operands from 64 to 128 bits in width.

In at least one embodiment, execution units 3912, 3914, 3916, 3918, 3920, 3922, 3924 may execute instructions. In at least one embodiment, register files 3908, 3910 store integer and floating point data operand values that micro-instructions need to execute. In at least one embodiment, processor 3900 may include, without limitation, any number and combination of execution units 3912, 3914, 3916, 3918, 3920, 3922, 3924. In at least one embodiment, floating point ALU 3922 and floating point move unit 3924 may execute floating point, MMX, SIMD, AVX and SSE, or other operations. In at least one embodiment, floating point ALU 3922 may include, without limitation, a 64-bit by 64-bit floating point divider to execute divide, square root, and remainder micro ops. In at least one embodiment, instructions involving a floating point value may be handled with floating point hardware. In at least one embodiment, ALU operations may be passed to fast ALUs 3916, 3918. In at least one embodiment, fast ALUS 3916, 3918 may execute fast operations with an effective latency of half a clock cycle. In at least one embodiment, most complex integer operations go to slow ALU 3920 as slow ALU 3920 may include, without limitation, integer execution hardware for long-latency type of operations, such as a multiplier, shifts, flag logic, and branch processing. In at least one embodiment, memory load/store operations may be executed by AGUs 3912, 3914. In at least one embodiment, fast ALU 3916, fast ALU 3918, and slow ALU 3920 may perform integer operations on 64-bit data operands. In at least one embodiment, fast ALU 3916, fast ALU 3918, and slow ALU 3920 may be implemented to support a variety of data bit sizes including sixteen, thirty-two, 128, 256, etc. In at least one embodiment, floating point ALU 3922 and floating point move unit 3924 may be implemented to support a range of operands having bits of various widths. In at least one embodiment, floating point ALU 3922 and floating point move unit 3924 may operate on 128-bit wide packed data operands in conjunction with SIMD and multimedia instructions.

In at least one embodiment, uop schedulers 3902, 3904, 3906 dispatch dependent operations before parent load has finished executing. In at least one embodiment, as uops may be speculatively scheduled and executed in processor 3900, processor 3900 may also include logic to handle memory misses. In at least one embodiment, if a data load misses in a data cache, there may be dependent operations in flight in pipeline that have left a scheduler with temporarily incorrect data. In at least one embodiment, a replay mechanism tracks and re-executes instructions that use incorrect data. In at least one embodiment, dependent operations might need to be replayed and independent ones may be allowed to complete. In at least one embodiment, schedulers and replay mechanisms of at least one embodiment of a processor may also be designed to catch instruction sequences for text string comparison operations.

In at least one embodiment, the term “registers” may refer to on-board processor storage locations that may be used as part of instructions to identify operands. In at least one embodiment, registers may be those that may be usable from outside of a processor (from a programmer's perspective). In at least one embodiment, registers might not be limited to a particular type of circuit. Rather, in at least one embodiment, a register may store data, provide data, and perform functions described herein. In at least one embodiment, registers described herein may be implemented by circuitry within a processor using any number of different techniques, such as dedicated physical registers, dynamically allocated physical registers using register renaming, combinations of dedicated and dynamically allocated physical registers, etc. In at least one embodiment, integer registers store 32-bit integer data. A register file of at least one embodiment also contains eight multimedia SIMD registers for packed data.

In at least one embodiment, at least one component shown or described with respect to FIG. 39 is used to perform techniques and/or functions described in connection with FIGS. 1-25. In at least one embodiment, at least one component shown or described with respect to FIG. 39 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 39 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 39 is used to perform at least one aspect described with respect to FIGS. 1-25, and/or other systems, methods, or operations described herein.

In at least one embodiment, at least one component shown or described with respect to FIG. 39 is used to perform techniques and/or functions described in connection with FIGS. 1-25. In at least one embodiment, at least one component shown or described with respect to FIG. 39 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 39 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 39 is used to perform techniques and/or functions described in connection with FIGS. 1-25. In at least one embodiment, at least one component shown or described with respect to FIG. 39 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 39 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 39 is used to perform techniques and/or functions described in connection with FIGS. 1-25. In at least one embodiment, at least one component shown or described with respect to FIG. 39 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 39 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 39 is used to perform techniques and/or functions described in connection with FIGS. 1-25. In at least one embodiment, at least one component shown or described with respect to FIG. 39 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 39 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 39 is used to perform techniques and/or functions described in connection with FIGS. 1-25. In at least one embodiment, at least one component shown or described with respect to FIG. 39 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 39 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 39 is used to perform techniques and/or functions described in connection with FIGS. 1-25. In at least one embodiment, at least one component shown or described with respect to FIG. 39 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 39 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 39 is used to perform techniques and/or functions described in connection with FIGS. 1-25. In at least one embodiment, at least one component shown or described with respect to FIG. 39 is used to perform an application programming interface (API) to cause context of one or more first software instructions to be communicated to one or more second software instructions, and/or other systems, methods, or operations described herein. In at least one embodiment, at least one component shown or described with respect to FIG. 39 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 39 is used to perform techniques and/or functions described in connection with FIGS. 1-25. In at least one embodiment, at least one component shown or described with respect to FIG. 39 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 39 is used to perform an application programming interface (API) to prevent one or more instructions from being performed by one or more resources of a first context of the processor until one or more indications of one or more events of a second context are generated, and/or other systems, methods, or operations described herein.

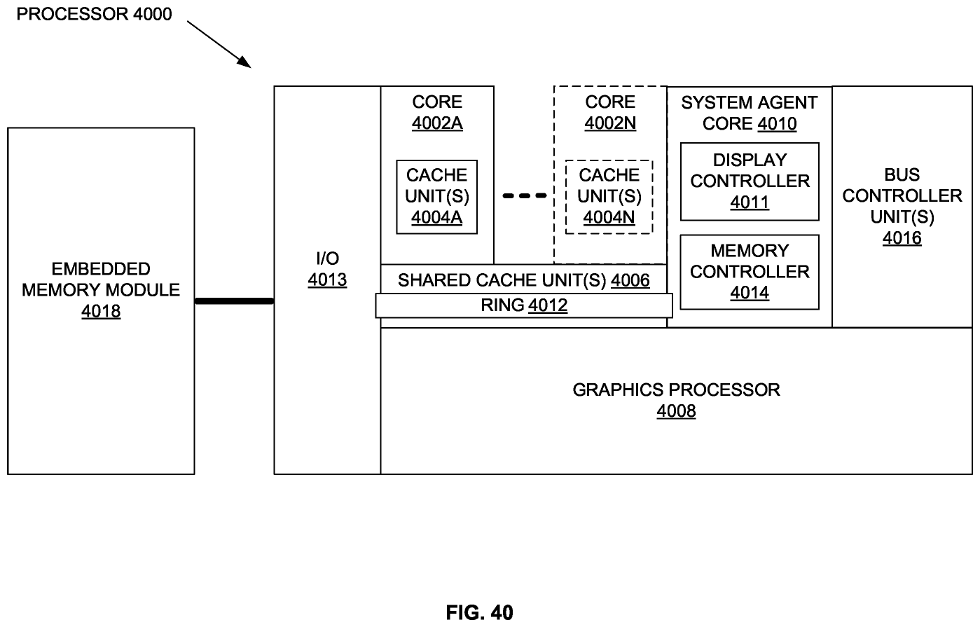

FIG. 40 illustrates a processor 4000, in accordance with at least one embodiment. In at least one embodiment, processor 4000 includes, without limitation, one or more processor cores (“cores”) 4002A-4002N, an integrated memory controller 4014, and an integrated graphics processor 4008. In at least one embodiment, processor 4000 can include additional cores up to and including additional processor core 4002N represented by dashed lined boxes. In at least one embodiment, each of processor cores 4002A-4002N includes one or more internal cache units 4004A-4004N. In at least one embodiment, each processor core also has access to one or more shared cached units 4006. In at least one embodiment, one or more processor cores 4002A-4002N are referred to as one or more compute units or computing units.

In at least one embodiment, internal cache units 4004A-4004N and shared cache units 4006 represent a cache memory hierarchy within processor 4000. In at least one embodiment, cache memory units 4004A-4004N may include at least one level of instruction and data cache within each processor core and one or more levels of shared mid-level cache, such as an L2, L3, Level 4 (“L4”), or other levels of cache, where a highest level of cache before external memory is classified as an LLC. In at least one embodiment, cache coherency logic maintains coherency between various cache units 4006 and 4004A-4004N.

In at least one embodiment, processor 4000 may also include a set of one or more bus controller units 4016 and a system agent core 4010. In at least one embodiment, one or more bus controller units 4016 manage a set of peripheral buses, such as one or more PCI or PCI express buses. In at least one embodiment, system agent core 4010 provides management functionality for various processor components. In at least one embodiment, system agent core 4010 includes one or more integrated memory controllers 4014 to manage access to various external memory devices (not shown).

In at least one embodiment, one or more of processor cores 4002A-4002N include support for simultaneous multi-threading. In at least one embodiment, system agent core 4010 includes components for coordinating and operating processor cores 4002A-4002N during multi-threaded processing. In at least one embodiment, system agent core 4010 may additionally include a power control unit (“PCU”), which includes logic and components to regulate one or more power states of processor cores 4002A-4002N and graphics processor 4008.

In at least one embodiment, processor 4000 additionally includes graphics processor 4008 to execute graphics processing operations. In at least one embodiment, graphics processor 4008 couples with shared cache units 4006, and system agent core 4010, including one or more integrated memory controllers 4014. In at least one embodiment, system agent core 4010 also includes a display controller 4011 to drive graphics processor output to one or more coupled displays. In at least one embodiment, display controller 4011 may also be a separate module coupled with graphics processor 4008 via at least one interconnect, or may be integrated within graphics processor 4008.

In at least one embodiment, a ring based interconnect unit 4012 is used to couple internal components of processor 4000. In at least one embodiment, an alternative interconnect unit may be used, such as a point-to-point interconnect, a switched interconnect, or other techniques. In at least one embodiment, graphics processor 4008 couples with ring interconnect 4012 via an I/O link 4013.

In at least one embodiment, I/O link 4013 represents at least one of multiple varieties of I/O interconnects, including an on package I/O interconnect which facilitates communication between various processor components and a high-performance embedded memory module 4018, such as an eDRAM module. In at least one embodiment, each of processor cores 4002A-4002N and graphics processor 4008 use embedded memory modules 4018 as a shared LLC.

In at least one embodiment, processor cores 4002A-4002N are homogeneous cores executing a common instruction set architecture. In at least one embodiment, processor cores 4002A-4002N are heterogeneous in terms of ISA, where one or more of processor cores 4002A-4002N execute a common instruction set, while one or more other cores of processor cores 4002A-40-02N executes a subset of a common instruction set or a different instruction set. In at least one embodiment, processor cores 4002A-4002N are heterogeneous in terms of microarchitecture, where one or more cores having a relatively higher power consumption couple with one or more cores having a lower power consumption. In at least one embodiment, processor 4000 can be implemented on one or more chips or as an SoC integrated circuit.

In at least one embodiment, at least one component shown or described with respect to FIG. 40 is used to perform techniques and/or functions described in connection with FIGS. 1-25. In at least one embodiment, at least one component shown or described with respect to FIG. 40 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 40 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 40 is used to perform at least one aspect described with respect to FIGS. 1-25, and/or other systems, methods, or operations described herein.

In at least one embodiment, at least one component shown or described with respect to FIG. 40 is used to perform techniques and/or functions described in connection with FIGS. 1-25. In at least one embodiment, at least one component shown or described with respect to FIG. 40 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 40 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 40 is used to perform techniques and/or functions described in connection with FIGS. 1-25. In at least one embodiment, at least one component shown or described with respect to FIG. 40 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 40 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 40 is used to perform techniques and/or functions described in connection with FIGS. 1-25. In at least one embodiment, at least one component shown or described with respect to FIG. 40 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 40 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 40 is used to perform techniques and/or functions described in connection with FIGS. 1-25. In at least one embodiment, at least one component shown or described with respect to FIG. 40 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 40 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 40 is used to perform techniques and/or functions described in connection with FIGS. 1-25. In at least one embodiment, at least one component shown or described with respect to FIG. 40 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 40 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 40 is used to perform techniques and/or functions described in connection with FIGS. 1-25. In at least one embodiment, at least one component shown or described with respect to FIG. 40 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 40 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 40 is used to perform techniques and/or functions described in connection with FIGS. 1-25. In at least one embodiment, at least one component shown or described with respect to FIG. 40 is used to perform an application programming interface (API) to cause context of one or more first software instructions to be communicated to one or more second software instructions, and/or other systems, methods, or operations described herein. In at least one embodiment, at least one component shown or described with respect to FIG. 40 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 40 is used to perform techniques and/or functions described in connection with FIGS. 1-25. In at least one embodiment, at least one component shown or described with respect to FIG. 40 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 40 is used to perform an application programming interface (API) to prevent one or more instructions from being performed by one or more resources of a first context of the processor until one or more indications of one or more events of a second context are generated, and/or other systems, methods, or operations described herein.

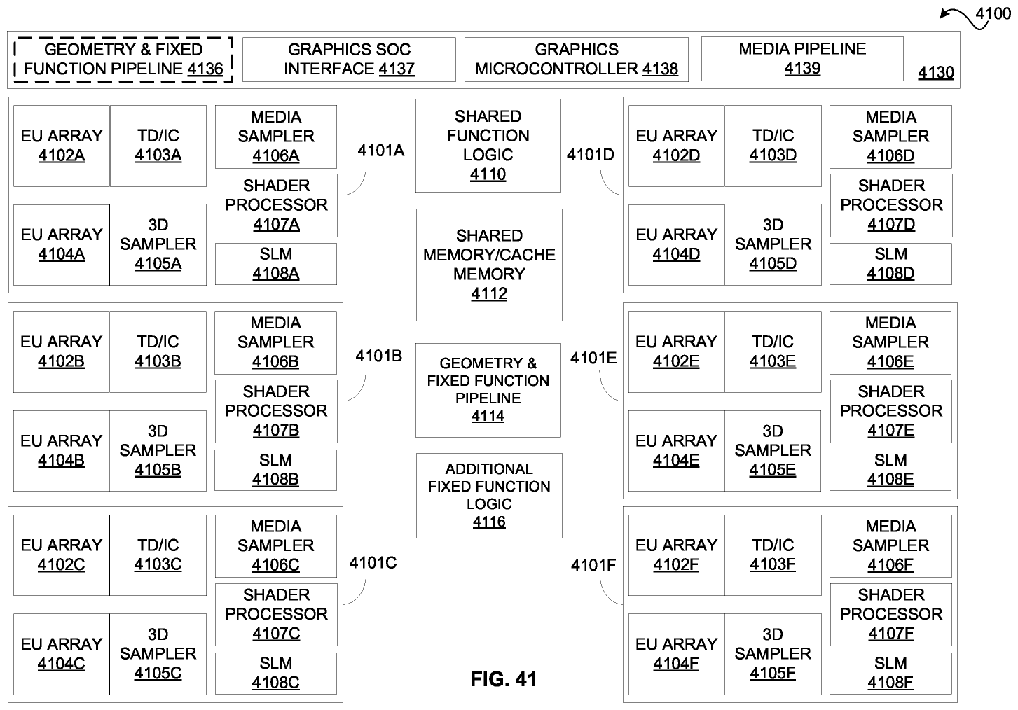

FIG. 41 illustrates a graphics processor core 4100, in accordance with at least one embodiment described. In at least one embodiment, graphics processor core 4100 is included within a graphics core array. In at least one embodiment, graphics processor core 4100, sometimes referred to as a core slice, can be one or multiple graphics cores within a modular graphics processor. In at least one embodiment, graphics processor core 4100 is exemplary of one graphics core slice, and a graphics processor as described herein may include multiple graphics core slices based on target power and performance envelopes. In at least one embodiment, each graphics core 4100 can include a fixed function block 4130 coupled with multiple sub-cores 4101A-4101F, also referred to as sub-slices, that include modular blocks of general-purpose and fixed function logic.

In at least one embodiment, fixed function block 4130 includes a geometry/fixed function pipeline 4136 that can be shared by all sub-cores in graphics processor 4100, for example, in lower performance and/or lower power graphics processor implementations. In at least one embodiment, geometry/fixed function pipeline 4136 includes a 3D fixed function pipeline, a video front-end unit, a thread spawner and thread dispatcher, and a unified return buffer manager, which manages unified return buffers.

In at least one embodiment, fixed function block 4130 also includes a graphics SoC interface 4137, a graphics microcontroller 4138, and a media pipeline 4139. Graphics SoC interface 4137 provides an interface between graphics core 4100 and other processor cores within an SoC integrated circuit. In at least one embodiment, graphics microcontroller 4138 is a programmable sub-processor that is configurable to manage various functions of graphics processor 4100, including thread dispatch, scheduling, and pre-emption. In at least one embodiment, media pipeline 4139 includes logic to facilitate decoding, encoding, pre-processing, and/or post-processing of multimedia data, including image and video data. In at least one embodiment, media pipeline 4139 implements media operations via requests to compute or sampling logic within sub-cores 4101-4101F.

In at least one embodiment, SoC interface 4137 enables graphics core 4100 to communicate with general-purpose application processor cores (e.g., CPUs) and/or other components within an SoC, including memory hierarchy elements such as a shared LLC memory, system RAM, and/or embedded on-chip or on-package DRAM. In at least one embodiment, SoC interface 4137 can also enable communication with fixed function devices within an SoC, such as camera imaging pipelines, and enables use of and/or implements global memory atomics that may be shared between graphics core 4100 and CPUs within an SoC. In at least one embodiment, SoC interface 4137 can also implement power management controls for graphics core 4100 and enable an interface between a clock domain of graphic core 4100 and other clock domains within an SoC. In at least one embodiment, SoC interface 4137 enables receipt of command buffers from a command streamer and global thread dispatcher that are configured to provide commands and instructions to each of one or more graphics cores within a graphics processor. In at least one embodiment, commands and instructions can be dispatched to media pipeline 4139, when media operations are to be performed, or a geometry and fixed function pipeline (e.g., geometry and fixed function pipeline 4136, geometry and fixed function pipeline 4114) when graphics processing operations are to be performed.

In at least one embodiment, graphics microcontroller 4138 can be configured to perform various scheduling and management tasks for graphics core 4100. In at least one embodiment, graphics microcontroller 4138 can perform graphics and/or compute workload scheduling on various graphics parallel engines within execution unit (EU) arrays 4102A-4102F, 4104A-4104F within sub-cores 4101A-4101F. In at least one embodiment, host software executing on a CPU core of an SoC including graphics core 4100 can submit workloads one of multiple graphic processor doorbells, which invokes a scheduling operation on an appropriate graphics engine. In at least one embodiment, scheduling operations include determining which workload to run next, submitting a workload to a command streamer, pre-empting existing workloads running on an engine, monitoring progress of a workload, and notifying host software when a workload is complete. In at least one embodiment, graphics microcontroller 4138 can also facilitate low-power or idle states for graphics core 4100, providing graphics core 4100 with an ability to save and restore registers within graphics core 4100 across low-power state transitions independently from an operating system and/or graphics driver software on a system.

In at least one embodiment, graphics core 4100 may have greater than or fewer than illustrated sub-cores 4101A-4101F, up to N modular sub-cores. For each set of N sub-cores, in at least one embodiment, graphics core 4100 can also include shared function logic 4110, shared and/or cache memory 4112, a geometry/fixed function pipeline 4114, as well as additional fixed function logic 4116 to accelerate various graphics and compute processing operations. In at least one embodiment, shared function logic 4110 can include logic units (e.g., sampler, math, and/or inter-thread communication logic) that can be shared by each N sub-cores within graphics core 4100. Shared and/or cache memory 4112 can be an LLC for N sub-cores 4101A-4101F within graphics core 4100 and can also serve as shared memory that is accessible by multiple sub-cores. In at least one embodiment, geometry/fixed function pipeline 4114 can be included instead of geometry/fixed function pipeline 4136 within fixed function block 4130 and can include same or similar logic units.

In at least one embodiment, graphics core 4100 includes additional fixed function logic 4116 that can include various fixed function acceleration logic for use by graphics core 4100. In at least one embodiment, additional fixed function logic 4116 includes an additional geometry pipeline for use in position only shading. In position-only shading, at least two geometry pipelines exist, whereas in a full geometry pipeline within geometry/fixed function pipeline 4116, 4136, and a cull pipeline, which is an additional geometry pipeline which may be included within additional fixed function logic 4116. In at least one embodiment, cull pipeline is a trimmed down version of a full geometry pipeline. In at least one embodiment, a full pipeline and a cull pipeline can execute different instances of an application, each instance having a separate context. In at least one embodiment, position only shading can hide long cull runs of discarded triangles, enabling shading to be completed earlier in some instances. For example, in at least one embodiment, cull pipeline logic within additional fixed function logic 4116 can execute position shaders in parallel with a main application and generally generates critical results faster than a full pipeline, as a cull pipeline fetches and shades position attribute of vertices, without performing rasterization and rendering of pixels to a frame buffer. In at least one embodiment, a cull pipeline can use generated critical results to compute visibility information for all triangles without regard to whether those triangles are culled. In at least one embodiment, a full pipeline (which in this instance may be referred to as a replay pipeline) can consume visibility information to skip culled triangles to shade only visible triangles that are finally passed to a rasterization phase.

In at least one embodiment, additional fixed function logic 4116 can also include general purpose processing acceleration logic, such as fixed function matrix multiplication logic, for accelerating CUDA programs.

In at least one embodiment, each graphics sub-core 4101A-4101F includes a set of execution resources that may be used to perform graphics, media, and compute operations in response to requests by graphics pipeline, media pipeline, or shader programs. In at least one embodiment, graphics sub-cores 4101A-4101F include multiple EU arrays 4102A-4102F, 4104A-4104F, thread dispatch and inter-thread communication (“TD/IC”) logic 4103A-4103F, a 3D (e.g., texture) sampler 4105A-4105F, a media sampler 4106A-4106F, a shader processor 4107A-4107F, and shared local memory (“SLM”) 4108A-4108F. EU arrays 4102A-4102F, 4104A-4104F each include multiple execution units, which are GPGPUs capable of performing floating-point and integer/fixed-point logic operations in service of a graphics, media, or compute operation, including graphics, media, or compute shader programs. In at least one embodiment, TD/IC logic 4103A-4103F performs local thread dispatch and thread control operations for execution units within a sub-core and facilitate communication between threads executing on execution units of a sub-core. In at least one embodiment, 3D sampler 4105A-4105F can read texture or other 3D graphics related data into memory. In at least one embodiment, 3D sampler can read texture data differently based on a configured sample state and texture format associated with a given texture. In at least one embodiment, media sampler 4106A-4106F can perform similar read operations based on a type and format associated with media data. In at least one embodiment, each graphics sub-core 4101A-4101F can alternately include a unified 3D and media sampler. In at least one embodiment, threads executing on execution units within each of sub-cores 4101A-4101F can make use of shared local memory 4108A-4108F within each sub-core, to enable threads executing within a thread group to execute using a common pool of on-chip memory.

In at least one embodiment, at least one component shown or described with respect to FIG. 41 is used to perform techniques and/or functions described in connection with FIGS. 1-25. In at least one embodiment, at least one component shown or described with respect to FIG. 41 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 41 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 41 is used to perform at least one aspect described with respect to FIGS. 1-25, and/or other systems, methods, or operations described herein.

In at least one embodiment, at least one component shown or described with respect to FIG. 41 is used to perform techniques and/or functions described in connection with FIGS. 1-25. In at least one embodiment, at least one component shown or described with respect to FIG. 41 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 41 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 41 is used to perform techniques and/or functions described in connection with FIGS. 1-25. In at least one embodiment, at least one component shown or described with respect to FIG. 41 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 41 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 41 is used to perform techniques and/or functions described in connection with FIGS. 1-25. In at least one embodiment, at least one component shown or described with respect to FIG. 41 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 41 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 41 is used to perform techniques and/or functions described in connection with FIGS. 1-25. In at least one embodiment, at least one component shown or described with respect to FIG. 41 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 41 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 41 is used to perform techniques and/or functions described in connection with FIGS. 1-25. In at least one embodiment, at least one component shown or described with respect to FIG. 41 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 41 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 41 is used to perform techniques and/or functions described in connection with FIGS. 1-25. In at least one embodiment, at least one component shown or described with respect to FIG. 41 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 41 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 41 is used to perform techniques and/or functions described in connection with FIGS. 1-25. In at least one embodiment, at least one component shown or described with respect to FIG. 41 is used to perform an application programming interface (API) to cause context of one or more first software instructions to be communicated to one or more second software instructions, and/or other systems, methods, or operations described herein. In at least one embodiment, at least one component shown or described with respect to FIG. 41 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 41 is used to perform techniques and/or functions described in connection with FIGS. 1-25. In at least one embodiment, at least one component shown or described with respect to FIG. 41 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 41 is used to perform an application programming interface (API) to prevent one or more instructions from being performed by one or more resources of a first context of the processor until one or more indications of one or more events of a second context are generated, and/or other systems, methods, or operations described herein.

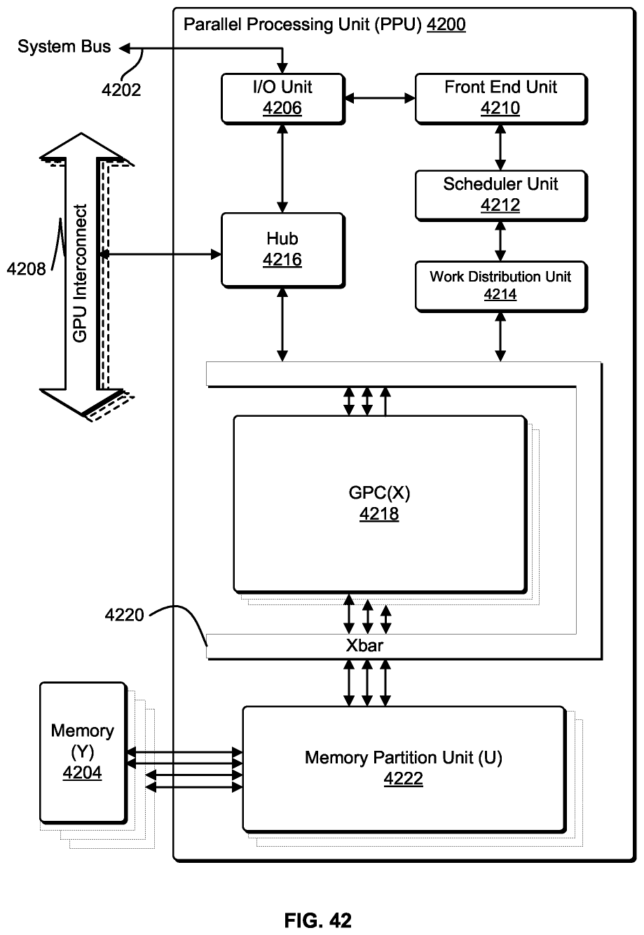

FIG. 42 illustrates a parallel processing unit (“PPU”) 4200, in accordance with at least one embodiment. In at least one embodiment, PPU 4200 is configured with machine-readable code that, if executed by PPU 4200, causes PPU 4200 to perform some or all of processes and techniques described herein. In at least one embodiment, PPU 4200 is a multi-threaded processor that is implemented on one or more integrated circuit devices and that utilizes multithreading as a latency-hiding technique designed to process computer-readable instructions (also referred to as machine-readable instructions or simply instructions) on multiple threads in parallel. In at least one embodiment, a thread refers to a thread of execution and is an instantiation of a set of instructions configured to be executed by PPU 4200. In at least one embodiment, PPU 4200 is a GPU configured to implement a graphics rendering pipeline for processing three-dimensional (“3D”) graphics data in order to generate two-dimensional (“2D”) image data for display on a display device such as an LCD device. In at least one embodiment, PPU 4200 is utilized to perform computations such as linear algebra operations and machine-learning operations. FIG. 42 illustrates an example parallel processor for illustrative purposes only and should be construed as a non-limiting example of a processor architecture that may be implemented in at least one embodiment.

In at least one embodiment, one or more PPUs 4200 are configured to accelerate High Performance Computing (“HPC”), data center, and machine learning applications. In at least one embodiment, one or more PPUs 4200 are configured to accelerate CUDA programs. In at least one embodiment, PPU 4200 includes, without limitation, an I/O unit 4206, a front-end unit 4210, a scheduler unit 4212, a work distribution unit 4214, a hub 4216, a crossbar (“Xbar”) 4220, one or more general processing clusters (“GPCs”) 4218, and one or more partition units (“memory partition units”) 4222. In at least one embodiment, PPU 4200 is connected to a host processor or other PPUs 4200 via one or more high-speed GPU interconnects (“GPU interconnects”) 4208. In at least one embodiment, PPU 4200 is connected to a host processor or other peripheral devices via a system bus or interconnect 4202. In at least one embodiment, PPU 4200 is connected to a local memory comprising one or more memory devices (“memory”) 4204. In at least one embodiment, memory devices 4204 include, without limitation, one or more dynamic random access memory (DRAM) devices. In at least one embodiment, one or more DRAM devices are configured and/or configurable as high-bandwidth memory (“HBM”) subsystems, with multiple DRAM dies stacked within each device.

In at least one embodiment, high-speed GPU interconnect 4208 may refer to a wire-based multi-lane communications link that is used by systems to scale and include one or more PPUs 4200 combined with one or more CPUs, supports cache coherence between PPUs 4200 and CPUs, and CPU mastering. In at least one embodiment, data and/or commands are transmitted by high-speed GPU interconnect 4208 through hub 4216 to/from other units of PPU 4200 such as one or more copy engines, video encoders, video decoders, power management units, and other components which may not be explicitly illustrated in FIG. 42.

In at least one embodiment, I/O unit 4206 is configured to transmit and receive communications (e.g., commands, data) from a host processor (not illustrated in FIG. 42) over system bus 4202. In at least one embodiment, I/O unit 4206 communicates with host processor directly via system bus 4202 or through one or more intermediate devices such as a memory bridge. In at least one embodiment, I/O unit 4206 may communicate with one or more other processors, such as one or more of PPUs 4200 via system bus 4202. In at least one embodiment, I/O unit 4206 implements a PCIe interface for communications over a PCIe bus. In at least one embodiment, I/O unit 4206 implements interfaces for communicating with external devices.

In at least one embodiment, I/O unit 4206 decodes packets received via system bus 4202. In at least one embodiment, at least some packets represent commands configured to cause PPU 4200 to perform various operations. In at least one embodiment, I/O unit 4206 transmits decoded commands to various other units of PPU 4200 as specified by commands. In at least one embodiment, commands are transmitted to front-end unit 4210 and/or transmitted to hub 4216 or other units of PPU 4200 such as one or more copy engines, a video encoder, a video decoder, a power management unit, etc. (not explicitly illustrated in FIG. 42). In at least one embodiment, I/O unit 4206 is configured to route communications between and among various logical units of PPU 4200.

In at least one embodiment, a program executed by host processor encodes a command stream in a buffer that provides workloads to PPU 4200 for processing. In at least one embodiment, a workload comprises instructions and data to be processed by those instructions. In at least one embodiment, buffer is a region in a memory that is accessible (e.g., read/write) by both a host processor and PPU 4200—a host interface unit may be configured to access buffer in a system memory connected to system bus 4202 via memory requests transmitted over system bus 4202 by I/O unit 4206. In at least one embodiment, a host processor writes a command stream to a buffer and then transmits a pointer to the start of the command stream to PPU 4200 such that front-end unit 4210 receives pointers to one or more command streams and manages one or more command streams, reading commands from command streams and forwarding commands to various units of PPU 4200.

In at least one embodiment, front-end unit 4210 is coupled to scheduler unit 4212 that configures various GPCs 4218 to process tasks defined by one or more command streams. In at least one embodiment, scheduler unit 4212 is configured to track state information related to various tasks managed by scheduler unit 4212 where state information may indicate which of GPCs 4218 a task is assigned to, whether task is active or inactive, a priority level associated with task, and so forth. In at least one embodiment, scheduler unit 4212 manages execution of a plurality of tasks on one or more of GPCs 4218.

In at least one embodiment, scheduler unit 4212 is coupled to work distribution unit 4214 that is configured to dispatch tasks for execution on GPCs 4218. In at least one embodiment, work distribution unit 4214 tracks a number of scheduled tasks received from scheduler unit 4212 and work distribution unit 4214 manages a pending task pool and an active task pool for each of GPCs 4218. In at least one embodiment, pending task pool comprises a number of slots (e.g., 32 slots) that contain tasks assigned to be processed by a particular GPC 4218; active task pool may comprise a number of slots (e.g., 4 slots) for tasks that are actively being processed by GPCs 4218 such that as one of GPCs 4218 completes execution of a task, that task is evicted from active task pool for GPC 4218 and one of other tasks from pending task pool is selected and scheduled for execution on GPC 4218. In at least one embodiment, if an active task is idle on GPC 4218, such as while waiting for a data dependency to be resolved, then the active task is evicted from GPC 4218 and returned to a pending task pool while another task in the pending task pool is selected and scheduled for execution on GPC 4218.

In at least one embodiment, work distribution unit 4214 communicates with one or more GPCs 4218 via XBar 4220. In at least one embodiment, XBar 4220 is an interconnect network that couples many units of PPU 4200 to other units of PPU 4200 and can be configured to couple work distribution unit 4214 to a particular GPC 4218. In at least one embodiment, one or more other units of PPU 4200 may also be connected to XBar 4220 via hub 4216.

In at least one embodiment, tasks are managed by scheduler unit 4212 and dispatched to one of GPCs 4218 by work distribution unit 4214. GPC 4218 is configured to process task and generate results. In at least one embodiment, results may be consumed by other tasks within GPC 4218, routed to a different GPC 4218 via XBar 4220, or stored in memory 4204. In at least one embodiment, results can be written to memory 4204 via partition units 4222, which implement a memory interface for reading and writing data to/from memory 4204. In at least one embodiment, results can be transmitted to another PPU 4204 or CPU via high-speed GPU interconnect 4208. In at least one embodiment, PPU 4200 includes, without limitation, a number U of partition units 4222 that is equal to number of separate and distinct memory devices 4204 coupled to PPU 4200.

In at least one embodiment, a host processor executes a driver kernel that implements an application programming interface (“API”) that enables one or more applications executing on host processor to schedule operations for execution on PPU 4200. In at least one embodiment, multiple compute applications are simultaneously executed by PPU 4200 and PPU 4200 provides isolation, quality of service (“QoS”), and independent address spaces for multiple compute applications. In at least one embodiment, an application generates instructions (e.g., in the form of API calls) that cause a driver kernel to generate one or more tasks for execution by PPU 4200 and the driver kernel outputs tasks to one or more streams being processed by PPU 4200. In at least one embodiment, each task comprises one or more groups of related threads, which may be referred to as a warp. In at least one embodiment, a warp comprises a plurality of related threads (e.g., 32 threads) that can be executed in parallel. In at least one embodiment, cooperating threads can refer to a plurality of threads including instructions to perform a task and that exchange data through shared memory.

In at least one embodiment, at least one component shown or described with respect to FIG. 42 is used to perform techniques and/or functions described in connection with FIGS. 1-25. In at least one embodiment, at least one component shown or described with respect to FIG. 42 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 42 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 42 is used to perform at least one aspect described with respect to FIGS. 1-25, and/or other systems, methods, or operations described herein.

In at least one embodiment, at least one component shown or described with respect to FIG. 42 is used to perform techniques and/or functions described in connection with FIGS. 1-25. In at least one embodiment, at least one component shown or described with respect to FIG. 42 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 42 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 42 is used to perform techniques and/or functions described in connection with FIGS. 1-25. In at least one embodiment, at least one component shown or described with respect to FIG. 42 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 42 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 42 is used to perform techniques and/or functions described in connection with FIGS. 1-25. In at least one embodiment, at least one component shown or described with respect to FIG. 42 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 42 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 42 is used to perform techniques and/or functions described in connection with FIGS. 1-25. In at least one embodiment, at least one component shown or described with respect to FIG. 42 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 42 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 42 is used to perform techniques and/or functions described in connection with FIGS. 1-25. In at least one embodiment, at least one component shown or described with respect to FIG. 42 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 42 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 42 is used to perform techniques and/or functions described in connection with FIGS. 1-25. In at least one embodiment, at least one component shown or described with respect to FIG. 42 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 42 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 42 is used to perform techniques and/or functions described in connection with FIGS. 1-25. In at least one embodiment, at least one component shown or described with respect to FIG. 42 is used to perform an application programming interface (API) to cause context of one or more first software instructions to be communicated to one or more second software instructions, and/or other systems, methods, or operations described herein. In at least one embodiment, at least one component shown or described with respect to FIG. 42 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 42 is used to perform techniques and/or functions described in connection with FIGS. 1-25. In at least one embodiment, at least one component shown or described with respect to FIG. 42 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 42 is used to perform an application programming interface (API) to prevent one or more instructions from being performed by one or more resources of a first context of the processor until one or more indications of one or more events of a second context are generated, and/or other systems, methods, or operations described herein.

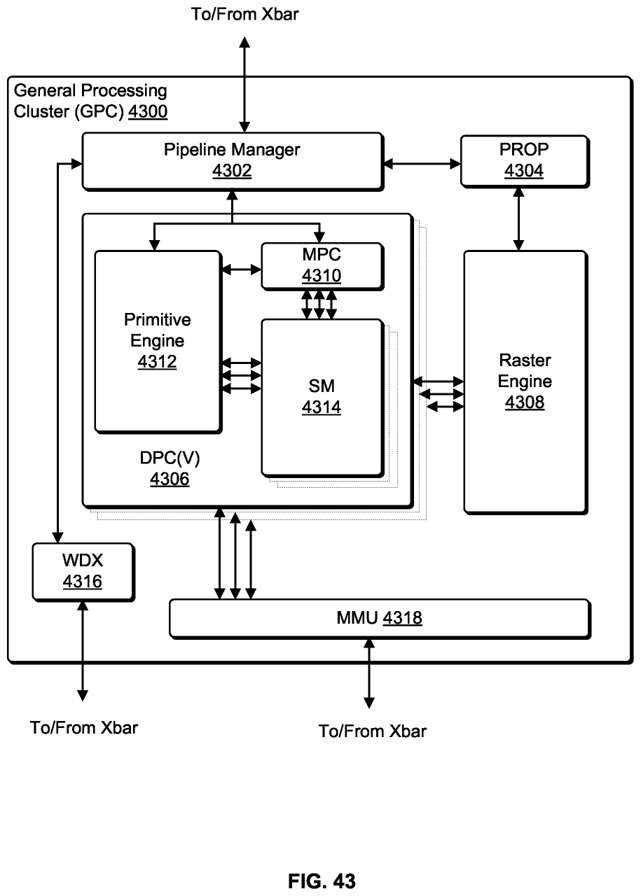

FIG. 43 illustrates a GPC 4300, in accordance with at least one embodiment. In at least one embodiment, GPC 4300 is GPC 4218 of FIG. 42. In at least one embodiment, each GPC 4300 includes, without limitation, a number of hardware units for processing tasks and each GPC 4300 includes, without limitation, a pipeline manager 4302, a pre-raster operations unit (“PROP”) 4304, a raster engine 4308, a work distribution crossbar (“WDX”) 4316, an MMU 4318, one or more Data Processing Clusters (“DPCs”) 4306, and any suitable combination of parts.

In at least one embodiment, operation of GPC 4300 is controlled by pipeline manager 4302. In at least one embodiment, pipeline manager 4302 manages configuration of one or more DPCs 4306 for processing tasks allocated to GPC 4300. In at least one embodiment, pipeline manager 4302 configures at least one of one or more DPCs 4306 to implement at least a portion of a graphics rendering pipeline. In at least one embodiment, DPC 4306 is configured to execute a vertex shader program on a programmable streaming multiprocessor (“SM”) 4314. In at least one embodiment, pipeline manager 4302 is configured to route packets received from a work distribution unit to appropriate logical units within GPC 4300 and, in at least one embodiment, some packets may be routed to fixed function hardware units in PROP 4304 and/or raster engine 4308 while other packets may be routed to DPCs 4306 for processing by a primitive engine 4312 or SM 4314. In at least one embodiment, pipeline manager 4302 configures at least one of DPCs 4306 to implement a computing pipeline. In at least one embodiment, pipeline manager 4302 configures at least one of DPCs 4306 to execute at least a portion of a CUDA program.

In at least one embodiment, PROP unit 4304 is configured to route data generated by raster engine 4308 and DPCs 4306 to a Raster Operations (“ROP”) unit in a partition unit, such as memory partition unit 4222 described in more detail above in conjunction with FIG. 42. In at least one embodiment, PROP unit 4304 is configured to perform optimizations for color blending, organize pixel data, perform address translations, and more. In at least one embodiment, raster engine 4308 includes, without limitation, a number of fixed function hardware units configured to perform various raster operations and, in at least one embodiment, raster engine 4308 includes, without limitation, a setup engine, a coarse raster engine, a culling engine, a clipping engine, a fine raster engine, a tile coalescing engine, and any suitable combination thereof. In at least one embodiment, a setup engine receives transformed vertices and generates plane equations associated with geometric primitive defined by vertices; plane equations are transmitted to a coarse raster engine to generate coverage information (e.g., an x, y coverage mask for a tile) for a primitive; the output of the coarse raster engine is transmitted to a culling engine where fragments associated with a primitive that fail a z-test are culled, and transmitted to a clipping engine where fragments lying outside a viewing frustum are clipped. In at least one embodiment, fragments that survive clipping and culling are passed to a fine raster engine to generate attributes for pixel fragments based on plane equations generated by a setup engine. In at least one embodiment, the output of raster engine 4308 comprises fragments to be processed by any suitable entity such as by a fragment shader implemented within DPC 4306.

In at least one embodiment, each DPC 4306 included in GPC 4300 comprise, without limitation, an M-Pipe Controller (“MPC”) 4310; primitive engine 4312; one or more SMs 4314; and any suitable combination thereof. In at least one embodiment, MPC 4310 controls operation of DPC 4306, routing packets received from pipeline manager 4302 to appropriate units in DPC 4306. In at least one embodiment, packets associated with a vertex are routed to primitive engine 4312, which is configured to fetch vertex attributes associated with vertex from memory; in contrast, packets associated with a shader program may be transmitted to SM 4314.

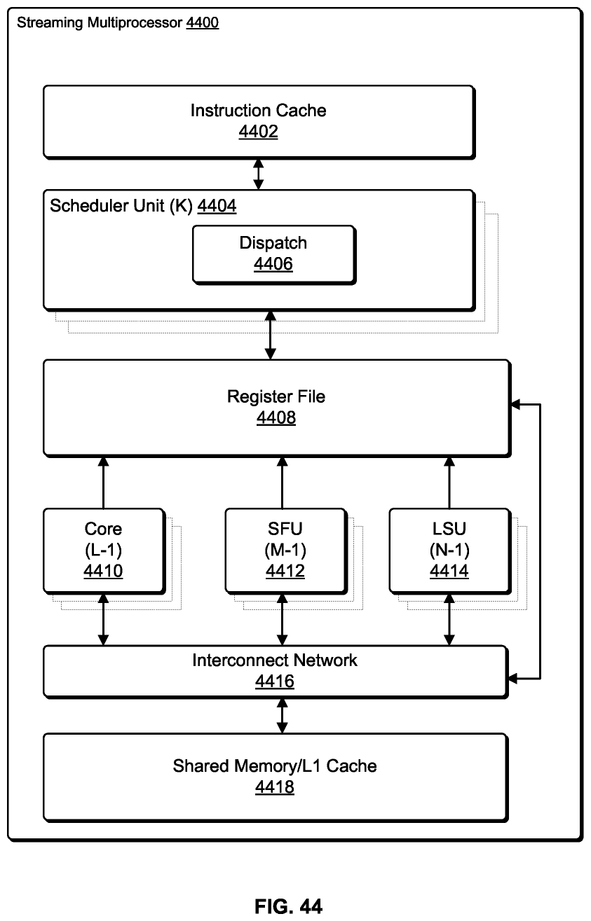

In at least one embodiment, SM 4314 comprises, without limitation, a programmable streaming processor that is configured to process tasks represented by a number of threads. In at least one embodiment, SM 4314 is multi-threaded and configured to execute a plurality of threads (e.g., 32 threads) from a particular group of threads concurrently and implements a SIMD architecture where each thread in a group of threads (e.g., a warp) is configured to process a different set of data based on same set of instructions. In at least one embodiment, all threads in group of threads execute same instructions. In at least one embodiment, SM 4314 implements a SIMT architecture wherein each thread in a group of threads is configured to process a different set of data based on same set of instructions, but where individual threads in group of threads are allowed to diverge during execution. In at least one embodiment, a program counter, a call stack, and an execution state is maintained for each warp, enabling concurrency between warps and serial execution within warps when threads within a warp diverge. In another embodiment, a program counter, a call stack, and an execution state is maintained for each individual thread, enabling equal concurrency between all threads, within and between warps. In at least one embodiment, an execution state is maintained for each individual thread and threads executing the same instructions may be converged and executed in parallel for better efficiency. At least one embodiment of SM 4314 is described in more detail in conjunction with FIG. 44.

In at least one embodiment, MMU 4318 provides an interface between GPC 4300 and a memory partition unit (e.g., partition unit 4222 of FIG. 42) and MMU 4318 provides translation of virtual addresses into physical addresses, memory protection, and arbitration of memory requests. In at least one embodiment, MMU 4318 provides one or more translation lookaside buffers (TLBs) for performing translation of virtual addresses into physical addresses in memory.

In at least one embodiment, at least one component shown or described with respect to FIG. 43 is used to perform techniques and/or functions described in connection with FIGS. 1-25. In at least one embodiment, at least one component shown or described with respect to FIG. 43 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 43 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 43 is used to perform at least one aspect described with respect to FIGS. 1-25, and/or other systems, methods, or operations described herein.

In at least one embodiment, at least one component shown or described with respect to FIG. 43 is used to perform techniques and/or functions described in connection with FIGS. 1-25. In at least one embodiment, at least one component shown or described with respect to FIG. 43 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 43 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 43 is used to perform techniques and/or functions described in connection with FIGS. 1-25. In at least one embodiment, at least one component shown or described with respect to FIG. 43 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 43 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 43 is used to perform techniques and/or functions described in connection with FIGS. 1-25. In at least one embodiment, at least one component shown or described with respect to FIG. 43 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 43 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 43 is used to perform techniques and/or functions described in connection with FIGS. 1-25. In at least one embodiment, at least one component shown or described with respect to FIG. 43 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 43 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 43 is used to perform techniques and/or functions described in connection with FIGS. 1-25. In at least one embodiment, at least one component shown or described with respect to FIG. 43 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 43 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 43 is used to perform techniques and/or functions described in connection with FIGS. 1-25. In at least one embodiment, at least one component shown or described with respect to FIG. 43 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 43 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 43 is used to perform techniques and/or functions described in connection with FIGS. 1-25. In at least one embodiment, at least one component shown or described with respect to FIG. 43 is used to perform an application programming interface (API) to cause context of one or more first software instructions to be communicated to one or more second software instructions, and/or other systems, methods, or operations described herein. In at least one embodiment, at least one component shown or described with respect to FIG. 43 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 43 is used to perform techniques and/or functions described in connection with FIGS. 1-25. In at least one embodiment, at least one component shown or described with respect to FIG. 43 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 43 is used to perform an application programming interface (API) to prevent one or more instructions from being performed by one or more resources of a first context of the processor until one or more indications of one or more events of a second context are generated, and/or other systems, methods, or operations described herein.

FIG. 44 illustrates a streaming multiprocessor (“SM”) 4400, in accordance with at least one embodiment. In at least one embodiment, SM 4400 is SM 4314 of FIG. 43. In at least one embodiment, SM 4400 includes, without limitation, an instruction cache 4402; one or more scheduler units 4404; a register file 4408; one or more processing cores (“cores”) 4410; one or more special function units (“SFUs”) 4412; one or more LSUs 4414; an interconnect network 4416; a shared memory/L1 cache 4418; and any suitable combination thereof. In at least one embodiment, a work distribution unit dispatches tasks for execution on GPCs of parallel processing units (PPUs) and each task is allocated to a particular Data Processing Cluster (DPC) within a GPC and, if a task is associated with a shader program, then the task is allocated to one of SMs 4400. In at least one embodiment, scheduler unit 4404 receives tasks from a work distribution unit and manages instruction scheduling for one or more thread blocks assigned to SM 4400. In at least one embodiment, scheduler unit 4404 schedules thread blocks for execution as warps of parallel threads, wherein each thread block is allocated at least one warp. In at least one embodiment, each warp executes threads. In at least one embodiment, scheduler unit 4404 manages a plurality of different thread blocks, allocating warps to different thread blocks and then dispatching instructions from a plurality of different cooperative groups to various functional units (e.g., processing cores 4410, SFUs 4412, and LSUs 4414) during each clock cycle. In at least one embodiment, SM 4400 includes one or more thread block clusters, where a thread block cluster can enable programmatic control of locality at a granularity larger than a single thread block of a single streaming multiprocessor (SM). In at least one embodiment, thread block clusters (also referred to as “clusters”) enables multiple thread blocks running concurrently across streaming multiprocessors to synchronize and collaboratively fetch, exchange, or otherwise use data.

In at least one embodiment, “cooperative groups” may refer to a programming model for organizing groups of communicating threads that allows developers to express granularity at which threads are communicating, enabling expression of richer, more efficient parallel decompositions. In at least one embodiment, cooperative launch APIs support synchronization amongst thread blocks for execution of parallel algorithms. In at least one embodiment, APIs of conventional programming models provide a single, simple construct for synchronizing cooperating threads: a barrier across all threads of a thread block (e.g., syncthreads( ) function). However, in at least one embodiment, programmers may define groups of threads at smaller than thread block granularities and synchronize within defined groups to enable greater performance, design flexibility, and software reuse in the form of collective group-wide function interfaces. In at least one embodiment, cooperative groups enable programmers to define groups of threads explicitly at sub-block and multi-block granularities, and to perform collective operations such as synchronization on threads in a cooperative group. In at least one embodiment, a sub-block granularity is as small as a single thread. In at least one embodiment, a programming model supports clean composition across software boundaries, so that libraries and utility functions can synchronize safely within their local context without having to make assumptions about convergence. In at least one embodiment, cooperative group primitives enable new patterns of cooperative parallelism, including, without limitation, producer-consumer parallelism, opportunistic parallelism, and global synchronization across an entire grid of thread blocks.

In at least one embodiment, a dispatch unit 4406 is configured to transmit instructions to one or more of functional units and scheduler unit 4404 includes, without limitation, two dispatch units 4406 that enable two different instructions from same warp to be dispatched during each clock cycle. In at least one embodiment, each scheduler unit 4404 includes a single dispatch unit 4406 or additional dispatch units 4406.

In at least one embodiment, each SM 4400, in at least one embodiment, includes, without limitation, register file 4408 that provides a set of registers for functional units of SM 4400. In at least one embodiment, register file 4408 is divided between each of the functional units such that each functional unit is allocated a dedicated portion of register file 4408. In at least one embodiment, register file 4408 is divided between different warps being executed by SM 4400 and register file 4408 provides temporary storage for operands connected to data paths of functional units. In at least one embodiment, each SM 4400 comprises, without limitation, a plurality of L processing cores 4410. In at least one embodiment, SM 4400 includes, without limitation, a large number (e.g., 128 or more) of distinct processing cores 4410. In at least one embodiment, each processing core 4410 includes, without limitation, a fully-pipelined, single-precision, double-precision, and/or mixed precision processing unit that includes, without limitation, a floating point arithmetic logic unit and an integer arithmetic logic unit. In at least one embodiment, floating point arithmetic logic units implement IEEE 754-2008 standard for floating point arithmetic. In at least one embodiment, processing cores 4410 include, without limitation, 64 single-precision (32-bit) floating point cores, 64 integer cores, 32 double-precision (64-bit) floating point cores, and 8 tensor cores.

In at least one embodiment, tensor cores are configured to perform matrix operations. In at least one embodiment, one or more tensor cores are included in processing cores 4410. In at least one embodiment, tensor cores are configured to perform deep learning matrix arithmetic, such as convolution operations for neural network training and inferencing. In at least one embodiment, each tensor core operates on a 4×4 matrix and performs a matrix multiply and accumulate operation D=A×B+C, where A, B, C, and D are 4×4 matrices.

In at least one embodiment, matrix multiply inputs A and B are 16-bit floating point matrices and accumulation matrices C and D are 16-bit floating point or 32-bit floating point matrices. In at least one embodiment, tensor cores operate on 16-bit floating point input data with 32-bit floating point accumulation. In at least one embodiment, 16-bit floating point multiply uses 64 operations and results in a full precision product that is then accumulated using 32-bit floating point addition with other intermediate products for a 4×4×4 matrix multiply. Tensor cores are used to perform much larger two-dimensional or higher dimensional matrix operations, built up from these smaller elements, in at least one embodiment. In at least one embodiment, an API, such as a CUDA-C++ API, exposes specialized matrix load, matrix multiply and accumulate, and matrix store operations to efficiently use tensor cores from a CUDA-C++ program. In at least one embodiment, at the CUDA level, a warp-level interface assumes 16×16 size matrices spanning all 32 threads of a warp.

In at least one embodiment, each SM 4400 comprises, without limitation, M SFUs 4412 that perform special functions (e.g., attribute evaluation, reciprocal square root, and like). In at least one embodiment, SFUs 4412 include, without limitation, a tree traversal unit configured to traverse a hierarchical tree data structure. In at least one embodiment, SFUs 4412 include, without limitation, a texture unit configured to perform texture map filtering operations. In at least one embodiment, texture units are configured to load texture maps (e.g., a 2D array of texels) from memory and sample texture maps to produce sampled texture values for use in shader programs executed by SM 4400. In at least one embodiment, texture maps are stored in shared memory/L1 cache 4418. In at least one embodiment, texture units implement texture operations such as filtering operations using mip-maps (e.g., texture maps of varying levels of detail). In at least one embodiment, each SM 4400 includes, without limitation, two texture units.

In at least one embodiment, each SM 4400 comprises, without limitation, N LSUs 4414 that implement load and store operations between shared memory/L1 cache 4418 and register file 4408. In at least one embodiment, each SM 4400 includes, without limitation, interconnect network 4416 that connects each of the functional units to register file 4408 and LSU 4414 to register file 4408 and shared memory/L1 cache 4418. In at least one embodiment, interconnect network 4416 is a crossbar that can be configured to connect any of the functional units to any of the registers in register file 4408 and connect LSUs 4414 to register file 4408 and memory locations in shared memory/L1 cache 4418.

In at least one embodiment, shared memory/L1 cache 4418 is an array of on-chip memory that allows for data storage and communication between SM 4400 and a primitive engine and between threads in SM 4400. In at least one embodiment, shared memory/L1 cache 4418 comprises, without limitation, 128 KB of storage capacity and is in a path from SM 4400 to a partition unit. In at least one embodiment, shared memory/L1 cache 4418 is used to cache reads and writes. In at least one embodiment, one or more of shared memory/L1 cache 4418, L2 cache, and memory are backing stores.

In at least one embodiment, combining data cache and shared memory functionality into a single memory block provides improved performance for both types of memory accesses. In at least one embodiment, capacity is used or is usable as a cache by programs that do not use shared memory, such as if shared memory is configured to use half of capacity, texture and load/store operations can use remaining capacity. In at least one embodiment, integration within shared memory/L1 cache 4418 enables shared memory/L1 cache 4418 to function as a high-throughput conduit for streaming data while simultaneously providing high-bandwidth and low-latency access to frequently reused data. In at least one embodiment, when configured for general purpose parallel computation, a simpler configuration can be used compared with graphics processing. In at least one embodiment, fixed function GPUs are bypassed, creating a much simpler programming model. In at least one embodiment and in a general purpose parallel computation configuration, a work distribution unit assigns and distributes blocks of threads directly to DPCs. In at least one embodiment, threads in a block execute the same program, using a unique thread ID in a calculation to ensure each thread generates unique results, using SM 4400 to execute a program and perform calculations, shared memory/L1 cache 4418 to communicate between threads, and LSU 4414 to read and write global memory through shared memory/L1 cache 4418 and a memory partition unit. In at least one embodiment, when configured for general purpose parallel computation, SM 4400 writes commands that scheduler unit 4404 can use to launch new work on DPCs. In at least one embodiment, SM 4400 includes one or more distributed shared memories (or distributed shared memory) that enable direct SM-to-SM operations such as loading, storing, and performing atomics across multiple SM shared memory blocks.

In at least one embodiment, SM 4400 includes one or more asynchronous execution functions that include a tensor memory accelerator (TMA) unit that can transfer blocks of data between global memory and shared memory. In at least one embodiment, one or more processors uses or access one or more TMAs to perform bi-directional copy operations, e.g., from global to shared memory and vice versa. In at least one embodiment, SM 4400 includes one or more TMAs to asynchronously copy between thread blocks in a cluster. In at least one embodiment, SM 4400 includes one or more asynchronous transaction barriers to perform atomic data movement and synchronization. In at least one embodiment, SM 4400 includes a tensor core transformer engine, which includes software and one or more cores to accelerate transformer model training and inferencing. In at least one embodiment, a transformer one or more processor cores performing one or more tensor core transformer engines manage and dynamically choose between FP8 and 16-bit calculations by re-casting and scaling between FP8 and 16-bit in each layer of one or more neural networks.

In at least one embodiment, PPU is included in or coupled to a desktop computer, a laptop computer, a tablet computer, servers, supercomputers, a smart-phone (e.g., a wireless, hand-held device), a PDA, a digital camera, a vehicle, a head mounted display, a hand-held electronic device, and more. In at least one embodiment, PPU is embodied on a single semiconductor substrate. In at least one embodiment, PPU is included in an SoC along with one or more other devices such as additional PPUs, memory, a RISC CPU, an MMU, a digital-to-analog converter (“DAC”), and like.

In at least one embodiment, PPU may be included on a graphics card that includes one or more memory devices. In at least one embodiment, a graphics card may be configured to interface with a PCIe slot on a motherboard of a desktop computer. In at least one embodiment, PPU may be an integrated GPU (“iGPU”) included in chipset of motherboard.

In at least one embodiment, at least one component shown or described with respect to FIG. 44 is used to perform techniques and/or functions described in connection with FIGS. 1-25. In at least one embodiment, at least one component shown or described with respect to FIG. 44 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 44 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 44 is used to perform at least one aspect described with respect to FIGS. 1-25, and/or other systems, methods, or operations described herein.

In at least one embodiment, at least one component shown or described with respect to FIG. 44 is used to perform techniques and/or functions described in connection with FIGS. 1-25. In at least one embodiment, at least one component shown or described with respect to FIG. 44 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 44 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 44 is used to perform techniques and/or functions described in connection with FIGS. 1-25. In at least one embodiment, at least one component shown or described with respect to FIG. 44 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 44 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 44 is used to perform techniques and/or functions described in connection with FIGS. 1-25. In at least one embodiment, at least one component shown or described with respect to FIG. 44 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 44 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 44 is used to perform techniques and/or functions described in connection with FIGS. 1-25. In at least one embodiment, at least one component shown or described with respect to FIG. 44 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 44 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 44 is used to perform techniques and/or functions described in connection with FIGS. 1-25. In at least one embodiment, at least one component shown or described with respect to FIG. 44 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 44 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 44 is used to perform techniques and/or functions described in connection with FIGS. 1-25. In at least one embodiment, at least one component shown or described with respect to FIG. 44 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 44 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 44 is used to perform techniques and/or functions described in connection with FIGS. 1-25. In at least one embodiment, at least one component shown or described with respect to FIG. 44 is used to perform an application programming interface (API) to cause context of one or more first software instructions to be communicated to one or more second software instructions, and/or other systems, methods, or operations described herein. In at least one embodiment, at least one component shown or described with respect to FIG. 44 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 44 is used to perform techniques and/or functions described in connection with FIGS. 1-25. In at least one embodiment, at least one component shown or described with respect to FIG. 44 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 44 is used to perform an application programming interface (API) to prevent one or more instructions from being performed by one or more resources of a first context of the processor until one or more indications of one or more events of a second context are generated, and/or other systems, methods, or operations described herein.

### Software Constructions for General-Purpose Computing

The following figures set forth, without limitation, exemplary software constructs for implementing at least one embodiment.

FIG. 45 illustrates a software stack of a programming platform, in accordance with at least one embodiment. In at least one embodiment, a programming platform is a platform for leveraging hardware on a computing system to accelerate computational tasks. A programming platform may be accessible to software developers through libraries, compiler directives, and/or extensions to programming languages, in at least one embodiment. In at least one embodiment, a programming platform may be, but is not limited to, CUDA, Radeon Open Compute Platform (“ROCm”), OpenCL (OpenCL™ is developed by Khronos group), SYCL, or Intel One API.

In at least one embodiment, a software stack 4500 of a programming platform provides an execution environment for an application 4501. In at least one embodiment, application 4501 may include any computer software capable of being launched on software stack 4500. In at least one embodiment, application 4501 may include, but is not limited to, an artificial intelligence (“AI”)/machine learning (“ML”) application, a high performance computing (“HPC”) application, a virtual desktop infrastructure (“VDI”), or a data center workload.

In at least one embodiment, application 4501 and software stack 4500 run on hardware 4507. Hardware 4507 may include one or more GPUs, CPUs, FPGAs, AI engines, and/or other types of compute devices that support a programming platform, in at least one embodiment. In at least one embodiment, such as with CUDA, software stack 4500 may be vendor specific and compatible with only devices from particular vendor(s). In at least one embodiment, such as in with OpenCL, software stack 4500 may be used with devices from different vendors. In at least one embodiment, hardware 4507 includes a host connected to one more devices that can be accessed to perform computational tasks via application programming interface (“API”) calls. A device within hardware 4507 may include, but is not limited to, a GPU, FPGA, AI engine, or other compute device (but may also include a CPU) and its memory, as opposed to a host within hardware 4507 that may include, but is not limited to, a CPU (but may also include a compute device) and its memory, in at least one embodiment.

In at least one embodiment, software stack 4500 of a programming platform includes, without limitation, a number of libraries 4503, a runtime 4505, and a device kernel driver 4506. Each of libraries 4503 may include data and programming code that can be used by computer programs and leveraged during software development, in at least one embodiment. In at least one embodiment, libraries 4503 may include, but are not limited to, pre-written code and subroutines, classes, values, type specifications, configuration data, documentation, help data, and/or message templates. In at least one embodiment, libraries 4503 include functions that are optimized for execution on one or more types of devices. In at least one embodiment, libraries 4503 may include, but are not limited to, functions for performing mathematical, deep learning, and/or other types of operations on devices. In at least one embodiment, libraries 4503 are associated with corresponding APIs 4502, which may include one or more APIs, that expose functions implemented in libraries 4503. In at least one embodiment, a processor (e.g. CPU, GPU) performs, calls, or otherwise uses one or more APIs to prioritize kernels. For example, a first kernel (e.g., parent) can launch a second kernel (e.g., child kernel), and said second kernel can be used by a processor to launch additional kernels (e.g., grandchildren kernels) independent of said first kernel. In at least one embodiment, a processor performs an API or calls an API from memory to be performed to support dynamic stream priority (e.g., updating priority while a stream is being used to perform operations). For example, when a processor performs said API, it allows a programmer to copy stream priority from one stream to one or more other streams.

In at least one embodiment, software stack 4500 includes an API to support dynamic stream priority (e.g., updating priority while a stream is being used to perform operations), which allows a programmer to set priority of a stream at any time after creation. In at least one embodiment, software stack 4500 includes an API to support dynamic stream priority (e.g., updating priority while the stream is being used to perform operations), which allows a programmer to obtain current priority of a stream, where the priority is one of a plurality of attributes of a stream. In at least one embodiment, software stack 4500 includes an API to support dynamic stream priority (e.g., updating priority while the stream is being used to perform operations), which allows a programmer to obtain current priority of a stream as a single attribute. In at least one embodiment, software stack 4500 includes an API to support dynamic stream priority (e.g., updating priority while the stream is being used to perform operations), which allows a programmer to launch a kernel to perform operations on a stream at a set priority, which may be different from the stream priority. In at least one embodiment, software stack 4500 includes an API to indicate whether an object (e.g., a thread synchronization object such as a barrier) tracks whether all data movement operations for a set of threads operating on a GPU are complete has a specified state after a specified period of time, where a specified state can be a state indicating that data has been moved and is ready for use, and is specified using an expected parity value as an input to the API.

In at least one embodiment, software stack 4500 includes one or more APIs to updated kernels. In at least one embodiment, a processor performs an API or calls an API from memory to be performed to update to an existing API is to support context-free kernels, which allows a programmer to add a kernel node to a graph without a graphics context, so that a graphics context can be dynamically associated with a kernel at runtime. In at least one embodiment, software stack 4500 includes one or more APIs to allow a programmer to obtain a kernel identifier and a graphics context as separate parameters from a kernel node, so that parameters to be obtained from kernels and from context-free kernels. In at least one embodiment, software stack 4500 includes one or more APIs to use parallel processor(s), such as one or more graphics processing units, to launch task graphs (e.g., task graphs) and to execute one or more task graphs (e.g., including one or more programs).

In at least one embodiment, software stack 4500 includes one or more APIs to associate one or more instructions with one or more memory ordering operations, such as a fence or member operation. In at least one embodiment, instructions are associated with one or more domains such that a memory ordering operation is executed in association to one or more particular domains without interfering with instructions of other domains. an API to indicate a thread has arrived (e.g., at a thread synchronization barrier), or finished a stage of work in relation to asynchronous data movement operations on a GPU. In at least one embodiment, software stack 4500 includes one or more to allow programmers to manually indicate an expected transaction count when a thread has finished a stage of work, which is used to update an object that tracks whether all data movement operations for a set of threads are complete.

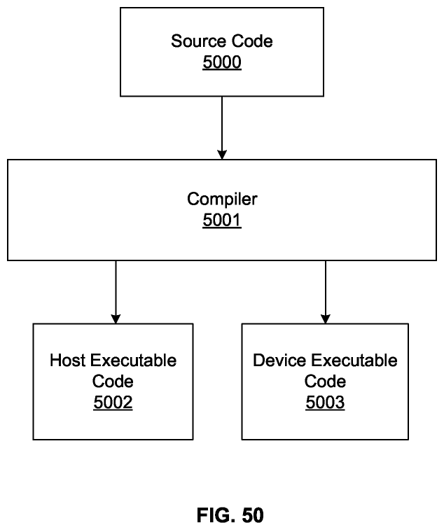

In at least one embodiment, application 4501 is written as source code that is compiled into executable code, as discussed in greater detail below in conjunction with FIGS. 50-52. Executable code of application 4501 may run, at least in part, on an execution environment provided by software stack 4500, in at least one embodiment. In at least one embodiment, during execution of application 4501, code may be reached that needs to run on a device, as opposed to a host. In such a case, runtime 4505 may be called to load and launch requisite code on the device, in at least one embodiment. In at least one embodiment, runtime 4505 may include any technically feasible runtime system that is able to support execution of application S01.

In at least one embodiment, runtime 4505 is implemented as one or more runtime libraries associated with corresponding APIs, which are shown as API(s) 4504. One or more of such runtime libraries may include, without limitation, functions for memory management, execution control, device management, error handling, and/or synchronization, among other things, in at least one embodiment. In at least one embodiment, memory management functions may include, but are not limited to, functions to allocate, deallocate, and copy device memory, as well as transfer data between host memory and device memory. In at least one embodiment, execution control functions may include, but are not limited to, functions to launch a function (sometimes referred to as a “kernel” when a function is a global function callable from a host) on a device and set attribute values in a buffer maintained by a runtime library for a given function to be executed on a device.

Runtime libraries and corresponding API(s) 4504 may be implemented in any technically feasible manner, in at least one embodiment. In at least one embodiment, one (or any number of) API may expose a low-level set of functions for fine-grained control of a device, while another (or any number of) API may expose a higher-level set of such functions. In at least one embodiment, a high-level runtime API may be built on top of a low-level API. In at least one embodiment, one or more of runtime APIs may be language-specific APIs that are layered on top of a language-independent runtime API.

In at least one embodiment, one or more processors disclosed in “processing systems” can perform, access, or otherwise use software stack 4500. For example, APU 3200, CPU 3300, 35A-35B exemplary graphics processors, general-purpose graphics processing unit (“GPGPU”) 3630, parallel processor 3700, processing cluster 3794, graphics multiprocessor 3734, graphics multiprocessor 3796, graphics processor 3800, processor 3900, processor 4000, parallel processing unit (“PPU”) 4200, GPC 4300, and/or streaming multiprocessor (“SM”) 4400 can perform, use, call, or otherwise implement (e.g., through accessing a memory) one or more APIs included in software stack 4500.

In at least one embodiment, device kernel driver 4506 is configured to facilitate communication with an underlying device. In at least one embodiment, device kernel driver 4506 may provide low-level functionalities upon which APIs, such as API(s) 4504, and/or other software relies. In at least one embodiment, device kernel driver 4506 may be configured to compile intermediate representation (“IR”) code into binary code at runtime. For CUDA, device kernel driver 4506 may compile Parallel Thread Execution (“PTX”) IR code that is not hardware specific into binary code for a specific target device at runtime (with caching of compiled binary code), which is also sometimes referred to as “finalizing” code, in at least one embodiment. Doing so may permit finalized code to run on a target device, which may not have existed when source code was originally compiled into PTX code, in at least one embodiment. Alternatively, in at least one embodiment, device source code may be compiled into binary code offline, without requiring device kernel driver 4506 to compile IR code at runtime.

In at least one embodiment, at least one component shown or described with respect to FIG. 45 is used to perform techniques and/or functions described in connection with FIGS. 1-25. In at least one embodiment, at least one component shown or described with respect to FIG. 45 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 45 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 45 is used to perform at least one aspect described with respect to FIGS. 1-25, and/or other systems, methods, or operations described herein.

In at least one embodiment, at least one component shown or described with respect to FIG. 45 is used to perform techniques and/or functions described in connection with FIGS. 1-25. In at least one embodiment, at least one component shown or described with respect to FIG. 45 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 45 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 45 is used to perform techniques and/or functions described in connection with FIGS. 1-25. In at least one embodiment, at least one component shown or described with respect to FIG. 45 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 45 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 45 is used to perform techniques and/or functions described in connection with FIGS. 1-25. In at least one embodiment, at least one component shown or described with respect to FIG. 45 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 45 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 45 is used to perform techniques and/or functions described in connection with FIGS. 1-25. In at least one embodiment, at least one component shown or described with respect to FIG. 45 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 45 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 45 is used to perform techniques and/or functions described in connection with FIGS. 1-25. In at least one embodiment, at least one component shown or described with respect to FIG. 45 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 45 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 45 is used to perform techniques and/or functions described in connection with FIGS. 1-25. In at least one embodiment, at least one component shown or described with respect to FIG. 45 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 45 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 45 is used to perform techniques and/or functions described in connection with FIGS. 1-25. In at least one embodiment, at least one component shown or described with respect to FIG. 45 is used to perform an application programming interface (API) to cause context of one or more first software instructions to be communicated to one or more second software instructions, and/or other systems, methods, or operations described herein. In at least one embodiment, at least one component shown or described with respect to FIG. 45 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 45 is used to perform techniques and/or functions described in connection with FIGS. 1-25. In at least one embodiment, at least one component shown or described with respect to FIG. 45 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 45 is used to perform an application programming interface (API) to prevent one or more instructions from being performed by one or more resources of a first context of the processor until one or more indications of one or more events of a second context are generated, and/or other systems, methods, or operations described herein.

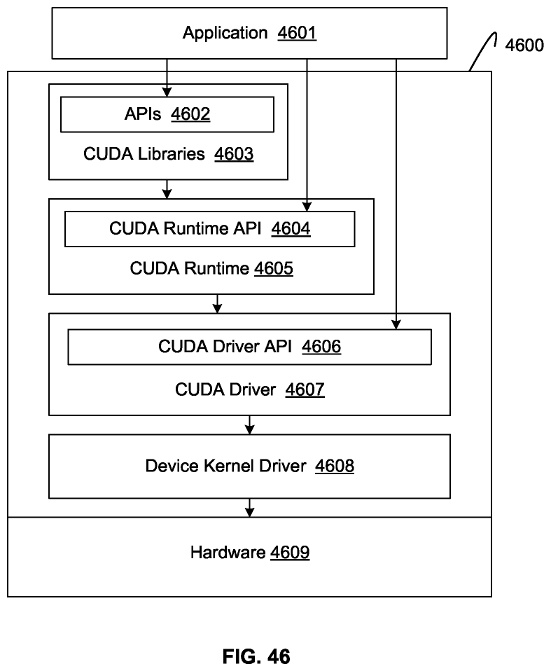

FIG. 46 illustrates a CUDA implementation of software stack 4500 of FIG. 45, in accordance with at least one embodiment. In at least one embodiment, a CUDA software stack 4600, on which an application 4601 may be launched, includes CUDA libraries 4603, a CUDA runtime 4605, a CUDA driver 4607, and a device kernel driver 4608. In at least one embodiment, CUDA software stack 4600 executes on hardware 4609, which may include a GPU that supports CUDA and is developed by NVIDIA Corporation of Santa Clara, CA.

In at least one embodiment, application 4601, CUDA runtime 4605, and device kernel driver 4608 may perform similar functionalities as application 4501, runtime 4505, and device kernel driver 4506, respectively, which are described above in conjunction with FIG. 45. In at least one embodiment, CUDA driver 4607 includes a library (libcuda.so) that implements a CUDA driver API 4606. Similar to a CUDA runtime API 4604 implemented by a CUDA runtime library (cudart), CUDA driver API 4606 may, without limitation, expose functions for memory management, execution control, device management, error handling, synchronization, and/or graphics interoperability, among other things, in at least one embodiment. In at least one embodiment, CUDA driver API 4606 differs from CUDA runtime API 4604 in that CUDA runtime API 4604 simplifies device code management by providing implicit initialization, context (analogous to a process) management, and module (analogous to dynamically loaded libraries) management. In contrast to high-level CUDA runtime API 4604, CUDA driver API 4606 is a low-level API providing more fine-grained control of the device, particularly with respect to contexts and module loading, in at least one embodiment. In at least one embodiment, CUDA driver API 4606 may expose functions for context management that are not exposed by CUDA runtime API 4604. In at least one embodiment, CUDA driver API 4606 is also language-independent and supports, e.g., OpenCL in addition to CUDA runtime API 4604. Further, in at least one embodiment, development libraries, including CUDA runtime 4605, may be considered as separate from driver components, including user-mode CUDA driver 4607 and kernel-mode device driver 4608 (also sometimes referred to as a “display” driver).

In at least one embodiment, CUDA libraries 4603 may include, but are not limited to, mathematical libraries, deep learning libraries, parallel algorithm libraries, and/or signal/image/video processing libraries, which parallel computing applications such as application 4601 may utilize. In at least one embodiment, CUDA libraries 4603 may include mathematical libraries such as a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. In at least one embodiment, CUDA libraries 4603 may include deep learning libraries such as a cuDNN library of primitives for deep neural networks and a TensorRT platform for high-performance deep learning inference, among others.

In at least one embodiment, at least one component shown or described with respect to FIG. 46 is used to perform techniques and/or functions described in connection with FIGS. 1-25. In at least one embodiment, at least one component shown or described with respect to FIG. 46 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 46 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 46 is used to perform at least one aspect described with respect to FIGS. 1-25, and/or other systems, methods, or operations described herein.

In at least one embodiment, at least one component shown or described with respect to FIG. 46 is used to perform techniques and/or functions described in connection with FIGS. 1-25. In at least one embodiment, at least one component shown or described with respect to FIG. 46 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 46 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 46 is used to perform techniques and/or functions described in connection with FIGS. 1-25. In at least one embodiment, at least one component shown or described with respect to FIG. 46 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 46 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 46 is used to perform techniques and/or functions described in connection with FIGS. 1-25. In at least one embodiment, at least one component shown or described with respect to FIG. 46 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 46 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 46 is used to perform techniques and/or functions described in connection with FIGS. 1-25. In at least one embodiment, at least one component shown or described with respect to FIG. 46 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 46 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 46 is used to perform techniques and/or functions described in connection with FIGS. 1-25. In at least one embodiment, at least one component shown or described with respect to FIG. 46 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 46 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 46 is used to perform techniques and/or functions described in connection with FIGS. 1-25. In at least one embodiment, at least one component shown or described with respect to FIG. 46 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 46 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 46 is used to perform techniques and/or functions described in connection with FIGS. 1-25. In at least one embodiment, at least one component shown or described with respect to FIG. 46 is used to perform an application programming interface (API) to cause context of one or more first software instructions to be communicated to one or more second software instructions, and/or other systems, methods, or operations described herein. In at least one embodiment, at least one component shown or described with respect to FIG. 46 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 46 is used to perform techniques and/or functions described in connection with FIGS. 1-25. In at least one embodiment, at least one component shown or described with respect to FIG. 46 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 46 is used to perform an application programming interface (API) to prevent one or more instructions from being performed by one or more resources of a first context of the processor until one or more indications of one or more events of a second context are generated, and/or other systems, methods, or operations described herein.

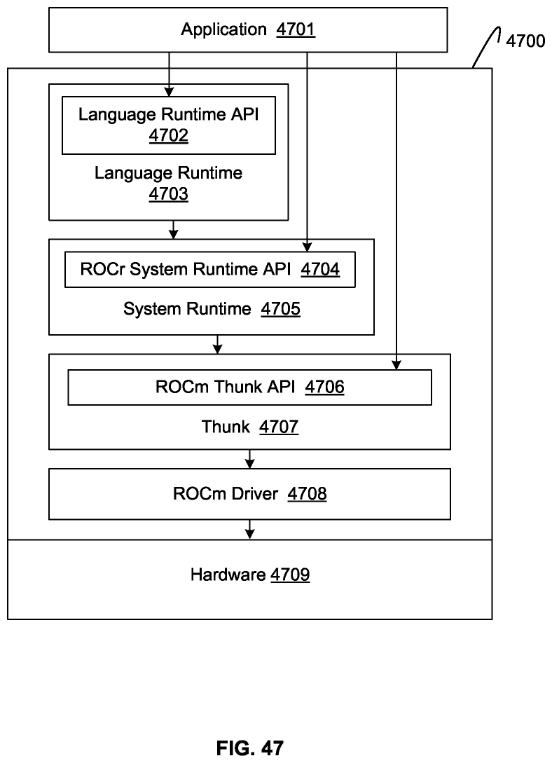

FIG. 47 illustrates a ROCm implementation of software stack 4500 of FIG. 45, in accordance with at least one embodiment. In at least one embodiment, a ROCm software stack 4700, on which an application 4701 may be launched, includes a language runtime 4703, a system runtime 4705, a thunk 4707, and a ROCm kernel driver 4708. In at least one embodiment, ROCm software stack 4700 executes on hardware 4709, which may include a GPU that supports ROCm and is developed by AMD Corporation of Santa Clara, CA.

In at least one embodiment, application 4701 may perform similar functionalities as application 4501 discussed above in conjunction with FIG. 45. In addition, language runtime 4703 and system runtime 4705 may perform similar functionalities as runtime 4505 discussed above in conjunction with FIG. 45, in at least one embodiment. In at least one embodiment, language runtime 4703 and system runtime 4705 differ in that system runtime 4705 is a language-independent runtime that implements a ROCr system runtime API 4704 and makes use of a Heterogeneous System Architecture (“HSA”) Runtime API. HSA runtime API is a thin, user-mode API that exposes interfaces to access and interact with an AMD GPU, including functions for memory management, execution control via architected dispatch of kernels, error handling, system and agent information, and runtime initialization and shutdown, among other things, in at least one embodiment. In contrast to system runtime 4705, language runtime 4703 is an implementation of a language-specific runtime API 4702 layered on top of ROCr system runtime API 4704, in at least one embodiment. In at least one embodiment, language runtime API may include, but is not limited to, a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and, in at least one embodiment, a HIP language runtime API includes functions that are similar to those of CUDA runtime API 4604 discussed above in conjunction with FIG. 46, such as functions for memory management, execution control, device management, error handling, and synchronization, among other things.

In at least one embodiment, thunk (ROCt) 4707 is an interface 4706 that can be used to interact with underlying ROCm driver 4708. In at least one embodiment, ROCm driver 4708 is a ROCK driver, which is a combination of an AMDGPU driver and a HSA kernel driver (amdkfd). In at least one embodiment, AMDGPU driver is a device kernel driver for GPUs developed by AMD that performs similar functionalities as device kernel driver 4506 discussed above in conjunction with FIG. 45. In at least one embodiment, HSA kernel driver is a driver permitting different types of processors to share system resources more effectively via hardware features.

In at least one embodiment, various libraries (not shown) may be included in ROCm software stack 4700 above language runtime 4703 and provide functionality similarity to CUDA libraries 4603, discussed above in conjunction with FIG. 46. In at least one embodiment, various libraries may include, but are not limited to, mathematical, deep learning, and/or other libraries such as a hipBLAS library that implements functions similar to those of CUDA cuBLAS, a rocFFT library for computing FFTs that is similar to CUDA cuFFT, among others.

In at least one embodiment, at least one component shown or described with respect to FIG. 47 is used to perform techniques and/or functions described in connection with FIGS. 1-25. In at least one embodiment, at least one component shown or described with respect to FIG. 47 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 47 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 47 is used to perform at least one aspect described with respect to FIGS. 1-25, and/or other systems, methods, or operations described herein.

In at least one embodiment, at least one component shown or described with respect to FIG. 47 is used to perform techniques and/or functions described in connection with FIGS. 1-25. In at least one embodiment, at least one component shown or described with respect to FIG. 47 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 47 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 47 is used to perform techniques and/or functions described in connection with FIGS. 1-25. In at least one embodiment, at least one component shown or described with respect to FIG. 47 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 47 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 47 is used to perform techniques and/or functions described in connection with FIGS. 1-25. In at least one embodiment, at least one component shown or described with respect to FIG. 47 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 47 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 47 is used to perform techniques and/or functions described in connection with FIGS. 1-25. In at least one embodiment, at least one component shown or described with respect to FIG. 47 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 47 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 47 is used to perform techniques and/or functions described in connection with FIGS. 1-25. In at least one embodiment, at least one component shown or described with respect to FIG. 47 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 47 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 47 is used to perform techniques and/or functions described in connection with FIGS. 1-25. In at least one embodiment, at least one component shown or described with respect to FIG. 47 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 47 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 47 is used to perform techniques and/or functions described in connection with FIGS. 1-25. In at least one embodiment, at least one component shown or described with respect to FIG. 47 is used to perform an application programming interface (API) to cause context of one or more first software instructions to be communicated to one or more second software instructions, and/or other systems, methods, or operations described herein. In at least one embodiment, at least one component shown or described with respect to FIG. 47 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 47 is used to perform techniques and/or functions described in connection with FIGS. 1-25. In at least one embodiment, at least one component shown or described with respect to FIG. 47 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 47 is used to perform an application programming interface (API) to prevent one or more instructions from being performed by one or more resources of a first context of the processor until one or more indications of one or more events of a second context are generated, and/or other systems, methods, or operations described herein.

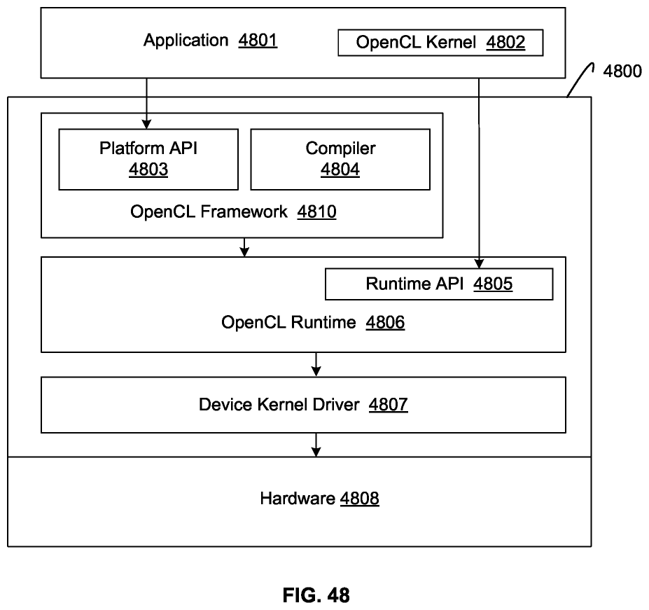

FIG. 48 illustrates an OpenCL implementation of software stack 4500 of FIG. 45, in accordance with at least one embodiment. In at least one embodiment, an OpenCL software stack 4800, on which an application 4801 may be launched, includes an OpenCL framework 4810, an OpenCL runtime 4806, and a driver 4807. In at least one embodiment, OpenCL software stack 4800 executes on hardware 4609 that is not vendor-specific. As OpenCL is supported by devices developed by different vendors, specific OpenCL drivers may be required to interoperate with hardware from such vendors, in at least one embodiment.

In at least one embodiment, application 4801, OpenCL runtime 4806, device kernel driver 4807, and hardware 4808 may perform similar functionalities as application 4501, runtime 4505, device kernel driver 4506, and hardware 4507, respectively, that are discussed above in conjunction with FIG. 45. In at least one embodiment, application 4801 further includes an OpenCL kernel 4802 with code that is to be executed on a device.

In at least one embodiment, OpenCL defines a “platform” that allows a host to control devices connected to the host. In at least one embodiment, an OpenCL framework provides a platform layer API and a runtime API, shown as platform API 4803 and runtime API 4805. In at least one embodiment, runtime API 4805 uses contexts to manage execution of kernels on devices. In at least one embodiment, each identified device may be associated with a respective context, which runtime API 4805 may use to manage command queues, program objects, and kernel objects, share memory objects, among other things, for that device. In at least one embodiment, platform API 4803 exposes functions that permit device contexts to be used to select and initialize devices, submit work to devices via command queues, and enable data transfer to and from devices, among other things. In addition, OpenCL framework provides various built-in functions (not shown), including math functions, relational functions, and image processing functions, among others, in at least one embodiment.

In at least one embodiment, a compiler 4804 is also included in OpenCL frame-work 4810. Source code may be compiled offline prior to executing an application or online during execution of an application, in at least one embodiment. In contrast to CUDA and ROCm, OpenCL applications in at least one embodiment may be compiled online by compiler 4804, which is included to be representative of any number of compilers that may be used to compile source code and/or IR code, such as Standard Portable Intermediate Representation (“SPIR-V”) code, into binary code. Alternatively, in at least one embodiment, OpenCL ap-plications may be compiled offline, prior to execution of such applications.

In at least one embodiment, at least one component shown or described with respect to FIG. 48 is used to perform techniques and/or functions described in connection with FIGS. 1-25. In at least one embodiment, at least one component shown or described with respect to FIG. 48 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 48 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 48 is used to perform at least one aspect described with respect to FIGS. 1-25, and/or other systems, methods, or operations described herein.

In at least one embodiment, at least one component shown or described with respect to FIG. 48 is used to perform techniques and/or functions described in connection with FIGS. 1-25. In at least one embodiment, at least one component shown or described with respect to FIG. 48 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 48 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 48 is used to perform techniques and/or functions described in connection with FIGS. 1-25. In at least one embodiment, at least one component shown or described with respect to FIG. 48 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 48 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 48 is used to perform techniques and/or functions described in connection with FIGS. 1-25. In at least one embodiment, at least one component shown or described with respect to FIG. 48 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 48 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 48 is used to perform techniques and/or functions described in connection with FIGS. 1-25. In at least one embodiment, at least one component shown or described with respect to FIG. 48 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 48 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 48 is used to perform techniques and/or functions described in connection with FIGS. 1-25. In at least one embodiment, at least one component shown or described with respect to FIG. 48 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 48 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 48 is used to perform techniques and/or functions described in connection with FIGS. 1-25. In at least one embodiment, at least one component shown or described with respect to FIG. 48 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 48 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 48 is used to perform techniques and/or functions described in connection with FIGS. 1-25. In at least one embodiment, at least one component shown or described with respect to FIG. 48 is used to perform an application programming interface (API) to cause context of one or more first software instructions to be communicated to one or more second software instructions, and/or other systems, methods, or operations described herein. In at least one embodiment, at least one component shown or described with respect to FIG. 48 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 48 is used to perform techniques and/or functions described in connection with FIGS. 1-25. In at least one embodiment, at least one component shown or described with respect to FIG. 48 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 48 is used to perform an application programming interface (API) to prevent one or more instructions from being performed by one or more resources of a first context of the processor until one or more indications of one or more events of a second context are generated, and/or other systems, methods, or operations described herein.

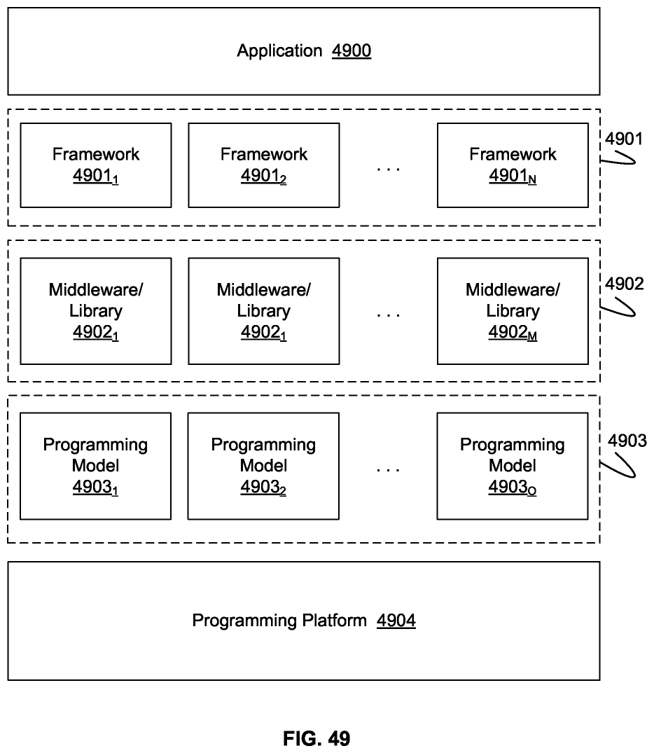

FIG. 49 illustrates software that is supported by a programming platform, in accordance with at least one embodiment. In at least one embodiment, a programming platform 4904 is configured to support various programming models 4903, middlewares and/or libraries 4902, and frameworks 4901 that an application 4900 may rely upon. In at least one embodiment, application 4900 may be an AI/ML application implemented using, for example, a deep learning framework such as MXNet, PyTorch, or TensorFlow, which may rely on libraries such as cuDNN, NVIDIA Collective Communications Library (“NCCL”), and/or NVIDA Developer Data Loading Library (“DALI”) CUDA libraries to provide accelerated computing on underlying hardware.

In at least one embodiment, programming platform 4904 may be one of a CUDA, ROCm, or OpenCL platform described above in conjunction with FIG. 46, FIG. 47, and FIG. 48, respectively. In at least one embodiment, programming platform 4904 supports multiple programming models 4903, which are abstractions of an underlying computing system permitting expressions of algorithms and data structures. Programming models 4903 may expose features of underlying hardware in order to improve performance, in at least one embodiment. In at least one embodiment, programming models 4903 may include, but are not limited to, CUDA, HIP, OpenCL, C++ Accelerated Massive Parallelism (“C++ AMP”), Open Multi-Processing (“OpenMP”), Open Accelerators (“OpenACC”), and/or Vulcan Compute.

In at least one embodiment, libraries and/or middlewares 4902 provide implementations of abstractions of programming models 4904. In at least one embodiment, such libraries include data and programming code that may be used by computer programs and leveraged during software development. In at least one embodiment, such middlewares include software that provides services to applications beyond those available from programming platform 4904. In at least one embodiment, libraries and/or middlewares 4902 may include, but are not limited to, cuBLAS, cuFFT, cuRAND, and other CUDA libraries, or rocBLAS, rocFFT, rocRAND, and other ROCm libraries. In addition, in at least one embodiment, libraries and/or middlewares 4902 may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

In at least one embodiment, application frameworks 4901 depend on libraries and/or middlewares 4902. In at least one embodiment, each of application frameworks 4901 is a software framework used to implement a standard structure of application software. Returning to the AI/ML example discussed above, an AI/ML application may be implemented using a framework such as Caffe, Caffe2, TensorFlow, Keras, PyTorch, or MxNet deep learning frameworks, in at least one embodiment.

In at least one embodiment, at least one component shown or described with respect to FIG. 49 is used to perform techniques and/or functions described in connection with FIGS. 1-25. In at least one embodiment, at least one component shown or described with respect to FIG. 49 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 49 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 49 is used to perform at least one aspect described with respect to FIGS. 1-25, and/or other systems, methods, or operations described herein.

In at least one embodiment, at least one component shown or described with respect to FIG. 49 is used to perform techniques and/or functions described in connection with FIGS. 1-25. In at least one embodiment, at least one component shown or described with respect to FIG. 49 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 49 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 49 is used to perform techniques and/or functions described in connection with FIGS. 1-25. In at least one embodiment, at least one component shown or described with respect to FIG. 49 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 49 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 49 is used to perform techniques and/or functions described in connection with FIGS. 1-25. In at least one embodiment, at least one component shown or described with respect to FIG. 49 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 49 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 49 is used to perform techniques and/or functions described in connection with FIGS. 1-25. In at least one embodiment, at least one component shown or described with respect to FIG. 49 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 49 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 49 is used to perform techniques and/or functions described in connection with FIGS. 1-25. In at least one embodiment, at least one component shown or described with respect to FIG. 49 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 49 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 49 is used to perform techniques and/or functions described in connection with FIGS. 1-25. In at least one embodiment, at least one component shown or described with respect to FIG. 49 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 49 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 49 is used to perform techniques and/or functions described in connection with FIGS. 1-25. In at least one embodiment, at least one component shown or described with respect to FIG. 49 is used to perform an application programming interface (API) to cause context of one or more first software instructions to be communicated to one or more second software instructions, and/or other systems, methods, or operations described herein. In at least one embodiment, at least one component shown or described with respect to FIG. 49 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 49 is used to perform techniques and/or functions described in connection with FIGS. 1-25. In at least one embodiment, at least one component shown or described with respect to FIG. 49 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 49 is used to perform an application programming interface (API) to prevent one or more instructions from being performed by one or more resources of a first context of the processor until one or more indications of one or more events of a second context are generated, and/or other systems, methods, or operations described herein.

FIG. 50 illustrates compiling code to execute on one of programming platforms of FIGS. 45-48, in accordance with at least one embodiment. In at least one embodiment, a compiler 5001 receives source code 5000 that includes both host code as well as device code. In at least one embodiment, complier 5001 is configured to convert source code 5000 into host executable code 5002 for execution on a host and device executable code 5003 for execution on a device. In at least one embodiment, source code 5000 may either be compiled offline prior to execution of an application, or online during execution of an application. In at least one embodiment, compiler 5001 includes or has access to one or more libraries to recognize a sequence of API calls to perform a single fused API, where a single fused API is a combined API for two or more APIs.

In at least one embodiment, source code 5000 may include code in any programming language supported by compiler 5001, such as C++, C, Fortran, etc. In at least one embodiment, source code 5000 may be included in a single-source file having a mixture of host code and device code, with locations of device code being indicated therein. In at least one embodiment, a single-source file may be a .cu file that includes CUDA code or a .hip.cpp file that includes HIP code. Alternatively, in at least one embodiment, source code 5000 may include multiple source code files, rather than a single-source file, into which host code and device code are separated.

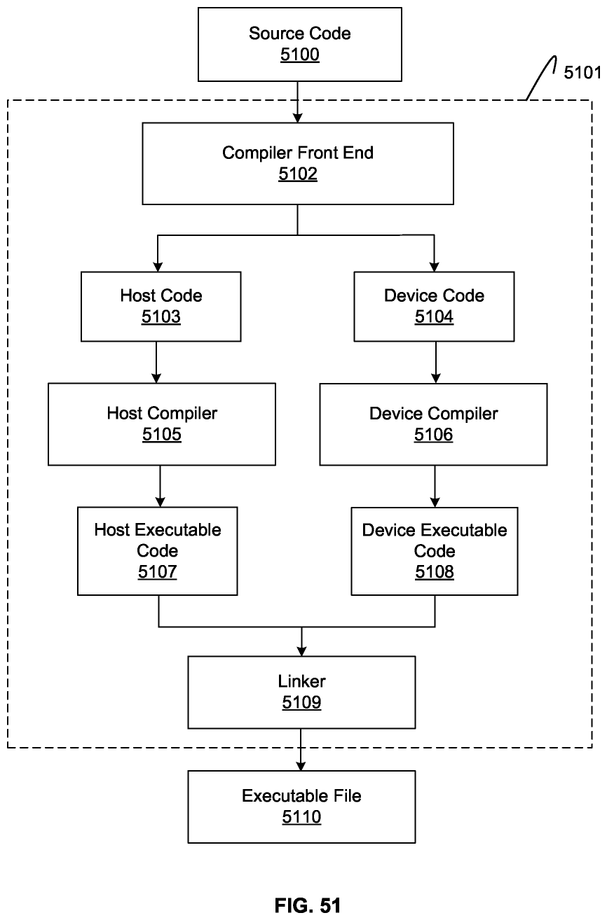

In at least one embodiment, compiler 5001 is configured to compile source code 5000 into host executable code 5002 for execution on a host and device executable code 5003 for execution on a device. In at least one embodiment, compiler 5001 performs operations including parsing source code 5000 into an abstract system tree (AST), performing optimizations, and generating executable code. In at least one embodiment in which source code 5000 includes a single-source file, compiler 5001 may separate device code from host code in such a single-source file, compile device code and host code into device executable code 5003 and host executable code 5002, respectively, and link device executable code 5003 and host executable code 5002 together in a single file, as discussed in greater detail below with respect to FIG. 51.

In at least one embodiment, host executable code 5002 and device executable code 5003 may be in any suitable format, such as binary code and/or IR code. In the case of CUDA, host executable code 5002 may include native object code and device executable code 5003 may include code in PTX intermediate representation, in at least one embodiment. In the case of ROCm, both host executable code 5002 and device executable code 5003 may include target binary code, in at least one embodiment.

In at least one embodiment, at least one component shown or described with respect to FIG. 50 is used to perform techniques and/or functions described in connection with FIGS. 1-25. In at least one embodiment, at least one component shown or described with respect to FIG. 50 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 50 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 50 is used to perform at least one aspect described with respect to FIGS. 1-25, and/or other systems, methods, or operations described herein.

In at least one embodiment, at least one component shown or described with respect to FIG. 50 is used to perform techniques and/or functions described in connection with FIGS. 1-25. In at least one embodiment, at least one component shown or described with respect to FIG. 50 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 50 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 50 is used to perform techniques and/or functions described in connection with FIGS. 1-25. In at least one embodiment, at least one component shown or described with respect to FIG. 50 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 50 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 50 is used to perform techniques and/or functions described in connection with FIGS. 1-25. In at least one embodiment, at least one component shown or described with respect to FIG. 50 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 50 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 50 is used to perform techniques and/or functions described in connection with FIGS. 1-25. In at least one embodiment, at least one component shown or described with respect to FIG. 50 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 50 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 50 is used to perform techniques and/or functions described in connection with FIGS. 1-25. In at least one embodiment, at least one component shown or described with respect to FIG. 50 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 50 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 50 is used to perform techniques and/or functions described in connection with FIGS. 1-25. In at least one embodiment, at least one component shown or described with respect to FIG. 50 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 50 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 50 is used to perform techniques and/or functions described in connection with FIGS. 1-25. In at least one embodiment, at least one component shown or described with respect to FIG. 50 is used to perform an application programming interface (API) to cause context of one or more first software instructions to be communicated to one or more second software instructions, and/or other systems, methods, or operations described herein. In at least one embodiment, at least one component shown or described with respect to FIG. 50 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 50 is used to perform techniques and/or functions described in connection with FIGS. 1-25. In at least one embodiment, at least one component shown or described with respect to FIG. 50 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 50 is used to perform an application programming interface (API) to prevent one or more instructions from being performed by one or more resources of a first context of the processor until one or more indications of one or more events of a second context are generated, and/or other systems, methods, or operations described herein.

FIG. 51 is a more detailed illustration of compiling code to execute on one of programming platforms of FIGS. 45-48, in accordance with at least one embodiment. In at least one embodiment, a compiler 5101 is configured to receive source code 5100, compile source code 5100, and output an executable file 5110. In at least one embodiment, source code 5100 is a single-source file, such as a .cu file, a .hip.cpp file, or a file in another format, that includes both host and device code. In at least one embodiment, compiler 5101 may be, but is not limited to, an NVIDIA CUDA compiler (“NVCC”) for compiling CUDA code in .cu files, or a HCC compiler for compiling HIP code in .hip.cpp files.

In at least one embodiment, compiler 5101 includes a compiler front end 5102, a host compiler 5105, a device compiler 5106, and a linker 5109. In at least one embodiment, compiler front end 5102 is configured to separate device code 5104 from host code 5103 in source code 5100. Device code 5104 is compiled by device compiler 5106 into device executable code 5108, which as described may include binary code or IR code, in at least one embodiment. Separately, host code 5103 is compiled by host compiler 5105 into host executable code 5107, in at least one embodiment. For NVCC, host compiler 5105 may be, but is not limited to, a general purpose C/C++ compiler that outputs native object code, while device compiler 5106 may be, but is not limited to, a Low Level Virtual Machine (“LLVM”)-based compiler that forks a LLVM compiler infrastructure and outputs PTX code or binary code, in at least one embodiment. For HCC, both host compiler 5105 and device compiler 5106 may be, but are not limited to, LLVM-based compilers that output target binary code, in at least one embodiment.

Subsequent to compiling source code 5100 into host executable code 5107 and device executable code 5108, linker 5109 links host and device executable code 5107 and 5108 together in executable file 5110, in at least one embodiment. In at least one embodiment, native object code for a host and PTX or binary code for a device may be linked together in an Executable and Linkable Format (“ELF”) file, which is a container format used to store object code.

In at least one embodiment, at least one component shown or described with respect to FIG. 51 is used to perform techniques and/or functions described in connection with FIGS. 1-25. In at least one embodiment, at least one component shown or described with respect to FIG. 51 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 51 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 51 is used to perform at least one aspect described with respect to FIGS. 1-25, and/or other systems, methods, or operations described herein.

In at least one embodiment, at least one component shown or described with respect to FIG. 51 is used to perform techniques and/or functions described in connection with FIGS. 1-25. In at least one embodiment, at least one component shown or described with respect to FIG. 51 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 51 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 51 is used to perform techniques and/or functions described in connection with FIGS. 1-25. In at least one embodiment, at least one component shown or described with respect to FIG. 51 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 51 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 51 is used to perform techniques and/or functions described in connection with FIGS. 1-25. In at least one embodiment, at least one component shown or described with respect to FIG. 51 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 51 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 51 is used to perform techniques and/or functions described in connection with FIGS. 1-25. In at least one embodiment, at least one component shown or described with respect to FIG. 51 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 51 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 51 is used to perform techniques and/or functions described in connection with FIGS. 1-25. In at least one embodiment, at least one component shown or described with respect to FIG. 51 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 51 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 51 is used to perform techniques and/or functions described in connection with FIGS. 1-25. In at least one embodiment, at least one component shown or described with respect to FIG. 51 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 51 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 51 is used to perform techniques and/or functions described in connection with FIGS. 1-25. In at least one embodiment, at least one component shown or described with respect to FIG. 51 is used to perform an application programming interface (API) to cause context of one or more first software instructions to be communicated to one or more second software instructions, and/or other systems, methods, or operations described herein. In at least one embodiment, at least one component shown or described with respect to FIG. 51 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 51 is used to perform techniques and/or functions described in connection with FIGS. 1-25. In at least one embodiment, at least one component shown or described with respect to FIG. 51 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 51 is used to perform an application programming interface (API) to prevent one or more instructions from being performed by one or more resources of a first context of the processor until one or more indications of one or more events of a second context are generated, and/or other systems, methods, or operations described herein.

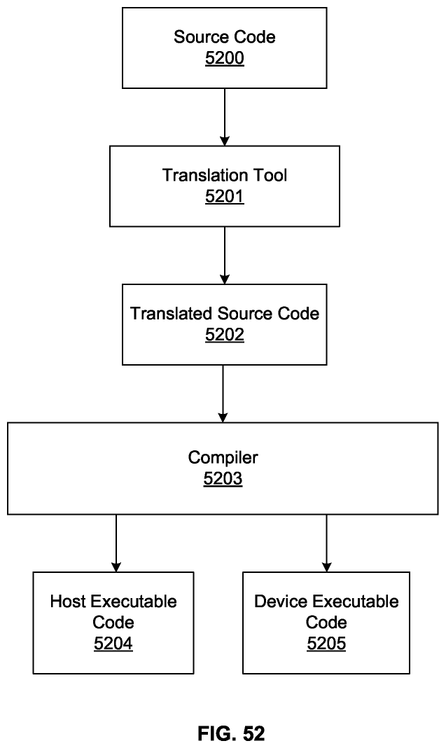

FIG. 52 illustrates translating source code prior to compiling source code, in accordance with at least one embodiment. In at least one embodiment, source code 5200 is passed through a translation tool 5201, which translates source code 5200 into translated source code 5202. In at least one embodiment, a compiler 5203 is used to compile translated source code 5202 into host executable code 5204 and device executable code 5205 in a process that is similar to compilation of source code 5000 by compiler 5001 into host executable code 5002 and device executable 5003, as discussed above in conjunction with FIG. 50.

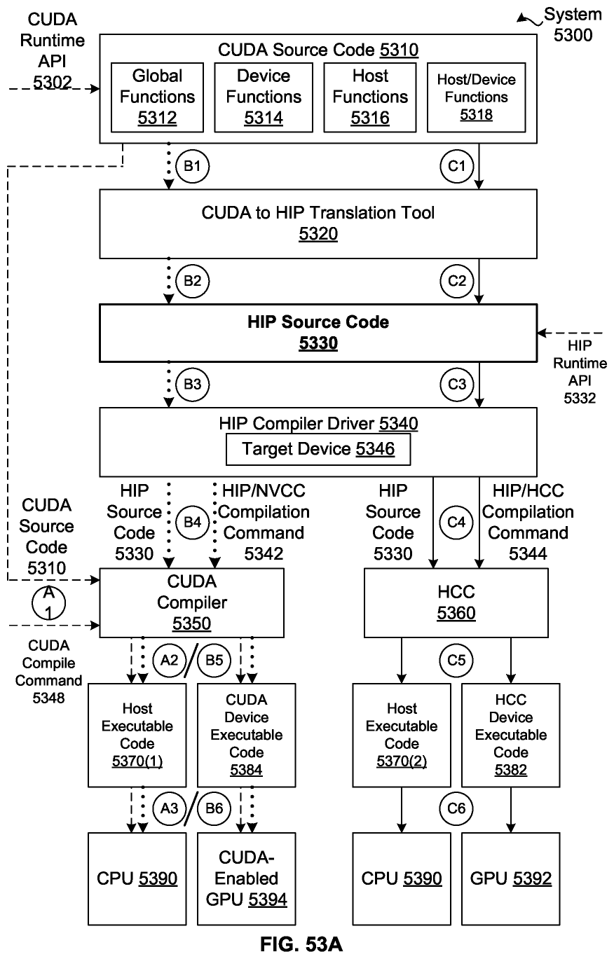

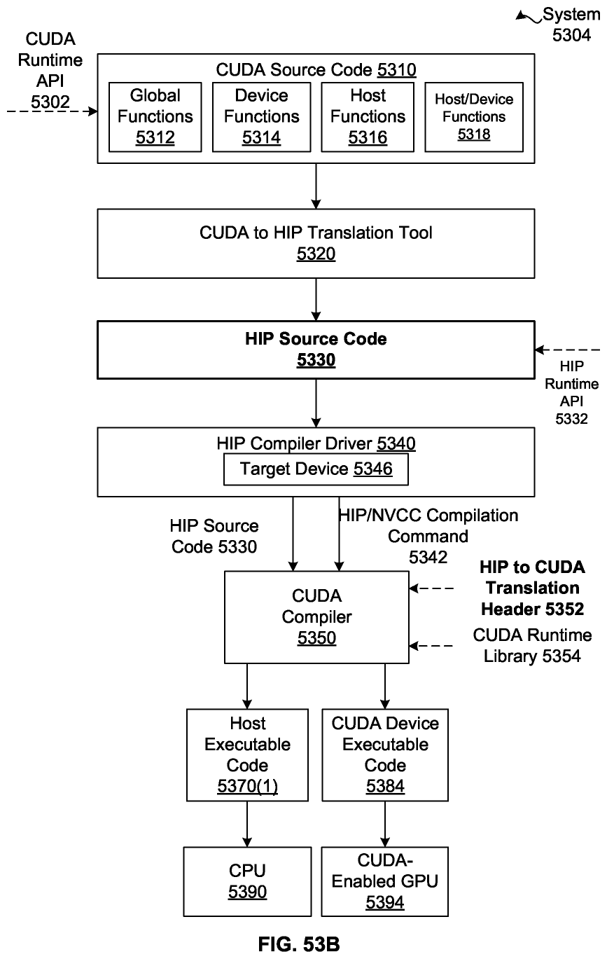

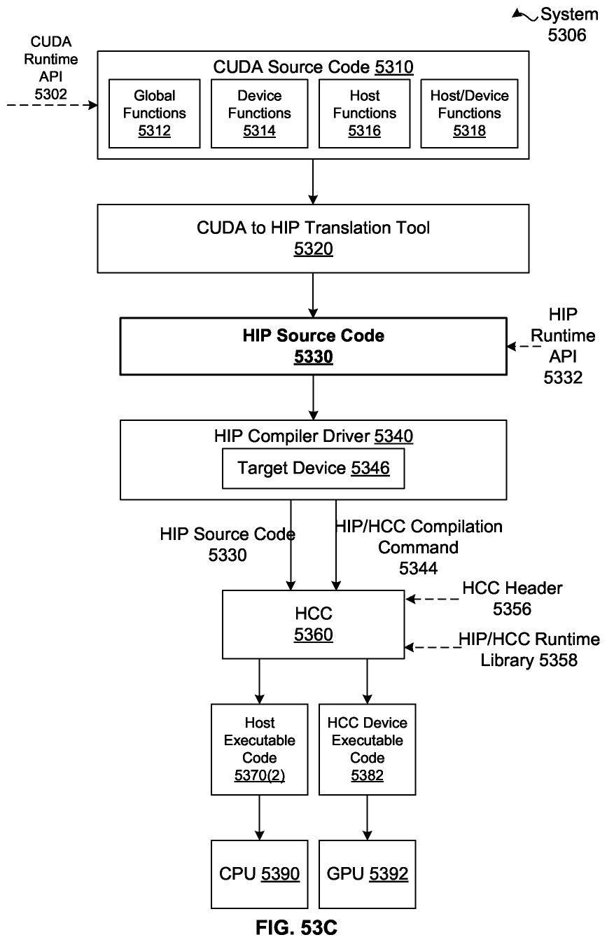

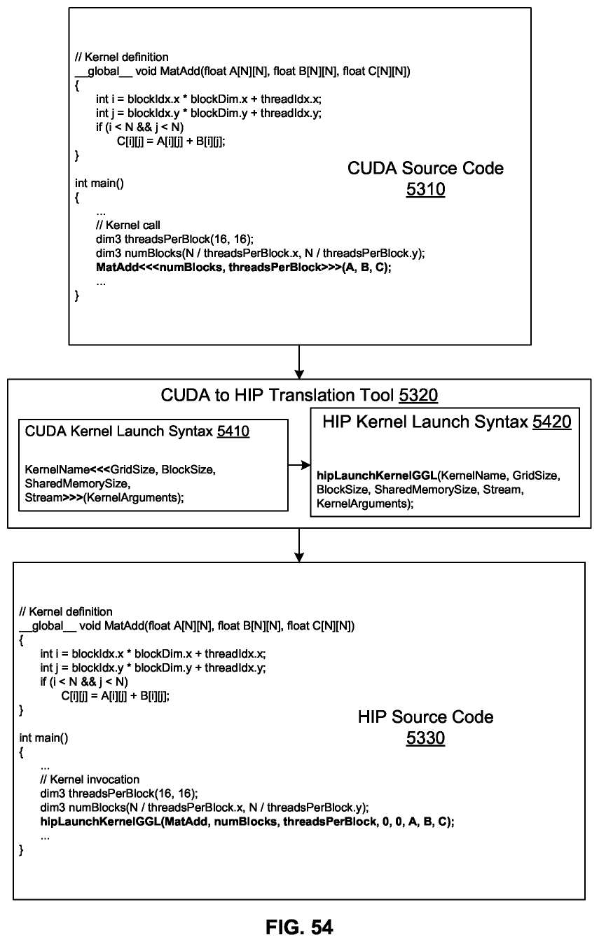

In at least one embodiment, a translation performed by translation tool 5201 is used to port source 5200 for execution in a different environment than that in which it was originally intended to run. In at least one embodiment, translation tool 5201 may include, but is not limited to, a HIP translator that is used to “hipify” CUDA code intended for a CUDA platform into HIP code that can be compiled and executed on a ROCm platform. In at least one embodiment, translation of source code 5200 may include parsing source code 5200 and converting calls to API(s) provided by one programming model (e.g., CUDA) into corresponding calls to API(s) provided by another programming model (e.g., HIP), as discussed in greater detail below in conjunction with FIGS. 53A-54. Returning to the example of hipifying CUDA code, calls to CUDA runtime API, CUDA driver API, and/or CUDA libraries may be converted to corresponding HIP API calls, in at least one embodiment. In at least one embodiment, automated translations performed by translation tool 5201 may sometimes be incomplete, requiring additional, manual effort to fully port source code 5200.

In at least one embodiment, at least one component shown or described with respect to FIG. 52 is used to perform techniques and/or functions described in connection with FIGS. 1-25. In at least one embodiment, at least one component shown or described with respect to FIG. 52 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 52 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 52 is used to perform at least one aspect described with respect to FIGS. 1-25, and/or other systems, methods, or operations described herein.

In at least one embodiment, at least one component shown or described with respect to FIG. 52 is used to perform techniques and/or functions described in connection with FIGS. 1-25. In at least one embodiment, at least one component shown or described with respect to FIG. 52 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 52 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 52 is used to perform techniques and/or functions described in connection with FIGS. 1-25. In at least one embodiment, at least one component shown or described with respect to FIG. 52 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 52 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 52 is used to perform techniques and/or functions described in connection with FIGS. 1-25. In at least one embodiment, at least one component shown or described with respect to FIG. 52 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 52 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 52 is used to perform techniques and/or functions described in connection with FIGS. 1-25. In at least one embodiment, at least one component shown or described with respect to FIG. 52 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 52 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 52 is used to perform techniques and/or functions described in connection with FIGS. 1-25. In at least one embodiment, at least one component shown or described with respect to FIG. 52 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 52 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 52 is used to perform techniques and/or functions described in connection with FIGS. 1-25. In at least one embodiment, at least one component shown or described with respect to FIG. 52 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 52 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 52 is used to perform techniques and/or functions described in connection with FIGS. 1-25. In at least one embodiment, at least one component shown or described with respect to FIG. 52 is used to perform an application programming interface (API) to cause context of one or more first software instructions to be communicated to one or more second software instructions, and/or other systems, methods, or operations described herein. In at least one embodiment, at least one component shown or described with respect to FIG. 52 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 52 is used to perform techniques and/or functions described in connection with FIGS. 1-25. In at least one embodiment, at least one component shown or described with respect to FIG. 52 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 52 is used to perform an application programming interface (API) to prevent one or more instructions from being performed by one or more resources of a first context of the processor until one or more indications of one or more events of a second context are generated, and/or other systems, methods, or operations described herein.

### Configuring GPUs for General-Purpose Computing

The following figures set forth, without limitation, exemplary architectures for compiling and executing compute source code, in accordance with at least one embodiment.

FIG. 53A illustrates a system 5300 configured to compile and execute CUDA source code 5310 using different types of processing units, in accordance with at least one embodiment. In at least one embodiment, system 5300 includes, without limitation, CUDA source code 5310, a CUDA compiler 5350, host executable code 5370(1), host executable code 5370(2), CUDA device executable code 5384, a CPU 5390, a CUDA-enabled GPU 5394, a GPU 5392, a CUDA to HIP translation tool 5320, HIP source code 5330, a HIP compiler driver 5340, an HCC 5360, and HCC device executable code 5382.

In at least one embodiment, CUDA source code 5310 is a collection of human-readable code in a CUDA programming language. In at least one embodiment, CUDA code is human-readable code in a CUDA programming language. In at least one embodiment, a CUDA programming language is an extension of the C++ programming language that includes, without limitation, mechanisms to define device code and distinguish between device code and host code. In at least one embodiment, device code is source code that, after compilation, is executable in parallel on a device. In at least one embodiment, a device may be a processor that is optimized for parallel instruction processing, such as CUDA-enabled GPU 5390, GPU 53192, or another GPGPU, etc. In at least one embodiment, host code is source code that, after compilation, is executable on a host. In at least one embodiment, a host is a processor that is optimized for sequential instruction processing, such as CPU 5390.

In at least one embodiment, CUDA source code 5310 includes, without limitation, any number (including zero) of global functions 5312, any number (including zero) of device functions 5314, any number (including zero) of host functions 5316, and any number (including zero) of host/device functions 5318. In at least one embodiment, global functions 5312, device functions 5314, host functions 5316, and host/device functions 5318 may be mixed in CUDA source code 5310. In at least one embodiment, each of global functions 5312 is executable on a device and callable from a host. In at least one embodiment, one or more of global functions 5312 may therefore act as entry points to a device. In at least one embodiment, each of global functions 5312 is a kernel. In at least one embodiment and in a technique known as dynamic parallelism, one or more of global functions 5312 defines a kernel that is executable on a device and callable from such a device. In at least one embodiment, a kernel is executed N (where N is any positive integer) times in parallel by N different threads on a device during execution.

In at least one embodiment, each of device functions 5314 is executed on a device and callable from such a device only. In at least one embodiment, each of host functions 5316 is executed on a host and callable from such a host only. In at least one embodiment, each of host/device functions 5316 defines both a host version of a function that is executable on a host and callable from such a host only and a device version of the function that is executable on a device and callable from such a device only.

In at least one embodiment, CUDA source code 5310 may also include, without limitation, any number of calls to any number of functions that are defined via a CUDA runtime API 5302. In at least one embodiment, CUDA runtime API 5302 may include, without limitation, any number of functions that execute on a host to allocate and deallocate device memory, transfer data between host memory and device memory, manage systems with multiple devices, etc. In at least one embodiment, CUDA source code 5310 may also include any number of calls to any number of functions that are specified in any number of other CUDA APIs. In at least one embodiment, a CUDA API may be any API that is designed for use by CUDA code. In at least one embodiment, CUDA APIs include, without limitation, CUDA runtime API 5302, a CUDA driver API, APIs for any number of CUDA libraries, etc. In at least one embodiment and relative to CUDA runtime API 5302, a CUDA driver API is a lower-level API but provides finer-grained control of a device. In at least one embodiment, examples of CUDA libraries include, without limitation, cuBLAS, cuFFT, cuRAND, cuDNN, etc.

In at least one embodiment, CUDA compiler 5350 compiles input CUDA code (e.g., CUDA source code 5310) to generate host executable code 5370(1) and CUDA device executable code 5384. In at least one embodiment, CUDA compiler 5350 is NVCC. In at least one embodiment, host executable code 5370(1) is a compiled version of host code included in input source code that is executable on CPU 5390. In at least one embodiment, CPU 5390 may be any processor that is optimized for sequential instruction processing.

In at least one embodiment, CUDA device executable code 5384 is a compiled version of device code included in input source code that is executable on CUDA-enabled GPU 5394. In at least one embodiment, CUDA device executable code 5384 includes, without limitation, binary code. In at least one embodiment, CUDA device executable code 5384 includes, without limitation, IR code, such as PTX code, that is further compiled at runtime into binary code for a specific target device (e.g., CUDA-enabled GPU 5394) by a device driver. In at least one embodiment, CUDA-enabled GPU 5394 may be any processor that is optimized for parallel instruction processing and that supports CUDA. In at least one embodiment, CUDA-enabled GPU 5394 is developed by NVIDIA Corporation of Santa Clara, CA.

In at least one embodiment, CUDA to HIP translation tool 5320 is configured to translate CUDA source code 5310 to functionally similar HIP source code 5330. In a least one embodiment, HIP source code 5330 is a collection of human-readable code in a HIP programming language. In at least one embodiment, HIP code is human-readable code in a HIP programming language. In at least one embodiment, a HIP programming language is an extension of the C++ programming language that includes, without limitation, functionally similar versions of CUDA mechanisms to define device code and distinguish between device code and host code. In at least one embodiment, a HIP programming language may include a subset of functionality of a CUDA programming language. In at least one embodiment, for example, a HIP programming language includes, without limitation, mechanism(s) to define global functions 5312, but such a HIP programming language may lack support for dynamic parallelism and therefore global functions 5312 defined in HIP code may be callable from a host only.

In at least one embodiment, HIP source code 5330 includes, without limitation, any number (including zero) of global functions 5312, any number (including zero) of device functions 5314, any number (including zero) of host functions 5316, and any number (including zero) of host/device functions 5318. In at least one embodiment, HIP source code 5330 may also include any number of calls to any number of functions that are specified in a HIP runtime API 5332. In at least one embodiment, HIP runtime API 5332 includes, without limitation, functionally similar versions of a subset of functions included in CUDA runtime API 5302. In at least one embodiment, HIP source code 5330 may also include any number of calls to any number of functions that are specified in any number of other HIP APIs. In at least one embodiment, a HIP API may be any API that is designed for use by HIP code and/or ROCm. In at least one embodiment, HIP APIs include, without limitation, HIP runtime API 5332, a HIP driver API, APIs for any number of HIP libraries, APIs for any number of ROCm libraries, etc.

In at least one embodiment, CUDA to HIP translation tool 5320 converts each kernel call in CUDA code from a CUDA syntax to a HIP syntax and converts any number of other CUDA calls in CUDA code to any number of other functionally similar HIP calls. In at least one embodiment, a CUDA call is a call to a function specified in a CUDA API, and a HIP call is a call to a function specified in a HIP API. In at least one embodiment, CUDA to HIP translation tool 5320 converts any number of calls to functions specified in CUDA runtime API 5302 to any number of calls to functions specified in HIP runtime API 5332.

In at least one embodiment, CUDA to HIP translation tool 5320 is a tool known as hipify-perl that executes a text-based translation process. In at least one embodiment, CUDA to HIP translation tool 5320 is a tool known as hipify-clang that, relative to hipify-perl, executes a more complex and more robust translation process that involves parsing CUDA code using clang (a compiler front-end) and then translating resulting symbols. In at least one embodiment, properly converting CUDA code to HIP code may require modifications (e.g., manual edits) in addition to those performed by CUDA to HIP translation tool 5320.

In at least one embodiment, HIP compiler driver 5340 is a front end that determines a target device 5346 and then configures a compiler that is compatible with target device 5346 to compile HIP source code 5330. In at least one embodiment, target device 5346 is a processor that is optimized for parallel instruction processing. In at least one embodiment, HIP compiler driver 5340 may determine target device 5346 in any technically feasible fashion.

In at least one embodiment, if target device 5346 is compatible with CUDA (e.g., CUDA-enabled GPU 5394), then HIP compiler driver 5340 generates a HIP/NVCC compilation command 5342. In at least one embodiment and as described in greater detail in conjunction with FIG. 53B, HIP/NVCC compilation command 5342 configures CUDA compiler 5350 to compile HIP source code 5330 using, without limitation, a HIP to CUDA translation header and a CUDA runtime library. In at least one embodiment and in response to HIP/NVCC compilation command 5342, CUDA compiler 5350 generates host executable code 5370(1) and CUDA device executable code 5384.

In at least one embodiment, if target device 5346 is not compatible with CUDA, then HIP compiler driver 5340 generates a HIP/HCC compilation command 5344. In at least one embodiment and as described in greater detail in conjunction with FIG. 53C, HIP/HCC compilation command 5344 configures HCC 5360 to compile HIP source code 5330 using, without limitation, an HCC header and a HIP/HCC runtime library. In at least one embodiment and in response to HIP/HCC compilation command 5344, HCC 5360 generates host executable code 5370(2) and HCC device executable code 5382. In at least one embodiment, HCC device executable code 5382 is a compiled version of device code included in HIP source code 5330 that is executable on GPU 5392. In at least one embodiment, GPU 5392 may be any processor that is optimized for parallel instruction processing, is not compatible with CUDA, and is compatible with HCC. In at least one embodiment, GPU 5392 is developed by AMD Corporation of Santa Clara, CA. In at least one embodiment GPU, 5392 is a non-CUDA-enabled GPU 5392.

For explanatory purposes only, three different flows that may be implemented in at least one embodiment to compile CUDA source code 5310 for execution on CPU 5390 and different devices are depicted in FIG. 53A. In at least one embodiment, a direct CUDA flow compiles CUDA source code 5310 for execution on CPU 5390 and CUDA-enabled GPU 5394 without translating CUDA source code 5310 to HIP source code 5330. In at least one embodiment, an indirect CUDA flow translates CUDA source code 5310 to HIP source code 5330 and then compiles HIP source code 5330 for execution on CPU 5390 and CUDA-enabled GPU 5394. In at least one embodiment, a CUDA/HCC flow translates CUDA source code 5310 to HIP source code 5330 and then compiles HIP source code 5330 for execution on CPU 5390 and GPU 5392.

A direct CUDA flow that may be implemented in at least one embodiment is depicted via dashed lines and a series of bubbles annotated A1-A3. In at least one embodiment and as depicted with bubble annotated A1, CUDA compiler 5350 receives CUDA source code 5310 and a CUDA compile command 5348 that configures CUDA compiler 5350 to compile CUDA source code 5310. In at least one embodiment, CUDA source code 5310 used in a direct CUDA flow is written in a CUDA programming language that is based on a programming language other than C++ (e.g., C, Fortran, Python, Java, etc.). In at least one embodiment and in response to CUDA compile command 5348, CUDA compiler 5350 generates host executable code 5370(1) and CUDA device executable code 5384 (depicted with bubble annotated A2). In at least one embodiment and as depicted with bubble annotated A3, host executable code 5370(1) and CUDA device executable code 5384 may be executed on, respectively, CPU 5390 and CUDA-enabled GPU 5394. In at least one embodiment, CUDA device executable code 5384 includes, without limitation, binary code. In at least one embodiment, CUDA device executable code 5384 includes, without limitation, PTX code and is further compiled into binary code for a specific target device at runtime.

An indirect CUDA flow that may be implemented in at least one embodiment is depicted via dotted lines and a series of bubbles annotated B1-B6. In at least one embodiment and as depicted with bubble annotated B1, CUDA to HIP translation tool 5320 receives CUDA source code 5310. In at least one embodiment and as depicted with bubble annotated B2, CUDA to HIP translation tool 5320 translates CUDA source code 5310 to HIP source code 5330. In at least one embodiment and as depicted with bubble annotated B3, HIP compiler driver 5340 receives HIP source code 5330 and determines that target device 5346 is CUDA-enabled.

In at least one embodiment and as depicted with bubble annotated B4, HIP compiler driver 5340 generates HIP/NVCC compilation command 5342 and transmits both HIP/NVCC compilation command 5342 and HIP source code 5330 to CUDA compiler 5350. In at least one embodiment and as described in greater detail in conjunction with FIG. 53B, HIP/NVCC compilation command 5342 configures CUDA compiler 5350 to compile HIP source code 5330 using, without limitation, a HIP to CUDA translation header and a CUDA runtime library. In at least one embodiment and in response to HIP/NVCC compilation command 5342, CUDA compiler 5350 generates host executable code 5370(1) and CUDA device executable code 5384 (depicted with bubble annotated B5). In at least one embodiment and as depicted with bubble annotated B6, host executable code 5370(1) and CUDA device executable code 5384 may be executed on, respectively, CPU 5390 and CUDA-enabled GPU 5394. In at least one embodiment, CUDA device executable code 5384 includes, without limitation, binary code. In at least one embodiment, CUDA device executable code 5384 includes, without limitation, PTX code and is further compiled into binary code for a specific target device at runtime.

A CUDA/HCC flow that may be implemented in at least one embodiment is depicted via solid lines and a series of bubbles annotated C₁-C₆. In at least one embodiment and as depicted with bubble annotated CI, CUDA to HIP translation tool 5320 receives CUDA source code 5310. In at least one embodiment and as depicted with bubble annotated C2, CUDA to HIP translation tool 5320 translates CUDA source code 5310 to HIP source code 5330. In at least one embodiment and as depicted with bubble annotated C3, HIP compiler driver 5340 receives HIP source code 5330 and determines that target device 5346 is not CUDA-enabled.

In at least one embodiment, HIP compiler driver 5340 generates HIP/HCC compilation command 5344 and transmits both HIP/HCC compilation command 5344 and HIP source code 5330 to HCC 5360 (depicted with bubble annotated C4). In at least one embodiment and as described in greater detail in conjunction with FIG. 53C, HIP/HCC compilation command 5344 configures HCC 5360 to compile HIP source code 5330 using, without limitation, an HCC header and a HIP/HCC runtime library. In at least one embodiment and in response to HIP/HCC compilation command 5344, HCC 5360 generates host executable code 5370(2) and HCC device executable code 5382 (depicted with bubble annotated C5). In at least one embodiment and as depicted with bubble annotated C6, host executable code 5370(2) and HCC device executable code 5382 may be executed on, respectively, CPU 5390 and GPU 5392.

In at least one embodiment, after CUDA source code 5310 is translated to HIP source code 5330, HIP compiler driver 5340 may subsequently be used to generate executable code for either CUDA-enabled GPU 5394 or GPU 5392 without re-executing CUDA to HIP translation tool 5320. In at least one embodiment, CUDA to HIP translation tool 5320 translates CUDA source code 5310 to HIP source code 5330 that is then stored in memory. In at least one embodiment, HIP compiler driver 5340 then configures HCC 5360 to generate host executable code 5370(2) and HCC device executable code 5382 based on HIP source code 5330. In at least one embodiment, HIP compiler driver 5340 subsequently configures CUDA compiler 5350 to generate host executable code 5370(1) and CUDA device executable code 5384 based on stored HIP source code 5330.

In at least one embodiment, at least one component shown or described with respect to FIG. 53A is used to perform techniques and/or functions described in connection with FIGS. 1-25. In at least one embodiment, at least one component shown or described with respect to FIG. 53A is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 53A is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 53A is used to perform at least one aspect described with respect to FIGS. 1-25, and/or other systems, methods, or operations described herein.

In at least one embodiment, at least one component shown or described with respect to FIG. 53A is used to perform techniques and/or functions described in connection with FIGS. 1-25. In at least one embodiment, at least one component shown or described with respect to FIG. 53A is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 53A is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 53A is used to perform techniques and/or functions described in connection with FIGS. 1-25. In at least one embodiment, at least one component shown or described with respect to FIG. 53A is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 53A is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 53A is used to perform techniques and/or functions described in connection with FIGS. 1-25. In at least one embodiment, at least one component shown or described with respect to FIG. 53A is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 53A is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 53A is used to perform techniques and/or functions described in connection with FIGS. 1-25. In at least one embodiment, at least one component shown or described with respect to FIG. 53A is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 53A is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 53A is used to perform techniques and/or functions described in connection with FIGS. 1-25. In at least one embodiment, at least one component shown or described with respect to FIG. 53A is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 53A is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 53A is used to perform techniques and/or functions described in connection with FIGS. 1-25. In at least one embodiment, at least one component shown or described with respect to FIG. 53A is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 53A is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 53A is used to perform techniques and/or functions described in connection with FIGS. 1-25. In at least one embodiment, at least one component shown or described with respect to FIG. 53A is used to perform an application programming interface (API) to cause context of one or more first software instructions to be communicated to one or more second software instructions, and/or other systems, methods, or operations described herein. In at least one embodiment, at least one component shown or described with respect to FIG. 53A is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 53A is used to perform techniques and/or functions described in connection with FIGS. 1-25. In at least one embodiment, at least one component shown or described with respect to FIG. 53A is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 53A is used to perform an application programming interface (API) to prevent one or more instructions from being performed by one or more resources of a first context of the processor until one or more indications of one or more events of a second context are generated, and/or other systems, methods, or operations described herein.

FIG. 53B illustrates a system 5304 configured to compile and execute CUDA source code 5310 of FIG. 53A using CPU 5390 and CUDA-enabled GPU 5394, in accordance with at least one embodiment. In at least one embodiment, system 5304 includes, without limitation, CUDA source code 5310, CUDA to HIP translation tool 5320, HIP source code 5330, HIP compiler driver 5340, CUDA compiler 5350, host executable code 5370(1), CUDA device executable code 5384, CPU 5390, and CUDA-enabled GPU 5394.

In at least one embodiment and as described previously herein in conjunction with FIG. 53A, CUDA source code 5310 includes, without limitation, any number (including zero) of global functions 5312, any number (including zero) of device functions 5314, any number (including zero) of host functions 5316, and any number (including zero) of host/device functions 5318. In at least one embodiment, CUDA source code 5310 also includes, without limitation, any number of calls to any number of functions that are specified in any number of CUDA APIs.

In at least one embodiment, CUDA to HIP translation tool 5320 translates CUDA source code 5310 to HIP source code 5330. In at least one embodiment, CUDA to HIP translation tool 5320 converts each kernel call in CUDA source code 5310 from a CUDA syntax to a HIP syntax and converts any number of other CUDA calls in CUDA source code 5310 to any number of other functionally similar HIP calls.

In at least one embodiment, HIP compiler driver 5340 determines that target device 5346 is CUDA-enabled and generates HIP/NVCC compilation command 5342. In at least one embodiment, HIP compiler driver 5340 then configures CUDA compiler 5350 via HIP/NVCC compilation command 5342 to compile HIP source code 5330. In at least one embodiment, HIP compiler driver 5340 provides access to a HIP to CUDA translation header 5352 as part of configuring CUDA compiler 5350. In at least one embodiment, HIP to CUDA translation header 5352 translates any number of mechanisms (e.g., functions) specified in any number of HIP APIs to any number of mechanisms specified in any number of CUDA APIs. In at least one embodiment, CUDA compiler 5350 uses HIP to CUDA translation header 5352 in conjunction with a CUDA runtime library 5354 corresponding to CUDA runtime API 5302 to generate host executable code 5370(1) and CUDA device executable code 5384. In at least one embodiment, host executable code 5370(1) and CUDA device executable code 5384 may then be executed on, respectively, CPU 5390 and CUDA-enabled GPU 5394. In at least one embodiment, CUDA device executable code 5384 includes, without limitation, binary code. In at least one embodiment, CUDA device executable code 5384 includes, without limitation, PTX code and is further compiled into binary code for a specific target device at runtime.

In at least one embodiment, at least one component shown or described with respect to FIG. 53B is used to perform techniques and/or functions described in connection with FIGS. 1-25. In at least one embodiment, at least one component shown or described with respect to FIG. 53B is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 53B is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 53B is used to perform at least one aspect described with respect to FIGS. 1-25, and/or other systems, methods, or operations described herein.

In at least one embodiment, at least one component shown or described with respect to FIG. 53B is used to perform techniques and/or functions described in connection with FIGS. 1-25. In at least one embodiment, at least one component shown or described with respect to FIG. 53B is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 53B is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 53B is used to perform techniques and/or functions described in connection with FIGS. 1-25. In at least one embodiment, at least one component shown or described with respect to FIG. 53B is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 53B is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 53B is used to perform techniques and/or functions described in connection with FIGS. 1-25. In at least one embodiment, at least one component shown or described with respect to FIG. 53B is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 53B is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 53B is used to perform techniques and/or functions described in connection with FIGS. 1-25. In at least one embodiment, at least one component shown or described with respect to FIG. 53B is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 53B is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 53B is used to perform techniques and/or functions described in connection with FIGS. 1-25. In at least one embodiment, at least one component shown or described with respect to FIG. 53B is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 53B is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 53B is used to perform techniques and/or functions described in connection with FIGS. 1-25. In at least one embodiment, at least one component shown or described with respect to FIG. 53B is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 53B is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 53B is used to perform techniques and/or functions described in connection with FIGS. 1-25. In at least one embodiment, at least one component shown or described with respect to FIG. 53B is used to perform an application programming interface (API) to cause context of one or more first software instructions to be communicated to one or more second software instructions, and/or other systems, methods, or operations described herein. In at least one embodiment, at least one component shown or described with respect to FIG. 53B is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 53B is used to perform techniques and/or functions described in connection with FIGS. 1-25. In at least one embodiment, at least one component shown or described with respect to FIG. 53B is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 53B is used to perform an application programming interface (API) to prevent one or more instructions from being performed by one or more resources of a first context of the processor until one or more indications of one or more events of a second context are generated, and/or other systems, methods, or operations described herein.

FIG. 53C illustrates a system 5306 configured to compile and execute CUDA source code 5310 of FIG. 53A using CPU 5390 and non-CUDA-enabled GPU 5392, in accordance with at least one embodiment. In at least one embodiment, system 5306 includes, without limitation, CUDA source code 5310, CUDA to HIP translation tool 5320, HIP source code 5330, HIP compiler driver 5340, HCC 5360, host executable code 5370(2), HCC device executable code 5382, CPU 5390, and GPU 5392.

In at least one embodiment and as described previously herein in conjunction with FIG. 53A, CUDA source code 5310 includes, without limitation, any number (including zero) of global functions 5312, any number (including zero) of device functions 5314, any number (including zero) of host functions 5316, and any number (including zero) of host/device functions 5318. In at least one embodiment, CUDA source code 5310 also includes, without limitation, any number of calls to any number of functions that are specified in any number of CUDA APIs.

In at least one embodiment, CUDA to HIP translation tool 5320 translates CUDA source code 5310 to HIP source code 5330. In at least one embodiment, CUDA to HIP translation tool 5320 converts each kernel call in CUDA source code 5310 from a CUDA syntax to a HIP syntax and converts any number of other CUDA calls in source code 5310 to any number of other functionally similar HIP calls.

In at least one embodiment, HIP compiler driver 5340 subsequently determines that target device 5346 is not CUDA-enabled and generates HIP/HCC compilation command 5344. In at least one embodiment, HIP compiler driver 5340 then configures HCC 5360 to execute HIP/HCC compilation command 5344 to compile HIP source code 5330. In at least one embodiment, HIP/HCC compilation command 5344 configures HCC 5360 to use, without limitation, a HIP/HCC runtime library 5358 and an HCC header 5356 to generate host executable code 5370(2) and HCC device executable code 5382. In at least one embodiment, HIP/HCC runtime library 5358 corresponds to HIP runtime API 5332. In at least one embodiment, HCC header 5356 includes, without limitation, any number and type of interoperability mechanisms for HIP and HCC. In at least one embodiment, host executable code 5370(2) and HCC device executable code 5382 may be executed on, respectively, CPU 5390 and GPU 5392.

In at least one embodiment, at least one component shown or described with respect to FIG. 53C is used to perform techniques and/or functions described in connection with FIGS. 1-25. In at least one embodiment, at least one component shown or described with respect to FIG. 53C is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 53C is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 53C is used to perform at least one aspect described with respect to FIGS. 1-25, and/or other systems, methods, or operations described herein.

In at least one embodiment, at least one component shown or described with respect to FIG. 53C is used to perform techniques and/or functions described in connection with FIGS. 1-25. In at least one embodiment, at least one component shown or described with respect to FIG. 53C is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 53C is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 53C is used to perform techniques and/or functions described in connection with FIGS. 1-25. In at least one embodiment, at least one component shown or described with respect to FIG. 53C is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 53C is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 53C is used to perform techniques and/or functions described in connection with FIGS. 1-25. In at least one embodiment, at least one component shown or described with respect to FIG. 53C is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 53C is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 53C is used to perform techniques and/or functions described in connection with FIGS. 1-25. In at least one embodiment, at least one component shown or described with respect to FIG. 53C is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 53C is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 53C is used to perform techniques and/or functions described in connection with FIGS. 1-25. In at least one embodiment, at least one component shown or described with respect to FIG. 53C is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 53C is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 53C is used to perform techniques and/or functions described in connection with FIGS. 1-25. In at least one embodiment, at least one component shown or described with respect to FIG. 53C is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 53C is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 53C is used to perform techniques and/or functions described in connection with FIGS. 1-25. In at least one embodiment, at least one component shown or described with respect to FIG. 53C is used to perform an application programming interface (API) to cause context of one or more first software instructions to be communicated to one or more second software instructions, and/or other systems, methods, or operations described herein. In at least one embodiment, at least one component shown or described with respect to FIG. 53C is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 53C is used to perform techniques and/or functions described in connection with FIGS. 1-25. In at least one embodiment, at least one component shown or described with respect to FIG. 53C is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 53C is used to perform an application programming interface (API) to prevent one or more instructions from being performed by one or more resources of a first context of the processor until one or more indications of one or more events of a second context are generated, and/or other systems, methods, or operations described herein.

FIG. 54 illustrates an exemplary kernel translated by CUDA-to-HIP translation tool 5320 of FIG. 53C, in accordance with at least one embodiment. In at least one embodiment, CUDA source code 5310 partitions an overall problem that a given kernel is designed to solve into relatively coarse sub-problems that can independently be solved using thread blocks. In at least one embodiment, each thread block includes, without limitation, any number of threads. In at least one embodiment, each sub-problem is partitioned into relatively fine pieces that can be solved cooperatively in parallel by threads within a thread block. In at least one embodiment, threads within a thread block can cooperate by sharing data through shared memory and by synchronizing execution to coordinate memory accesses.

In at least one embodiment, CUDA source code 5310 organizes thread blocks associated with a given kernel into a one-dimensional, a two-dimensional, or a three-dimensional grid of thread blocks. In at least one embodiment, each thread block includes, without limitation, any number of threads, and a grid includes, without limitation, any number of thread blocks.

In at least one embodiment, a kernel is a function in device code that is defined using a “_global_” declaration specifier. In at least one embodiment, the dimension of a grid that executes a kernel for a given kernel call and associated streams are specified using a CUDA kernel launch syntax 5410. In at least one embodiment, CUDA kernel launch syntax 5410 is specified as “KernelName<<<GridSize, BlockSize, SharedMemorySize, Stream>>>(KernelArguments);”. In at least one embodiment, an execution configuration syntax is a “<<< . . . >>>” construct that is inserted between a kernel name (“KernelName”) and a parenthesized list of kernel arguments (“KernelArguments”). In at least one embodiment, CUDA kernel launch syntax 5410 includes, without limitation, a CUDA launch function syntax instead of an execution configuration syntax.

In at least one embodiment, “GridSize” is of a type dim3 and specifies the dimension and size of a grid. In at least one embodiment, type dim3 is a CUDA-defined structure that includes, without limitation, unsigned integers x, y, and z. In at least one embodiment, if z is not specified, then z defaults to one. In at least one embodiment, if y is not specified, then y defaults to one. In at least one embodiment, the number of thread blocks in a grid is equal to the product of GridSize.x, GridSize.y, and GridSize.z. In at least one embodiment, “BlockSize” is of type dim3 and specifies the dimension and size of each thread block. In at least one embodiment, the number of threads per thread block is equal to the product of BlockSize.x, BlockSize.y, and BlockSize.z. In at least one embodiment, each thread that executes a kernel is given a unique thread ID that is accessible within the kernel through a built-in variable (e.g., “threadIdx”).

In at least one embodiment and with respect to CUDA kernel launch syntax 5410, “SharedMemorySize” is an optional argument that specifies a number of bytes in a shared memory that is dynamically allocated per thread block for a given kernel call in addition to statically allocated memory. In at least one embodiment and with respect to CUDA kernel launch syntax 5410, SharedMemorySize defaults to zero. In at least one embodiment and with respect to CUDA kernel launch syntax 5410, “Stream” is an optional argument that specifies an associated stream and defaults to zero to specify a default stream. In at least one embodiment, a stream is a sequence of commands (possibly issued by different host threads) that execute in order. In at least one embodiment, different streams may execute commands out of order with respect to one another or concurrently.

In at least one embodiment, CUDA source code 5310 includes, without limitation, a kernel definition for an exemplary kernel “MatAdd” and a main function. In at least one embodiment, main function is host code that executes on a host and includes, without limitation, a kernel call that causes kernel MatAdd to execute on a device. In at least one embodiment and as shown, kernel MatAdd adds two matrices A and B of size N×N, where N is a positive integer, and stores the result in a matrix C. In at least one embodiment, main function defines a threadsPerBlock variable as 16 by 16 and a numBlocks variable as N/16 by N/16. In at least one embodiment, main function then specifies kernel call “MatAdd<<<numBlocks, threadsPerBlock>>>(A, B, C);”. In at least one embodiment and as per CUDA kernel launch syntax 5410, kernel MatAdd is executed using a grid of thread blocks having a dimension N/16 by N/16, where each thread block has a dimension of 16 by 16. In at least one embodiment, each thread block includes 256 threads, a grid is created with enough blocks to have one thread per matrix element, and each thread in such a grid executes kernel MatAdd to perform one pair-wise addition.

In at least one embodiment, while translating CUDA source code 5310 to HIP source code 5330, CUDA to HIP translation tool 5320 translates each kernel call in CUDA source code 5310 from CUDA kernel launch syntax 5410 to a HIP kernel launch syntax 5420 and converts any number of other CUDA calls in source code 5310 to any number of other functionally similar HIP calls. In at least one embodiment, HIP kernel launch syntax 5420 is specified as “hipLaunchKernelGGL(KernelName, GridSize, BlockSize, SharedMemorySize, Stream, KernelArguments);”. In at least one embodiment, each of KernelName, GridSize, BlockSize, ShareMemorySize, Stream, and KernelArguments has the same meaning in HIP kernel launch syntax 5420 as in CUDA kernel launch syntax 5410 (described previously herein). In at least one embodiment, arguments SharedMemorySize and Stream are required in HIP kernel launch syntax 5420 and are optional in CUDA kernel launch syntax 5410.

In at least one embodiment, a portion of HIP source code 5330 depicted in FIG. 54 is identical to a portion of CUDA source code 5310 depicted in FIG. 54 except for a kernel call that causes kernel MatAdd to execute on a device. In at least one embodiment, kernel MatAdd is defined in HIP source code 5330 with the same “_global_” declaration specifier with which kernel MatAdd is defined in CUDA source code 5310. In at least one embodiment, a kernel call in HIP source code 5330 is “hipLaunchKernelGGL (MatAdd, numBlocks, threadsPerBlock, 0, 0, A, B, C);”, while a corresponding kernel call in CUDA source code 5310 is “MatAdd<<<numBlocks, threadsPerBlock>>>(A, B, C);”.

In at least one embodiment, at least one component shown or described with respect to FIG. 54 is used to perform techniques and/or functions described in connection with FIGS. 1-25. In at least one embodiment, at least one component shown or described with respect to FIG. 54 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 54 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 54 is used to perform at least one aspect described with respect to FIGS. 1-25, and/or other systems, methods, or operations described herein.

In at least one embodiment, at least one component shown or described with respect to FIG. 54 is used to perform techniques and/or functions described in connection with FIGS. 1-25. In at least one embodiment, at least one component shown or described with respect to FIG. 54 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 54 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 54 is used to perform techniques and/or functions described in connection with FIGS. 1-25. In at least one embodiment, at least one component shown or described with respect to FIG. 54 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 54 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 54 is used to perform techniques and/or functions described in connection with FIGS. 1-25. In at least one embodiment, at least one component shown or described with respect to FIG. 54 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 54 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 54 is used to perform techniques and/or functions described in connection with FIGS. 1-25. In at least one embodiment, at least one component shown or described with respect to FIG. 54 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 54 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 54 is used to perform techniques and/or functions described in connection with FIGS. 1-25. In at least one embodiment, at least one component shown or described with respect to FIG. 54 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 54 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 54 is used to perform techniques and/or functions described in connection with FIGS. 1-25. In at least one embodiment, at least one component shown or described with respect to FIG. 54 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 54 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 54 is used to perform techniques and/or functions described in connection with FIGS. 1-25. In at least one embodiment, at least one component shown or described with respect to FIG. 54 is used to perform an application programming interface (API) to cause context of one or more first software instructions to be communicated to one or more second software instructions, and/or other systems, methods, or operations described herein. In at least one embodiment, at least one component shown or described with respect to FIG. 54 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 54 is used to perform techniques and/or functions described in connection with FIGS. 1-25. In at least one embodiment, at least one component shown or described with respect to FIG. 54 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 54 is used to perform an application programming interface (API) to prevent one or more instructions from being performed by one or more resources of a first context of the processor until one or more indications of one or more events of a second context are generated, and/or other systems, methods, or operations described herein.

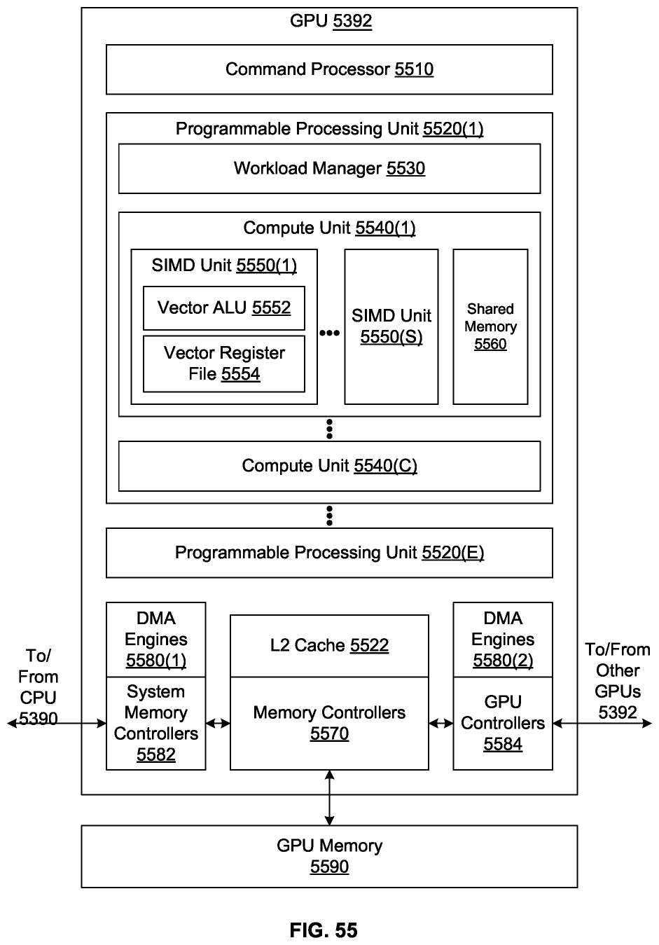

FIG. 55 illustrates non-CUDA-enabled GPU 5392 of FIG. 53C in greater detail, in accordance with at least one embodiment. In at least one embodiment, GPU 5392 is developed by AMD corporation of Santa Clara. In at least one embodiment, GPU 5392 can be configured to perform compute operations in a highly-parallel fashion. In at least one embodiment, GPU 5392 is configured to execute graphics pipeline operations such as draw commands, pixel operations, geometric computations, and other operations associated with rendering an image to a display. In at least one embodiment, GPU 5392 is configured to execute operations unrelated to graphics. In at least one embodiment, GPU 5392 is configured to execute both operations related to graphics and operations unrelated to graphics. In at least one embodiment, GPU 5392 can be configured to execute device code included in HIP source code 5330.

In at least one embodiment, GPU 5392 includes, without limitation, any number of programmable processing units 5520, a command processor 5510, an L2 cache 5522, memory controllers 5570, DMA engines 5580(1), system memory controllers 5582, DMA engines 5580(2), and GPU controllers 5584. In at least one embodiment, each programmable processing unit 5520 includes, without limitation, a workload manager 5530 and any number of compute units 5540. In at least one embodiment, command processor 5510 reads commands from one or more command queues (not shown) and distributes commands to workload managers 5530. In at least one embodiment, for each programmable processing unit 5520, associated workload manager 5530 distributes work to compute units 5540 included in programmable processing unit 5520. In at least one embodiment, each compute unit 5540 may execute any number of thread blocks, but each thread block executes on a single compute unit 5540. In at least one embodiment, a workgroup is a thread block.

In at least one embodiment, each compute unit 5540 includes, without limitation, any number of SIMD units 5550 and a shared memory 5560. In at least one embodiment, each SIMD unit 5550 implements a SIMD architecture and is configured to perform operations in parallel. In at least one embodiment, each SIMD unit 5550 includes, without limitation, a vector ALU 5552 and a vector register file 5554. In at least one embodiment, each SIMD unit 5550 executes a different warp. In at least one embodiment, a warp is a group of threads (e.g., 16 threads), where each thread in the warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 5560. In at least one embodiment, compute unit 5540 includes one or more distributed shared memories (or distributed shared memory) that enable direct streaming multiprocessor (SM) to streaming multiple processor (SM) for operations related to loading, storing, and performing atomics across multiple SM shared memory blocks. compute unit 5540 includes one or more cluster distributed shared memories (DSMEM), which are blocks of memory within a cluster that enabled to access each other's shared memory directly.

In at least one embodiment, programmable processing units 5520 are referred to as “shader engines.” In at least one embodiment, each programmable processing unit 5520 includes, without limitation, any amount of dedicated graphics hardware in addition to compute units 5540. In at least one embodiment, each programmable processing unit 5520 includes, without limitation, any number (including zero) of geometry processors, any number (including zero) of rasterizers, any number (including zero) of render back ends, workload manager 5530, and any number of compute units 5540.

In at least one embodiment, compute units 5540 share L2 cache 5522. In at least one embodiment, L2 cache 5522 is partitioned. In at least one embodiment, a GPU memory 5590 is accessible by all compute units 5540 in GPU 5392. In at least one embodiment, memory controllers 5570 and system memory controllers 5582 facilitate data transfers between GPU 5392 and a host, and DMA engines 5580(1) enable asynchronous memory transfers between GPU 5392 and such a host. In at least one embodiment, memory controllers 5570 and GPU controllers 5584 facilitate data transfers between GPU 5392 and other GPUs 5392, and DMA engines 5580(2) enable asynchronous memory transfers between GPU 5392 and other GPUs 5392.

In at least one embodiment, GPU 5392 includes, without limitation, any amount and type of system interconnect that facilitates data and control transmissions across any number and type of directly or indirectly linked components that may be internal or external to GPU 5392. In at least one embodiment, GPU 5392 includes, without limitation, any number and type of I/O interfaces (e.g., PCIe) that are coupled to any number and type of peripheral devices. In at least one embodiment, GPU 5392 may include, without limitation, any number (including zero) of display engines and any number (including zero) of multimedia engines. In at least one embodiment, GPU 5392 implements a memory subsystem that includes, without limitation, any amount and type of memory controllers (e.g., memory controllers 5570 and system memory controllers 5582) and memory devices (e.g., shared memories 5560) that may be dedicated to one component or shared among multiple components. In at least one embodiment, GPU 5392 implements a cache subsystem that includes, without limitation, one or more cache memories (e.g., L2 cache 5522) that may each be private to or shared between any number of components (e.g., SIMD units 5550, compute units 5540, and programmable processing units 5520).

In at least one embodiment, at least one component shown or described with respect to FIG. 55 is used to perform techniques and/or functions described in connection with FIGS. 1-25. In at least one embodiment, at least one component shown or described with respect to FIG. 55 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 55 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 55 is used to perform at least one aspect described with respect to FIGS. 1-25, and/or other systems, methods, or operations described herein.

In at least one embodiment, at least one component shown or described with respect to FIG. 55 is used to perform techniques and/or functions described in connection with FIGS. 1-25. In at least one embodiment, at least one component shown or described with respect to FIG. 55 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 55 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 55 is used to perform techniques and/or functions described in connection with FIGS. 1-25. In at least one embodiment, at least one component shown or described with respect to FIG. 55 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 55 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 55 is used to perform techniques and/or functions described in connection with FIGS. 1-25. In at least one embodiment, at least one component shown or described with respect to FIG. 55 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 55 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 55 is used to perform techniques and/or functions described in connection with FIGS. 1-25. In at least one embodiment, at least one component shown or described with respect to FIG. 55 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 55 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 55 is used to perform techniques and/or functions described in connection with FIGS. 1-25. In at least one embodiment, at least one component shown or described with respect to FIG. 55 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 55 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 55 is used to perform techniques and/or functions described in connection with FIGS. 1-25. In at least one embodiment, at least one component shown or described with respect to FIG. 55 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 55 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 55 is used to perform techniques and/or functions described in connection with FIGS. 1-25. In at least one embodiment, at least one component shown or described with respect to FIG. 55 is used to perform an application programming interface (API) to cause context of one or more first software instructions to be communicated to one or more second software instructions, and/or other systems, methods, or operations described herein. In at least one embodiment, at least one component shown or described with respect to FIG. 55 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 55 is used to perform techniques and/or functions described in connection with FIGS. 1-25. In at least one embodiment, at least one component shown or described with respect to FIG. 55 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 55 is used to perform an application programming interface (API) to prevent one or more instructions from being performed by one or more resources of a first context of the processor until one or more indications of one or more events of a second context are generated, and/or other systems, methods, or operations described herein.

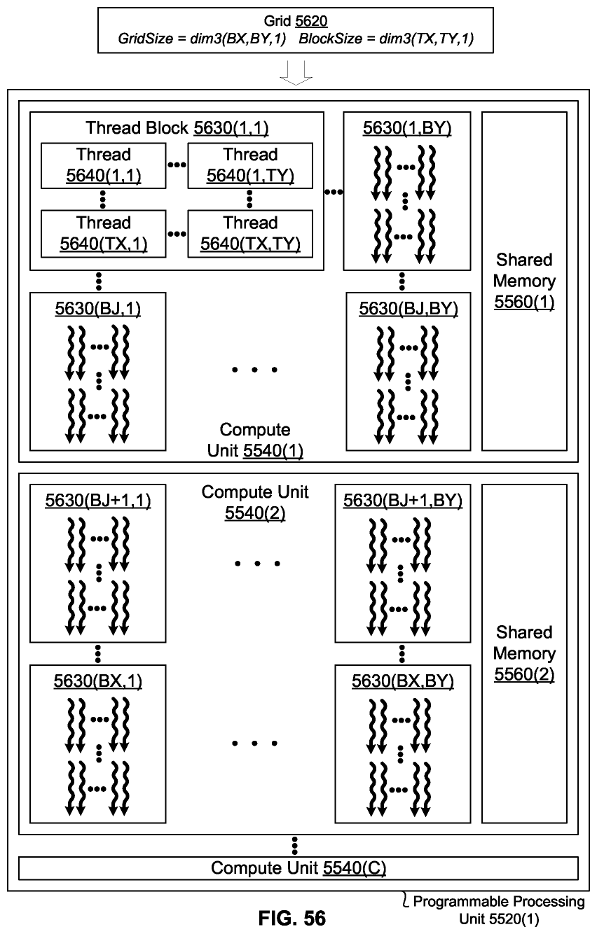

FIG. 56 illustrates how threads of an exemplary CUDA grid 5620 are mapped to different compute units 5540 of FIG. 55, in accordance with at least one embodiment. In at least one embodiment and for explanatory purposes only, grid 5620 has a GridSize of BX by BY by 1 and a BlockSize of TX by TY by 1. In at least one embodiment, grid 5620 therefore includes, without limitation, (BX*BY) thread blocks 5630 and each thread block 5630 includes, without limitation, (TX*TY) threads 5640. Threads 5640 are depicted in FIG. 56 as squiggly arrows.

In at least one embodiment, grid 5620 is mapped to programmable processing unit 5520(1) that includes, without limitation, compute units 5540(1)-5540(C). In at least one embodiment and as shown, (BJ*BY) thread blocks 5630 are mapped to compute unit 5540(1), and the remaining thread blocks 5630 are mapped to compute unit 5540(2). In at least one embodiment, each thread block 5630 may include, without limitation, any number of warps, and each warp is mapped to a different SIMD unit 5550 of FIG. 55.

In at least one embodiment, warps in a given thread block 5630 may synchronize together and communicate through shared memory 5560 included in associated compute unit 5540. For example and in at least one embodiment, warps in thread block 5630(BJ,1) can synchronize together and communicate through shared memory 5560(1). For example and in at least one embodiment, warps in thread block 5630(BJ+1,1) can synchronize together and communicate through shared memory 5560(2).

In at least one embodiment, at least one component shown or described with respect to FIG. 56 is used to perform techniques and/or functions described in connection with FIGS. 1-25. In at least one embodiment, at least one component shown or described with respect to FIG. 56 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 56 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 56 is used to perform at least one aspect described with respect to FIGS. 1-25, and/or other systems, methods, or operations described herein.

In at least one embodiment, at least one component shown or described with respect to FIG. 56 is used to perform techniques and/or functions described in connection with FIGS. 1-25. In at least one embodiment, at least one component shown or described with respect to FIG. 56 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 56 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 56 is used to perform techniques and/or functions described in connection with FIGS. 1-25. In at least one embodiment, at least one component shown or described with respect to FIG. 56 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 56 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 56 is used to perform techniques and/or functions described in connection with FIGS. 1-25. In at least one embodiment, at least one component shown or described with respect to FIG. 56 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 56 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 56 is used to perform techniques and/or functions described in connection with FIGS. 1-25. In at least one embodiment, at least one component shown or described with respect to FIG. 56 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 56 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 56 is used to perform techniques and/or functions described in connection with FIGS. 1-25. In at least one embodiment, at least one component shown or described with respect to FIG. 56 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 56 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 56 is used to perform techniques and/or functions described in connection with FIGS. 1-25. In at least one embodiment, at least one component shown or described with respect to FIG. 56 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 56 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 56 is used to perform techniques and/or functions described in connection with FIGS. 1-25. In at least one embodiment, at least one component shown or described with respect to FIG. 56 is used to perform an application programming interface (API) to cause context of one or more first software instructions to be communicated to one or more second software instructions, and/or other systems, methods, or operations described herein. In at least one embodiment, at least one component shown or described with respect to FIG. 56 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 56 is used to perform techniques and/or functions described in connection with FIGS. 1-25. In at least one embodiment, at least one component shown or described with respect to FIG. 56 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 56 is used to perform an application programming interface (API) to prevent one or more instructions from being performed by one or more resources of a first context of the processor until one or more indications of one or more events of a second context are generated, and/or other systems, methods, or operations described herein.

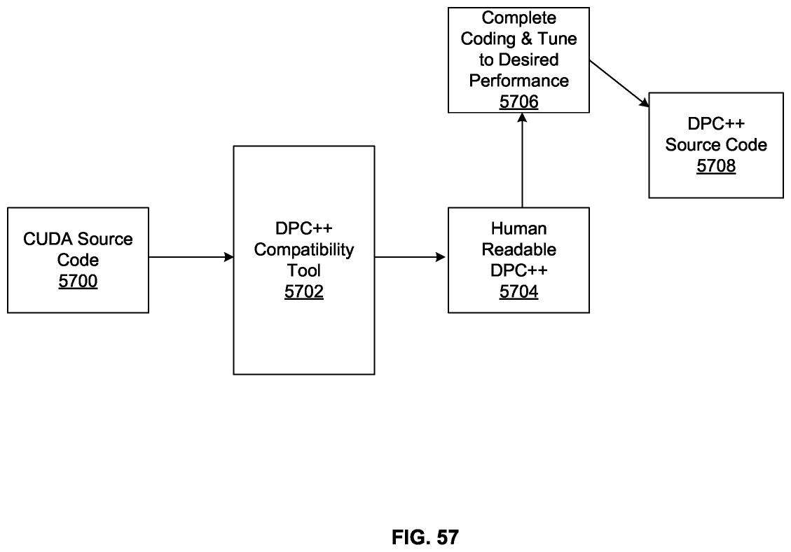

FIG. 57 illustrates how to migrate existing CUDA code to Data Parallel C++ code, in accordance with at least one embodiment. Data Parallel C++ (DPC++) may refer to an open, standards-based alternative to single-architecture proprietary languages that allows developers to reuse code across hardware targets (CPUs and accelerators such as GPUs and FPGAs) and also perform custom tuning for a specific accelerator. DPC++ use similar and/or identical C and C++ constructs in accordance with ISO C++ which developers may be familiar with. DPC++ incorporates standard SYCL from The Khronos Group to support data parallelism and heterogeneous programming. SYCL refers to a cross-platform abstraction layer that builds on underlying concepts, portability and efficiency of OpenCL that enables code for heterogeneous processors to be written in a “single-source” style using standard C++. SYCL may enable single source development where C++ template functions can contain both host and device code to construct complex algorithms that use OpenCL acceleration, and then re-use them throughout their source code on different types of data.

In at least one embodiment, a DPC++ compiler is used to compile DPC++ source code which can be deployed across diverse hardware targets. In at least one embodiment, a DPC++ compiler is used to generate DPC++ applications that can be deployed across diverse hardware targets and a DPC++ compatibility tool can be used to migrate CUDA applications to a multiplatform program in DPC++. In at least one embodiment, a DPC++ base tool kit includes a DPC++ compiler to deploy applications across diverse hardware targets; a DPC++ library to increase productivity and performance across CPUs, GPUs, and FPGAs; a DPC++ compatibility tool to migrate CUDA applications to multi-platform applications; and any suitable combination thereof.

In at least one embodiment, a DPC++ programming model is utilized to simply one or more aspects relating to programming CPUs and accelerators by using modern C++ features to express parallelism with a programming language called Data Parallel C++. DPC++ programming language may be utilized to code reuse for hosts (e.g., a CPU) and accelerators (e.g., a GPU or FPGA) using a single source language, with execution and memory dependencies being clearly communicated. Mappings within DPC++ code can be used to transition an application to run on a hardware or set of hardware devices that best accelerates a workload. A host may be available to simplify development and debugging of device code, even on platforms that do not have an accelerator available.

In at least one embodiment, CUDA source code 5700 is provided as an input to a DPC++ compatibility tool 5702 to generate human readable DPC++ 5704. In at least one embodiment, human readable DPC++ 5704 includes inline comments generated by DPC++ compatibility tool 5702 that guides a developer on how and/or where to modify DPC++ code to complete coding and tuning to desired performance 5706, thereby generating DPC++ source code 5708.

In at least one embodiment, CUDA source code 5700 is or includes a collection of human-readable source code in a CUDA programming language. In at least one embodiment, CUDA source code 5700 is human-readable source code in a CUDA programming language. In at least one embodiment, a CUDA programming language is an extension of the C++ programming language that includes, without limitation, mechanisms to define device code and distinguish between device code and host code. In at least one embodiment, device code is source code that, after compilation, is executable on a device (e.g., GPU or FPGA) and may include or more parallelizable workflows that can be executed on one or more processor cores of a device. In at least one embodiment, a device may be a processor that is optimized for parallel instruction processing, such as CUDA-enabled GPU, GPU, or another GPGPU, etc. In at least one embodiment, host code is source code that, after compilation, is executable on a host. In least one embodiment, some or all of host code and device code can be executed in parallel across a CPU and GPU/FPGA. In at least one embodiment, a host is a processor that is optimized for sequential instruction processing, such as CPU. CUDA source code 5700 described in connection with FIG. 57 may be in accordance with those discussed elsewhere in this document.

In at least one embodiment, DPC++ compatibility tool 5702 refers to an executable tool, program, application, or any other suitable type of tool that is used to facilitate migration of CUDA source code 5700 to DPC++ source code 5708. In at least one embodiment, DPC++ compatibility tool 5702 is a command-line-based code migration tool available as part of a DPC++ tool kit that is used to port existing CUDA sources to DPC++. In at least one embodiment, DPC++ compatibility tool 5702 converts some or all source code of a CUDA application from CUDA to DPC++ and generates a resulting file that is written at least partially in DPC++, referred to as human readable DPC++ 5704. In at least one embodiment, human readable DPC++ 5704 includes comments that are generated by DPC++ compatibility tool 5702 to indicate where user intervention may be necessary. In at least one embodiment, user intervention is necessary when CUDA source code 5700 calls a CUDA API that has no analogous DPC++ API; other examples where user intervention is required are discussed later in greater detail.

In at least one embodiment, a workflow for migrating CUDA source code 5700 (e.g., application or portion thereof) includes creating one or more compilation database files; migrating CUDA to DPC++ using a DPC++ compatibility tool 5702; completing migration and verifying correctness, thereby generating DPC++ source code 5708; and compiling DPC++ source code 5708 with a DPC++ compiler to generate a DPC++ application. In at least one embodiment, a compatibility tool provides a utility that intercepts commands used when Makefile executes and stores them in a compilation database file. In at least one embodiment, a file is stored in JSON format. In at least one embodiment, an intercept-built command converts Makefile command to a DPC compatibility command.

In at least one embodiment, intercept-build is a utility script that intercepts a build process to capture compilation options, macro defs, and include paths, and writes this data to a compilation database file. In at least one embodiment, a compilation database file is a JSON file. In at least one embodiment, DPC++ compatibility tool 5702 parses a compilation database and applies options when migrating input sources. In at least one embodiment, use of intercept-build is optional, but highly recommended for Make or CMake based environments. In at least one embodiment, a migration database includes commands, directories, and files: command may include necessary compilation flags; directory may include paths to header files; file may include paths to CUDA files.

In at least one embodiment, DPC++ compatibility tool 5702 migrates CUDA code (e.g., applications) written in CUDA to DPC++ by generating DPC++ wherever possible. In at least one embodiment, DPC++ compatibility tool 5702 is available as part of a tool kit. In at least one embodiment, a DPC++ tool kit includes an intercept-build tool. In at least one embodiment, an intercept-built tool creates a compilation database that captures compilation commands to migrate CUDA files. In at least one embodiment, a compilation database generated by an intercept-built tool is used by DPC++ compatibility tool 5702 to migrate CUDA code to DPC++. In at least one embodiment, non-CUDA C++ code and files are migrated as is. In at least one embodiment, DPC++ compatibility tool 5702 generates human readable DPC++ 5704 which may be DPC++ code that, as generated by DPC++ compatibility tool 5702, cannot be compiled by DPC++ compiler and requires additional plumbing for verifying portions of code that were not migrated correctly, and may involve manual intervention, such as by a developer. In at least one embodiment, DPC++ compatibility tool 5702 provides hints or tools embedded in code to help developers manually migrate additional code that could not be migrated automatically. In at least one embodiment, migration is a one-time activity for a source file, project, or application.

In at least one embodiment, DPC++ compatibility tool 57002 is able to successfully migrate all portions of CUDA code to DPC++ and there may simply be an optional step for manually verifying and tuning performance of DPC++ source code that was generated. In at least one embodiment, DPC++ compatibility tool 5702 directly generates DPC++ source code 5708 which is compiled by a DPC++ compiler without requiring or utilizing human intervention to modify DPC++ code generated by DPC++ compatibility tool 5702. In at least one embodiment, DPC++ compatibility tool generates compile-able DPC++ code which can be optionally tuned by a developer for performance, readability, maintainability, other various considerations; or any combination thereof.

In at least one embodiment, one or more CUDA source files are migrated to DPC++ source files at least partially using DPC++ compatibility tool 5702. In at least one embodiment, CUDA source code includes one or more header files which may include CUDA header files. In at least one embodiment, a CUDA source file includes a <cuda.h> header file and a <stdio.h> header file which can be used to print text. In at least one embodiment, a portion of a vector addition kernel CUDA source file may be written as or related to:

```
#include <cuda.h>
#include <stdio.h>
#define VECTOR_SIZE 256
[ ] global_{——} void VectorAddKernel(float* A, float* B, float* C)
{
  A[threadIdx.x] = threadIdx.x + 1.0f;
  B[threadIdx.x] = threadIdx.x + 1.0f;
  C[threadIdx.x] = A[threadIdx.x] + B[threadIdx.x];
}
int main( )
{
  float *d_A, *d_B, *d_C;
  cudaMalloc(&d_A, VECTOR_SIZE*sizeof(float));
  cudaMalloc(&d_B, VECTOR_SIZE*sizeof(float));
  cudaMalloc(&d_C, VECTOR_SIZE*sizeof(float));
  VectorAddKernel<<<1, VECTOR_SIZE>>>(d_A, d_B, d_C);
  float Result[VECTOR_SIZE] = { };
  cudaMemcpy(Result, d_C, VECTOR_SIZE*sizeof(float),
cudaMemcpyDeviceToHost);
  cudaFree(d_A);
  cudaFree(d_B);
  cudaFree(d_C);
  for (int i=0; i<VECTOR_SIZE; i++ {
    if (i % 16 == 0) {
      printf(“\n”);
    }
    printf(“%f ”, Result[i]);
  }
  return 0;
}
```

In at least one embodiment and in connection with CUDA source file presented above, DPC++ compatibility tool 5702 parses a CUDA source code and replaces header files with appropriate DPC++ and SYCL header files. In at least one embodiment, DPC++ header files includes helper declarations. In CUDA, there is a concept of a thread ID and correspondingly, in DPC++ or SYCL, for each element there is a local identifier.

In at least one embodiment and in connection with CUDA source file presented above, there are two vectors A and B which are initialized and a vector addition result is put into vector C as part of VectorAddKernel( ). In at least one embodiment, DPC++ compatibility tool 5702 converts CUDA thread IDs used to index work elements to SYCL standard addressing for work elements via a local ID as part of migrating CUDA code to DPC++ code. In at least one embodiment, DPC++ code generated by DPC++ compatibility tool 5702 can be optimized—for example, by reducing dimensionality of an nd_item, thereby increasing memory and/or processor utilization.

In at least one embodiment and in connection with CUDA source file presented above, memory allocation is migrated. In at least one embodiment, cudaMalloc( ) is migrated to a unified shared memory SYCL call malloc_device( ) to which a device and context is passed, relying on SYCL concepts such as platform, device, context, and queue. In at least one embodiment, a SYCL platform can have multiple devices (e.g., host and GPU devices); a device may have multiple queues to which jobs can be submitted; each device may have a context; and a context may have multiple devices and manage shared memory objects.

In at least one embodiment and in connection with CUDA source file presented above, a main( ) function invokes or calls VectorAddKernel( ) to add two vectors A and B together and store result in vector C. In at least one embodiment, CUDA code to invoke VectorAddKernel( ) is replaced by DPC++ code to submit a kernel to a command queue for execution. In at least one embodiment, a command group handler cgh passes data, synchronization, and computation that is submitted to the queue, parallel_for is called for a number of global elements and a number of work items in that work group where VectorAddKernel( ) is called.

In at least one embodiment and in connection with CUDA source file presented above, CUDA calls to copy device memory and then free memory for vectors A, B, and C are migrated to corresponding DPC++ calls. In at least one embodiment, C++ code (e.g., standard ISO C++ code for printing a vector of floating point variables) is migrated as is, without being modified by DPC++ compatibility tool 5702. In at least one embodiment, DPC++ compatibility tool 5702 modify CUDA APIs for memory setup and/or host calls to execute kernel on the acceleration device. In at least one embodiment and in connection with CUDA source file presented above, a corresponding human readable DPC++ 5704 (e.g., which can be compiled) is written as or related to:

#include <CL/sycl.hpp>
#include <dpct/dpct.hpp>
#define VECTOR_SIZE 256
void VectorAddKernel(float* A, float* B, float* C,

sycl::nd_item<3> item_ct1)

```
{
  A[item_ct1.get_local_id(2)] = item_ct1.get_local_id(2) + 1.0f;
  B[item_ct1.get_local_id(2)] = item_ct1.get_local_id(2) + 1.0f;
  C[item_ct1.get_local_id(2)] =
      A[item_ct1.get_local_id(2)] + B[item_ct1.get_local_id(2)];
}
int main( )
{
  float *d_A, *d_B, *d_C;
  d_A = (float *)sycl::malloc_device(VECTOR_SIZE * sizeof(float),
    dpct::get_current_device( ),
    dpct::get_default_context( ));
  d_B = (float *)sycl::malloc_device(VECTOR_SIZE * sizeof(float),
    dpct::get_current_device( ),
    dpct::get_default_context( ));
  d_C = (float *)sycl::malloc_device(VECTOR_SIZE * sizeof(float),
    dpct::get_current_device( ),
    dpct::get_default_context( ));
  dpct::get_default_queue_wait( ).submit([&](sycl::handler &cgh) {
    cgh.parallel_for(
      sycl::nd_range<3>(sycl::range<3>(1, 1, 1) *
```

```
  sycl::range<3>(1, 1, VECTOR_SIZE) *
  sycl::range<3>(1, 1, VECTOR_SIZE)),
```

```
      [=](sycl::nd_items<3> item_ct1) {
        VectorAddKernel(d_A, d_B, d_C, item_ct1);
      });
  });
  float Result[VECTOR_SIZE] = { };
  dpct::get_default_queue_wait( )
    .memcpy(Result, d_C, VECTOR_SIZE * sizeof(float))
    .wait( );
  sycl::free(d_A, dpct::get_default_context( ));
  sycl::free(d_B, dpct::get_default_context( ));
  sycl::free(d_C, dpct::get_default_context( ));
  for (int i=0; i<VECTOR_SIZE; i++ {
    if (i % 16 == 0) {
        printf(“\n”);
    }
    printf(“%f ”, Result[i]);
  }
  return 0;
}
```

In at least one embodiment, human readable DPC++ 5704 refers to output generated by DPC++ compatibility tool 5702 and may be optimized in one manner or another. In at least one embodiment, human readable DPC++ 5704 generated by DPC++ compatibility tool 5702 can be manually edited by a developer after migration to make it more maintainable, performance, or other considerations. In at least one embodiment, DPC++ code generated by DPC++ compatibility tool 57002 such as DPC++ disclosed can be optimized by removing repeat calls to get_current_device( ) and/or get_default_context( ) for each malloc_device( ) call. In at least one embodiment, DPC++ code generated above uses a 3 dimensional nd_range which can be refactored to use only a single dimension, thereby reducing memory usage. In at least one embodiment, a developer can manually edit DPC++ code generated by DPC++ compatibility tool 5702 replace uses of unified shared memory with accessors. In at least one embodiment, DPC++ compatibility tool 5702 has an option to change how it migrates CUDA code to DPC++ code. In at least one embodiment, DPC++ compatibility tool 5702 is verbose because it is using a general template to migrate CUDA code to DPC++ code that works for a large number of cases.

In at least one embodiment, a CUDA to DPC++ migration workflow includes steps to: prepare for migration using intercept-build script; perform migration of CUDA projects to DPC++ using DPC++ compatibility tool 5702; review and edit migrated source files manually for completion and correctness; and compile final DPC++ code to generate a DPC++ application. In at least one embodiment, manual review of DPC++ source code may be required in one or more scenarios including but not limited to: migrated API does not return error code (CUDA code can return an error code which can then be consumed by the application but SYCL uses exceptions to report errors, and therefore does not use error codes to surface errors); CUDA compute capability dependent logic is not supported by DPC++; statement could not be removed. In at least one embodiment, scenarios in which DPC++ code requires manual intervention may include, without limitation: error code logic replaced with (*,0) code or commented out; equivalent DPC++ API not available; CUDA compute capability-dependent logic; hardware-dependent API (clock( )); missing features unsupported API; execution time measurement logic; handling built-in vector type conflicts; migration of cuBLAS API; and more.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a one API math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, one VPL implements device discovery and selection in media centric and video analytics workloads. In at least one embodiment, one VPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, at least one component shown or described with respect to FIG. 57 is used to perform techniques and/or functions described in connection with FIGS. 1-25. In at least one embodiment, at least one component shown or described with respect to FIG. 57 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 57 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 57 is used to perform at least one aspect described with respect to FIGS. 1-25, and/or other systems, methods, or operations described herein.

In at least one embodiment, at least one component shown or described with respect to FIG. 57 is used to perform techniques and/or functions described in connection with FIGS. 1-25. In at least one embodiment, at least one component shown or described with respect to FIG. 57 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 57 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 57 is used to perform techniques and/or functions described in connection with FIGS. 1-25. In at least one embodiment, at least one component shown or described with respect to FIG. 57 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 57 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 57 is used to perform techniques and/or functions described in connection with FIGS. 1-25. In at least one embodiment, at least one component shown or described with respect to FIG. 57 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 57 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 57 is used to perform techniques and/or functions described in connection with FIGS. 1-25. In at least one embodiment, at least one component shown or described with respect to FIG. 57 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 57 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 57 is used to perform techniques and/or functions described in connection with FIGS. 1-25. In at least one embodiment, at least one component shown or described with respect to FIG. 57 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 57 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 57 is used to perform techniques and/or functions described in connection with FIGS. 1-25. In at least one embodiment, at least one component shown or described with respect to FIG. 57 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 57 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 57 is used to perform techniques and/or functions described in connection with FIGS. 1-25. In at least one embodiment, at least one component shown or described with respect to FIG. 57 is used to perform an application programming interface (API) to cause context of one or more first software instructions to be communicated to one or more second software instructions, and/or other systems, methods, or operations described herein. In at least one embodiment, at least one component shown or described with respect to FIG. 57 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 57 is used to perform techniques and/or functions described in connection with FIGS. 1-25. In at least one embodiment, at least one component shown or described with respect to FIG. 57 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 57 is used to perform an application programming interface (API) to prevent one or more instructions from being performed by one or more resources of a first context of the processor until one or more indications of one or more events of a second context are generated, and/or other systems, methods, or operations described herein.

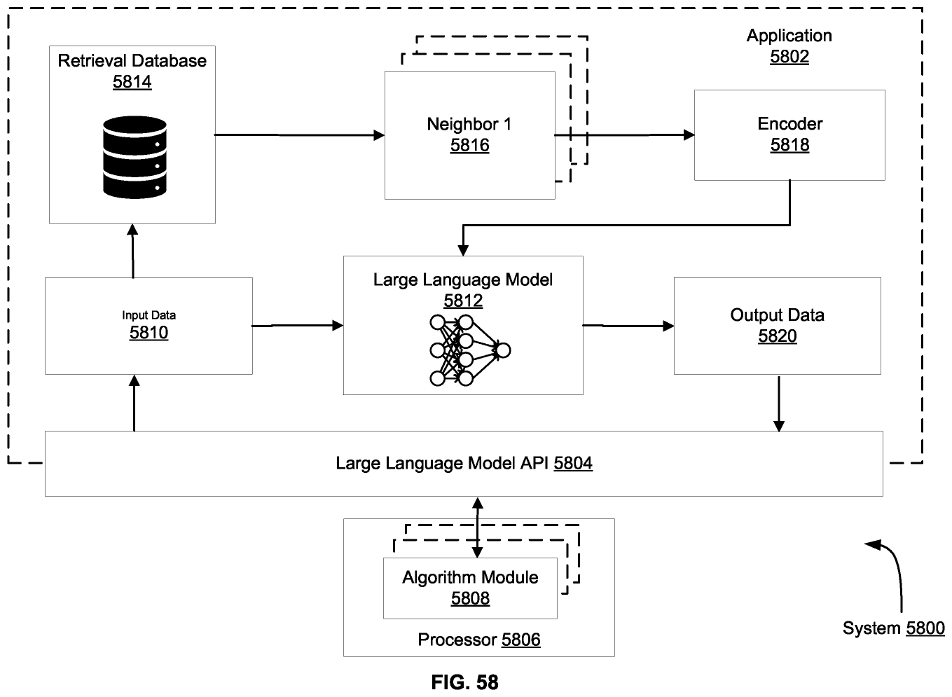

FIG. 58 is a system diagram illustrating system 5800 for interfacing with an application 5802 to process data, according to at least one embodiment. In at least one embodiment, application 5802 uses large language model (LLM) 5812 to generate output data 5820 based, at least in part, on input data 5810. In at least one embodiment, input data 5810 is a text prompt. In at least one embodiment, input data 5810 includes unstructured text. In at least one embodiment, input data 5810 includes a sequence of tokens. In at least one embodiment, a token is a portion of input data. In at least one embodiment, a token is a word. In at least one embodiment, a token is a character. In at least one embodiment, a token is a subword. In at least one embodiment, input data 5810 is formatted in Chat Markup Language (ChatML). In at least one embodiment, input data 5810 is an image. In at least one embodiment, input data 5810 is one or more video frames. In at least one embodiment, input data 5810 is any other expressive medium.

In at least one embodiment, large language model 5812 comprises a deep neural network. In at least one embodiment, a deep neural network is a neural network with two or more layers. In at least one embodiment, large language model 5812 comprises a transformer model. In at least one embodiment, large language model 5812 comprises a neural network configured to perform natural language processing. In at least one embodiment, large language model 5812 is configured to process one or more sequences of data. In at least one embodiment, large language model 5812 is configured to process text. In at least one embodiment, weights and biases of a large language model 5812 are configured to process text. In at least one embodiment, large language model 5812 is configured to determine patterns in data to perform one or more natural language processing tasks. In at least one embodiment, a natural language processing task comprises text generation. In at least one embodiment, a natural language processing task comprises question answering. In at least one embodiment, performing a natural language processing task results in output data 5820.

In at least one embodiment, a processor uses input data 5810 to query retrieval database 5814. In at least one embodiment, retrieval database 5814 is a key-value store. In at least one embodiment, retrieval database 5814 is a corpus used to train large language model 5812. In at least one embodiment, a processor uses retrieval database 5814 to provide large language model 5812 with updated information. In at least one embodiment, retrieval database 5814 comprises data from an internet source. In at least one embodiment, large language model 5812 does not use retrieval database 5814 to perform inferencing.

In at least one embodiment, an encoder encodes input data 5810 into one or more feature vectors. In at least one embodiment, an encoder encodes input data 5810 into a sentence embedding vector. In at least one embodiment, a processor uses said sentencing embedding vector to perform a nearest neighbor search to generate one or more neighbors 5816. In at least one embodiment, one or more neighbors 5816 is value in retrieval database 5814 corresponding to a key comprising input data 5810. In at least one embodiment, one or more neighbors 5816 comprise text data. In at least one embodiment, encoder 5818 encodes one or more neighbors 5816. In at least one embodiment, encoder 5818 encodes one or more neighbors 5816 into a text embedding vector. In at least one embodiment, encoder 5818 encodes one or more neighbors 5816 into a sentence embedding vector. In at least one embodiment, large language model 5816 uses input data 5810 and data generated by encoder 5818 to generate output data 5820. In at least one embodiment, processor 5806 interfaces with application 5802 using large language model (LLM) application programming interface(s) (API(s)) 5804. In at least one embodiment, processor 5806 accesses large language model 5816 using large language model (LLM) application programming interface(s) (API(s)) 5804.

In at least one embodiment, output data 5820 comprise computer instructions. In at least one embodiment, output data 5820 comprise instructions written in CUDA programming language. In at least one embodiment, output data 5820 comprise instructions to be performed by processor 5806. In at least one embodiment, output data 5820 comprise instructions to control execution of one or more algorithm modules 5808. In at least one embodiment, one or more algorithm modules 5808 comprise, for example, one or more neural networks to perform pattern recognition. In at least one embodiment, one or more algorithm modules 5808 comprise, for example, one or more neural networks to perform frame generation. In at least one embodiment, one or more algorithm modules 5808 comprise, for example, one or more neural networks to generate a drive path. In at least one embodiment, one or more algorithm modules 5808 comprise, for example, one or more neural networks to generate a 5G signal. In at least one embodiment, processor 5806 interfaces with application 5802 using large language model (LLM) application programming interface(s) (API(s)) 5804. In at least one embodiment, processor 5806 may use one or more parallel computing platforms and/or programming models (e.g., NVIDIA's CUDA model).

In at least one embodiment, aspects of systems and techniques described herein in relation to FIG. 58 are incorporated into aspects of preceding figure(s). For example, in at least one embodiment, an apparatus depicted in preceding figure(s) includes processor 5806.

For example, in at least one embodiment, system 5800 uses ChatGPT to write CUDA code. For example, in at least one embodiment, system 5800 uses ChatGPT to train an object classification neural network. For example, in at least one embodiment, system 5800 uses ChatGPT and a neural network to identify a driving path. For example, in at least one embodiment, system 5800 uses ChatGPT and a neural network to generate a 5G signal.

It should be noted that, while example embodiments described herein may relate to a CUDA programming model, techniques described herein can be utilized with any suitable programming model, such HIP, oneAPI (e.g., using oneAPI-based programming to perform or implement a method disclosed herein), and/or variations thereof.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

In at least one embodiment, at least one component shown or described with respect to FIG. 58 is used to perform techniques and/or functions described in connection with FIGS. 1-25. In at least one embodiment, at least one component shown or described with respect to FIG. 58 is used to perform an application programming interface (API) to allocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 58 is used to perform an application programming interface (API) to generate one or more masks to indicate one or more subsets of streaming multiprocessors of one or more graphics processing units (GPUs) usable to perform one or more kernels, and/or other systems, methods, or operations described herein. In at least one embodiment, at least one component shown or described with respect to FIG. 58 is used to perform at least one aspect described with respect to FIGS. 1-25, and/or other systems, methods, or operations described herein.

In at least one embodiment, at least one component shown or described with respect to FIG. 58 is used to perform techniques and/or functions described in connection with FIGS. 1-25. In at least one embodiment, at least one component shown or described with respect to FIG. 58 is used to perform an application programming interface (API) to deallocate one or more data structures to indicate which of one or more streaming multiprocessors (SMs) of one or more processors are to be used to perform one or more software threads, and/or other systems, methods, or operations described herein. In at least one embodiment, at least one component shown or described with respect to FIG. 58 is used to perform an application programming interface (API) to cause one or more masks to be deactivated, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 58 is used to perform techniques and/or functions described in connection with FIGS. 1-25. In at least one embodiment, at least one component shown or described with respect to FIG. 58 is used to perform an application programming interface (API) to cause one or more identifiers of one or more data structures indicating a number of one or more streaming multiprocessors (SMs) of one or more processors to be stored, and/or other systems, methods, or operations described herein. In at least one embodiment, at least one component shown or described with respect to FIG. 58 is used to perform an application programming interface (API) to indicate one or more identifiers of one or more masks, wherein the one or more masks indicate one or more subsets of streaming multiprocessors of one or more graphics processing units (GPUs) usable to perform one or more kernels, and/or other systems, methods, or operations described herein.

In at least one embodiment, at least one component shown or described with respect to FIG. 58 is used to perform techniques and/or functions described in connection with FIGS. 1-25. In at least one embodiment, at least one component shown or described with respect to FIG. 58 is used to perform an application programming interface (API) to indicate one or more streaming multiprocessors (SMs) of one or more processors available to be used to perform one or more software threads, and/or other systems, methods, or operations described herein. In at least one embodiment, at least one component shown or described with respect to FIG. 58 is used to perform an application programming interface (API) to indicate one or more streaming multiprocessors (SMs) of one or more graphics processing units (GPUs) available to be used to perform one or more software kernels, and/or other systems, methods, or operations described herein.

In at least one embodiment, at least one component shown or described with respect to FIG. 58 is used to perform techniques and/or functions described in connection with FIGS. 1-25. In at least one embodiment, at least one component shown or described with respect to FIG. 58 is used to perform an application programming interface (API) to cause a plurality of identifiers of a corresponding plurality of streaming multiprocessors (SMs) of one or more processors to be stored according to a plurality of groups, in which the corresponding plurality of SMs are to be used, and/or other systems, methods, or operations described herein. In at least one embodiment, at least one component shown or described with respect to FIG. 58 is used to perform an application programming interface (API) to generate an indication of one or more subsets of streaming multiprocessors (SMs) of a processor to be available to be used to perform one or more software kernels, and/or other systems, methods, or operations described herein.

In at least one embodiment, at least one component shown or described with respect to FIG. 58 is used to perform techniques and/or functions described in connection with FIGS. 1-25. In at least one embodiment, at least one component shown or described with respect to FIG. 58 is used to perform an application programming interface (API) to indicate one or more groups of streaming multiprocessors (SMs) of one or more processors, on which to schedule one or more corresponding groups of software threads, and/or other systems, methods, or operations described herein. In at least one embodiment, at least one component shown or described with respect to FIG. 58 is used to perform an application programming interface (API) to generate a data structure comprising information to indicate one or more streaming multiprocessors (SMs) of one or more GPUs to be usable to perform one or more software kernels, and/or other systems, methods, or operations described herein.

In at least one embodiment, at least one component shown or described with respect to FIG. 58 is used to perform techniques and/or functions described in connection with FIGS. 1-25. In at least one embodiment, at least one component shown or described with respect to FIG. 58 is used to perform an application programming interface (API) to cause one or more indicators of one or more numbers of one or more streaming multiprocessors (SMs) of one or more processors to be read from one or more data structures storing the one or more indicators, and/or other systems, methods, or operations described herein. In at least one embodiment, at least one component shown or described with respect to FIG. 58 is used to perform an application programming interface (API) to cause a number of streaming multiprocessors indicated by one or more masks to be usable to perform one or more software kernels to be indicated, and/or other systems, methods, or operations described herein.

In at least one embodiment, at least one component shown or described with respect to FIG. 58 is used to perform techniques and/or functions described in connection with FIGS. 1-25. In at least one embodiment, at least one component shown or described with respect to FIG. 58 is used to perform an application programming interface (API) to cause context of one or more first software instructions to be communicated to one or more second software instructions, and/or other systems, methods, or operations described herein. In at least one embodiment, at least one component shown or described with respect to FIG. 58 is used to perform an application programming interface (API) to cause one or more indications of one or more events of one or more resources of a first context of the processor to be indicated to one or more resources of a second context of the processor, and/or other systems, methods, or operations described herein.

In at least one embodiment, at least one component shown or described with respect to FIG. 58 is used to perform techniques and/or functions described in connection with FIGS. 1-25. In at least one embodiment, at least one component shown or described with respect to FIG. 58 is used to perform an application programming interface (API) to cause one or more second instructions to wait to be performed until the one or more second instructions receives context corresponding to one or more first software instructions, and/or other systems, methods, or operations described herein. In at least one embodiment, at least one component shown or described with respect to FIG. 58 is used to perform an application programming interface (API) to prevent one or more instructions from being performed by one or more resources of a first context of the processor until one or more indications of one or more events of a second context are generated, and/or other systems, methods, or operations described herein.

At least one embodiment of the disclosure can be described in view of the following clauses:
1. A processor comprising:
   one or more circuits to perform an application programming interface (API) to allocate one or more data structures to indicate which of one or more streaming multiprocessors (SMs) of one or more processors are to be used to perform one or more software threads.
2. The processor of clause 1, wherein the API is to receive arguments comprising a memory location to store a sub-context corresponding to the one or more data structures.
3. The processor of clause 1 or 2, wherein the API is to receive arguments comprising a resource descriptor indicative of the one or more SMs.
4. The processor any of clauses 1-3, wherein the API is to receive arguments comprising an indication of a device comprising the one or more SMs upon which to perform at least a portion of the API.
5. The processor any of clauses 1-4, wherein the API is to receive arguments comprising a set of flags at least indicating which SMs of a device comprising the one or more SMs are to be used to perform the one or more software threads.
6. The processor any of clauses 1-5, wherein the API is to indicate that a sub-context comprising the one or more data structures has been created.
7. The processor any of clauses 1-6, wherein the one or more data structures indicate a partitioning of a plurality of SMs of the one or more devices into at least the one or more SMs and a second one or more SMs not including the first one or more SMs.
8. A computer-implemented method comprising:
   performing an application programming interface (API) to allocate one or more data structures to indicate which of one or more streaming multiprocessors (SMs) of one or more processors are to be used to perform one or more software threads.
9. The computer-implemented method of clause 8, wherein performing the API comprises receiving arguments comprising a memory location to store a sub-context corresponding to the one or more data structures.
10. The computer-implemented method of clause 8 or 9, wherein performing the API comprises receiving arguments comprising an indication of the one or more SMs.
11. The computer-implemented method any of clauses 8-10, wherein performing the API comprises receiving arguments comprising an indication of a device comprising the one or more SMs upon which to perform at least a portion of the API.
12. The computer-implemented method any of clauses 8-11, wherein performing the API comprises receiving arguments comprising a set of flags at least indicating which SMs of a device comprising the one or more SMs are to be used to perform the one or more software threads.
13. The computer-implemented method any of clauses 8-12, wherein the API indicates that a sub-context comprising the one or more data structures has been created.
14. The computer-implemented method any of clauses 8-13, wherein the one or more data structures indicate a partitioning of a plurality of SMs of the one or more devices into at least the one or more SMs and a second one or more SMs not including the first one or more SMs.
15. A computer system comprising:
   one or more processors and memory storing executable instructions that, if performed by the one or more processors, perform an application programming interface (API) to allocate one or more data structures to indicate which of one or more streaming multiprocessors (SMs) of one or more processors are to be used to perform one or more software threads.
16. The computer system of clause 15, wherein the API is to receive arguments comprising a memory location to store a sub-context corresponding to the one or more data structures.
17. The computer system of clause 15 or 16, wherein the API is to receive arguments comprising a resource descriptor indicative of the one or more SMs.
18. The computer system any of clauses 15-17, wherein the API is to receive arguments comprising an indication of a device comprising the one or more SMs upon which to perform at least a portion of the API.
19. The computer system any of clauses 15-18, wherein the API is to receive arguments comprising a set of flags at least indicating which SMs of a device comprising the one or more SMs are to be used to perform the one or more software threads.
20. The computer system any of clauses 15-19, wherein the one or more data structures indicate a partitioning of a plurality of SMs of the one or more devices into at least the one or more SMs and a second one or more SMs not including the first one or more SMs.
21. A non-transitory machine-readable medium having stored thereon a set of instructions, which if performed by one or more processors, cause the one or more processors to perform an application programming interface (API) to allocate one or more data structures to indicate which of one or more streaming multiprocessors (SMs) of one or more processors are to be used to perform one or more software threads.
22. The non-transitory machine-readable medium of clause 21, wherein the API is to receive arguments comprising a memory location to store a sub-context corresponding to the one or more data structures.
23. The non-transitory machine-readable medium of clause 21 or 22, wherein the API is to receive arguments comprising a resource descriptor indicative of the one or more SMs.
24. The non-transitory machine-readable medium any of clauses 21-23, wherein the API is to receive arguments comprising an indication of a device comprising the one or more SMs upon which to perform at least a portion of the API.
25. The non-transitory machine-readable medium any of clauses 21-24, wherein the API is to receive arguments comprising a set of flags at least indicating which SMs of a device comprising the one or more SMs are to be used to perform the one or more software threads.
26. The non-transitory machine-readable medium any of clauses 21-25, wherein the API is to indicate that a sub-context comprising the one or more data structures has been created.
27. The non-transitory machine-readable medium any of clauses 21-26, wherein the one or more data structures indicate a partitioning of a plurality of SMs of the one or more devices into at least the one or more SMs and a second one or more SMs not including the first one or more SMs.
28. A processor comprising:
   one or more circuits to perform an application programming interface (API) to deallocate one or more data structures to indicate which of one or more streaming multiprocessors (SMs) of one or more processors are to be used to perform one or more software threads.
29. The processor of clause 28, wherein the API is to receive arguments comprising a sub-context indicating the one or more data structures to deallocate.
30. The processor of clause 28 or 29, wherein the API is to indicate that a sub-context comprising the one or more data structures has been deallocated.
31. The processor any of clauses 28-30, wherein the one or more data structures indicate a partitioning of a plurality of SMs of the one or more devices into at least the one or more SMs and a second one or more SMs not including the first one or more SMs.
32. The processor any of clauses 28-31, wherein the API is to deallocate one or more data structures allocated by a second API to allocate the one or more data structures.
33. The processor any of clauses 28-32, wherein the one or more data structures are included in a context of the one or more processors.
34. The processor any of clauses 28-33, wherein the one or more data structures indicate a sub-context of a context of the one or more processors.
35. A computer-implemented method comprising:
   performing an application programming interface (API) to deallocate one or more data structures to indicate which of one or more streaming multiprocessors (SMs) of one or more processors are to be used to perform one or more software threads.
36. The computer-implemented method of clause 35, wherein performing the API comprises receiving arguments comprising a sub-context indicating the one or more data structures to deallocate.
37. The computer-implemented method of clause 35 or 36, wherein performing the API comprises indicating that a sub-context comprising the one or more data structures has been deallocated.
38. The computer-implemented method any of clauses 35-37, wherein the one or more data structures indicate a partitioning of a plurality of SMs of the one or more devices into at least the one or more SMs and a second one or more SMs not including the first one or more SMs.
39. The computer-implemented method any of clauses 35-38, wherein performing the API comprises deallocating one or more data structures allocated by a second API to allocate the one or more data structures.
40. The computer-implemented method any of clauses 35-39, wherein the one or more data structures are included in a context of the one or more processors.
41. The computer-implemented method any of clauses 35-40, wherein the one or more data structures are included in a sub-context of a context of the one or more processors.
42. A computer system comprising:
   one or more processors and memory storing executable instructions that, if performed by the one or more processors, perform an application programming interface (API) to deallocate one or more data structures to indicate which of one or more streaming multiprocessors (SMs) of one or more processors are to be used to perform one or more software threads.
43. The computer system of clause 42, wherein the API is to receive arguments comprising a sub-context indicating the one or more data structures to deallocate.
44. The computer system of clause 42 or 43, wherein the API is to indicate that a sub-context comprising the one or more data structures has been deallocated.
45. The computer system any of clauses 42-44, wherein the one or more data structures indicate a partitioning of a plurality of SMs of the one or more devices into at least the one or more SMs and a second one or more SMs not including the first one or more SMs.
46. The computer system any of clauses 42-45, wherein the API is to deallocate one or more data structures allocated by a second API to allocate the one or more data structures.
47. The computer system any of clauses 42-46, wherein the one or more data structures are included in a sub-context of a context of the one or more processors.
48. A non-transitory machine-readable medium having stored thereon a set of instructions, which if performed by one or more processors, cause the one or more processors to perform an application programming interface (API) to deallocate one or more data structures to indicate which of one or more streaming multiprocessors (SMs) of one or more processors are to be used to perform one or more software threads.
49. The non-transitory machine-readable medium of clause 48, wherein the API is to receive arguments comprising a sub-context indicating the one or more data structures to deallocate.
50. The non-transitory machine-readable medium of clause 48 or 49, wherein the API is to indicate that a sub-context comprising the one or more data structures has been deallocated.
51. The non-transitory machine-readable medium any of clauses 48-50, wherein the one or more data structures indicate a partitioning of a plurality of SMs of the one or more devices into at least the one or more SMs and a second one or more SMs not including the first one or more SMs.
52. The non-transitory machine-readable medium any of clauses 48-51, wherein the API is to deallocate one or more data structures allocated by a second API to allocate the one or more data structures.
53. The non-transitory machine-readable medium any of clauses 48-52, wherein the one or more data structures are included in a context of the one or more processors.
54. The non-transitory machine-readable medium any of clauses 48-53, wherein the one or more data structures indicate a sub-context of a context of the one or more processors.
55. A processor comprising:
   one or more circuits to perform an application programming interface (API) to cause one or more identifiers of one or more data structures indicating a number of one or more streaming multiprocessors (SMs) of one or more processors to be stored.
56. The processor of clause 55, wherein the API is to receive arguments comprising a stream indicating set of software operations to be performed using the one or more SMs.
57. The processor of clause 55 or 56, wherein the API is to receive arguments comprising a memory location usable to store the one or more data structures.
58. The processor any of clauses 55-57, wherein the API is to indicate that the one or more identifiers have been stored.
59. The processor any of clauses 55-58, wherein the one or more SMs comprise a subset of SMs of the one or more processors.
60. The processor any of clauses 55-59, wherein the one or more identifiers are indicated based, at least in part, on a stream of software operations operating on the one or more processors.
61. The processor any of clauses 55-60, wherein the one or more identifiers are indicated by a sub-context of the one or more processors.
62. A computer-implemented method comprising:
performing an application programming interface (API) to cause one or more identifiers of one or more data structures indicating a number of one or more streaming multiprocessors (SMs) of one or more processors to be stored.
63. The computer-implemented method of clause 62, wherein performing the API comprises receiving arguments comprising a stream indicating set of software operations to be performed using the one or more SMs.
64. The computer-implemented method of clause 62 or 63, wherein performing the API comprises receiving arguments comprising a memory location usable to store the one or more data structures.
65. The computer-implemented method any of clauses 62-64, wherein performing the API comprises indicating that the one or more identifiers have been stored.
66. The computer-implemented method any of clauses 62-65, wherein the one or more SMs comprise a subset of SMs of the one or more processors.
67. The computer-implemented method any of clauses 62-66, wherein performing the API comprises indicating the one or more identifiers based, at least in part, on a stream of software operations operating on the one or more processors.
68. The computer-implemented method any of clauses 62-67, wherein the one or more identifiers are indicated by a context of the one or more processors.
69. A computer system comprising:
   one or more processors and memory storing executable instructions that, if performed by the one or more processors, perform an application programming interface (API) to cause one or more identifiers of one or more data structures indicating a number of one or more streaming multiprocessors (SMs) of one or more processors to be stored.
70. The computer system of clause 69, wherein the API is to receive arguments comprising a stream indicating set of software operations to be performed using the one or more SMs.
71. The computer system of clause 69 or 70, wherein the API is to receive arguments comprising a memory location usable to store the one or more data structures.
72. The computer system any of clauses 69-71, wherein the API is to indicate that the one or more identifiers have been stored.
73. The computer system any of clauses 69-72, wherein the one or more SMs comprise a subset of SMs of the one or more processors.
74. The computer system any of clauses 69-73, wherein the one or more identifiers are included in a sub-context of the one or more processors.
75. A non-transitory machine-readable medium having stored thereon a set of instructions, which if performed by one or more processors, cause the one or more processors to perform an application programming interface (API) to cause one or more identifiers of one or more data structures indicating a number of one or more streaming multiprocessors (SMs) of one or more processors to be stored.
76. The non-transitory machine-readable medium of clause 75, wherein the API is to receive arguments comprising a stream indicating set of software operations to be performed using the one or more SMs.
77. The non-transitory machine-readable medium of clause 75 or 76, wherein the API is to receive arguments comprising a memory location usable to store the one or more data structures.
78. The non-transitory machine-readable medium any of clauses 75-77, wherein the API is to indicate that the one or more identifiers have been stored.
79. The non-transitory machine-readable medium any of clauses 75-78, wherein the one or more SMs comprise a subset of SMs of the one or more processors.
80. The non-transitory machine-readable medium any of clauses 75-79, wherein the one or more identifiers are indicated based, at least in part, on a stream of software operations operating on the one or more processors.
81. The non-transitory machine-readable medium any of clauses 75-80, wherein the one or more identifiers are indicated by a sub-context of the one or more processors.
82. A processor comprising:
   one or more circuits to perform an application programming interface (API) to indicate one or more streaming multiprocessors (SMs) of one or more processors available to be used to perform one or more software threads.
83. The processor of clause 82, wherein the API is to receive arguments comprising a memory location usable to store the indication of the one or more SMs.
84. The processor of clause 82 or 83, wherein the API is to receive arguments comprising a context indicating resources usable to perform the one or more software threads.
85. The processor any of clauses 82-84, wherein the API is to indicate that the one or more SMs are available to be used to perform the one or more software threads.
86. The processor any of clauses 82-85, wherein the API is to return one or more data structures indicating the one or more SMs allocated by a second API to allocate the one or more data structures.
87. The processor any of clauses 82-86, wherein the indication of the one or more SMs is included in a context of the one or more processors.
88. The processor any of clauses 82-87, wherein the indication of the one or more SMs is included in a sub-context of the one or more processors.
89. A computer-implemented method comprising:
   performing an application programming interface (API) to indicate one or more streaming multiprocessors (SMs) of one or more processors available to be used to perform one or more software threads.
90. The computer-implemented method of clause 89, wherein performing the API comprises receiving arguments comprising a memory location usable to store the indication of the one or more SMs.
91. The computer-implemented method of clause 89 or 90, wherein performing the API comprises receiving arguments comprising a set of resources usable to perform the one or more software threads.
92. The computer-implemented method any of clauses 89-91, wherein performing the API comprises indicating that the one or more SMs are available to be used to perform the one or more software threads.
93. The computer-implemented method any of clauses 89-92, wherein performing the API comprises returning one or more data structures indicating the one or more SMs allocated by a second API to allocate the one or more data structures.
94. The computer-implemented method any of clauses 89-93, wherein the indication of the one or more SMs is included in a context of the one or more processors.
95. The computer-implemented method any of clauses 89-94, wherein the indication of the one or more SMs is included in a sub-context of the one or more processors.
96. A computer system comprising:
   one or more processors and memory storing executable instructions that, if performed by the one or more processors, perform an application programming interface (API) to indicate one or more streaming multiprocessors (SMs) of one or more processors available to be used to perform one or more software threads.
97. The computer system of clause 96, wherein the API is to receive arguments comprising a memory location usable to store the indication of the one or more SMs.
98. The computer system of clause 96 or 97, wherein the API is to receive arguments comprising a context indicating resources usable to perform the one or more software threads.
99. The computer system any of clauses 96-98, wherein the API is to indicate that the one or more SMs are available to be used to perform the one or more software threads.
100. The computer system any of clauses 96-99, wherein the API is to return one or more data structures indicating the one or more SMs allocated by a second API to allocate the one or more data structures.
101. The computer system any of clauses 96-100, wherein the indication of the one or more SMs is included in a sub-context of the one or more processors.
102. A non-transitory machine-readable medium having stored thereon a set of instructions, which if performed by one or more processors, cause the one or more processors to perform an application programming interface (API) to indicate one or more streaming multiprocessors (SMs) of one or more processors available to be used to perform one or more software threads.
103. The non-transitory machine-readable medium of clause 102, wherein the API is to receive arguments comprising a memory location usable to store the indication of the one or more SMs.
104. The non-transitory machine-readable medium of clause 102 or 103, wherein the API is to receive arguments comprising a context indicating resources usable to perform the one or more software threads.
105. The non-transitory machine-readable medium any of clauses 102-104, wherein the API is to indicate that the one or more SMs are available to be used to perform the one or more software threads.
106. The non-transitory machine-readable medium any of clauses 102-105, wherein the API is to return one or more data structures indicating the one or more SMs allocated by a second API to allocate the one or more data structures.
107. The non-transitory machine-readable medium any of clauses 102-106, wherein the indication of the one or more SMs is included in a context of the one or more processors.
108. The non-transitory machine-readable medium any of clauses 102-107, wherein the indication of the one or more SMs is included in a sub-context of the one or more processors.
109. A processor comprising:
   one or more circuits to perform an application programming interface (API) to cause a plurality of identifiers of a corresponding plurality of streaming multiprocessors (SMs) of one or more processors to be stored according to a plurality of groups, in which the corresponding plurality of SMs are to be used.
110. The processor of clause 109, wherein the API is to receive arguments comprising a memory location usable to store a first plurality of identifiers of a first group of the plurality of groups.
111. The processor of clause 109 or 110, wherein the API is to receive arguments comprising a memory location usable to store a second plurality of identifiers of one or more second groups of the plurality of groups.
112. The processor any of clauses 109-111, wherein the API is to receive arguments comprising a list of identifiers including at least the plurality of identifiers.
113. The processor any of clauses 109-112, wherein the API is to receive arguments comprising a set of flags at least indicating which identifiers are to be stored in the plurality of groups.
114. The processor any of clauses 109-113, wherein the API is to receive arguments comprising a minimum count of identifiers of SMs of at least one of the plurality of groups.
115. The processor any of clauses 109-114, wherein the API is to indicate that the plurality of identifiers have been stored.
116. A computer-implemented method comprising:
   performing an application programming interface (API) to cause a plurality of identifiers of a corresponding plurality of streaming multiprocessors (SMs) of one or more processors to be stored according to a plurality of groups, in which the corresponding plurality of SMs are to be used.
117. The computer-implemented method of clause 116, wherein performing the API comprises receiving arguments comprising a memory location usable to store a list of identifiers of a first group of the plurality of groups.
118. The computer-implemented method of clause 116 or 117, wherein performing the API comprises receiving arguments comprising a memory location usable to store a list of identifiers of one or more second groups of the plurality of groups.
119. The computer-implemented method any of clauses 116-118, wherein performing the API comprises receiving arguments comprising a list of identifiers including at least the plurality of identifiers.
120. The computer-implemented method any of clauses 116-119, wherein performing the API comprises receiving arguments comprising a set of flags at least indicating which identifiers are to be stored in the plurality of groups.
121. The computer-implemented method any of clauses 116-120, wherein performing the API comprises receiving arguments comprising a minimum size of at least one of the plurality of groups.
122. The computer-implemented method any of clauses 116-121, wherein performing the API comprises indicating that the plurality of identifiers have been stored.
123. A computer system comprising:
   one or more processors and memory storing executable instructions that, if performed by the one or more processors, perform an application programming interface (API) to cause a plurality of identifiers of a corresponding plurality of streaming multiprocessors (SMs) of one or more processors to be stored according to a plurality of groups, in which the corresponding plurality of SMs are to be used.
124. The computer system of clause 123, wherein the API is to receive arguments comprising a memory location usable to store a first plurality of identifiers of a first group of the plurality of groups.
125. The computer system of clause 123 or 124, wherein the API is to receive arguments comprising a memory location usable to store a second plurality of identifiers of one or more second groups of the plurality of groups.
126. The computer system any of clauses 123-125, wherein the API is to receive arguments comprising a list of identifiers including at least the plurality of identifiers.
127. The computer system any of clauses 123-126, wherein the API is to receive arguments comprising a set of flags at least indicating which identifiers are to be stored in the plurality of groups.
128. The computer system any of clauses 123-127, wherein the API is to receive arguments comprising a minimum count of identifiers of SMs of at least one of the plurality of groups.
129. A non-transitory machine-readable medium having stored thereon a set of instructions, which if performed by one or more processors, cause the one or more processors to perform an application programming interface (API) to cause a plurality of identifiers of a corresponding plurality of streaming multiprocessors (SMs) of one or more processors to be stored according to a plurality of groups, in which the corresponding plurality of SMs are to be used.
130. The non-transitory machine-readable medium of clause 129, wherein the API is to receive arguments comprising a memory location usable to store a first plurality of identifiers of a first group of the plurality of groups.
131. The non-transitory machine-readable medium of clause 129 or 130, wherein the API is to receive arguments comprising a memory location usable to store a second plurality of identifiers of one or more second groups of the plurality of groups.
132. The non-transitory machine-readable medium any of clauses 129-131, wherein the API is to receive arguments comprising a list of identifiers including at least the plurality of identifiers.
133. The non-transitory machine-readable medium any of clauses 129-132, wherein the API is to receive arguments comprising a set of flags at least indicating which identifiers are to be stored in the plurality of groups.
134. The non-transitory machine-readable medium any of clauses 129-133, wherein the API is to receive arguments comprising a minimum count of identifiers of SMs of at least one of the plurality of groups.
135. The non-transitory machine-readable medium any of clauses 129-134, wherein the API is to indicate that the plurality of identifiers have been stored.
136. A processor comprising:
   one or more circuits to perform an application programming interface (API) to indicate one or more groups of streaming multiprocessors (SMs) of one or more processors, on which to schedule one or more corresponding groups of software threads.
137. The processor of clause 136, wherein the API is to receive arguments comprising a memory location usable to store the indication of the one or more groups of SMs.
138. The processor of clause 136 or 137, wherein the API is to receive arguments comprising a list of resources usable by the one or more groups of SMs to perform the one or more corresponding groups of software threads.
139. The processor any of clauses 136-138, wherein the API is to receive arguments comprising a number of resources of a list of resources usable by the one or more groups of SMs to perform the one or more corresponding groups of software threads.
140. The processor any of clauses 136-139, wherein the API is to indicate that the groups of software threads have been scheduled on the SMs.
141. The processor any of clauses 136-140, wherein the indication of the one or more groups of SMs is included in a resource descriptor describing a context of the one or more processors.
142. The processor any of clauses 136-141, wherein the indication of the one or more groups of SMs is included in a resource descriptor describing a sub-context of the one or more processors.
143. A computer-implemented method comprising:
   performing an application programming interface (API) to indicate one or more groups of streaming multiprocessors (SMs) of one or more processors, on which to schedule one or more corresponding groups of software threads.
144. The computer-implemented method of clause 143, wherein performing the API comprises receiving arguments comprising a memory location usable to store the indication of the one or more groups of SMs.
145. The computer-implemented method of clause 143 or 144, wherein performing the API comprises receiving arguments comprising a list of resources usable by the one or more groups of SMs to perform the one or more corresponding groups of software threads.
146. The computer-implemented method any of clauses 143-145, wherein performing the API comprises receiving arguments comprising a number of resources of a list of resources usable by the one or more groups of SMs to perform the one or more corresponding groups of software threads.
147. The computer-implemented method any of clauses 143-146, wherein performing the API comprises indicating that the groups of software threads have been scheduled on the SMs.
148. The computer-implemented method any of clauses 143-147, wherein the indication of the one or more groups of SMs is included in resource descriptor describing a context of the one or more processors.
149. The computer-implemented method any of clauses 143-148, wherein the indication of the one or more groups of SMs is included in resource descriptor describing a sub-context of the one or more processors.
150. A computer system comprising:
   one or more processors and memory storing executable instructions that, if performed by the one or more processors, perform an application programming interface (API) to indicate one or more groups of streaming multiprocessors (SMs) of one or more processors, on which to schedule one or more corresponding groups of software threads.
151. The computer system of clause 150, wherein the API is to receive arguments comprising a memory location usable to store the indication of the one or more groups of SMs.
152. The computer system of clause 150 or 151, wherein the API is to receive arguments comprising a list of resources usable by the one or more groups of SMs to perform the one or more corresponding groups of software threads.
153. The computer system any of clauses 150-152, wherein the API is to receive arguments comprising a number of resources of a list of resources usable by the one or more groups of SMs to perform the one or more corresponding groups of software threads.
154. The computer system any of clauses 150-153, wherein the API is to indicate that the groups of software threads have been scheduled on the SMs.
155. The computer system any of clauses 150-154, wherein the indication of the one or more groups of SMs is included in resource descriptor describing a sub-context of the one or more processors.
156. A non-transitory machine-readable medium having stored thereon a set of instructions, which if performed by one or more processors, cause the one or more processors to perform an application programming interface (API) to indicate one or more groups of streaming multiprocessors (SMs) of one or more processors, on which to schedule one or more corresponding groups of software threads.
157. The non-transitory machine-readable medium of clause 156, wherein the API is to receive arguments comprising a memory location usable to store the indication of the one or more groups of SMs.
158. The non-transitory machine-readable medium of clause 156 or 157, wherein the API is to receive arguments comprising a list of resources usable by the one or more groups of SMs to perform the one or more corresponding groups of software threads.
159. The non-transitory machine-readable medium any of clauses 156-158, wherein the API is to receive arguments comprising a number of resources of a list of resources usable by the one or more groups of SMs to perform the one or more corresponding groups of software threads.
160. The non-transitory machine-readable medium any of clauses 156-159, wherein the API is to indicate that the groups of software threads have been scheduled on the SMs.
161. The non-transitory machine-readable medium any of clauses 156-160, wherein the indication of the one or more groups of SMs is included in a resource descriptor describing a context of the one or more processors.
162. The non-transitory machine-readable medium any of clauses 156-161, wherein the indication of the one or more groups of SMs is included in a resource descriptor describing a sub-context of the one or more processors.
163. A processor comprising:
   one or more circuits to perform an application programming interface (API) to cause one or more indicators of one or more numbers of one or more streaming multiprocessors (SMs) of one or more processors to be read from one or more data structures storing the one or more indicators.
164. The processor of clause 163, wherein the API is to receive arguments comprising a memory location usable to store the one or more indicators of the one or more SMs.
165. The processor of clause 163 or 164, wherein the API is to receive arguments comprising a type of data to be read from the one or more data structures.
166. The processor any of clauses 163-165, wherein the API is to receive arguments comprising a sub-context indicating resources usable to perform one or more software threads using the one or more SMs.
167. The processor any of clauses 163-166, wherein the API is to receive arguments comprising a context indicating resources usable to perform one or more software threads using the one or more SMs.
168. The processor any of clauses 163-167, wherein the API is to indicate that the one or more indicators have been read from the one or more data structures.
169. The processor any of clauses 163-168, wherein the one or more indicators of the one or more numbers of the one or more SMs is included in a sub-context of the one or more processors.
170. A computer-implemented method comprising:
   performing an application programming interface (API) to cause one or more indicators of one or more numbers of one or more streaming multiprocessors (SMs) of one or more processors to be read from one or more data structures storing the one or more indicators.
171. The computer-implemented method of clause 170, wherein performing the API comprises receiving arguments comprising a memory location usable to store the one or more indicators of the one or more SMs.
172. The computer-implemented method of clause 170 or 172, wherein performing the API comprises receiving arguments comprising a type of data to be read from the one or more data structures.
173. The computer-implemented method any of clauses 170-172, wherein performing the API comprises receiving arguments comprising a sub-context indicating resources usable to perform one or more software threads using the one or more SMs.
174. The computer-implemented method any of clauses 170-173, wherein performing the API comprises receiving arguments comprising a context indicating resources usable to perform one or more software threads using the one or more SMs.
175. The computer-implemented method any of clauses 170-174, wherein performing the API comprises indicating that the one or more indicators have been read from the one or more data structures.
176. The computer-implemented method any of clauses 170-175, wherein the one or more indicators of the one or more numbers of the one or more SMs is included in a sub-context of the one or more processors.
177. A computer system comprising:
   one or more processors and memory storing executable instructions that, if performed by the one or more processors, perform an application programming interface (API) to cause one or more indicators of one or more numbers of one or more streaming multiprocessors (SMs) of one or more processors to be read from one or more data structures storing the one or more indicators.
178. The computer system of clause 177, wherein the API is to receive arguments comprising a memory location usable to store the one or more indicators of the one or more SMs.
179. The computer system of clause 177 or 178, wherein the API is to receive arguments comprising a type of data to be read from the one or more data structures.
180. The computer system any of clauses 177-179, wherein the API is to receive arguments comprising a sub-context indicating resources usable to perform one or more software threads using the one or more SMs.
181. The computer system any of clauses 177-180, wherein the API is to receive arguments comprising a context indicating resources usable to perform one or more software threads using the one or more SMs.
182. The computer system any of clauses 177-181, wherein the API is to indicate that the one or more indicators have been read from the one or more data structures.
183. A non-transitory machine-readable medium having stored thereon a set of instructions, which if performed by one or more processors, cause the one or more processors to perform an application programming interface (API) to cause one or more indicators of one or more numbers of one or more streaming multiprocessors (SMs) of one or more processors to be read from one or more data structures storing the one or more indicators.
184. The non-transitory machine-readable medium of clause 183, wherein the API is to receive arguments comprising a memory location usable to store the one or more indicators of the one or more SMs.
185. The non-transitory machine-readable medium of clause 183 or 184, wherein the API is to receive arguments comprising a type of data to be read from the one or more data structures.
186. The non-transitory machine-readable medium any of clauses 183-185, wherein the API is to receive arguments comprising a sub-context indicating resources usable to perform one or more software threads using the one or more SMs.
187. The non-transitory machine-readable medium any of clauses 183-186, wherein the API is to receive arguments comprising a context indicating resources usable to perform one or more software threads using the one or more SMs.
188. The non-transitory machine-readable medium any of clauses 183-187, wherein the API is to indicate that the one or more indicators have been read from the one or more data structures.
189. The non-transitory machine-readable medium any of clauses 183-188, wherein the one or more indicators of the one or more numbers of the one or more SMs is included in a sub-context of the one or more processors.
190. A processor comprising:
   one or more circuits to perform an application programming interface (API) to cause context of one or more first software instructions to be communicated to one or more second software instructions.
191. The processor of clause 190, wherein the API is to receive arguments comprising an indication of the context.
192. The processor of clause 190 or 191, wherein the API is to receive arguments comprising an event usable to cause the context to be communicated.
193. The processor any of clauses 190-192, wherein the context is communicated using a second API to cause the one or more second software instructions to wait to be performed until the one or more second instructions receive the context of the one or more first software instructions.
194. The processor any of clauses 190-193, wherein the API is to indicate that the context has been communicated.
195. The processor any of clauses 190-194, wherein the context comprises one or more sub-contexts.
196. The processor any of clauses 190-195, wherein the context is associated with one or more processors usable to perform the one or more first software instructions.
197. A computer-implemented method comprising:
   performing an application programming interface (API) to cause context of one or more first software instructions to be communicated to one or more second software instructions.
198. The computer-implemented method of clause 197, wherein performing the API comprises receiving arguments comprising an indication of the context.
199. The computer-implemented method of clause 197 or 198, wherein performing the API comprises receiving arguments comprising an event usable to cause the context to be communicated.
200. The computer-implemented method any of clauses 197-199, wherein performing the API comprises communicating the context using a second API to cause the one or more second software instructions to wait to be performed until the one or more second instructions receive the context of the one or more first software instructions.
201. The computer-implemented method any of clauses 197-200, wherein performing the API comprises indicating that the context has been communicated.
202. The computer-implemented method any of clauses 197-201, wherein the context comprises one or more sub-contexts.
203. The computer-implemented method any of clauses 197-202, wherein the context is a sub-context of a primary context of one or more processors usable to perform the one or more first software instructions.
204. A computer system comprising:
   one or more processors and memory storing executable instructions that, if performed by the one or more processors, perform an application programming interface (API) to cause context of one or more first software instructions to be communicated to one or more second software instructions.
205. The computer system of clause 204, wherein the API is to receive arguments comprising an indication of the context.
206. The computer system of clause 204 or 205, wherein the API is to receive arguments comprising an event usable to cause the context to be communicated.
207. The computer system any of clauses 204-206, wherein the context is communicated using a second API to cause the one or more second software instructions to wait to be performed until the one or more second instructions receive the context of the one or more first software instructions.
208. The computer system any of clauses 204-207, wherein the API is to indicate that the context has been communicated.
209. The computer system any of clauses 204-208, wherein the context is associated with one or more processors usable to perform the one or more first software instructions.
210. A non-transitory machine-readable medium having stored thereon a set of instructions, which if performed by one or more processors, cause the one or more processors to perform an application programming interface (API) to cause context of one or more first software instructions to be communicated to one or more second software instructions.
211. The non-transitory machine-readable medium of clause 210, wherein the API is to receive arguments comprising an indication of the context.
212. The non-transitory machine-readable medium of clause 210 or 211, wherein the API is to receive arguments comprising an event usable to cause the context to be communicated.
213. The non-transitory machine-readable medium any of clauses 210-212, wherein the context is communicated using a second API to cause the one or more second software instructions to wait to be performed until the one or more second instructions receive the context of the one or more first software instructions.
214. The non-transitory machine-readable medium any of clauses 210-213, wherein the API is to indicate that the context has been communicated.
215. The non-transitory machine-readable medium any of clauses 210-214, wherein the context comprises one or more sub-contexts.
216. The non-transitory machine-readable medium any of clauses 210-215, wherein the context is associated with one or more processors usable to perform the one or more first software instructions.
217. A processor comprising:
   one or more circuits to perform an application programming interface (API) to cause one or more second instructions to wait to be performed until the one or more second instructions receives context corresponding to one or more first software instructions.
218. The processor of clause 217, wherein the API is to receive arguments comprising an indication of the context.
219. The processor of clause 217 or 218, wherein the API is to receive arguments comprising an event usable to cause the context to be communicated.
220. The processor any of clauses 217-219, wherein the context is communicated using a second API to cause the context of the one or more first software instructions to be communicated to the one or more second software instructions.
221. The processor any of clauses 217-220, wherein the API is to indicate that the context has been received.
222. The processor any of clauses 217-221, wherein the context comprises one or more sub-contexts.
223. The processor any of clauses 217-222, wherein the context is associated with one or more processors usable to perform the one or more second software instructions.
224. A computer-implemented method comprising:
   performing an application programming interface (API) to cause one or more second instructions to wait to be performed until the one or more second instructions receives context corresponding to one or more first software instructions.
225. The computer-implemented method of clause 224, wherein performing the API comprises receiving arguments comprising an indication of the context.
226. The computer-implemented method of clause 224 or 225, wherein performing the API comprises receiving arguments comprising an event usable to cause the context to be communicated.
227. The computer-implemented method any of clauses 224-226, wherein performing the API comprises communicating the context using a second API to cause the context of the one or more first software instructions to be communicated to the one or more second software instructions.
228. The computer-implemented method any of clauses 224-227, wherein performing the API comprises indicating that the context has been received.
229. The computer-implemented method any of clauses 224-228, wherein the context comprises one or more sub-contexts.
230. The computer-implemented method any of clauses 224-229, wherein the context is a context of one or more processors usable to perform the one or more second software instructions.
231. A computer system comprising:
   one or more processors and memory storing executable instructions that, if performed by the one or more processors, perform an application programming interface (API) to cause one or more second instructions to wait to be performed until the one or more second instructions receives context corresponding to one or more first software instructions.
232. The computer system of clause 231, wherein the API is to receive arguments comprising an indication of the context.
233. The computer system of clause 231 or 232, wherein the API is to receive arguments comprising an event usable to cause the context to be communicated.
234. The computer system any of clauses 231-233, wherein the context is communicated using a second API to cause the context of the one or more first software instructions to be communicated to the one or more second software instructions.
235. The computer system any of clauses 231-234, wherein the API is to indicate that the context has been received.
236. The computer system any of clauses 231-235, wherein the context is associated with one or more processors usable to perform the one or more second software instructions.
237. A non-transitory machine-readable medium having stored thereon a set of instructions, which if performed by one or more processors, cause the one or more processors to perform an application programming interface (API) to cause one or more second instructions to wait to be performed until the one or more second instructions receives context corresponding to one or more first software instructions.
238. The non-transitory machine-readable medium of clause 237, wherein the API is to receive arguments comprising an indication of the context.
239. The non-transitory machine-readable medium of clause 237 or 238, wherein the API is to receive arguments comprising an event usable to cause the context to be communicated.
240. The non-transitory machine-readable medium any of clauses 237-239, wherein the context is communicated using a second API to cause the context of the one or more first software instructions to be communicated to the one or more second software instructions.
241. The non-transitory machine-readable medium any of clauses 237-240, wherein the API is to indicate that the context has been received.
242. The non-transitory machine-readable medium any of clauses 237-241, wherein the context comprises one or more sub-contexts.
243. The non-transitory machine-readable medium any of clauses 237-242, wherein the context is associated with one or more processors usable to perform the one or more second software instructions.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). A number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In present document, references may be made to obtaining, acquiring, receiving, or inputting analog or digital data into a subsystem, computer system, or computer-implemented machine. Process of obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor comprising:
one or more circuits to perform an application programming interface (API) to deallocate one or more data structures to indicate which of one or more streaming multiprocessors (SMs) of one or more processors are to be used to perform one or more software threads.

2. The processor of claim 1, wherein the API is to receive arguments comprising a sub-context indicating the one or more data structures to deallocate.

3. The processor of claim 1, wherein the API is to indicate that a sub-context comprising the one or more data structures has been deallocated.

4. The processor of claim 1, wherein the one or more data structures indicate a partitioning of a plurality of SMs of the one or more devices into at least the one or more SMs and a second one or more SMs not including the first one or more SMs.

5. The processor of claim 1, wherein the API is to deallocate one or more data structures allocated by a second API to allocate the one or more data structures.

6. The processor of claim 1, wherein the one or more data structures are included in a context of the one or more processors.

7. The processor of claim 1, wherein the one or more data structures indicate a sub-context of a context of the one or more processors.

8. A computer-implemented method comprising:
performing an application programming interface (API) to deallocate one or more data structures to indicate which of one or more streaming multiprocessors (SMs) of one or more processors are to be used to perform one or more software threads.

9. The computer-implemented method of claim 8, wherein performing the API comprises receiving arguments comprising a sub-context indicating the one or more data structures to deallocate.

10. The computer-implemented method of claim 8, wherein performing the API comprises indicating that a sub-context comprising the one or more data structures has been deallocated.

11. The computer-implemented method of claim 8, wherein the one or more data structures indicate a partitioning of a plurality of SMs of the one or more devices into at least the one or more SMs and a second one or more SMs not including the first one or more SMs.

12. The computer-implemented method of claim 8, wherein performing the API comprises deallocating one or more data structures allocated by a second API to allocate the one or more data structures.

13. The computer-implemented method of claim 8, wherein the one or more data structures are included in a context of the one or more processors.

14. The computer-implemented method of claim 8, wherein the one or more data structures are included in a sub-context of a context of the one or more processors.

15. A computer system comprising:
one or more processors and memory storing executable instructions that, if performed by the one or more processors, perform an application programming interface (API) to deallocate one or more data structures to indicate which of one or more streaming multiprocessors (SMs) of one or more processors are to be used to perform one or more software threads.

16. The computer system of claim 15, wherein the API is to receive arguments comprising a sub-context indicating the one or more data structures to deallocate.

17. The computer system of claim 15, wherein the API is to indicate that a sub-context comprising the one or more data structures has been deallocated.

18. The computer system of claim 15, wherein the one or more data structures indicate a partitioning of a plurality of SMs of the one or more devices into at least the one or more SMs and a second one or more SMs not including the first one or more SMs.

19. The computer system of claim 15, wherein the API is to deallocate one or more data structures allocated by a second API to allocate the one or more data structures.

20. The computer system of claim 15, wherein the one or more data structures are included in a sub-context of a context of the one or more processors.
